(19) United States
(12) Patent Application Publication
(10) Pub. No.: US 2005/0166036 A1
(43) Pub. Date: Jul. 28, 2005

(54) Microcontroller instruction set

(75) Inventors: Michael I. Catherwood, Pepperell, MA (US); Edward Brian Boles, Mesa, AZ (US); Stephen A. Bowling, Chandler, AZ (US); Joshua M. Conner, Apache Junction, AZ (US); Rodney Drake, Gilbert, AZ (US); John Elliott, Chandler, AZ (US); Brian Neil Fall, Chandler, AZ (US); James H. Grosbach, Scottsdale, AZ (US); Tracy Ann Kuhrt, Apache Junction, AZ (US); Guy McCarthy, Chandler, AZ (US); Manuel Muro, Cary, NC (US); Mike Pyska, Phoenix, AZ (US); Joseph W. Triece, Phoenix, AZ (US)

Correspondence Address: BAKER BOTTS, LLP, 910 LOUISIANA, HOUSTON, TX, 77002-4995, US

(73) Assignee: Microchip Technology Inc.

(21) Appl. No.: 10/969,338

(22) Filed: Oct. 19, 2004

Related U.S. Application Data
(63) Continuation-in-part of application No. 09/870,457, filed on Jun. 1, 2001.

(51) Int. Cl. G06F 15/00

(52) U.S. Cl. 712/34

(57) ABSTRACT

An instruction set is provided that features multiple instructions and various address modes to deliver a mixture of flexible microcontroller-like instructions and specialized digital signal processing (“DSP”) execute instructions from a single instruction stream. A subset of instructions of the instruction set can be executed by a processor. Similarly, another subset of the instructions can be utilized by the digital signal processor. A software application can thus take advantage of digital signal processing capabilities in the same program, obviating the need for separate programs for separate processors.

### CROSS REFERENCE TO RELATED APPLICATIONS

This application is a continuation-in-part of, and claims priority to, U.S. patent application Ser. No. 09/870,457 which was filed on Jun. 1, 2001 by the same inventors and assigned to the same entity, and is herein incorporated by reference for all purposes. This application is related to the following applications: U.S. application for “Repeat Instruction with Interrupt” on Jun. 1, 2001 by M. Catherwood, et al. (MTI-1665); U.S. application for “Low Overhead Interrupt” on Jun. 1, 2001 by M. Catherwood, et al. (MTI-1666); U.S. application for “Find First Bit Value Instructions” on Jun. 1, 2001 by M. Catherwood (MTI-1667); U.S. application for “Bit Replacement and Extraction Instructions” on Jun. 1, 2001 by B. Boles, et al. (MTI-1668); U.S. application for “Shadow Register Array Control Instructions” on Jun. 1, 2001 by M. Catherwood, et al. (MTI-1669); U.S. application for “Multi-Precision Barrel Shifting” on Jun. 1, 2001 by J. Conner, et al. (MTI-1670); U.S. application for “Dynamically Reconfigurable Data Space” on Jun. 1, 2001 by M. Catherwood, et al. (MTI-1735); U.S. application for “Modified Harvard Architecture Processor Having Data Memory Space Mapped to Program Memory Space” on Jun. 1, 2001 by J. Grosbach, et al. (MTI-1736); U.S. application for “Modified Harvard Architecture Processor Having Data Memory Space Mapped to Program Memory Space with Erroneous Execution Protection” on Jun. 1, 2001 by M. Catherwood (MTI-1737); U.S. application for “Dual Mode Arithmetic Saturation Processing” on Jun. 1, 2001 by M. Catherwood (MTI-1738); U.S. application for “Compatible Effective Addressing With a Dynamically Reconfigurable Data Space Word Width” on Jun. 1, 2001 by M. Catherwood, et al. (MTI-1739); U.S. application for “Maximally Negative Signed Fractional Number Multiplication” on Jun. 1, 2001 by M. Catherwood (MTI-1754); U.S. application for “Euclidean Distance Instructions” on Jun. 1, 2001 by M. Catherwood (MTI-1755); U.S. application for “Sticky Z Bit” on Jun. 1, 2001 by J. Elliot (MTI-1756); U.S. application for “Variable Cycle Interrupt Disabling” on Jun. 1, 2001 by B. Boles, et al. (MTI-1757); U.S. application for “Register Pointer Trap” on Jun. 1, 2001 by M. Catherwood (MTI-1758); U.S. application for “Modulo Addressing Based on Absolute Offset” on Jun. 1, 2001 by M. Catherwood (MTI-1759); U.S. application for “Dual Dead Time Unit for PWM Module” on Jun. 1, 2001 by S. Bowling (MTI-1789); U.S. application for “Fault Pin Priority” on Jun. 1, 2001 by S. Bowling (MTI-1790); U.S. application for “Extended Resolution Mode for PWM Module” on Jun. 1, 2001 by S. Bowling (MTI-1791); U.S. application for “Configuration Fuses for Setting PWM Options” on Jun. 1, 2001 by S. Bowling (MTI-1792); U.S. application for “Automatic A/D Sample Triggering” on Jun. 1, 2001 by B. Boles (MTI-1794); U.S. application for “Reduced Power Option” on Jun. 1, 2001 by M. Catherwood (MTI-1796) which are all hereby incorporated herein by reference for all purposes.

### FIELD OF THE INVENTION

The present invention relates generally to processor instruction sets and, more particularly, to an instruction set for processing micro-controller type instructions and digital signal processor instructions from a single instruction stream.

### BACKGROUND OF THE INVENTION

Processors, including microprocessors, digital signal processors and microcontrollers, operate by running software programs that are embodied in one or more series of instructions stored in a memory. The processors run the software by fetching the instructions from the series of instructions, decoding the instructions and executing them.

In addition to program instructions, data is also stored in memory that is accessible by the processor. Generally, the program instructions process data by accessing data in memory, modifying the data and storing the modified data into memory.

The instructions themselves also control the sequence of functions that the processor performs and the order in which the processor fetches and executes the instructions. For example, the order for fetching and executing each instruction may be inherent in the order of the instructions within the series. Alternatively, instructions such as branch instructions, conditional branch instructions, subroutine calls and other flow control instructions may cause instructions to be fetched and executed out of the inherent order of the instruction series.

The program instructions that comprise a software program are taken from an instruction set that is designed for each processor. The instruction set includes a plurality of instructions, each of which specifies operations of one or more functional components of the processor. The instructions are decoded in an instruction decoder which generates control signals distributed to the functional components of the processor to perform the operation(s) specified in the instruction.

The instruction set itself, in terms of breadth, flexibility and simplicity dictates the ease with which programmers may generate programs. The instruction set also reflects the processor architecture and accordingly the functional and performance capability of the processor.

There is a need for a processor and an instruction set that includes a robust and an efficient set of instructions for a wide variety of applications. Given the rapid growth of digital signal processing (DSP) applications, there is a further need for an instruction set that incorporates DSP type instructions and micro-controller type instructions. There is a further need to provide processor having a tightly coupled DSP engine and a microcontroller arithmetic logic unit (ALU) for many types of applications conventionally handled separately by either a microcontroller or a digital signal processor, including motor control, soft modems, automotive body computers, speech recognition, echo cancellation and fingerprint recognition.

### SUMMARY OF THE INVENTION

According to embodiments of the present invention, an instruction set is provided that features ninety four instructions and eleven address modes to deliver a mixture of flexible micro-controller like instructions and specialized digital signal processor (DSP) instructions that execute from a single instruction stream.

According to an embodiment of the present invention, a processor executes instructions within the designated instruction set. The processor includes a program memory, a program counter, registers and at least one execution unit. The program memory stores program instructions, including instructions from the designated instruction set. The program counter determines the current instruction for processing. The registers store operand data specified by the program instructions and the execution unit(s) execute the current instruction. The execution unit may include a DSP engine and arithmetic logic unit. Each designated instruction is identified to the processor by designated encoding and to programmers by a designated mnemonic.

### BRIEF DESCRIPTION OF THE DRAWINGS

A more complete understanding of the present disclosure and advantages thereof may be acquired by referring to the following description taken in conjunction with the accompanying drawings, wherein:

FIG. 1 depicts a functional block diagram of an embodiment of a processor chip within which embodiments of the present invention may find application.

FIG. 2 depicts a functional block diagram of a data busing scheme for use in a processor, which has a microcontroller and a digital signal processing engine, within which embodiments of the present invention may find application.

FIG. 3 depicts a functional block diagram of a digital signal processor (“DSP”) engine according to an embodiment of the present disclosure.

FIGS. 4A-4E depict five different instruction flow types according to embodiments of the present disclosure.

FIG. 5 depicts a programmer's model of the processor according to an embodiment of the present disclosure.

FIG. 6 is a block diagram illustrating a Program Memory Addressing Scheme according to an embodiment of the present disclosure.

FIG. 7 is a block diagram illustrating a illustrating a “CALL lit23” Map to the Program Counter according to an embodiment of the present disclosure.

FIG. 8 is a block diagram illustrating a “BRA SLIT16” Map to the Program Counter according to an embodiment of the present disclosure.

FIG. 9 is a block diagram illustrating a “GOTO Wn” Map to the Program Counter according to an embodiment of the present disclosure.

FIG. 10 is a block diagram illustrating a “BRA Wn” Map to the Program Counter according to an embodiment of the present disclosure.

FIG. 11 is a block diagram illustrating a Data Alignment in Memory according to an embodiment of the present disclosure.

FIG. 12 is a block diagram illustrating a MOV.D operation according to an embodiment of the present disclosure.

FIG. 13 is a block diagram illustrating a MOV.Q operation according to an embodiment of the present disclosure.

FIG. 14 is a block diagram illustrating a stack at the beginning of a calling sequence according to an embodiment of the present disclosure.

FIG. 15 is a block diagram illustrating a stack at the entry to a routine according to an embodiment of the present disclosure.

FIG. 16 is a block diagram illustrating a stack after a LNK instruction according to an embodiment of the present disclosure.

FIG. 17 is a block diagram illustrating a Multi-Word Left Shift by 4 Instruction Execution according to an embodiment of the present disclosure.

FIG. 18 is a block diagram illustrating a Multi-Word Left Shift by 20 Instruction Execution according to an embodiment of the present disclosure.

FIG. 19 is a block diagram illustrating a Multi-Word Right Shift by 4 Instruction Execution according to an embodiment of the present disclosure.

FIG. 20 is a block diagram illustrating a Multi-Word Right Shift by 20 Instruction Execution according to an embodiment of the present disclosure.

FIG. 21 is a block diagram illustrating a 16-Bit integer and fractional modes according to an embodiment of the present disclosure.

FIG. 22 is a block diagram illustrating a DO operation according to an embodiment of the present disclosure.

FIG. 23 is a block diagram illustrating an alternate embodiment of the DO operation according to an embodiment of the present disclosure.

FIG. 24 is a block diagram illustrating a Register Direct addressing mode according to an embodiment of the present disclosure.

FIG. 25 is a block diagram illustrating an alternate Register Indirect addressing mode according to an embodiment of the present disclosure.

FIG. 26 is a block diagram illustrating a Register Indirect with Post-Decrement addressing mode according to an embodiment of the present disclosure.

FIG. 27 is a block diagram illustrating a Register Indirect with Post-Increment addressing mode according to an embodiment of the present disclosure.

FIG. 28 is a block diagram illustrating a Register Indirect with Pre-Decrement addressing mode according to an embodiment of the present disclosure.

FIG. 29 Register Indirect with Pre-Increment Addressing mode according to an embodiment of the present disclosure.

FIG. 30 is a block diagram illustrating a Register Direct with 5-bit signed Literal Operation mode according to an embodiment of the present disclosure.

FIG. 31 is a block diagram illustrating a Register Direct, Operand Source mode according to an embodiment of the present disclosure.

FIG. 32 is a block diagram illustrating a Register Indirect, Result Destination mode according to an embodiment of the present disclosure.

FIG. 33 is a block diagram illustrating a Register Indirect, Operand Source mode according to an embodiment of the present disclosure.

FIG. 34 is a block diagram illustrating a Register Indirect, Result Destination mode according to an embodiment of the present disclosure.

FIG. 35 is a block diagram illustrating a Register Indirect with Post Decrement, Source Operand mode according to an embodiment of the present disclosure.

FIG. 36 is a block diagram illustrating a Register Indirect with Post Decrement, Result Destination mode according to an embodiment of the present disclosure.

FIG. 37 is a block diagram illustrating a Register Indirect with Post Increment, Operand Source mode according to an embodiment of the present disclosure.

FIG. 38 is a block diagram illustrating a Register Indirect with Post Increment, Result Destination mode according to an embodiment of the present disclosure.

FIG. 39 is a block diagram illustrating a Register Indirect with Pre-Decrement, Source Operand mode according to an embodiment of the present disclosure.

FIG. 40 is a block diagram illustrating a Register Indirect with Pre-Decrement, Result Destination mode according to an embodiment of the present disclosure.

FIG. 41 is a block diagram illustrating a Register Indirect with Pre-Increment, Source Operand mode according to an embodiment of the present disclosure.

FIG. 42 is a block diagram illustrating a Register Indirect with Pre-Increment, Result Destination mode according to an embodiment of the present disclosure.

FIG. 43 is a block diagram illustrating a Register Direct, Operand Source mode according to an embodiment of the present disclosure.

FIG. 44 is a block diagram illustrating a Register Direct, Operand Source mode according to an embodiment of the present disclosure.

FIG. 45 is a block diagram illustrating a Register Indirect, Source Operand mode according to an embodiment of the present disclosure.

FIG. 46 is a block diagram illustrating a Register Indirect, Result Destination mode according to an embodiment of the present disclosure.

FIG. 47 is a block diagram illustrating a Register Indirect with Post Decrement, Source Operand mode according to an embodiment of the present disclosure.

FIG. 48 is a block diagram illustrating a Register Indirect with Post Decrement, Result Destination mode according to an embodiment of the present disclosure.

FIG. 49 is a block diagram illustrating a Register Indirect with Post Increment, Source Operand mode according to an embodiment of the present disclosure.

FIG. 50 is a block diagram illustrating a Register Indirect with Post Increment, Result Destination mode according to an embodiment of the present disclosure.

FIG. 51 is a block diagram illustrating a Register Indirect with Pre-Decrement, Source Operand mode according to an embodiment of the present disclosure.

FIG. 52 is a block diagram illustrating a Register Indirect with Pre-Decrement, Result Destination mode according to an embodiment of the present disclosure.

FIG. 53 is a block diagram illustrating a Register Indirect with Register Offset, Operand Source mode according to an embodiment of the present disclosure.

FIG. 54 is a block diagram illustrating a Register Indirect with Register Offset, Result Destination mode according to an embodiment of the present disclosure.

FIG. 55 is a block diagram illustrating a Register Indirect with Constant Offset, Source Operand mode according to an embodiment of the present disclosure.

FIG. 56 is a block diagram illustrating a Register Indirect with Constant Offset, Result Destination mode according to an embodiment of the present disclosure.

FIG. 57 is a block diagram illustrating a Register Indirect with Pre-Decrement, Source Operand mode according to an embodiment of the present disclosure.

FIG. 58 is a block diagram illustrating a Register Indirect with Pre-Decrement, Result Destination mode according to an embodiment of the present disclosure.

FIG. 59 is a block diagram illustrating a Register Indirect mode according to an embodiment of the present disclosure.

FIG. 60 is a block diagram illustrating a Register Indirect with Post Increment mode according to an embodiment of the present disclosure.

FIG. 61 is a block diagram illustrating a Register Indirect with Register Offset Operand Source mode according to an embodiment of the present disclosure.

FIG. 62 is a block diagram illustrating a Register Indirect with Post Decrement mode according to an embodiment of the present disclosure.

FIG. 63 is a block diagram illustrating an X AGU according to an embodiment of the present disclosure.

FIG. 64 is a block diagram illustrating a Y AGU according to an embodiment of the present disclosure.

FIG. 65 is a block diagram illustrating an Incrementing Buffer Modulo addressing operation according to an embodiment of the present disclosure.

FIG. 66 is a block diagram illustrating a Decrementing Buffer Modulo addressing operation according to an embodiment of the present disclosure.

FIG. 67 is a block diagram illustrating a Bit Reversed EA calculation according to an embodiment of the present disclosure.

FIG. 68 is a block diagram illustrating a Alternative Bit Reversed EA calculation method according to an embodiment of the present disclosure.

FIG. 69 is a block diagram illustrating a Bit Reversed Addressing, Source Operand mode according to an embodiment of the present disclosure.

FIG. 70 is a block diagram illustrating a Bit Reversed Addressing, Destination Operand mode according to an embodiment of the present disclosure.

FIG. 71 is a block diagram illustrating a Register Indirect, Table Read Operand Destination mode according to an embodiment of the present disclosure.

FIG. 72 is a block diagram illustrating a Register Indirect, Table Read Operand Source mode according to an embodiment of the present disclosure.

FIG. 73 is a block diagram illustrating a Register Indirect, Table Read Result Destination mode according to an embodiment of the present disclosure.

FIG. 74 is a block diagram illustrating a Register Indirect with Post Decrement, Table Read Source Operand mode according to an embodiment of the present disclosure.

FIG. 75 is a block diagram illustrating a Register Indirect with Post Decrement, Table Read Result Destination mode according to an embodiment of the present disclosure.

FIG. 76 is a block diagram illustrating a Register Indirect with Post Increment, Table Read Operand Source mode according to an embodiment of the present disclosure.

FIG. 77 is a block diagram illustrating a Register Indirect with Post Increment, Table Read Result Destination mode according to an embodiment of the present disclosure.

FIG. 78 is a block diagram illustrating a Register Indirect with Pre-Decrement, Table Read Source Operand mode according to an embodiment of the present disclosure.

FIG. 79 is a block diagram illustrating a Register Indirect with Pre-Decrement, Table Read Result Destination mode according to an embodiment of the present disclosure.

FIG. 80 is a block diagram illustrating a Register Indirect with Pre-Increment, Table Read Source Operand mode according to an embodiment of the present disclosure.

FIG. 81 is a block diagram illustrating a Register Indirect with Pre-Increment, Table Read Result Destination according to an embodiment of the present disclosure.

FIG. 82 is a timing diagram illustrating a XOR, the SUBR, the SUBR, the SUB B, the SUB, the MOVE, the IOR, the AND, the ADDC and the ADD operations according to an embodiment of the present disclosure.

FIG. 83 is a timing diagram illustrating a XORLS, the SUBRLS, the SUBLS, the SUBBRLS, the SUBLS, the IORLS, the ANDLS, the ADCCLS and the ADDCLS operations according to an embodiment of the present disclosure.

FIG. 84 is a timing diagram illustrating a COR, the INC2, the DEC2, the DEC COM, the NEG and the NCTM operations according to an embodiment of the present disclosure.

FIG. 85 is a timing diagram illustrating a ASR, the LSR, the ZE, the SE, the SL, the RLC, the RLNC, the RRC and the RRNC operation according to an embodiment of the present disclosure.

FIG. 86 is a timing diagram illustrating a CPB and the CP operations according to an embodiment of the present disclosure.

FIG. 87 is a timing diagram illustrating a CP1 and the CP0 operations according to an embodiment of the present disclosure.

FIG. 88 is a timing diagram illustrating a CPBLS and the CPBLS operations according to an embodiment of the present disclosure.

FIG. 89 is a timing diagram illustrating a XORLW, the SUBLW, the SUBBBLW, the MOVLW, the MOVL, the IORLW, the ANDLW, the ADDLW and the ADDCLW operations according to an embodiment of the present disclosure.

FIG. 90 is a timing diagram illustrating a ASRF, the SLF, the LSRF, the RRNCF, the RRCF, the RLNCF, the RLCF, the XORWF, the SUBWS, the SUBBWS, the SUBFW, the SUBDFW, the MOVFW, the MOV, the IORWV, the ANDWF, the ADDWFC and the ADDWF operations according to an embodiment of the present disclosure.

FIG. 91 is a timing diagram illustrating a CPFB, the CPF1, the CPF0 and the CPF operations according to an embodiment of the present disclosure.

FIG. 92 is a timing diagram illustrating a INCF, the DECF, the NEGF, the SETF, the COMF and the CLRF operations according to an embodiment of the present disclosure.

FIG. 93 is a timing diagram illustrating a CPFSEQ, the FPFSGT, the CPFSLT and the CPFSNE operations according to an embodiment of the present disclosure.

FIG. 94 is a timing diagram illustrating an INCFSNZ, the INCFSA, the DECFSNZ, and the DECFSZ operations according to an embodiment of the present disclosure.

FIG. 95 is a timing diagram illustrating a SWAP operation according to an embodiment of the present disclosure.

FIG. 96 is a timing diagram illustrating a STW operation according to an embodiment of the present disclosure.

FIG. 97 is a timing diagram illustrating a EXCH operation according to an embodiment of the present disclosure.

FIG. 98 is a timing diagram illustrating a BSW operation according to an embodiment of the present disclosure.

FIG. 99 is a timing diagram illustrating a BTSTW operation according to an embodiment of the present disclosure.

FIG. 100 is a timing diagram illustrating a BCLRF, the BTSTSF, the BTSTF, the BTGF and BSETF operations according to an embodiment of the present disclosure.

FIG. 101 is a timing diagram illustrating a BSET, the BTG, the BTST, the BTSTS, and the BCLR operations according to an embodiment of the present disclosure.

FIG. 102 is a timing diagram illustrating a BTSS, the BTSC, the BTFSC and the BTFSS operations according to an embodiment of the present disclosure.

FIG. 103 is a timing diagram illustrating a TBLRDH and the TBLRDL operations according to an embodiment of the present disclosure.

FIG. 104 is a timing diagram illustrating a TBLWTH and the TBLWTL operations according to an embodiment of the present disclosure.

FIG. 105 is a timing diagram illustrating a LDQW operation according to an embodiment of the present disclosure.

FIG. 106 is a timing diagram illustrating a LDDW operation according to an embodiment of the present disclosure.

FIG. 107 is a timing diagram illustrating a STQW operation according to an embodiment of the present disclosure.

FIG. 108 is a timing diagram illustrating a STDW operation according to an embodiment of the present disclosure.

FIG. 109 is a timing diagram illustrating a MULS, the MULSU, the MULSULS, the MULU, the MULULS and the MULUS operations according to an embodiment of the present disclosure.

FIG. 110 is a timing diagram illustrating a MULWF operation according to an embodiment of the present disclosure.

FIG. 111 is a timing diagram illustrating an ALL BRANCHES operation according to an embodiment of the present disclosure.

FIG. 112 is a timing diagram illustrating a BRAW operation according to an embodiment of the present disclosure.

FIG. 113 is a timing diagram illustrating a RCALL, and the RCALLW operations according to an embodiment of the present disclosure.

FIG. 114 is a timing diagram illustrating a CALLW operation according to an embodiment of the present disclosure.

FIG. 115 is a timing diagram illustrating a CALL operation according to an embodiment of the present disclosure.

FIG. 116 is a timing diagram illustrating a GOTOW operation according to an embodiment of the present disclosure.

FIG. 117 is a timing diagram illustrating a GOTO operation according to an embodiment of the present disclosure.

FIG. 118 is a timing diagram illustrating a LNK operation according to an embodiment of the present disclosure.

FIG. 119 is a timing diagram illustrating a ULNK operation according to an embodiment of the present disclosure.

FIG. 120 is a timing diagram illustrating a DAW operation according to an embodiment of the present disclosure.

FIG. 121 is a timing diagram illustrating a SCRATCH operation according to an embodiment of the present disclosure.

FIG. 122 is a timing diagram illustrating a ITCH operation according to an embodiment of the present disclosure.

FIG. 123 is a timing diagram illustrating a PUSH operation according to an embodiment of the present disclosure.

FIG. 124 is a timing diagram illustrating a POP operation according to an embodiment of the present disclosure.

FIG. 125 is a timing diagram illustrating a LDW operation according to an embodiment of the present disclosure.

FIG. 126 is a timing diagram illustrating a TRAP operation according to an embodiment of the present disclosure.

FIG. 127 is a timing diagram illustrating a DISI operation according to an embodiment of the present disclosure.

FIG. 128 is a timing diagram illustrating a LDW operation according to an embodiment of the present disclosure.

FIG. 129 is a timing diagram illustrating a DO and the DOW operations according to an embodiment of the present disclosure.

FIG. 130 is a timing diagram illustrating a DO and the DOW operations continued according to an embodiment of the present disclosure.

FIG. 131 is a timing diagram illustrating a MAC, the CLRAC, the EDAC, the SQRAC and the MOVSAC operations according to an embodiment of the present disclosure.

FIG. 132 is a timing diagram illustrating a SQR, the ED, the MPY, the MPYN and the MSC operations according to an embodiment of the present disclosure.

FIG. 133 is a timing diagram illustrating a LSRW, the LSRK, the ASRK, the ASRW, the SLW and the SLK operations according to an embodiment of the present disclosure.

FIG. 134 is a timing diagram illustrating a ADDAB, the NEGAB and the SUBAB operations according to an embodiment of the present disclosure.

FIG. 135 is a timing diagram illustrating an ADDAC operation according to an embodiment of the present disclosure.

FIG. 136 is a timing diagram illustrating a LAC operation according to an embodiment of the present disclosure.

FIG. 137 is a timing diagram illustrating a SAC and the SAC.R operations according to an embodiment of the present disclosure.

FIG. 138 is a timing diagram illustrating a SFTACK and the SFTAC operations according to an embodiment of the present disclosure.

FIG. 139 is a timing diagram illustrating a RETURN, the RE and the TFIE operations according to an embodiment of the present disclosure.

FIG. 140 is a timing diagram illustrating a MSLK, the MSRK, the MSLW and the MSRW operations according to an embodiment of the present disclosure.

FIG. 141 is a timing diagram illustrating a FBCL, the FBCR, the FFOL, the FFOR, the FFIL and the FFIR operations according to an embodiment of the present disclosure.

FIG. 142 is a timing diagram illustrating a RETLW operation according to an embodiment of the present disclosure.

FIG. 143 is a timing diagram illustrating a REPEAT and the REPEAT W operations according to an embodiment of the present disclosure.

FIG. 144 is a timing diagram illustrating a REPEAT and the REPEAT W operations continued according to an embodiment of the present disclosure.

FIG. 145 is a block diagram illustrating a CPU Core according to an embodiment of the present disclosure.

FIG. 146 is a block diagram illustrating data alignment according to an embodiment of the present disclosure.

FIG. 147 is a block diagram illustrating a Data Space Memory Map Example according to an embodiment of the present disclosure.

FIG. 148 is a block diagram illustrating a data space for a microcontroller and digital signal processor instructions according to an embodiment of the present disclosure.

FIG. 149 is a block diagram illustrating a data space window into the program space operation according to an embodiment of the present disclosure.

FIG. 150 is a block diagram illustrating a PS Data Read-Through DS operation according to an embodiment of the present disclosure.

FIG. 151 is a block diagram illustrating a PS Data Read-Through DS within a REPEAT loop operation according to an embodiment of the present disclosure.

FIG. 152 is a block diagram illustrating a data access operation from program space address generation according to an embodiment of the present disclosure.

FIG. 153 is a block diagram illustrating an instruction fetch according to an embodiment of the present disclosure.

FIG. 154 is a block diagram illustrating a program space memory map according to an embodiment of the present disclosure.

FIG. 155 is a block diagram illustrating a program data table access according to an embodiment of the present disclosure.

FIG. 156 is a block diagram illustrating program data table access according to an embodiment of the present disclosure.

FIG. 157 is a block diagram illustrating HEX file compatibility according to an embodiment of the present disclosure.

FIG. 158 is a basic core timing diagram according to an embodiment of the present disclosure.

FIG. 159 is a timing diagram illustrating a clock/instruction cycle according to an embodiment of the present disclosure.

FIG. 160 is a flow chart illustrating a REPEAT[W] loop functional flow according to an embodiment of the present disclosure.

FIG. 161 is a block diagram illustrating a REPEAT[W] instruction pipeline Flow according to an embodiment of the present disclosure.

FIG. 162 is a block diagram of a Do Loop hardware operation according to an embodiment of the present disclosure.

FIG. 163 is timing diagram of a DO loop entry operation according to an embodiment of the present disclosure.

FIG. 164 is a timing diagram illustrating a DO loop continuation operation according to an embodiment of the present disclosure.

FIG. 165 is a timing diagram illustrating a DO Continue with Branch to Last Instruction operation according to an embodiment of the present disclosure.

FIG. 166 is a timing diagram illustrating a DO loop EXIT operation according to an embodiment of the present disclosure.

FIG. 167 is a flow chart illustrating a DO and REPEAT operation according to an embodiment of the present disclosure.

FIG. 168 is a block diagram illustrating an Uninitialized W Register Trap operation according to an embodiment of the present disclosure.

FIG. 169 is a block diagram illustrating a Stack Pointer Overflow & Underflow Trap operation according to an embodiment of the present disclosure.

FIG. 170 is a timing diagram illustrating a Stack Timing of a PC PUSH CALL operation according to an embodiment of the present disclosure.

FIG. 171 is a timing diagram illustrating a Stack Timing of a PC POP RETURN operation according to an embodiment of the present disclosure.

FIG. 172 is a block diagram illustrating a CALL stack frame according to an embodiment of the present disclosure.

FIG. 173a is a block diagram illustrating a stack pointer at initialization according to an embodiment of the present disclosure.

FIG. 173b is a block diagram illustrating a stack pointer after a PUSH operation according to an embodiment of the present disclosure.

FIG. 173c is a block diagram illustrating a stack pointer after a PUSH operation according to an embodiment of the present disclosure.

FIG. 173d is a block diagram illustrating a stack pointer after a POP operation according to an embodiment of the present disclosure.

While the present invention is susceptible to various modifications and alternative forms, specific exemplary embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

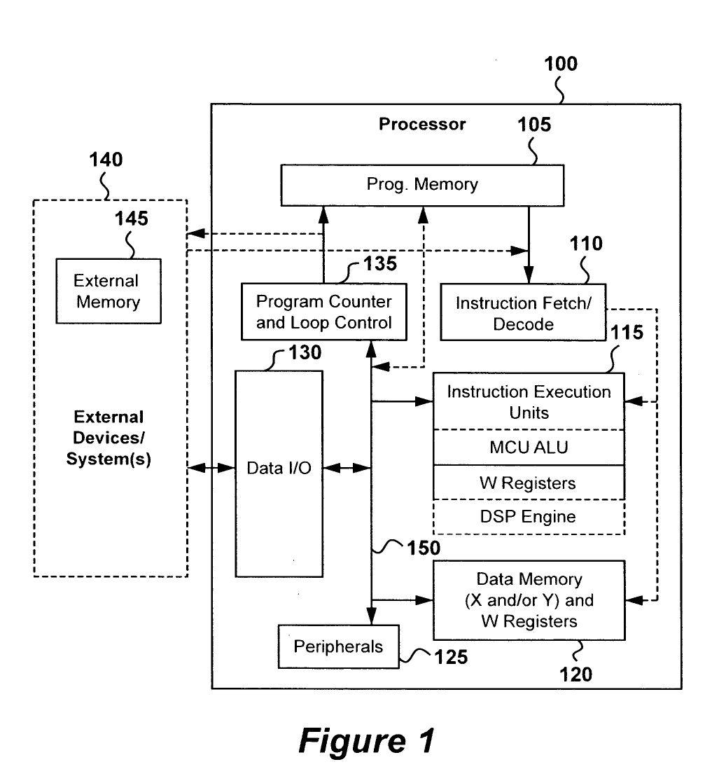

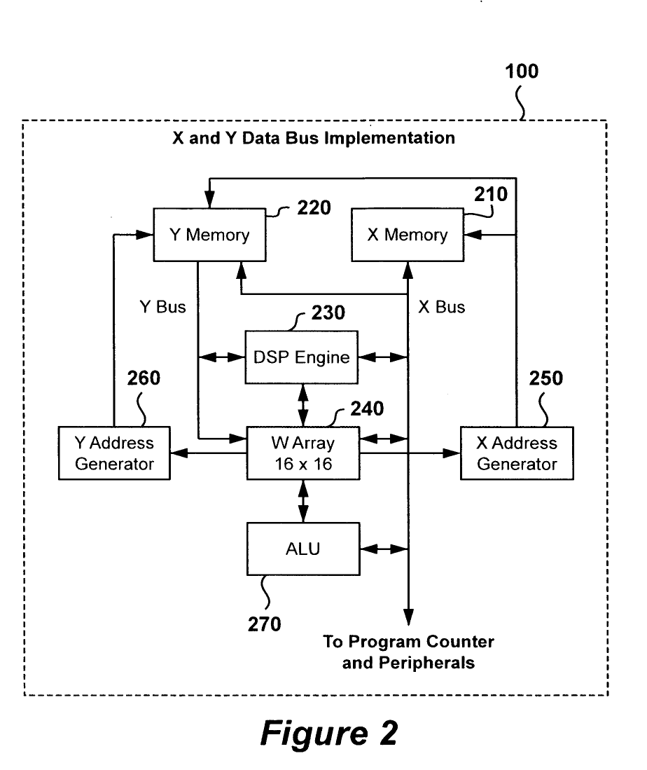

In order to describe the instruction set and its relationship to a processor for executing the instruction set, an overview of pertinent processor elements is first presented with reference to FIGS. 1 and 2. The overview section describes the process of fetching, decoding and executing program instructions taken from the instruction set according to embodiments of the present invention.

Overview of Processor Elements

FIG. 1 depicts a functional block diagram of an embodiment of a processor chip within which the present invention may find application. Referring to FIG. 1, a processor 100 is coupled to external devices/systems 140. The processor 100 may be any type of processor including, for example, a digital signal processor (DSP), a microprocessor, a microcontroller or combinations thereof. The external devices 140 may be any type of systems or devices including input/output devices such as keyboards, displays, speakers, microphones, memory, or other systems which may or may not include processors. Moreover, the processor 100 and the external devices 140 may together comprise a stand alone system.

The processor 100 includes a program memory 105, an instruction fetch/decode unit 110, instruction execution units 115, data memory and registers 120, peripherals 125, data I/O 130, and a program counter and loop control unit 135. The bus 150, which may include one or more common buses, communicates data between the units as shown.

The program memory 105 stores software embodied in program instructions for execution by the processor 100. The program memory 105 may comprise any type of nonvolatile memory such as a read only memory (ROM), a programmable read only memory (PROM), an electrically programmable or an electrically programmable and erasable read only memory (EPROM or EEPROM) or flash memory. In addition, the program memory 105 may be supplemented with external nonvolatile memory 145 as shown to increase the complexity of software available to the processor 100. Alternatively, the program memory may be volatile memory which receives program instructions from, for example, an external non-volatile memory 145. When the program memory 105 is nonvolatile memory, the program memory may be programmed at the time of manufacturing the processor 100 or prior to or during implementation of the processor 100 within a system. In the latter scenario, the processor 100 may be programmed through a process called in-line serial programming.

The instruction fetch/decode unit 110 is coupled to the program memory 105, the instruction execution units 115 and the data memory 120. Coupled to the program memory 105 and the bus 150 is the program counter and loop control unit 135. The instruction fetch/decode unit 110 fetches the instructions from the program memory 105 specified by the address value contained in the program counter 135. The instruction fetch/decode unit 110 then decodes the fetched instructions and sends the decoded instructions to the appropriate execution unit 115. The instruction fetch/decode unit 110 may also send operand information including addresses of data to the data memory 120 and to functional elements that access the registers.

The program counter and loop control unit 135 includes a program counter register (not shown) which stores an address of the next instruction to be fetched. During normal instruction processing, the program counter register may be incremented to cause sequential instructions to be fetched. Alternatively, the program counter value may be altered by loading a new value into it via the bus 150. The new value may be derived based on decoding and executing a flow control instruction such as, for example, a branch instruction. In addition, the loop control portion of the program counter and loop control unit 135 may be used to provide repeat instruction processing and repeat loop control as further described below.

The instruction execution units 115 receive the decoded instructions from the instruction fetch/decode unit 110 and thereafter execute the decoded instructions. As part of this process, the execution units may retrieve one or two operands via the bus 150 and store the result into a register or memory location within the data memory 120. The execution units may include an arithmetic logic unit (ALU) such as those typically found in a microcontroller. The execution units may also include a digital signal processing engine, a floating point processor, an integer processor or any other convenient execution unit. A preferred embodiment of the execution units and their interaction with the bus 150, which may include one or more buses, is presented in more detail below with reference to FIG. 2.

The data memory and registers 120 are volatile memory and are used to store data used and generated by the execution units. The data memory 120 and program memory 105 are preferably separate memories for storing data and program instructions respectively. This format is a known generally as a Harvard architecture. It is noted, however, that according to the present invention, the architecture may be a Von-Neuman architecture or a modified Harvard architecture which permits the use of some program space for data space. A dotted line is shown, for example, connecting the program memory 105 to the bus 150. This path may include logic for aligning data reads from program space such as, for example, during table reads from program space to data memory 120.

Referring again to FIG. 1, a plurality of peripherals 125 on the processor may be coupled to the bus 125. The peripherals may include, for example, analog to digital converters, timers, bus interfaces and protocols such as, for example, the controller area network (CAN) protocol or the Universal Serial Bus (USB) protocol and other peripherals. The peripherals exchange data over the bus 150 with the other units.

The data I/O unit 130 may include transceivers and other logic for interfacing with the external devices/systems 140. The data I/O unit 130 may further include functionality to permit in circuit serial programming of the Program memory through the data I/O unit 130.

FIG. 2 depicts a functional block diagram of a data busing scheme for use in a processor 100, such as that shown in FIG. 1, which has an integrated microcontroller arithmetic logic unit (ALU) 270 and a digital signal processing (DSP) engine 230. This configuration may be used to integrate DSP functionality to an existing microcontroller core. Referring to FIG. 2, the data memory 120 of FIG. 1 is implemented as two separate memories: an X-memory 210 and a Y-memory 220, each being respectively addressable by an X-address generator 250 and a Y-address generator 260. The X-address generator may also permit addressing the Y-memory space thus making the data space appear like a single contiguous memory space when addressed from the X address generator. The bus 150 may be implemented as two buses, one for each of the X and Y memory, to permit simultaneous fetching of data from the X and Y memories.

The W registers 240 are general purpose address and/or data registers. The DSP engine 230 is coupled to both the X and Y memory buses and to the W registers 240. The DSP engine 230 may simultaneously fetch data from each the X and Y memory, execute instructions which operate on the simultaneously fetched data and write the result to an accumulator (not shown) and write a prior result to X or Y memory or to the W registers 240 within a single processor cycle.

In one embodiment, the ALU 270 may be coupled only to the X memory bus and may only fetch data from the X bus. However, the X and Y memories 210 and 220 may be addressed as a single memory space by the X address generator in order to make the data memory segregation transparent to the ALU 270. The memory locations within the X and Y memories may be addressed by values stored in the W registers 240.

Any processor clocking scheme may be implemented for fetching and executing instructions. A specific example follows, however, to illustrate an embodiment of the present invention. Each instruction cycle is comprised of four Q clock cycles Q1-Q4. The four phase Q cycles provide timing signals to coordinate the decode, read, process data and write data portions of each instruction cycle.

According to one embodiment of the processor 100, the processor 100 concurrently performs two operations—it fetches the next instruction and executes the present instruction. Accordingly, the two processes occur simultaneously. The following sequence of events may comprise, for example, the fetch instruction cycle:
Q1: Fetch Instruction
Q2: Fetch Instruction
Q3: Fetch Instruction
Q4: Latch Instruction into prefetch register, Increment PC

The following sequence of events may comprise, for example, the execute instruction cycle for a single operand instruction:
Q1: latch instruction into IR, decode and determine addresses of operand data
Q2: fetch operand
Q3: execute function specified by instruction and calculate destination address for data
Q4: write result to destination

The following sequence of events may comprise, for example, the execute instruction cycle for a dual operand instruction using a data pre-fetch mechanism. These instructions pre-fetch the dual operands simultaneously from the X and Y data memories and store them into registers specified in the instruction. They simultaneously allow instruction execution on the operands fetched during the previous cycle.
Q1: latch instruction into IR, decode and determine addresses of operand data
Q2: pre-fetch operands into specified registers, execute operation in instruction
Q3: execute operation in instruction, calculate destination address for data
Q4: complete execution, write result to destination
   Digital Signal Processing Engine

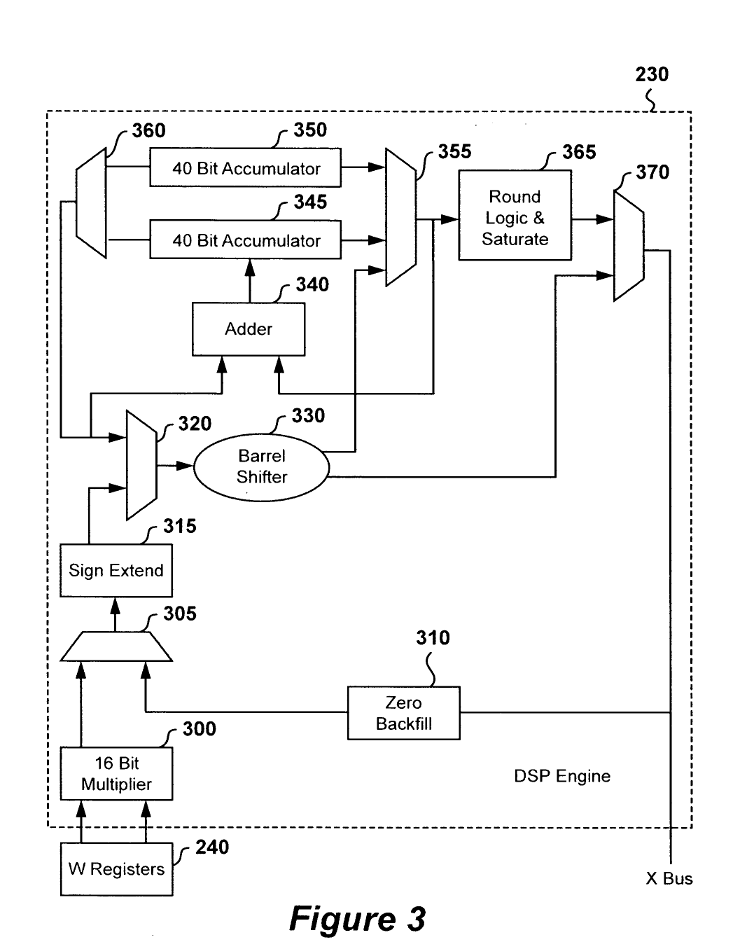

FIG. 3 depicts a functional block diagram of the DSP engine 230. The DSP engine executes various instructions within the instruction set according to embodiments of the present invention. The DSP engine 230 is coupled to the X and the Y bus and the W registers 240. The DSP engine includes a multiplier 300, a barrel shifter 330, an adder/subtractor 340, two accumulators 345 and 350 and round and saturation logic 365. These elements and others that are discussed below with reference to FIG. 3 cooperate to process DSP instructions including, for example, multiply and accumulate instructions and shift instructions. According to one embodiment of the invention, the DSP engine operates as an asynchronous block with only the accumulators and the barrel shifter result registers being clocked. Other configurations, including pipelined configurations, may be implemented according to the present invention.

The multiplier 300 has inputs coupled to the W registers 240 and an output coupled to the input of a multiplexer 305. The multiplier 300 may also have inputs coupled to the X and Y bus. The multiplier may be any size however, for convenience, a 16×16 bit multiplier is described herein which produces a 32 bit output result. The multiplier may be capable of signed and unsigned operation and can multiplex its output using a scaler to support either fractional or integer results.

The output of the multiplier 300 is coupled to one input of a multiplexer 305. The multiplexer 305 has another input coupled to zero backfill logic 310, which is coupled to the X Bus. The zero backfill logic 310 is included to illustrate that 16 zeros may be concatenated onto the 16 bit data read from the X bus to produce a 32 bit result fed into the multiplexer 305. The 16 zeros are generally concatenated into the least significant bit positions.

The multiplexer 305 includes a control signal controlled by the instruction decoder of the processor which determines which input, either the multiplier output or a value from the X bus is passed forward. For instructions such as multiply and accumulate (MAC), the output of the multiplier is selected. For other instructions such as shift instructions, the value from the X bus (via the zero backfill logic) may be selected. The output of the multiplexer 305 is fed into the sign extend unit 315.

The sign extend unit 315 sign extends the output of the multiplexer from a 32 bit value to a 40 bit value. The sign extend unit 315 is illustrative only and this function may be implemented in a variety of ways. The sign extend unit 315 outputs a 40 bit value to a multiplexer 320.

The multiplexer 320 receives inputs from the sign extend unit 315 and the accumulators 345 and 350. The multiplexer 320 selectively outputs values to the input of a barrel shifter 330 based on control signals derived from the decoded instruction. The accumulators 345 and 350 may be any length. According to the embodiment of the present invention selected for illustration, the accumulators are 40 bits in length. A multiplexer 360 determines which accumulator 345 or 350 is output to the multiplexer 320 and to the input of an adder 340.

The instruction decoder sends control signals to the multiplexers 320 and 360, based on the decoded instruction. The control signals determine which accumulator is selected for either an add operation or a shift operation and whether a value from the multiplier or the X bus is selected for an add operation or a shift operation.

The barrel shifter 330 performs shift operations on values received via the multiplexer 320. The barrel shifter may perform arithmetic and logical left and right shifts and circular shifts where bits rotated out one side of the shifter reenter through the opposite side of the buffer. In the illustrated embodiment, the barrel shifter is 40 bits in length and may perform a 15 bit arithmetic right shift and a 16 bit left shift in a single cycle. The shifter uses a signed binary value to determine both the magnitude and the direction of the shift operation. The signed binary value may come from a decoded instruction, such as shift instruction or a multi-precision shift instruction. According to one embodiment of the invention, a positive signed binary value produces a right shift and a negative signed binary value produces a left shift.

The output of the barrel shifter 330 is sent to the multiplexer 355 and the multiplexer 370. The multiplexer 355 also receives inputs from the accumulators 345 and 350. The multiplexer 355 operates under control of the instruction decoder to selectively apply the value from one of the accumulators or the barrel shifter to the adder/subtractor 340 and the round and saturate logic 365.

The adder/subtractor 340 may select either accumulator 345 or 350 as a source and/or a destination. In the illustrated embodiment, the adder/subtractor 340 has 40 bits. The adder receives an accumulator input and an input from another source such as the barrel shifter 331, the X bus or the multiplier. The value from the barrel shifter 331 may come from the multiplier or the X bus and may be scaled in the barrel shifter prior to its arrival at the other input of the adder/subtractor 340. The adder/subtractor 340 adds to or subtracts a value from the accumulator and stores the result back into one of the accumulators. In this manner values in the accumulators represent the accumulation of results from a series of arithmetic operations. The round and saturate logic 365 is used to round 40 bit values from the accumulator or the barrel shifter down to 16 bit values that may be transmitted over the X bus for storage into a W register or data memory. The round and saturate logic has an output coupled to a multiplexer 370. The multiplier 370 may be used to select either the output of the round and saturate logic 365 or the output from a selected 16 bits of the barrel shifter 330 for output to the X bus.

Description of the Instruction Set

The designated instruction set according to the present invention is set forth in the following tables, and are listed in alphabetical order using mnemonics. The mnemonics are merely illustrative, and one of ordinary skill in the art will understand that alternate mnemonics may be used to achieve the same result. The designated instruction set and descriptions of each designated instruction is presented in the following tables. To simplify the definition, each variant of an instruction is given a different “PLA mnemonic.” The detailed definitions of the instructions are listed by the PLA mnemonic in each table which lists the illustrative assembly syntax of each mnemonic, gives examples of usage of that syntax, gives the PLA mnemonic. Symbols used in the definitions of the tables of the instruction set are defined in Table 1.

TABLE 1
Symbols used in the Opcode Descriptions

| Field | Description |
|---|---|
| { } | Optional field or operation |
| [text] | Means “the location addressed by text” |
| (text) | Means “content of text” |
| #text | Means literal defined by “text” |
| text1 ∈ {text2, text3, . . . } | text1 must be in the set of text2, text3, . . . |
| none | field does not require an entry, may be blank |
| {label:} | Optional Label name |
| label | Translates to a literal representing the location of the label name |
| <n:m> | Register bit field |
| lit1 | 1-bit unsigned literal ∈ {0,1} |
| lit4 | 4-bit unsigned literal ∈ {0 . . . 15} |
| lit5 | 5-bit unsigned literal ∈ {0 . . . 31} |
| Slit5 | 5-bit signed literal ∈ {−16 . . . 15} |
| Slit10 | 10-bit signed literal ∈ {−512 . . . 511} |
| lit14 | 14-bit unsigned literal ∈ {0 . . . 16384} |
| lit16 | 16-bit unsigned literal ∈ {0 . . . 65535} |
| Slit16 | 16-bit signed literal ∈ {−32768 . . . 32767} |
| lit23 | 23-bit unsigned literal ∈ {0 . . . 8388608}; LSB must be 0 |
| bit3 | 3-bit bit selection field (used in byte addressed instructions) ∈ {0 . . . 7} |
| bit4 | 4-bit bit selection field (used in word addressed instructions) ∈ {0 . . . 15} |
| .w | Word mode selection (default) |
| .b | Byte mode selection |
| .S | Shadow register select |
| f | File register address ∈ {0000h . . . 1FFFh} |
| d | File register destination d ∈ {Ww, none} |
| Ww | Default W working register (used in file register instructions) |
| Wn | One of 16 working registers ∈ {W0..W15} |
| Wns | One of 16 source working registers ∈ {W0 . . . W15} |
| Wnd | One of 16 destination working registers ∈ {W0 . . . W15} |
| Wb | Base W register ∈ {W0..W15} |
| Ws | Source W register ∈ {Ws, [Ws], [Ws]++, [Ws]−−, [Ws++] } |
| Wd | Destination W register ∈ {Wd, [Wd], [Would]++, [Wd]−−, [Wd++] } |
| Wso | Source W register ∈ |
| | { Wns, [Wns], [Wns]++, [Wns]−−, [Wns−−], [Wns+Wb], [Wns+slit5] } |
| Wdo | Destination W register ∈ |
| | { Wnd, [Wnd], [Wnd]++, [Wnd]−−, [Wnd−−], [Wnd+Wb], [Wnd+slit5] } |
| Wm*Wm | Multiplicand and Multiplier W register for Square instructions ∈ |
| | {W0*W0,W1*W1,W2*W2,W3*W3} |
| Wm*Wn | Multiplicand and Multiplier W register for DSP instructions ∈ |
| | {W0*W1,W0*W2,W0*W3,W1*W2,W1*W3,W2*W3} |
| Wx | X data space prefetch address register for DSP instructions |
| | ∈ {[W4]+=6, [W4]+=4, [W4]+=2, [W4], [W4]−=6, [W4]−=4, [W4]−=2, |
| | [W5]+=6, [W5]+=4, [W5]+=2, [W5], [W5]−=6, [W5]−=4, [W4]−=2, |
| | [W5+W8], none} |
| Wy | Y data space prefetch address register for DSP instructions |
| | ∈{[W6]+=8, [W6]+=4, [W6]+=2, [W6], [W6]−=6, [W6]−=4, [W6]−=2, , |
| | [W7]+=8, [W7]+=4, [W7]+=2, [W7], [W7]−=6, [W7]−=4, [W7]−=2, , |
| | [W7+W8], none} |
| Wxp | X data space prefetch destination register for DSP instructions ∈{W0..W3} |
| Wyp | Y data space prefetch destination register for DSP instructions ∈{W0..W3} |
| AWB | Accumulator write back destination address register ∈{W9,[W9]++} |
| PC | Program Counter |
| PCL | Program Counter Low Byte |
| PCH | Program Counter High Byte |
| PCU | Program Counter Upper Byte |
| PCLATH | Program Counter High Byte Latch |
| PCLATU | Program Counter Upper Byte Latch |
| OA, OB, SA, SB | DSC status bits: ACCA Overflow, ACCB Overflow, ACCA Saturate, ACCB |
| | Saturate |
| C, DC, N, OV, SZ, Z | ALU status bits: Carry, Digit Carry, Negative, Overflow, Sticky-Zero, Zero |

TABLE 2
ADD: Add Wb and Ws

| Syntax: | {label:} | ADD{.b} | Wb, | Ws, | Wd | |
|---|---|---|---|---|---|---|
| | | | | [Ws], | [Wd] | |
| | | | | [Ws]++, | [Wd]++ | |
| | | | | [Ws]−−, | [Wd]−− | |
| | | | | [Ws++], | [Wd++] | |
| | | | | [Ws−−], | [Wd−−] | |
| Operands: | Wb ∈ [W0 . . . W15]; Ws ∈ [W0 . . . W15]; | | | | | |
| | Wd ∈ [W0 . . . W15] | | | | | |
| Operation: | (Wb) + (Ws) → Wd | | | | | |
| Status Affected: | C, DC, N, OV, Z | | | | | |
| Encoding: | 0100 | 0www | wBqq | qddd | dppp | ssss |

| Description: | Add the contents of the source register Ws and | |
|---|---|---|
| | the contents of the base register Wb and | |
| | place the result in the destination | |
| | register Wd. | |
| | The ‘B’ bit selects byte or word operation. | |
| | The ‘s’ bits select the address of the source | |
| | register. | |
| | The ‘w’ bits select the address of the base | |
| | register. | |
| | The ‘d’ bits select the address of the destination | |
| | register. | |
| | The ‘p’ bits select source address mode 2. | |
| | The ‘q’ bits select destination address mode 2. | |
| | See Table 1-5 and Table 1-6 for modifier addressing | |
| | information. | |
| | Note: | The extension .b in the instruction denotes a |
| | | byte operation rather than a word operation. |
| | | You may use a .w extension to denote a word |
| | | operation, but it is not required. |

| Words: | 1 | | | |
|---|---|---|---|---|
| Cycles: | 1 | | | |
| Example: | | ADD | W5,W6,W7 | ; Add |

Before
Instruction
After
Instruction

TABLE 3
ADDAB: Add ACCA to ACCB

| Syntax: | {label:} | ADD | A | | | |
|---|---|---|---|---|---|---|
| | | | B | | | |
| Operands: | none | | | | | |
| Operation: | (ACCA) + ACCB → ACC(A or B) | | | | | |
| Status Affected: | OA, OB, SA, SB | | | | | |
| Encoding: | 1100 | 1011 | A000 | 0000 | 0000 | 0000 |

| Description: | Add ACCA to ACCB and write results to selected | | | |
|---|---|---|---|---|
| | accumulator. | | | |
| | The ‘A’ bits specify the destination accumulator. | | | |
| Words: | 1 | | | |
| Cycles: | 1 | | | |
| Example: | | ADD | B | ; Add ACCA to ACCB, |
| | | | | result to ACCB |

Before Instruction
After Instruction

TABLE 4
ADDAC: 16-Bit Signed Add to Accumulator

| Syntax: | {label:} | ADD | A, | Wns, | [, Slit4] | |
|---|---|---|---|---|---|---|
| | | | B, | [Wns], | | |
| | | | | [Wns]++ | | |
| | | | | [Wns]−− | | |
| | | | | [Wns−−], | | |
| | | | | [Wns+Wb], | | |
| | | | | [Wns+lit5] | | |
| Operands: | Wns ∈ [W0 . . . W15]; | | | | | |
| | Wb ∈ [W0 . . . W15]; lit5 ∈ [0 . . . 31] | | | | | |
| | Slit4 ∈ [−8 . . . +7] | | | | | |
| Operation: | (ACC) + Shift_{Slit4}(Extend(Wns)) → ACC | | | | | |
| Status | OA, OB, SA, SB | | | | | |
| Affected: | | | | | | |
| Encoding: | 1100 | 1001 | Awww | wrrr | rggg | ssss |

| Description: | The term contained at the effective address is assumed | |
|---|---|---|
| | to be Q15 fractional data and is automatically sign- | |
| | extended and zero-backfilled prior to the operation. | |
| | Optionally shift the term, then add the term to | |
| | accumulator. | |
| | The ‘A’ bits specify the destination accumulator. | |
| | The ‘s’ bits specify the source register Wns. | |
| | The ‘g’ bits select source address mode 3. | |
| | The ‘w’ bits specify the offset amount lit5 OR the | |
| | offset register Wb. | |
| | The ‘r’ bits encode the optional operand Slit4 which | |
| | determines the amount of the accumulator preshift; if | |
| | the operand Slit4 is absent, a 0 is encoded. | |
| | See Table 1-7 for modifier addressing information. | |
| | Note: | Positive values of operand Slit4 represent |
| | | arithmetic shift right. Negative values of |
| | | operand Slit4 represent shift left. |

| | |
|---|---|
| Words: | 1 |
| Cycles: | 1 |

| | | | |
|---|---|---|---|
| Example: | ADD | A,W5, | ; Shift W5 right 3 bits, add to |
| | | # 3 | accumulator A |

Before
Instruction
After
Instruction

TABLE 5
ADDC: Add Wb and Ws with Carry

| Syntax: | {label:} | ADDC{.b} | Wb, | Ws, | Wd | |
|---|---|---|---|---|---|---|
| | | | | [Ws], | [Wd] | |
| | | | | [Ws]++, | [Wd]++ | |
| | | | | [Ws]−−, | [Wd]−− | |
| | | | | [Ws++], | [Wd++] | |
| | | | | [Ws−−], | [Wd−−] | |
| Operands: | Wb ∈ [W0 . . . W15]; Ws ∈ [W0 . . . W15]; | | | | | |
| | Wd ∈ [W0 . . . W15] | | | | | |
| Operation: | (Wb) + (Ws) + (C) → Wd | | | | | |
| Status | C, DC, N, OV, Z | | | | | |
| Affected: | | | | | | |
| Encoding: | 0100 | 1www | wBqq | qddd | dppp | Ssss |

| Description: | Add the contents of the source register Ws and the contents | |
|---|---|---|
| | of the base register Wb and the Carry bit and | |
| | place the result in the destination register Wd. | |
| | The ‘B’ bit selects byte or word operation. | |
| | The ‘s’ bits select the address of the source register. | |
| | The ‘w’ bits select the address of the base register. | |
| | The ‘d’ bits select the address of the destination | |
| | register. | |
| | The ‘p’ bits select source address mode 2. | |
| | The ‘q’ bits select destination address mode 2. | |
| | See Table 1-5 and Table 1-6 for modifier | |
| | addressing information. | |
| | Note: | The extension .b in the instruction denotes a |
| | | byte operation rather than a word operation. |
| | | You may use a .w extension to denote a word |
| | | operation, but it is not required. |

| Words: | 1 | | | |
|---|---|---|---|---|
| Cycles: | 1 | | | |
| Example: | | ADDC | W5,W6,W7 | ; Add |

Before
Instruction
After
Instruction

TABLE 6
ADDCLS: Add Wb and Short Literal with Carry

| Syntax: | {label:} | ADDC{.b} | Wb, | lit5, | Wd | |
|---|---|---|---|---|---|---|
| | | | | | [Wd] | |
| | | | | | [Wd]++ | |
| | | | | | [Wd]−− | |
| | | | | | [Wd++] | |
| | | | | | [Wd−−] | |
| Operands: | Wb ∈ [W0 . . . W15]; lit5 ∈ [0 . . . 31]; | | | | | |
| | Wd ∈ [W0 . . . W15] | | | | | |
| Operation: | (Wb) + lit5 + (C) → Wd | | | | | |
| Status Affected: | C, DC, N, OV, Z | | | | | |
| Encoding: | 0100 | 1www | wBqq | qddd | d11k | kkkk |

| Description: | Add the contents of the base register Wb, the literal | |
|---|---|---|
| | operand and the Carry bit; and place the result in the | |
| | destination register Wd. | |
| | The ‘B’ bit selects byte or word operation. | |
| | The ‘w’ bits select the address of the base register. | |
| | The ‘k’ bits provide the literal operand, a five-bit | |
| | integer number. | |
| | The ‘d’ bits select the address of the destination | |
| | register. | |
| | The ‘q’ bits select destination address mode 2. | |
| | See Table 1-6 for modifier addressing information. | |
| | Note: | The extension .b in the instruction denotes a |
| | | byte operation rather than a word operation. |
| | | You may use a .w extension to denote a word |
| | | operation, but it is not required. |

| Words: | 1 | | | |
|---|---|---|---|---|
| Cycles: | 1 | | | |
| Example: | | ADDC | W5, | ; Add |
| | | | #12,W7 | |

Before
Instruction
After
Instruction

TABLE 7
ADDCLW: Add Literal to Wn with Carry

| Syntax: | {label:} | ADDC{.b} | Slit10, | Wn | | |
|---|---|---|---|---|---|---|
| Operands: | Slit10 ∈ [−512 . . . 511]; Wn ∈ [W0 . . . W15] | | | | | |
| Operation: | Slit10 + (Wn) + (C) → Wn | | | | | |
| Status | C, DC, N, OV, Z | | | | | |
| Affected: | | | | | | |
| Encoding: | 1011 | 0000 | 1Bkk | kkkk | kkkk | dddd |

| Description: | Add the literal operand to the contents of the working | |
|---|---|---|
| | register Wn and the Carry bit and place the result | |
| | in the working register Wn. | |
| | The ‘B’ bit selects byte or word operation. | |
| | The ‘d’ bits select the address of the working register. | |
| | The ‘k’ bits specify the literal operand, a signed | |
| | 10-bit number. | |
| | Note: | The extension .b in the instruction denotes a |
| | | byte operation rather than a word operation. |
| | | You may use a .w extension to denote a word |
| | | operation, but it is not required. |

| Words. | 1 | | | |
|---|---|---|---|---|
| Cycles: | 1 | | | |
| Example: | | ADDC | #123, | ; Add |
| | | | W7 | w/ carry |

Before
Instruction
After
Instruction

TABLE 8
ADDLS: Add Wb and Short Literal

| Syntax: | {label:} | ADD{.b} | Wb, | lit5, | Wd | |
|---|---|---|---|---|---|---|
| | | | | | [Wd] | |
| | | | | | [Wd]++ | |
| | | | | | [Wd]−− | |
| | | | | | [Wd++] | |
| | | | | | [Wd−−] | |
| Operands: | Wb ∈ [W0 . . . W15]; lit5 ∈ [0 . . . 31]; | | | | | |
| | Wd ∈ [W0 . . . W15] | | | | | |
| Operation: | (Wb) + lit5 → Wd | | | | | |
| Status Affected: | C, DC, N, OV, Z | | | | | |
| Encoding: | 0100 | 0www | wBqq | qddd | d11k | kkkk |

| Description: | Add the contents of the source register Ws | |
|---|---|---|
| | and the literal operand and place the | |
| | result in the destination register Wd. | |
| | The ‘B’ bit selects byte or word operation. | |
| | The ‘w’ bits select the address of the | |
| | base register. | |
| | The ‘k’ bits provide the literal operand, a five-bit | |
| | integer number. | |
| | The ‘d’ bits select the address of the | |
| | destination register. | |
| | The ‘q’ bits select destination address mode 2. | |
| | See Table 1-6 for modifier addressing | |
| | information. | |
| | Note: | The extension .b in the instruction denotes a |
| | | byte operation rather than a word operation. |
| | | You may use a .w extension to denote a |
| | | word operation, but it is not required. |

| Words: | 1 | | | |
|---|---|---|---|---|
| Cycles: | 1 | | | |
| Example: | | ADD | W5,#12,W7 | ; Add |

Before
Instruction
After
Instruction

TABLE 9
ADDLW: Add Literal to Wn

| Syntax: | {label:} | ADD{.b} | Slit10, | Wn | | |
|---|---|---|---|---|---|---|
| Operands: | Slit10 ∈ [−512 . . . 511]; Wn ∈ [W0 . . . W15] | | | | | |
| Operation: | Slit10 + (Wn) → Wn | | | | | |
| Status Affected: | C, DC, N, OV, Z | | | | | |
| Encoding: | 1011 | 0000 | 0Bkk | kkkk | kkkk | dddd |

| Description: | Add the literal operand to the contents of the | |
|---|---|---|
| | working register Wn and place the | |
| | result in the working register Wn. | |
| | The ‘B’ bit selects byte or word operation. | |
| | The ‘d’ bits select the address of the working | |
| | register. | |
| | The ‘k’ bits specify the literal operand, a signed | |
| | 10-bit number. | |
| | Note: | The extension .b in the instruction denotes a |
| | | byte operation rather than a word operation. |
| | | You may use a .w extension to denote a |
| | | word operation, but it is not required. |

| Words: | 1 | | | |
|---|---|---|---|---|
| Cycles: | 1 | | | |
| Example: | | ADD | #123, | ; Add |
| | | | W7 | |

Before
Instruction
After
Instruction

TABLE 10
ADDWF: Add f and Ww

| Syntax: | {label:} | ADD{.b} | f | {,Ww} | | |
|---|---|---|---|---|---|---|
| Operands: | f ∈ [0 . . . 8191] | | | | | |
| Operation: | (f) + (Ww) → destination designated by D | | | | | |
| Status Affected: | C, DC, N, OV, Z | | | | | |
| Encoding: | 1011 | 0100 | 0BDf | ffff | ffff | ffff |

| Description: | Add the contents of the working register and | |
|---|---|---|
| | the contents of the file register and place the | |
| | result in the destination designated by D: If | |
| | the optional Ww is specified, D=0 and | |
| | store result in Ww; otherwise, D=1 and | |
| | store result in the file register. | |
| | The ‘B’ bit selects byte or word operation. | |
| | The ‘D’ bit selects the destination. | |
| | The ‘f’ bits select the address of the file | |
| | register. | |
| | Note: | The extension .b in the instruction denotes a |
| | | byte operation rather than a word operation. |
| | | You may use a .w extension to denote a |
| | | word operation, but it is not required. |

| Words: | 1 | | | |
|---|---|---|---|---|
| Cycles: | 1 | | | |
| Example: | | ADD | RAM135, | ; Add |
| | | | Ww | |

Before
Instruction
After
Instruction

TABLE 11
ADDWFC: Add f and Carry bit and Ww

| Syntax: | {label:} | ADDC{.b} | f | {,Ww} | | |
|---|---|---|---|---|---|---|
| Operands: | f ∈ [0 . . . 8191] | | | | | |
| Operation: | (f) + (Ww) + (C)→ destination designated by D | | | | | |
| Status Affected: | C, DC, N, OV, Z | | | | | |
| Encoding: | 1011 | 0100 | 1BDf | ffff | ffff | ffff |

| Description: | Add the contents of the working register | |
|---|---|---|
| | and the carry flag and the contents of the | |
| | file register and place the result in the | |
| | destination designated by D: If the optional | |
| | Ww is specified, D=0 and store result | |
| | in Ww; otherwise, D=1 and store result | |
| | in the file register. | |
| | The ‘B’ bit selects byte or word operation. | |
| | The ‘D’ bit selects the destination. | |
| | The ‘f’ bits select the address of the file register. | |
| | Note: | The extension .b in the instruction denotes |
| | | a byte operation rather than a word |
| | | operation. You may use a .w extension |
| | | to denote a word operation, but |
| | | it is not required. |

| Words: | 1 | | | |
|---|---|---|---|---|
| Cycles: | 1 | | | |
| Example: | | ADDC | RAM135, | ; Add |
| | | | Ww | |

Before
Instruction
After
Instruction

TABLE 12
AND: And Wb and Ws

| Syntax: | {label:} | AND{.b} | Wb, | Ws, | Wd | |
|---|---|---|---|---|---|---|
| | | | | [Ws], | [Wd] | |
| | | | | [Ws]++, | [Wd]++ | |
| | | | | [Ws]−−, | [Wd]−− | |
| | | | | [Ws++], | [Wd++] | |
| | | | | [Ws−−], | [Wd−−] | |
| Operands: | Wb ∈ [W0 . . . W15]; Ws ∈ [W0 . . . W15]; | | | | | |
| | Wd ∈ [W0 . . . W15] | | | | | |
| Operation: | (Wb).AND.(Ws) → Wd | | | | | |
| Status Affected: | N, Z | | | | | |
| Encoding: | 0110 | 0www | wBqq | qddd | dppp | ssss |

| Description: | Compute the AND of the contents of the source | |
|---|---|---|
| | register Ws and the contents of the base register Wb | |
| | and place the result in the destination register Wd. | |
| | The ‘B’ bit selects byte or word operation. | |
| | The ‘s’ bits select the address of the source register. | |
| | The ‘w’ bits select the address of the base register. | |
| | The ‘d’ bits select the address of the destination | |
| | register. | |
| | The ‘p’ bits select source address mode 2. | |
| | The ‘q’ bits select destination address mode 2. | |
| | See Table 1-5 and Table 1-6 for modifier addressing | |
| | information. | |
| | Note: | The extension .b in the instruction denotes a |
| | | byte operation rather than a word operation. |
| | | You may use a .w extension to denote a word |
| | | operation, but it is not required. |
| Words: | 1 | |
| Cycles: | 1 | |

| | | | |
|---|---|---|---|
| Example: | AND | W5,W6,W7 | ; And |

Before Instruction
After Instruction

TABLE 13
ANDLS; AND Wb and Short Literal

| Syntax: | {label:} | AND{.b} | Wb, | lit5, | Wd | |
|---|---|---|---|---|---|---|
| | | | | | [Wd] | |
| | | | | | [Wd]++ | |
| | | | | | [Wd]−− | |
| | | | | | [Wd++] | |
| | | | | | [Wd−−] | |
| Operands: | Wb ∈ [W0 . . . W15]; lit5 ∈ [0 . . . 31]; | | | | | |
| | Wd ∈ [W0 . . . W15] | | | | | |
| Operation: | (Wb).AND.lit5 → Wd | | | | | |
| Status Affected: | N, Z | | | | | |
| Encoding: | 0110 | 0www | wBqq | qddd | d11k | kkkk |

| Description: | Compute the AND of the contents of the base register | |
|---|---|---|
| | Wb and the literal operand and place the result in | |
| | the destination register Wd. | |
| | The ‘B’ bit selects byte or word operation. | |
| | The ‘w’ bits select the address of the base register. | |
| | The ‘k’ bits provide the literal operand, a five-bit | |
| | integer number. | |
| | The ‘d’ bits select the address of the destination | |
| | register. | |
| | The ‘q’ bits select destination address mode 2. | |
| | See Table 1-6 for modifier addressing information. | |
| | Note: | The extension .b in the instruction denotes a |
| | | byte operation rather than a word operation. |
| | | You may use a .w extension to denote a word |
| | | operation, but it is not required. |
| Words: | 1 | |
| Cycles: | 1 | |

| | | | |
|---|---|---|---|
| Example: | AND | W5,#12,W7 | ; AND |

Before Instruction
After Instruction

TABLE 14
ANDLW: AND Literal and Wd

| Syntax: | {label:} | AND{.b } | Slit10, | Wn | | |
|---|---|---|---|---|---|---|
| Operands: | Slit10 ∈ [−512 . . . 511]; Wn ∈ [W0 . . . W15] | | | | | |
| Operation: | Slit10.AND.(Wn) → Wn | | | | | |
| Status Affected: | N, Z | | | | | |
| Encoding: | 1011 | 0010 | 0Bkk | kkkk | kkkk | dddd |

| Description: | Compute the AND of the literal operand and the | |
|---|---|---|
| | contents of the working register Wn and place | |
| | the result in the working register Wn. | |
| | The ‘B’ bit selects byte or word operation. | |
| | The ‘d’ bits select the address of the working register. | |
| | The ‘k’ bits specify the literal operand, a signed | |
| | 10-bit number. | |
| | Note: | The extension .b in the instruction denotes a |
| | | byte operation rather than a word operation. |
| | | You may use a .w extension to denote a word |
| | | operation, but it is not required. |
| Words: | 1 | |
| Cycles: | 1 | |

| | | | |
|---|---|---|---|
| Example: | AND | #123,W7 | ; AND |

Before Instruction
After Instruction

TABLE 15
ANDWF: And f and Ww

| Syntax: | {label:} | AND{.b} | f | {,Ww} | | |
|---|---|---|---|---|---|---|
| Operands: | f ∈[0 . . . 8191] | | | | | |
| Operation: | (f).AND.(Ww) → destination designated by D | | | | | |
| Status Affected: | N, Z | | | | | |
| Encoding: | 1011 | 0110 | 0BDf | ffff | ffff | ffff |

| Description: | Compute the AND of the contents of the working | |
|---|---|---|
| | register and the contents of the file register and place | |
| | the result in the destination designated by D: If the | |
| | optional Ww is specified, D=0 and store result in | |
| | Ww; otherwise, D=1 and store result in the | |
| | file register. | |
| | The ‘B’ bit selects byte or word operation. | |
| | The ‘D’ bit selects the destination. | |
| | The ‘f’ bits select the address of the file register. | |
| | Note: | The extension .b in the instruction denotes a |
| | | byte operation rather than a word operation. |
| | | You may use a .w extension to denote a word |
| | | operation, but it is not required. |
| Words: | 1 | |
| Cycles: | 1 | |

| | | | |
|---|---|---|---|
| Example: | AND | RAM135, Ww | ; And |

Before Instruction
After Instruction

TABLE 16
ASR: Arithmetic Shift Right Ws

| | | | | |
|---|---|---|---|---|
| Syntax: | {label:} | ASR{.b} | Ws, | Wd |
| | | | [Ws], | [Wd] |
| | | | [Ws]++, | [Wd]++ |
| | | | [Ws]−−, | [Wd]−− |
| | | | [Ws++], | [Wd++] |
| | | | [Ws−−], | [Wd−−] |

| | |
|---|---|
| Operands: | Ws ∈ [W0 . . . W15]; Wd ∈ [W0 . . . W15] |
| Operation: | For word operation: |

(Ws<15>) → Wd<15>, (Ws<15>) → Wd<14>,
(Ws<14:1>) → Wd<13:0>, (Ws<0>) → C

For byte operation:

(Ws<7>) → Wd<7>, (Ws<7>) → Wd<6>,
(Ws<6:1>) → Wd<5:0>, (Ws<0>) → C

| | 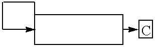 | | | | | |
|---|---|---|---|---|---|---|
| Status Affected: | C, N, OV, Z | | | | | |
| Encoding: | 1101 | 0001 | 1Bqq | qddd | dppp | ssss |

| Description: | Shift the contents of the source register Ws one bit to the right and place | |
|---|---|---|
| | the result in the destination register Wd. Shift the MSB back into itself. The | |
| | Carry Flag is set if the LSB of Ws is ‘1’. | |
| | The ‘B’ bit selects byte or word operation. | |
| | The ‘s’ bits select the address of the source register. | |
| | The ‘d’ bits select the address of the destination register. | |
| | The ‘p’ bits select source address mode 2. | |
| | The ‘q’ bits select destination address mode 2. | |
| | See Table 1-5 and Table 1-6 for modifier addressing information. | |
| | Note: | The extension .b in the instruction denotes a byte operation rather |
| | | than a word operation. You may use a .w extension to denote a |
| | | word operation, but it is not required. |

| | |
|---|---|
| Words: | 1 |
| Cycles: | 1 |

| | | | |
|---|---|---|---|
| Example: | ASR | W5, W6 | ; Arithmetic shift right |

Before Instruction
After Instruction

TABLE 17
ASRF: Arithmetic Shift Right f

| | | | | |
|---|---|---|---|---|
| Syntax: | {label:} | ASR{.b} | f | {,Ww} |

| | |
|---|---|
| Operands: | f ∈ [0 . . . 8191] |
| Operation: | For word operation: |

(f<15>) → Dest<15>, (f<15>) → Dest<14>
(f<14:1>) → Dest<13:0>, (f<0>) → C

For byte operation:

(f<7>) → Dest<7>, (f<7>) → Dest<6>,
(f<6:1>) → Dest<5:0>, (f<0>) → C

| | 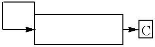 | | | | | |
|---|---|---|---|---|---|---|
| Status Affected: | C, N, OV, Z | | | | | |
| Encoding: | 1101 | 0101 | 1BDf | ffff | ffff | ffff |

| Description: | Shift the contents of the file register f one bit to the right through the carry | |
|---|---|---|
| | flag and place the result in the destination designated by D: If the optional | |
| | Ww is specified, D = 0 and store result in Ww; otherwise, D = 1 and store | |
| | result in the file register. | |
| | The ‘B’ bit selects byte or word operation. | |
| | The ‘D’ bit selects the destination. | |
| | The ‘f’ bits select the address of the file register. | |
| | Note: | The extension .b in the instruction denotes a byte operation rather |

than a word operation. You may use a .w extension to denote a
word operation, but it is not required.

| | |
|---|---|
| Words: | 1 |
| Cycles: | 1 |

| | | | |
|---|---|---|---|
| Example: | ASR | RAM135, Ww | Arithmetic shift right |

Before Instruction
After Instruction

TABLE 18
ASRK: Arithmetic Shift Right by Short Literal

| Syntax: | {label:} | ASR | Wb, | lit5, | Wnd | |
|---|---|---|---|---|---|---|
| Operands: | Wb ∈ [W0 . . . W15]; lit5 ∈ [0. . .31]; | | | | | |
| | Wnd ∈ [W0 . . . W15] | | | | | |
| Operation: | lit5<3:0>→Shift_Val | | | | | |
| | 0→Shift_In<39:32> | | | | | |
| | Wb<15:0>→Shift_In<31:16> | | | | | |
| | 0→Shift_In<15:0> | | | | | |
| | 0→Shift_Out<39:32> | | | | | |
| | Shift_In<31>→Shift_Out<32:32-Shift_Val> | | | | | |
| | Shift_In<31:Shift_Val>→Shift_Out<31-Shift_Val:0 > | | | | | |
| | If lit5<4>== 0: (less than 16) | | | | | |
| | Shift_Out<31:16>→Wnd | | | | | |
| | Shift_Out<15:0>→CARRY1 | | | | | |
| | 0→CARRY0 | | | | | |
| | If lit5<4 >==1: (16 or greater) | | | | | |
| | Shift_Out<31:31>→Wnd<15:0> | | | | | |
| | Shift_Out<31:16>→CARRY1 | | | | | |
| | Shift_Out<15:0>→CARRY0 | | | | | |
| Status | C,SZ,Z | | | | | |
| Affected: | | | | | | |
| Encoding: | 1101 | 1110 | 1www | wddd | d11k | kkkk |

| | |
|---|---|
| Description: | Arithmetic shift right the contents of the source register |
| | Wb by lit5 bits (up to 31 positions), placing the result in the |
| | destination register Wnd. Bits that are shifted beyond the |
| | rightmost position of the source are stored in the CARRY1 |
| | and CARRY0 registers. |
| | The Z and SZ bits will be set if the value placed in Wnd is |
| | zero and cleared otherwise. The C bit will be set if any of |
| | the bits shifted out were set (in other words, if the |
| | resultant CARRY is non-zero) and cleared otherwise. |
| | Note: This instruction operates in word mode only. |
| Words: | 1 |
| Cycles: | 1 |

TABLE 19
ASRW: Arithmetic Shift Right by Wns

| Syntax: | {label:} | ASR | Wb, | Wns, | Wnd | |
|---|---|---|---|---|---|---|
| Operands: | Wb ∈ [W0 . . . W15]; Wns ∈ [W0 . . .W15]; | | | | | |
| | Wnd ∈ [W0 . . . W15] | | | | | |
| Operation: | Wns<3:0>→Shift_Val | | | | | |
| | 0→Shift_In<39:32> | | | | | |
| | Wb<15:0>→Shift_In<31:16> | | | | | |
| | 0→Shift_In<15:0> | | | | | |
| | 0→Shift_Out<39:32> | | | | | |
| | Shift_In<31>→Shift_Out<32:32-Shift_Val> | | | | | |
| | Shift_In<31:Shift_Val>→Shift_Out<31-Shift_Val:0> | | | | | |
| | If Wns<4>==0: (less than 16) | | | | | |
| | Shift_Out<31:16>→Wnd | | | | | |
| | Shift_Out<15:0>→CARRY1 | | | | | |
| | 0→CARRY0 | | | | | |
| | If Wns<4>==1: (16 or greater) | | | | | |
| | Shift_Out<31:31>→Wnd<15:0> | | | | | |
| | Shift_Out<31:16>→CARRY1 | | | | | |
| | Shift_Out<15:0>→CARRY0 | | | | | |
| Status | C,SZ,Z | | | | | |
| Affected: | | | | | | |
| Encoding: | 1101 | 1110 | 1www | wddd | d000 | ssss |

| | |
|---|---|
| Description: | Arithmetic shift right the contents of the source register Wb |
| | by Wns bits (up to 31 positions), placing the result in the |
| | destination register Wnd. Bits that are shifted beyond |
| | the rightmost position of the source are stored in the |
| | CARRY1 and CARRY0 registers. |
| | The Z and SZ bits will be set if the value placed in Wnd is |
| | zero and cleared otherwise. The C bit will be set if any of |
| | the bits shifted out were set (in other words, if the resultant |
| | CARRY is non-zero) and cleared otherwise. |
| | Note: This instruction operates in word mode only. |
| Words: | 1 |
| Cycles: | 1 |

TABLE 20
BC: Branch if Carry

| Syntax: | {label:} | BRA | C, | Slit16 | | |
|---|---|---|---|---|---|---|
| | {label:} | BRA | GEU, | | | |
| Operands: | Slit16 ∈ [−32768 . . . +32767] | | | | | |
| Operation: | Condition = C | | | | | |
| | If (condition), then (PC+2) + 2*Slit16 −t PC, and | | | | | |
| | NOP + Instruction Register. | | | | | |
| Status Affected: | None | | | | | |
| Encoding: | 0011 | 0001 | nnnn | nnnn | nnnn | nnnn |

| | |
|---|---|
| Description: | If the Carry bit is ‘1’, then the program will branch. |
| | The 2's complement number ‘2*Slit16’ (the offset) is |
| | added to the PC. Since the PC will have incremented |
| | to fetch the next instruction, the new address will be |
| | (PC+2) + 2*Slit16. This instruction is then a |
| | two-cycle instruction, with a NOP in the second cycle. |
| | The ‘n’ bits are a signed literal that specifies the |
| | number of instructions offset from (PC+2). |
| Words: | 1 |
| Cycles: | 1 (2) |

| | | | |
|---|---|---|---|
| Example: | BRA | C, label | ; Branch if Carry |

Before Instruction
After Instruction

TABLE 21
BCLRF: Bit Clear f

| Syntax: | {label:} | BCLR.b | f, | bit3 | | |
|---|---|---|---|---|---|---|
| Operands: | bit3 ∈ [0 . . . 7]; f ∈ [0 . . . 8191] | | | | | |
| Operation: | 0 → f<bit3> | | | | | |
| Status | None | | | | | |
| Affected: | | | | | | |
| Encoding: | 1010 | 1001 | bbbf | ffff | ffff | ffff |

| | |
|---|---|
| Description: | Bit ‘bit3’ in file register f is cleared. |
| | The ‘b’ bits select value bit3 of the bit position to |
| | be cleared. |
| | The ‘f’ bits select the address of the file register. |
| | Note: This instruction operates in byte mode only. |
| | Note: The .b extension must be included with the opcode. |
| Words: | 1 |
| Cycles: | 1 |

| | | | |
|---|---|---|---|
| Example: | BCLR.b | RAM135, #5 | ; Clear bit 5 in RAM135 |

Before Instruction
After Instruction

TABLE 22
BGE: Branch if Signed Greater Than or Equal

| Syntax: | {label:} | BRA | GE, | Slit16 | | |
|---|---|---|---|---|---|---|
| Operands: | Slit16 ∈ [−32768 . . . +32767] | | | | | |
| Operation: | Condition = (N&&OV)∥(!N&&!OV) | | | | | |
| | If (Condition), then (PC+2) + 2*Slit16 → PC, | | | | | |
| | and NOP → Instruction Register. | | | | | |
| Status | None | | | | | |
| Affected: | | | | | | |
| Encoding: | 0011 | 1101 | nnnn | nnnn | nnnn | nnnn |

| | |
|---|---|
| Description: | If the branch condition is met, then the program |
| | will branch. |
| | The 2's complement number ‘2*Slit16’ (the offset) is added |
| | to the PC. Since the PC will have incremented to fetch |
| | the next instruction, the new address will be (PC+2) + |
| | 2*Slit16. This instruction is then a two-cycle instruction, |
| | with a NOP in the second cycle. |
| | The ‘n’ bits are a signed literal that specifies the number |
| | of instructions offset from (PC+2). |
| Words: | 1 |
| Cycles: | 1 (2) |

| | | | |
|---|---|---|---|
| Example: | BRA | GE, label | ; Branch if Greater Than or Equal |

Before Instruction
After Instruction

TABLE 23
BGT: Branch if Signed Greater Than

| Syntax: | {label:} | BRA | GT, | Slit16 | | |
|---|---|---|---|---|---|---|
| Operands: | Slit16 ∈ [−32768 . . . +32767] | | | | | |
| Operation: | Condition = (!Z&&N&&OV)∥(!Z&&!N&&!OV); | | | | | |
| | If (Condition), then (PC+2) + 2*Slit16 → PC, | | | | | |
| | and NOP → Instruction Register. | | | | | |
| Status | None | | | | | |
| Affected: | | | | | | |
| Encoding: | 0011 | 1100 | nnnn | nnnn | nnnn | nnnn |

| | |
|---|---|
| Description: | If the branch condition is met, then the program |
| | will branch. |
| | The 2's complement number ‘2*Slit16’ (the offset) is added |
| | to the PC. Since the PC will have incremented to fetch the |
| | next instruction, the new address will be (PC+2) + |
| | 2*Slit16. This instruction is then a two-cycle instruction, |
| | with a NOP in the second cycle. |
| | The ‘n’ bits are a signed literal that specifies the number |
| | of instructions offset from (PC+2). |
| Words: | 1 |
| Cycles: | 1 (2) |

| | | | |
|---|---|---|---|
| Example: | BRA | GT, label | ; Branch if Greater Than |

Before Instruction
After Instruction

TABLE 24
BGTU: Branch if Unsigned Greater Than

| Syntax: | {label:} | BRA | GTU, | Slit16 | | |
|---|---|---|---|---|---|---|
| Operands: | Slit16 ∈ [−32768 . . . +32767] | | | | | |
| Operation: | Condition = (C&&!Z); | | | | | |
| | If (Condition), then (PC+2) + 2*Slit16 → PC, | | | | | |
| | and NOP → Instruction Register. | | | | | |
| Status Affected: | None | | | | | |
| Encoding: | 0011 | 1110 | nnnn | nnnn | nnnn | nnnn |

| | |
|---|---|
| Description: | If the branch condition is met, then the program |
| | will branch. |
| | The 2's complement number ‘2*Slit16’ (the offset) |
| | is added to the PC. Since the PC will have |
| | incremented to fetch the next instruction, |
| | the new address will be (PC+2) + 2*Slit16. |
| | This instruction is then a two-cycle instruction, |
| | with a NOP in the second cycle. |
| | The ‘n’ bits are a signed literal that specifies the |
| | number of instructions offset from (PC+2). |
| Words: | 1 |
| Cycles: | 1 (2) |

| | | | |
|---|---|---|---|
| Example: | BRA | GTU, label | ; Branch if Unsigned |
| | | | Greater Than |

Before Instruction
After Instruction

TABLE 25
BLE: Branch if Signed Less Than or Equal

| Syntax: | {label:} | BRA | LE, | Slit16 | | |
|---|---|---|---|---|---|---|
| Operands: | Slit16 ∈ [−32768 . . . +32767] | | | | | |
| Operation: | Condition = Z\|\|(N&&!OV)\|\|(!N&&OV); | | | | | |
| | if (Condition), then (PC+2) + 2*Slit16 → PC, | | | | | |
| | and NOP → Instruction Register. | | | | | |
| Status Affected: | None | | | | | |
| Encoding: | 0011 | 0100 | nnnn | nnnn | nnnn | nnnn |

| | |
|---|---|
| Description: | If the branch condition is met, then the program |
| | will branch. |
| | The 2's complement number ‘2*Slit16’ (the offset) |
| | is added to the PC. Since the PC will have |
| | incremented to fetch the next instruction, |
| | the new address will be (PC+2) + 2*Slit16. |
| | This instruction is then a two-cycle instruction, |
| | with a NOP in the second cycle. |
| | The ‘n’ bits are a signed literal that specifies the |
| | number of instructions offset from (PC+2). |
| Words: | 1 |
| Cycles: | 1 (2) |

| | | | |
|---|---|---|---|
| Example: | BRA | LE, label | ; Branch if Less Than |
| | | | or Equal |

Before Instruction
After Instruction

TABLE 26
BLEU: Branch if Unsigned Less Than or Equal

| Syntax: | {label:} | BRA | LEU, | Slit16 | | |
|---|---|---|---|---|---|---|
| Operands: | Slit16 ∈ [−32768 . . . +32767] | | | | | |
| Operation: | Condition = !C\|\|Z; | | | | | |
| | If (Condition), then (PC+2) + 2*Slit16 → PC, | | | | | |
| | and NOP → Instruction Register. | | | | | |
| Status Affected: | None | | | | | |
| Encoding: | 0011 | 0110 | nnnn | nnnn | nnnn | nnnn |

| | |
|---|---|
| Description: | If the branch condition is met, then the program |
| | will branch. |
| | The 2's complement number ‘2*Slit16’ (the offset) |
| | is added to the PC. Since the PC will have |
| | incremented to fetch the next instruction, |
| | the new address will be (PC+2) + 2*Slit16. |
| | This instruction is then a two-cycle instruction, |
| | with a NOP in the second cycle. |
| | The ‘n’ bits are a signed literal that specifies the |
| | number of instructions offset from (PC+2). |
| Words: | 1 |
| Cycles: | 1 (2) |

| | | | |
|---|---|---|---|
| Example: | BRA | LEU, label | ; Branch if Unsigned Less |
| | | | Than or Equal |

Before Instruction
After Instruction

TABLE 27
BLT: Branch if Signed Less Than

| Syntax: | {label:} | BRA | LT, | Slit16 | | |
|---|---|---|---|---|---|---|
| Operands: | Slit16 ∈ [−32768 . . . +32767] | | | | | |
| Operation: | Condition = (N&&!OV)\|\|(!N&&OV); | | | | | |
| | if (Condition), then (PC+2) + 2*Slit16 → PC, | | | | | |
| | and NOP → Instruction Register. | | | | | |
| Status Affected: | None | | | | | |
| Encoding: | 0011 | 0101 | nnnn | nnnn | nnnn | nnnn |

| | |
|---|---|
| Description: | If the branch condition is met, then the program |
| | will branch. |
| | The 2’s complement number ‘2*Slit16’ (the offset) |
| | is added to the PC. Since the PC will have |
| | incremented to fetch the next instruction, |
| | the new address will be (PC+2) + 2*Slit16. |
| | This instruction is then a two-cycle instruction, |
| | with a NOP in the second cycle. |
| | The ‘n’ bits are a signed literal that specifies the |
| | number of instructions offset from (PC+2). |
| Words: | 1 |
| Cycles: | 1 (2) |

| | | | |
|---|---|---|---|
| Example: | BRA | LT, label | ; Branch if |
| | | | Less Than |

Before Instruction
After Instruction

TABLE 28
BN: Branch if Negative

| Syntax: | {label:} | BRA | N, | Slit16 | | |
|---|---|---|---|---|---|---|
| Operands: | Slit16 ∈ [−32768 . . . +32767] | | | | | |
| Operation: | Condition = N | | | | | |
| | if (Condition), then (PC+2) + 2*Slit16 → PC, and | | | | | |
| | NOP → Instruction Register. | | | | | |
| Status Affected: | None | | | | | |
| Encoding: | 0011 | 0011 | nnnn | nnnn | nnnn | nnnn |

| | |
|---|---|
| Description: | If the Negative Flag is ‘1’, then the program will |
| | branch. |
| | The 2's complement number ‘2*Slit16’ (the offset) is |
| | added to the PC. Since the PC will have incremented |
| | to fetch the next instruction, the new address will be |
| | (PC+2) + 2*Slit16. This instruction is then a |
| | two-cycle instruction, with a NOP in the second cycle. |
| | The ‘n’ bits are a signed literal that specifies the |
| | number of instructions offset from (PC+2). |
| Words: | 1 |
| Cycles: | 1 (2) |

| | | | |
|---|---|---|---|
| Example: | BRA | N, label | ; Branch if Negative |

Before Instruction
After Instruction

TABLE 29
BNC: Branch if Not Carry

| Syntax: | {label:} | BRA | NC, | Slit16 | | |
|---|---|---|---|---|---|---|
| | {label:} | BRA | LTU, | | | |
| Operands: | Slit16 ∈ [−32768 . . . +32767] | | | | | |
| Operation: | Condition = !C | | | | | |
| | If (condition), then (PC+2) + 2*Slit16 → PC, and | | | | | |
| | NOP → Instruction Register. | | | | | |
| Status Affected: | None | | | | | |
| Encoding: | 0011 | 1001 | nnnn | nnnn | nnnn | nnnn |

| | |
|---|---|
| Description: | If the Carry bit is ‘0’, then the program will branch. |
| | The 2's complement number ‘2*Slit16’ (the offset) is |
| | added to the PC. Since the PC will have incremented |
| | to fetch the next instruction, the new address will |
| | be (PC+2) + 2*Slit16. This instruction is then a |
| | two-cycle instruction, with a NOP in the second cycle. |
| | The ‘n’ bits are a signed literal that specifies the |
| | number of instructions offset from (PC+2). |
| Words: | 1 |
| Cycles: | 1 (2) |

| | | | |
|---|---|---|---|
| Example: | BRA | NC, label | ; Branch if Not |
| | | | Carry |

Before Instruction
After Instruction

TABLE 30
BNN: Branch if Not Negative

| Syntax: | {label:} | BRA | NN, | Slit16 | | |
|---|---|---|---|---|---|---|
| Operands: | Slit16 ∈ [−32768 . . . +32767] | | | | | |
| Operation: | Condition = !N | | | | | |
| | If (condition), then (PC+2) + 2*Slit16 → PC, and | | | | | |
| | NOP → Instruction Register. | | | | | |
| Status Affected: | None | | | | | |
| Encoding: | 0011 | 1011 | nnnn | nnnn | nnnn | nnnn |

| | |
|---|---|
| Description: | If the Negative Flag is ‘0’, then the program will |
| | branch. |
| | The 2's complement number ‘2*Slit16’ (the offset) is |
| | added to the PC. Since the PC will have incremented |
| | to fetch the next instruction, the new address will be |
| | (PC+2) + 2*Slit16. This instruction is then a two-cycle |
| | instruction, with a NOP in the second cycle. |
| | The ‘n’ bits are a signed literal that specifies the |
| | number of instructions offset from (PC+2). |
| Words: | 1 |
| Cycles: | 1 (2) |

| | | | |
|---|---|---|---|
| Example: | BRA | NN, label | ; Branch if Not |
| | | | Negative |

Before Instruction
After Instruction

TABLE 31
BNOV: Branch if Not Overflow

| Syntax: | {label:} | BRA | NOV, | Slit16 | | |
|---|---|---|---|---|---|---|
| Operands: | Slit16 ∈ [−32768 . . . +32767] | | | | | |
| Operation: | Condition = !0V | | | | | |
| | If (condition), then (PC+2) + 2*Slit16 → PC, and | | | | | |
| | NOP → Instruction Register. | | | | | |
| Status Affected: | None | | | | | |
| Encoding: | 0011 | 1000 | nnnn | nnnn | nnnn | nnnn |

| | |
|---|---|
| Description: | If the Overflow Flag is ‘0’, then the program will |
| | branch. |
| | The 2's complement number ‘2*Slit16’ (the offset) is |
| | added to the PC. Since the PC will have incremented |
| | to fetch the next instruction, the new address will be |
| | (PC+2) + 2*Slit16. This instruction is then a two-cycle |
| | instruction, with a NOP in the second cycle. |
| | The ‘n’ bits are a signed literal that specifies |
| | the number of instructions offset from (PC+2). |
| Words: | 1 |
| Cycles: | 1 (2) |

| | | | |
|---|---|---|---|
| Example: | BRA | NOV, label | ; Branch if Not |
| | | | OVerflow |

Before Instruction
After Instruction

TABLE 32
BNZ: Branch if Not Zero

| Syntax: | {label:} | BRA | NZ, | Slit16 | | |
|---|---|---|---|---|---|---|
| Operands: | Slit16 ∈ [−32768 . . . +32767] | | | | | |
| Operation: | Condition = !Z | | | | | |
| | If (condition), then (PC+2) + 2*Slit16 → PC, and | | | | | |
| | NOP → Instruction Register. | | | | | |
| Status Affected: | None | | | | | |
| Encoding: | 0011 | 1010 | nnnn | nnnn | nnnn | nnnn |

| | |
|---|---|
| Description: | If the Zero Flag is ‘0’, then the program will branch. |
| | The 2's complement number ‘2*Slit16’ (the offset) is |
| | added to the PC. Since the PC will have incremented |
| | to fetch the next instruction, the new address will be |
| | (PC+2) + 2*Slit16. This instruction is then a two-cycle |
| | instruction, with a NOP in the second cycle. |
| | The ‘n’ bits are a signed literal that specifies |
| | the number of instructions offset from (PC+2). |
| Words: | 1 |
| Cycles: | 1 (2) |

| | | | |
|---|---|---|---|
| Example: | BRA | NZ, label | ; Branch if Not Zero |

Before Instruction
After Instruction

TABLE 33
BOA: Branch if Overflow Accumulator A

| Syntax: | {label:} | BRA | OA, | Slit16 | | |
|---|---|---|---|---|---|---|
| Operands: | Slit16 ∈ [−32768 . . . +32767] | | | | | |
| Operation: | Condition = OA | | | | | |
| | If (condition), then (PC+2) + 2*Slit16 → PC, and | | | | | |
| | NOP → Instruction Register. | | | | | |
| Status Affected: | None | | | | | |
| Encoding: | 0000 | 1100 | nnnn | nnnn | nnnn | nnnn |

| | |
|---|---|
| Description: | If the OA Flag is ‘1’, then the program will |
| | branch. |
| | The 2's complement number ‘2*Slit16’ (the offset) is |
| | added to the PC. Since the PC will have incremented |
| | to fetch the next instruction, the new address will be |
| | (PC+2) + 2*Slit16. This instruction is then a two-cycle |
| | instruction, with a NOP in the second cycle. |
| | The ‘n’ bits are a signed literal that specifies the |
| | number of instructions offset from (PC+2). |
| Words: | 1 |
| Cycles: | 1 (2) |

| | | | |
|---|---|---|---|
| Example: | BRA | OA, label | ; Branch if Accumulator A |
| | | | Overflow |

Before Instruction
After Instruction

TABLE 34
BOB: Branch if Overflow Accumulator B

| Syntax: | {label:} | BRA | OB, | Slit16 | | |
|---|---|---|---|---|---|---|
| Operands: | Slit16 ∈ [−32768 . . . +32767] | | | | | |
| Operation: | Condition = OB | | | | | |
| | If (condition), then (PC+2) + 2*Slit16 → PC, and | | | | | |
| | NOP → Instruction Register. | | | | | |
| Status Affected: | None | | | | | |
| Encoding: | 0000 | 1101 | nnnn | nnnn | nnnn | nnnn |

| Description: | If the OB Flag is ‘1’, then the program will branch. | | | |
|---|---|---|---|---|
| | The 2's complement number ‘2*Slit16’ (the offset) | | | |
| | is added to the PC. Since the PC will have | | | |
| | incremented to fetch the next instruction, | | | |
| | the new address will be (PC+2) + 2*Slit16. | | | |
| | This instruction is then a two-cycle instruction, | | | |
| | with a NOP in the second cycle. | | | |
| | The ‘n’ bits are a signed literal that specifies the | | | |
| | number of instructions offset from (PC+2). | | | |
| Words: | 1 | | | |
| Cycles: | 1 (2) | | | |
| Example: | | BRA | OB, label | ; Branch if Accumulator |
| | | | | B Overflow |

Before Instruction
After Instruction

TABLE 35
BOV: Branch if Overflow

| Syntax: | {label:} | BRA | OV, | Slit16 | | |
|---|---|---|---|---|---|---|
| Operands: | Slit16 ∈ [−32768 . . . +32767] | | | | | |
| Operation: | Condition = OV | | | | | |
| | If (condition), then (PC+2) + 2*Slit16 → PC, and | | | | | |
| | NOP → Instruction Register. | | | | | |
| Status Affected: | None | | | | | |
| Encoding: | 0011 | 0000 | nnnn | nnnn | nnnn | nnnn |

| Description: | If the Overflow Flag is ‘1’, then the program | | | |
|---|---|---|---|---|
| | will branch. | | | |
| | The 2's complement number ‘2*Slit16’ (the offset) | | | |
| | is added to the PC. Since the PC will have | | | |
| | incremented to fetch the next instruction, | | | |
| | the new address will be (PC+2) + 2*Slit16. | | | |
| | This instruction is then a two-cycle instruction, | | | |
| | with a NOP in the second cycle. | | | |
| | The ‘n’ bits are a signed literal that specifies the | | | |
| | number of instructions offset from (PC+2). | | | |
| Words: | 1 | | | |
| Cycles: | 1 (2) | | | |
| Example: | | BRA | OV, label | ; Branch if |
| | | | | Overflow |

Before Instruction
After Instruction

TABLE 36
BRA: Branch Unconditionally

| Syntax: | {label:} | BRA | Slit16 | | | |
|---|---|---|---|---|---|---|
| Operands: | Slit16 ∈ [−32768 . . . +32767] | | | | | |
| Operation: | (PC+2) + 2*Slit16 → PC, and | | | | | |
| | NOP → Instruction Register. | | | | | |
| Status Affected: | None | | | | | |
| Encoding: | 0011 | 0111 | nnnn | nnnn | nnnn | nnnn |

| Description: | The program will branch unconditionally. | | | |
|---|---|---|---|---|
| | The 2's complement number ‘2*Slit16' (the offset) | | | |
| | is added to the PC. Since the PC will have | | | |
| | incremented to fetch the next instruction, the new | | | |
| | address will be (PC+2) + 2*Slit16. | | | |
| | This instruction is then a two-cycle instruction, | | | |
| | with a NOP in the second cycle. | | | |
| | The ‘n’ bits are a signed literal that specifies the | | | |
| | number of instructions offset from (PC+2). | | | |
| Words: | 1 | | | |
| Cycles: | 2 | | | |
| Example: | | BRA | label | ; Branch unconditionally |

Before Instruction
After Instruction

TABLE 37
BRAW: Computed Branch

| Syntax: | {label:} | BRA | Wn | | | |
|---|---|---|---|---|---|---|
| Operands: | Wn ∈ [W0 . . . W15] | | | | | |
| Operation: | (PC) +2 + (2 * (Wn)) → PC, | | | | | |
| | NOP → Instruction Register. | | | | | |
| Status Affected: | None | | | | | |
| Encoding: | 0000 | 0001 | 0110 | 0000 | 0000 | ssss |

| Description: | Computed branch with a jump up to 32K | | | |
|---|---|---|---|---|
| | instructions forward or backward from the | | | |
| | current location. | | | |
| | The sign extended 17-bit value (2 * (Wn)) is added | | | |
| | to the contents of the PC and the result is stored | | | |
| | into the PC. BRAW is a two-cycle instruction. | | | |
| | The ‘s’ bits select the address of the | | | |
| | source register. | | | |
| Words: | 1 | | | |
| Cycles: | 2 | | | |
| Example: | | BRA | W11 | ; Branch to |
| | | | | PC+W11 |

Before Instruction
After Instruction

TABLE 38
BSA: Branch if ACCA Saturation

| Syntax: | {label:} | BRA | SA, | Slit16 | | |
|---|---|---|---|---|---|---|
| Operands: | Slit16 ∈ [−32768 . . . +32767] | | | | | |
| Operation: | Condition = SA | | | | | |
| | If (condition), then (PC+2) + 2*Slit16 → PC, | | | | | |
| | and NOP → Instruction Register. | | | | | |
| Status Affected: | None | | | | | |
| Encoding: | 0000 | 1110 | nnnn | nnnn | nnnn | nnnn |

| Description: | If the ACCA Saturation Flag is ‘1’, then the | | | |
|---|---|---|---|---|
| | program will branch. | | | |
| | The 2's complement number ‘2*Slit16’ (the offset) | | | |
| | is added to the PC. Since the PC will have | | | |
| | incremented to fetch the next instruction, | | | |
| | the new address will be (PC+2) + 2*Slit16. | | | |
| | This instruction is then a two-cycle instruction, | | | |
| | with a NOP in the second cycle. | | | |
| | The ‘n’ bits are a signed literal that specifies the | | | |
| | number of instructions offset from (PC+2). | | | |
| Words: | 1 | | | |
| Cycles: | 1 (2) | | | |
| Example: | | BRA | SA, label | ; Branch if ACCA |
| | | | | Saturation |

Before Instruction
After Instruction

TABLE 39
BSB: Branch if ACCB Saturation

| Syntax: | {label:} | BRA | SB, | Slit16 | | |
|---|---|---|---|---|---|---|
| Operands: | Slit16 ∈ [−32768 . . . +32767] | | | | | |
| Operation: | Condition = SB | | | | | |
| | if (condition), then (PC+2) + 2*Slit16→ PC, and | | | | | |
| | NOP → Instruction Register. | | | | | |
| Status Affected: | None | | | | | |
| Encoding: | 0000 | 1111 | nnnn | nnnn | nnnn | nnnn |

| Description: | If the ACCB Saturation Flag is ‘1’, then the | | | |
|---|---|---|---|---|
| | program will branch. | | | |
| | The 2's complement number ‘2*Slit16’ (the offset) | | | |
| | is added to the PC. Since the PC will have | | | |
| | incremented to fetch the next | | | |
| | instruction, the new address will be | | | |
| | (PC+2) + n. | | | |
| | This instruction is then a two-cycle instruction, | | | |
| | with a NOP in the second cycle. | | | |
| | The ‘n’ bits are a signed literal that specifies | | | |
| | the number of instructions offset from (PC+2). | | | |
| Words: | 1 | | | |
| Cycles: | 1 (2) | | | |
| Example: | | BRA | SB, label | ; Branch if ACCB |
| | | | | Saturation |

Before Instruction
After Instruction

TABLE 40
BSETF: Bit Set f

| Syntax: | {label:} | BSET.b | f, | bit3 | | |
|---|---|---|---|---|---|---|
| Operands: | bit3 ∈ [0 ... 7]; f ∈ [0 . . . 8191] | | | | | |
| Operation: | 1 → f<bit3> | | | | | |
| Status Affected: | None | | | | | |
| Encoding: | 1010 | 1000 | bbbf | ffff | ffff | ffff |

| Description: | Bit ‘bit3’ in file register f is set. | |
|---|---|---|
| | The ‘b’ bits select value bit3 of the bit position | |
| | to be cleared. | |
| | The ‘f’ bits select the address of the file register. | |
| | Note: | This instruction operates in byte mode only. |
| | Note: | The .b extension must be included with the |
| | | opcode. |

| Words: | 1 | | | |
|---|---|---|---|---|
| Cycles: | 1 | | | |
| Example: | | BSET.B | RAM135, #5 | ; Set bit 5 |
| | | | | in RAM135 |

Before Instruction
After Instruction

TABLE 41
BSW: Bit Write in Ws

| Syntax: | {label:} | BSW.C | Ws, | Wb | | |
|---|---|---|---|---|---|---|
| | | BSW.Z | [Ws], | | | |
| | | | [Ws]++, | | | |
| | | | [Ws]−−, | | | |
| | | | [Ws++], | | | |
| | | | [Ws−−], | | | |
| Operands: | Wb ∈[W0 . . . W15]; Ws ∈[W0 . . . W15] | | | | | |
| Operation: | If “.Z” option, then → \overline{Z}→ Ws<(Wb)> | | | | | |
| | If “.C” option, then C → Ws<(Wb)> | | | | | |
| Status Affected: | None | | | | | |
| Encoding: | 1010 | 1101 | Zwww | w000 | 0ppp | ssss |

| Description: | Bit (Wb) in register Ws is written with the value of the | | | |
|---|---|---|---|---|
| | C or Z bit. | | | |
| | The ‘w’ bits select the address of the bit select | | | |
| | register. | | | |
| | The ‘Z’ bit selects the Z or C flag bit as source. | | | |
| | The ‘s’ bits select the address of the source register. | | | |
| | The ‘p’ bits select source address mode 2. | | | |
| | See Table 1-5 for modifier addressing information. | | | |
| Words: | 1 | | | |
| Cycles: | 1 | | | |
| Example: | | BSW.Z | W5,W6 | ; Test/Set bit |

Before Instruction
After Instruction

TABLE 42
BTFSC: Bit Test f, Skip if Clear

| Syntax: | {label:} | BTSC.b | f, | bit3 | | |
|---|---|---|---|---|---|---|
| Operands: | bit3 ∈ [0 . . . 7]; f ∈ [0 . . . 8191] | | | | | |
| Operation: | Test (f)<bit3>, skip if clear | | | | | |
| Status Affected: | None | | | | | |
| Encoding: | 1010 | 1111 | bbbf | ffff | ffff | ffff |

| Description: | Bit ‘bit3’ in (f) is tested. If the bit is ‘0’, | |
|---|---|---|
| | then the fetched instruction is discarded and | |
| | on the next cycle a NOP is executed instead. | |
| | The ‘b’ bits select the value bit3 of the bit position | |
| | to be tested. | |
| | The ‘f’ bits select the address of the file register. | |
| | Note: | This instruction operates in byte mode only. |
| | Note: | The .b extension must be included with the |
| | | opcode. |

| Words: | 1 | | | |
|---|---|---|---|---|
| Cycles: | 1 (2 or 3) | | | |
| Example: | | BTSC.b | RAM135, #5 | ; Bit test bit 5 in |
| | | | | RAM135, skip if clear |

Before Instruction
After Instruction

TABLE 43
BTFSS: Bit Test f, Skip if Set

| Syntax: | {label:} | BTSS.b | f, | bit3 | | |
|---|---|---|---|---|---|---|
| Operands: | bit3 ∈ [0 . . . 7]; f ∈ [0 . . . 8191] | | | | | |
| Operation: | Test (f)<bit3>, skip if set | | | | | |
| Status Affected: | None | | | | | |
| Encoding: | 1010 | 1110 | bbbf | ffff | ffff | ffff |

| Description: | Bit ‘bit3’ in (f) is tested. If the bit is ‘1’, | |
|---|---|---|
| | then the fetched instruction is discarded and | |
| | on the next cycle a NOP is executed instead. | |
| | The ‘b’ bits select value bit3 of the bit position | |
| | to be cleared. | |
| | The ‘f’ bits select the address of the file register. | |
| | Note: | This instruction operates in byte mode only. |
| | Note: | The .b extension must be included with the |
| | | opcode. |

| Words: | 1 | | | |
|---|---|---|---|---|
| Cycles: | 1 (2 or 3) | | | |
| Example: | | BTSS.b | RAM135, #5 | ; Bit test bit 5 in RAM135, |
| | | | | skip if set |

Before Instruction
After Instruction

TABLE 44
BTGF: Bit Toggle f

| Syntax: | {label:} | BTG.b | f, | bit3 | | |
|---|---|---|---|---|---|---|
| Operands: | bit3 ∈ [0 . . . 7]; f ∈ [0 . . . 8191] | | | | | |
| Operation: | \overline{(f) < bit3 >} → (f)<bit3> | | | | | |
| Status Affected: | None | | | | | |
| Encoding: | 1010 | 1010 | bbbf | ffff | ffff | ffff |

| Description: | Bit ‘bit3’ in file register f is toggled. | |
|---|---|---|
| | The ‘b’ bits select value bit3 of the bit | |
| | position to be cleared. | |
| | The ‘f’ bits select the address of the file register. | |
| | Note: | This instruction operates in byte mode only. |
| | Note: | The .b extension must be included |
| | | with the opcode. |

| | |
|---|---|
| Words: | 1 |
| Cycles: | 1 |

| | | | |
|---|---|---|---|
| Example: | BTG.b | RAM135, #5 | ; Toggle bit 5 |
| | | | in RAM135 |

Before Instruction
After Instruction

TABLE 45
BTSC: Bit Test Ws, Skip if Clear

| Syntax: | {label:} | BTSC | Ws, | bit4 | | |
|---|---|---|---|---|---|---|
| | | | [Ws], | | | |
| | | | [Ws]++, | | | |
| | | | [Ws]−−, | | | |
| | | | [Ws++], | | | |
| | | | [Ws−−], | | | |
| Operands: | bit4 ∈ [0 . . . 15]; Ws ∈ [W0 . . . W15] | | | | | |
| Operation: | Test (Ws)<bit4>, skip if clear. | | | | | |
| Status Affected: | None | | | | | |
| Encoding: | 1010 | 0111 | bbbb | 0000 | 0ppp | ssss |

| Description: | Bit ‘bit4’ in (Ws) is tested. If the bit is ‘0’, then | |
|---|---|---|
| | the fetched instruction is discarded and | |
| | on the next cycle a NOP is executed instead. | |
| | The ‘b’ bits select value bit4 of the bit | |
| | position to be tested. | |
| | The ‘s’ bits select the address of the source register. | |
| | The ‘p’ bits select source address mode 2 (values 0-4). | |
| | See Table 1-5 for modifier addressing information. | |
| | Note: | This instruction operates in word mode only. |

| | |
|---|---|
| Words: | 1 |
| Cycles: | 1 (2 or 3) |

| | | | |
|---|---|---|---|
| Example: | BTSC | W6, #5 | ; Test bit 5 in W6, |
| | | | skip if clear |

Before Instruction
After Instruction

TABLE 46
BTSS: Bit Test Ws, Skip if Set

| Syntax: | {label:} | BTSS | Ws, | bit4 | | |
|---|---|---|---|---|---|---|
| | | | [Ws], | | | |
| | | | [Ws]++, | | | |
| | | | [Ws]−−, | | | |
| | | | [Ws++], | | | |
| | | | [Ws−−], | | | |
| Operands: | bit4 ∈[0 . . . 15]; Ws ∈ [W0 . . . W15] | | | | | |
| Operation: | Test (Ws)<bit4>, skip if set. | | | | | |
| Status Affected: | None | | | | | |
| Encoding: | 1010 | 0110 | bbbb | 0000 | 0ppp | ssss |

| Description: | Bit ‘bit4’ in (Ws) is tested. If the bit is ‘1’, then | |
|---|---|---|
| | the fetched instruction is discarded and | |
| | on the next cycle a NOP is executed instead. | |
| | The ‘b’ bits select the value bit4 of the | |
| | bit position to be tested. | |
| | The ‘s’ bits select the address of the source register. | |
| | The ‘p’ bits select source address mode 2 (values 0-4). | |
| | See Table 1-5 for modifier addressing information. | |
| | Note: | This instruction operates in word mode only. |

| | |
|---|---|
| Words: | 1 |
| Cycles: | 1 (2 or 3) |

| | | | |
|---|---|---|---|
| Example: | BTSS | W6, #5 | ; Test bit 5 in W6, |
| | | | skip if set |

Before Instruction
After Instruction

TABLE 47
BTST: Bit Test in Ws

| Syntax: | {label:} | BTST.C | Ws, | bit4 | | |
|---|---|---|---|---|---|---|
| | | BTST.Z | [Ws], | | | |
| | | | [Ws]++, | | | |
| | | | [Ws]−−, | | | |
| | | | [Ws++], | | | |
| | | | [Ws−−], | | | |
| Operands: | bit4 ∈ [0 . . . 15]; Ws ∈ [W0 . . . W15]; | | | | | |
| Operation: | if “.Z” option, \overline{(Ws) < bit4 >}→ Z | | | | | |
| | if “.C” option, (Ws)<bit4> → C | | | | | |
| Status Affected: | C or Z | | | | | |
| Encoding: | 1010 | 0011 | bbbb | z000 | 0ppp | ssss |

| Description: | Bit ‘bit4’ in register Ws is tested. | |
|---|---|---|
| | The Zero flag contains the inversion of the bit or | |
| | the Carry flag contains the bit. | |
| | The ‘b’ bits select value bit4 of the bit | |
| | position to be test/set. | |
| | The ‘Z’ bit selects the Z or C flag bit as destination. | |
| | The ‘s’ bits select the address of the source register. | |
| | The ‘p’ bits select source address mode 2. | |
| | See Table 1-5 for modifier addressing information. | |
| | Note: | This instruction operates in word mode only. |

| | |
|---|---|
| Words: | 1 |
| Cycles: | 1 |

| | | | |
|---|---|---|---|
| Example: | BTST.C | W6,#5 | ; Test bit 5 in W6 to |
| | | | the C flag |

Before Instruction
After Instruction

TABLE 48
BTSTF: Bit Test f

| Syntax: | {label:} | BTST.b | f, | bit3 | | |
|---|---|---|---|---|---|---|
| Operands: | bit3 ∈[0 . . . 7]; f ∈[0 . . . 8191] | | | | | |
| Operation: | \overline{(f) < bit3 >}→ Z | | | | | |
| Status Affected: | Z | | | | | |
| Encoding: | 1010 | 1011 | bbbf | ffff | ffff | ffff |

| Description: | Bit ‘bit3’ in file register f is tested, the Zero | |
|---|---|---|
| | Flag bit is set if it is zero and cleared | |
| | otherwise. The file register contents are unchanged. | |
| | The ‘b’ bits select value bit3 of the bit | |
| | position to be cleared. | |
| | The ‘f’ bits select the address of the file register. | |
| | Note: | This instruction operates in byte mode only. |
| | Note: | The .b extension must be included |
| | | with the opcode. |

| | |
|---|---|
| Words: | 1 |
| Cycles: | 1 |

| | | | |
|---|---|---|---|
| Example: | BTST.b | RAM135, #5 | ; Test bit 5 |
| | | | in RAM135 |

Before Instruction
After Instruction

TABLE 49
BTSTS: Bit Test/Set in Ws

| Syntax: | {label:} | BTSTS.C | Ws, | bit4 | | |
|---|---|---|---|---|---|---|
| | | BTSTS.Z | [Ws], | | | |
| | | | [Ws]++, | | | |
| | | | [Ws]−−, | | | |
| | | | [Ws++], | | | |
| | | | [Ws−−], | | | |
| Operands: | bit4 ∈ [0 . . . 15]; Ws ∈[W0 . . . W15] | | | | | |
| Operation: | if “.Z” option, first \overline{(Ws)<bit4>} → Z, then | | | | | |
| | 1 → Ws<bit4> | | | | | |
| | if “.C” option, first (Ws)<bit4> → C, then | | | | | |
| | 1 → Ws<bit4> | | | | | |
| Status Affected: | C or Z | | | | | |
| Encoding: | 1010 | 0100 | bbbb | Z000 | 0ppp | ssss |

| Description: | Bit ‘bit4’ in register Ws is tested and then set. | |
|---|---|---|
| | The ‘b’ bits select the value bit4 of the bit | |
| | position to be test/set. | |
| | The ‘Z’ bit selects the Z or C flag bit as destination. | |
| | The ‘s’ bits select the address of the source register. | |
| | The ‘p’ bits select source address mode 2. | |
| | See Table 1-5 for modifier addressing information. | |
| | Note: | This instruction operates in word mode only. |

| | |
|---|---|
| Words: | 1 |
| Cycles: | 1 |

| | | | |
|---|---|---|---|
| Example: | BTSTS.Z | W6,#5 | ; Test/Set bit 5 in |
| | | | W6 to the Z flag |

Before Instruction
After Instruction

TABLE 50
BTSTSF: Bit Test/Set f

| Syntax: | {label:} | BTSTS.b | f, | bit3 | | |
|---|---|---|---|---|---|---|
| Operands: | bit3 ∈ [0 . . . 7]; f ∈ [0 . . . 8191] | | | | | |
| Operation: | First \overline{(f) < bit3 >} → Z, then 1 → (f)<bit3> | | | | | |
| Status Affected: | Z | | | | | |
| Encoding: | 1010 | 1100 | bbbf | ffff | ffff | ffff |

| Description: | Bit ‘bit3’ in file register f is tested and then set. | |
|---|---|---|
| | The ‘b’ bits select value bit3 of the | |
| | bit position to be cleared. | |
| | The ‘f’ bits select the address of the file register. | |
| | Note: | This instruction operates in byte mode only. |
| | Note: | The .b extension must be included |
| | | with the opcode. |

| | |
|---|---|
| Words: | 1 |
| Cycles: | 1 |

| | | | |
|---|---|---|---|
| Example: | BTSTS.b | RAM135, #5 | ; Test/Set bit 5 |
| | | | in RAM135 |

Before Instruction
After Instruction

TABLE 51
BTSTW: Bit Test in Ws

| Syntax: | {label:} | BTST.C | Ws, | Wb | | |
|---|---|---|---|---|---|---|
| | | BTST.Z | [Ws], | | | |
| | | | [Ws]++, | | | |
| | | | [Ws]−−, | | | |
| | | | [Ws++], | | | |
| | | | [Ws−−], | | | |
| Operands: | Wb ∈ [W0 . . . W15]; Ws ∈ [W0 . . . W15] | | | | | |
| Operation: | if “.Z” option, \overline{(Ws)<(Wb)>} → Z | | | | | |
| | if “.C” option, (Ws)<(Wb)> → C | | | | | |
| Status Affected: | C or Z | | | | | |
| Encoding: | 1010 | 0101 | Zwww | w000 | 0ppp | ssss |

| | |
|---|---|
| Description: | Bit (Wb) in register Ws is tested. |
| | The Zero flag contains the inversion of the |
| | bit or the Carry flag contains the bit. |
| | The ‘w’ bits select the address of the bit select register. |
| | The ‘Z’ bit selects the Z or C flag bit as destination. |
| | The ‘s’ bits select the address of the source register. |
| | The ‘p’ bits select source address mode 2. |
| | See Table 1-5 for modifier addressing information. |
| Words: | 1 |
| Cycles: | 1 |

| | | | |
|---|---|---|---|
| Example: | BTST.C | W5,W6 | ; Test bit in W5 selected |
| | | | by W6 |

Before Instruction
After Instruction

TABLE 52
BZ: Branch if Zero

| Syntax: | {label:} | BRA | BZ, | Slit16 | | |
|---|---|---|---|---|---|---|
| Operands: | Slit16 ∈ [−32768 . . . +32767] | | | | | |
| Operation: | Condition = Z | | | | | |
| | if (condition), then (PC+2) + 2*Slit16 → PC, and | | | | | |
| | NOP → Instruction Register. | | | | | |
| Status Affected: | None | | | | | |
| Encoding: | 0011 | 0010 | nnnn | nnnn | nnnn | nnnn |

| | |
|---|---|
| Description: | If the Z Flag is ‘1’, then the program will branch. |
| | The 2's complement number ‘2*Slit16’ (the offset) |
| | is added to the PC. Since the PC will have |
| | incremented to fetch the next instruction, the |
| | new address will be (PC+2) + 2*Slit16. |
| | This instruction is then a two-cycle instruction, with |
| | a NOP in the second cycle. |
| | The ‘n’ bits are a signed literal that specifies the |
| | number of instructions offset from (PC+2). |
| Words: | 1 |
| Cycles: | 1 (2) |

| | | | |
|---|---|---|---|
| Example: | BRA | Z, label | ; Branch if Zero |

Before Instruction
After Instruction

TABLE 53
CALL: Call Subroutine

| Syntax: | {label:} | CALL | lit23 | | | |
|---|---|---|---|---|---|---|
| | | CALL.S | | | | |
| Operands: | lit23 ∈ [0 . . . 8388606] | | | | | |
| Operation: | (PC) +4 → PC, | | | | | |
| | (PC<15:0>) →→ TOS, | | | | | |
| | (W15)+2 → W15 | | | | | |
| | (PC<23:16>) → TOS, | | | | | |
| | (W15)+2 → W15 | | | | | |
| | lit23 → PC, NOP → Instruction Register. | | | | | |
| | If S = 1, copy the contents of the primary | | | | | |
| | registers into the shadow registers. | | | | | |
| Status Affected: | None | | | | | |
| Encoding: | | | | | | |
| 1st word | 0000 | 001S | nnnn | nnnn | nnnn | nnn0 |
| 2nd word | 0000 | 0000 | 0000 | 0000 | 0nnn | nnnn |

| | |
|---|---|
| Description: | Subroutine call of entire 4M instruction program |
| | memory range. First, return address (PC+4) is pushed |
| | onto the return stack (24-bits wide). |
| | Then the 24-bit value ‘lit23’ is loaded into |
| | the PC. CALL is a two-cycle instruction. |
| | The ‘n’ bits form the target address. |
| | If ‘S’ = 1, the primary registers are copied |
| | into the shadow registers. |
| | If ‘S’ = 0, no update occurs. |
| Words: | 2 |
| Cycles: | 2 |

| | | | |
|---|---|---|---|
| Example: | CALL | label | ; Call |
| | | | subroutine |

Before Instruction
After Instruction

TABLE 54
CALLW: Call Indirect Subroutine

| Syntax: | {label:} | CALL | Wn | | | |
|---|---|---|---|---|---|---|
| | | CALL.S | | | | |
| Operands: | Wn ∈ [W0, W15] | | | | | |
| Operation: | (PC) +2 → PC, | | | | | |
| | (PC<15:0>) → TOS, | | | | | |
| | (W15)+2 → W15 | | | | | |
| | (PC<23:16>) → TOS, | | | | | |
| | (W15)+2 → W15 | | | | | |
| | 0 → PC<22:17>, (Wn) → PC<16:1>, 0 → PC<0>; | | | | | |
| | NOP → Instruction Register. | | | | | |
| Status Affected: | None | | | | | |
| Encoding: | 0000 | 0001 | S000 | 0000 | 0000 | ssss |

| | |
|---|---|
| Description: | Indirect subroutine call of first 64K instructions |
| | of program memory. First, return |
| | address (PC + 2) is pushed onto the return stack. |
| | Then, the 16-bit value (Wn) is left shifted 1 bit, |
| | zero-extended and loaded into the PC. CALL is |
| | a two-cycle instruction. |
| Words: | 1 |
| Cycles: | 2 |

| | | | |
|---|---|---|---|
| Example: | CALL | W5 | ; Call indirect |
| | | | subroutine |

Before Instruction
After Instruction

TABLE 55
CLRAC: Clear Accumulator, Prefetch Operands

| Syntax: | {label:} | CLR | A, | ,Wxp,[Wx] | ,Wyp,[Wy] | ,AWB |
|---|---|---|---|---|---|---|
| | | | B, | ,Wxp,[Wx]+=kx | ,Wyp,[Wy]+=ky | none |
| | | | | ,Wxp,[Wx]−=kx‡ | ,Wyp,[Wy]−=ky^{‡} | |
| | | | | ,Wxp,[W5+W8] | ,Wyp,[W7+W8] | |
| | | | | none | none | |
| | | | | ‡ Alternate format | | |
| | | | | for negative kx, ky | | |
| Operands: | Wxp ∈ {W0 . . . W3}; Wx ∈ {W4, W5}; kx ∈ {−6, −4, −2, 2, 4, 6}; | | | | | |
| | Wyp ∈ {W0 . . . W3}; Wy ∈ {W6, W7}; ky ∈ {−6, −4, −2, 2, 4, 6}; | | | | | |
| | AWB ∈ {W9, [W9]++} | | | | | |
| Operation: | 0 → ACC(A or B) | | | | | |
| | ([Wx])→ Wxp; (Wx)+kx→Wx; | | | | | |
| | ([Wy])→ Wyp; (Wy)+ky→Wy; | | | | | |
| | (ACC(B or A)) rounded → AWB | | | | | |
| Status Affected: | OA, OB, SA, SB | | | | | |
| Encoding: | 1100 | 0011 | A0xx | yyii | iijj | jjaa |

| Description: | Clear the specified accumulator, prefetch operands and optionally | | |
|---|---|---|---|
| | store accumulator results in preparation for a repeated | | |
| | MAC type instruction. Wx register specifies the prefetch | | |
| | of the multiplier Wxp register. The prefetch is done | | |
| | with indirect, indirect with post inc/dec, indirect | | |
| | with register offset, copy of the other | | |
| | prefetch or none. Post-modify Wx as required. | | |
| | Wy register specifies the prefetch of the multiplier | | |
| | Wyp register. Post-modify Wy as required. | | |
| | AWB specifies the direct or indirect store of the convergently | | |
| | rounded contents of other accumulator, if required. Note that | | |
| | the specification of (B or A) is consistant | | |
| | with the MAC instruction. For example, CLRAC A, W9 will store | | |
| | ACCB into W9. | | |
| | The ‘A’ bit selects the other accumulator used for write back. | | |
| | The ‘i’ bits select the Wx pre-fetch operation. | | |
| | The ‘j’ bits select the Wy pre-fetch operation. | | |
| | The ‘x’ bits select the pre-fetch Wxp destination. | | |
| | The ‘y’ bits select the pre-fetch Wyp destination. | | |
| | The ‘a’ bits select the accumulator write-back destination. | | |
| | See Table 1-9 through Table 1-14 for modifier addressing information. | | |
| Words: | 1 | | |
| Cycles: | 1 | | |
| Example: | CLR | A,W0,[W4]− | ; Clear ACCA, prefetch, move ACCB |
| | | =6,W1,[W6],[W9]++ | to [W9]++ |

Before Instruction
After Instruction

TABLE 56
CLRF: Clear f or Ww

| Syntax: | {label:} | CLR{.b} | f | | | |
|---|---|---|---|---|---|---|
| | | | Ww | | | |
| Operands: | f ∈ [0 . . . 8191] | | | | | |
| Operation: | 0 → destination designated by D | | | | | |
| Status Affected: | Z | | | | | |
| Encoding: | 1110 | 1111 | 0BDf | ffff | ffff | ffff |

| Description: | Clear the register designated by D: If | |
|---|---|---|
| | the optional Ww is specified, | |
| | D = 0 and clear Ww; otherwise, D = 1 and clear | |
| | the file register. Z flag is set. | |
| | The ‘B’ bit selects byte or word operation. | |
| | The ‘f’ bits select the address of the file register. | |
| | The ‘D’ bit selects the destination. | |
| | Note: | The extension .b in the instruction |
| | | denotes a byte operation rather than a |
| | | word operation. You may use a .w extension |
| | | to denote a word operation, but it is not |
| | | required. |

| | |
|---|---|
| Words: | 1 |
| Cycles: | 1 |

| | | | |
|---|---|---|---|
| Example: | CLR | 345 | ; Clear file |
| | | | register 345 |

Before Instruction
After Instruction

TABLE 57
CLRWDT: Clear Watchdog Timer

| Syntax: | {label:} | CLRWDT | | | | |
|---|---|---|---|---|---|---|
| Operands: | none | | | | | |
| Operation: | 0 → WDT Reg | | | | | |
| Status Affected: | \overline{TO} \overline{PD} | | | | | |
| Encoding: | 1111 | 1110 | 0110 | 0000 | 0000 | 0000 |

| | |
|---|---|
| Description: | Clear the WatchDog Timer register. |
| Words: | 1 |
| Cycles: | 1 |

| | | |
|---|---|---|
| Example: | CLRWDT | ; Clear Watchdog |
| | | Timer |

Before Instruction
After Instruction

TABLE 58
COM: Complement Ws

| | | | | |
|---|---|---|---|---|
| Syntax: | {label:} | COM{.b} | Ws, | Wd |
| | | | [Ws], | [Wd] |
| | | | [Ws]++, | [Wd]++ |
| | | | [Ws]−−, | [Wd]−− |
| | | | [Ws++], | [Wd++] |
| | | | [Ws−−], | [Wd−−] |

| Operands: | Ws ∈ [W0 . . . W15]; Wd ∈ [W0 . . . W15] | | | | | |
|---|---|---|---|---|---|---|
| Operation: | \overline{(Ws)} → Wd | | | | | |
| Status Affected: | Z, N | | | | | |
| Encoding: | 1110 | 1010 | 1Bqq | qddd | dppp | ssss |

| Description: | Compute the 1's complement of the contents | |
|---|---|---|
| | of the source register Ws and place the result in the | |
| | destination register Wd. | |
| | The ‘B’ bit selects byte or word operation. | |
| | The ‘s’ bits select the address of the source register. | |
| | The ‘d’ bits select the address of the destination | |
| | register. | |
| | The ‘p’ bits select the source address mode | |
| | 2 (values 0-4). | |
| | The ‘q’ bits select the destination address mode | |
| | 2 (values 0-4). | |
| | See Table 1-5 and Table 1-6 for modifier | |
| | addressing information. | |
| | Note: | The extension .b in the instruction |
| | | denotes a byte operation rather than |
| | | a word operation. You may use |
| | | a .w extension to |
| | | denote a word operation, but it |
| | | is not required. |

| | |
|---|---|
| Words: | 1 |
| Cycles: | 1 |

| | | | |
|---|---|---|---|
| Example: | COM | W5,W7 | ; Complement |

Before Instruction
After Instruction

TABLE 59
COMF: Complement f

| Syntax: | {label:} | COM{.b} | f | {,Ww} | | |
|---|---|---|---|---|---|---|
| Operands: | f ∈ [0 . . . 8191] | | | | | |
| Operation: | \overline{(f)}→ destination designated by D | | | | | |
| Status Affected: | Z, N | | | | | |
| Encoding: | 1110 | 1110 | 1BDf | ffff | ffff | ffff |

| Description: | Compute the 1's complement of the | |
|---|---|---|
| | contents of the file register and place the | |
| | result in the destination designated by D: If | |
| | the optional Ww is specified, D = 0 and | |
| | store result in Ww; otherwise, D = 1 and | |
| | store result in the file register. | |
| | The ‘B’ bit selects byte or word operation. | |
| | The ‘f’ bits select the address of the file register. | |
| | The ‘D’ bit selects the destination. | |
| | Note: | The extension .b in the |
| | | instruction denotes a byte operation rather than |
| | | a word operation. You may use a .w extension |
| | | to denote a word operation, but it is |
| | | not required. |

| | |
|---|---|
| Words: | 1 |
| Cycles: | 1 |

| | | | |
|---|---|---|---|
| Example: | COMF | RAM135 | ; Complement |

Before Instruction
After Instruction

TABLE 60
CP: Compare Wb with Ws, Set status flags

| | | | | |
|---|---|---|---|---|
| Syntax: | {label:} | CP{.b} | Wb, | Ws |
| | | | | [Ws] |
| | | | | [Ws]++ |
| | | | | [Ws]−− |
| | | | | [Ws++] |
| | | | | [Ws−−] |

| Operands: | Wb ∈ [W0 . . . W15]; Ws ∈ [W0 . . . W15] | | | | | |
|---|---|---|---|---|---|---|
| Operation: | (Ws) − (Wb) | | | | | |
| Status Affected: | C, DC, N, OV, Z | | | | | |
| Encoding: | 1110 | 0001 | 0www | wB00 | 0ppp | ssss |

| Description: | Compute (Ws) − (Wb), equivalent to SUBR | |
|---|---|---|
| | instruction, then set flags but do not | |
| | store result. | |
| | The ‘B’ bit selects byte or word operation. | |
| | The ‘p’ bits select source address mode 2. | |
| | The ‘w’ bits select the address of the | |
| | Wb source register. | |
| | The ‘s’ bits select the address of the | |
| | Ws source register. | |
| | See Table 1-5 for modifier addressing information. | |
| | Note: | The extension .b in the instruction |
| | | denotes a byte operation rather than |
| | | a word operation. You may use a .w extension |
| | | to denote a word operation, but |
| | | it is not required. |

| | |
|---|---|
| Words: | 1 |
| Cycles: | 1 |

| | | | |
|---|---|---|---|
| Example: | CP | W5,W6 | ; Skip |

Before Instruction
After Instruction

TABLE 61
CPB: Compare Wb with Ws with Borrow, set status flags

| Syntax: | {label:} | CPB{.b} | Wb, | Ws | | |
|---|---|---|---|---|---|---|
| | | | | [Ws] | | |
| | | | | [Ws]++ | | |
| | | | | [Ws]−− | | |
| | | | | [Ws++] | | |
| | | | | [Ws−−] | | |
| Operands: | Wb ∈[W0 . . . W15]; Ws ∈[W0 . . . W15] | | | | | |
| Operation: | (Ws) − (Wb) − (\overline{C}) | | | | | |
| Status Affected: | C, DC, N, OV, Z | | | | | |
| Encoding: | 1110 | 0001 | 1www | wB00 | 0ppp | ssss |

| Description: | Compute (Ws) − (Wb) − (c), equivalent to | |
|---|---|---|
| | SUBRB instruction, then set flags but do | |
| | not store result. | |
| | The ‘B’ bit selects byte or word operation. | |
| | The ‘p’ bits select source address mode 2. | |
| | The ‘w’ bits select the address of the | |
| | Wb source register. | |
| | The ‘s’ bits select the address of the | |
| | Ws source register. | |
| | See Table 1-5 for modifier addressing information. | |
| | Note: | The extension .b in the |
| | | instruction denotes a byte operation rather |
| | | than a word operation. You may use |
| | | a .w extension to denote a word |
| | | operation, but it is not required. |

| | |
|---|---|
| Words: | 1 |
| Cycles: | 1 |

| | | | |
|---|---|---|---|
| Example: | CPB | W5,W6 | ; Skip |

Before Instruction
After Instruction

TABLE 62
CPBLS: Compare Wb with lit5 with borrow, Set status flags

| Syntax: | {label:} | CPB{.b} | Wb, | lit5 | | |
|---|---|---|---|---|---|---|
| Operands: | Wb ∈[W0 . . . W15]; lit5 ∈[0 . . . 31] | | | | | |
| Operation: | (Wb) − lit5 − (\overline{C}) | | | | | |
| Status Affected: | C, DC, N, OV, Z | | | | | |
| Encoding: | 1110 | 0001 | 1www | wB00 | 011k | kkkk |

| Description: | Compute (Wb) − lit5, set flags but do not store result. | |
|---|---|---|
| | The ‘B’ bit selects byte or word operation. | |
| | The ‘w’ bits select the address of | |
| | the Wb source register. | |
| | The ‘k’ bits provide the literal operand, | |
| | a five bit integer number. | |
| | Note: | The extension .b in the instruction denotes |
| | | a byte operation rather than a word operation. |
| | | You may use a .w extension to denote a |
| | | word operation, but it is not required. |

| | |
|---|---|
| Words: | 1 |
| Cycles: | 1 |

| | | |
|---|---|---|
| Example: | CPB | W5, #30 |

Before Instruction
After Instruction

TABLE 63
CPF: Compare f with Ww, Set status flags

| Syntax: | {label:} | CP{.b} | f | | | |
|---|---|---|---|---|---|---|
| Operands: | f ∈ [0 . . . 8191] | | | | | |
| Operation: | (f) − (Ww) | | | | | |
| Status Affected: | C, DC, N, OV, Z | | | | | |
| Encoding: | 1110 | 0011 | 0B0f | ffff | ffff | ffff |

| Description: | Compute (f) − (Wd), set flags but do not store result. | |
|---|---|---|
| | The ‘B’ bit selects byte or word operation. | |
| | The ‘f’ bits select the address of the file register. | |
| | Note: | The extension .b in the instruction |
| | | denotes a byte operation rather than a word |
| | | operation. You may use a .w extension |
| | | to denote a word operation, but it |
| | | is not required. |

| | |
|---|---|
| Words: | 1 |
| Cycles: | 1 |

| | | | |
|---|---|---|---|
| Example: | CP | RAM135 | ; Compare |

Before Instruction
After Instruction

TABLE 64
CPF0: Compare f with 0x0000, Set status flags

| Syntax: | {label:} | CP0{.b} | f | | | |
|---|---|---|---|---|---|---|
| Operands: | f ∈ [0 . . . 8191] | | | | | |
| Operation: | (f) − 0x0000 | | | | | |
| Status | C, DC, N, OV, Z | | | | | |
| Affected: | | | | | | |
| Encoding: | 1110 | 0010 | 0B0f | ffff | ffff | ffff |

| Description: | Compute (f) − 0x0000, set flags but do not store result. | |
|---|---|---|
| | The ‘B’ bit selects byte or word operation. | |
| | The ‘f’ bits select the address of the file register. | |
| | Note: | The extension .b in the instruction denotes a byte |
| | | operation rather than a word operation. You may use |
| | | a .w extension to denote a word operation, but it is |
| | | not required. |

| | |
|---|---|
| Words: | 1 |
| Cycles: | 1 |

| | | | |
|---|---|---|---|
| Example: | CP0 | 53 | ; Compare |

Before Instruction
After Instruction

TABLE 65
CPFB: Compare f with Ww with Borrow, Set status flags

| Syntax: | {label:} | CPB{.b} | f | | | |
|---|---|---|---|---|---|---|
| Operands: | f ∈ [0 . . . 8191] | | | | | |
| Operation: | (f) − (Ww) − (\overline{C}) | | | | | |
| Status | C, DC, N, OV, Z | | | | | |
| Affected: | | | | | | |
| Encoding: | 1110 | 0011 | 1B0f | ffff | ffff | ffff |

| Description: | Compute (f) − (Ww) − ( ), set \overline{C} flags but do not store | |
|---|---|---|
| | result. | |
| | The ‘B’ bit selects byte or word operation. | |
| | The ‘f’ bits select the address of the file register. | |
| | Note: | The extension .b in the instruction denotes a byte |
| | | operation rather than a word operation. You may |
| | | use a .w extension to denote a word operation, |
| | | but it is not required. |

| | |
|---|---|
| Words: | 1 |
| Cycles: | 1 |

| | | | |
|---|---|---|---|
| Example: | CPB | RAM135 | ; Compare |
| | | | RAM135-Ww |

Before Instruction
After Instruction

TABLE 66
CPLS: Compare Wb with lit5, Set status flags

| Syntax: | {label:} | CP{.b} | Wb, | lit5 | | |
|---|---|---|---|---|---|---|
| Operands: | Wb ∈ [W0 . . . W15]; lit5 ∈ [0 . . . 31] | | | | | |
| Operation: | (Wb) − lit5 | | | | | |
| Status | C, DC, N, OV, Z | | | | | |
| Affected: | | | | | | |
| Encoding: | 1110 | 0001 | 0www | wB00 | 011k | kkkk |

| Description: | Compute (Wb) − lit5, set flags but do not store result. | |
|---|---|---|
| | The ‘B’ bit selects byte or word operation. | |
| | The ‘w’ bits select the address of the Wb base register. | |
| | The ‘k’ bits provide the literal operand, a five bit | |
| | integer number. | |
| | Note: | The extension .b in the instruction denotes a byte |
| | | operation rather than a word operation. You may |
| | | use a .w extension to denote a word operation, |
| | | but it is not required. |

| | |
|---|---|
| Words: | 1 |
| Cycles: | 1 |

| | | |
|---|---|---|
| Example: | CP | W5, #30 |

Before Instruction
After Instruction

TABLE 67
DAW: Decimal Adjust Wn

| Syntax: | {label:} | DAW.b | Wn | | | |
|---|---|---|---|---|---|---|
| Operands: | Wn ∈ [W0 . . . W15] | | | | | |
| Operation: | If [Wn<3:0> >9] or [DC = 1] then | | | | | |
| | (Wn<3:0>) + 6 → Wn<3:0> | | | | | |
| | else | | | | | |
| | (Wn<3:0>) → Wn<3:0>; | | | | | |
| | If [Wn<7:4> >9] or [C = 1] then | | | | | |
| | (Wn<7:4>) + 6 → Wn<7:4> | | | | | |
| | else | | | | | |
| | (Wn<7:4>) → Wn<7:4>; | | | | | |
| Status | C | | | | | |
| Affected: | | | | | | |
| Encoding: | 1111 | 1101 | 0100 | 0000 | 0000 | ssss |

| | |
|---|---|
| Description: | DAW adjusts the eight bit value in Wn (LSB's) resulting |
| | from the earlier addition of two variables (each in packed |
| | BCD format) and produces a correct packed BCD result. |
| | The ‘s’ bits select the address of the source register. |
| | This instruction operates in byte mode only. |
| | The .b extension must be included with the opcode. |
| Words: | 1 |
| Cycles: | 1 |

| | | | |
|---|---|---|---|
| Example: | DAW.b | W5 | ; Decimal adjust |

Before Instruction
After Instruction

TABLE 68
DEC: Decrement Ws

| Syntax: | {label:} | DEC{.b} | Ws, | Wd | | |
|---|---|---|---|---|---|---|
| | | | [Ws], | [Wd] | | |
| | | | [Ws]++, | [Wd]++ | | |
| | | | [Ws]−−, | [Wd]−− | | |
| | | | [Ws++], | [Wd++] | | |
| | | | [Ws−−], | [Wd−−] | | |
| Operands: | Ws ∈ [W0 . . . W15]; Wd ∈ [W0 . . . W15] | | | | | |
| Operation: | (Ws) − 1 → Wd | | | | | |
| Status | C, DC, N, OV, Z | | | | | |
| Affected: | | | | | | |
| Encoding: | 1110 | 1001 | 0Bqq | qddd | dppp | ssss |

| Description: | Subtract one from the contents of the source register Ws | |
|---|---|---|
| | and place the result in the destination register Wd. | |
| | The ‘B’ bit selects byte or word operation. | |
| | The ‘s’ bits select the address of the source register. | |
| | The ‘d’ bits select the address of the destination register. | |
| | The ‘p’ bits select the source address mode 2 (values 0-4). | |
| | The ‘q’ bits select the destination address mode 2 | |
| | (values 0-4). | |
| | See Table 1-5 and Table 1-6 for modifier addressing | |
| | information. | |
| | Note: | The extension .b in the instruction denotes a byte |
| | | operation rather than a word operation. You may |
| | | use a .w extension to denote a word operation, |
| | | but it is not required. |

| | |
|---|---|
| Words: | 1 |
| Cycles: | 1 |

| | | | |
|---|---|---|---|
| Example: | DEC | W5,W7 | ; Decrement |

Before Instruction
After Instruction

TABLE 69
DEC2: Decrement Ws by 2

| Syntax: | {label:} | DEC2{.b} | Ws, | Wd | | |
|---|---|---|---|---|---|---|
| | | | [Ws], | [Wd] | | |
| | | | [Ws]++, | [Wd]++ | | |
| | | | [Ws]−−, | [Wd]−− | | |
| | | | [Ws++], | [Wd++] | | |
| | | | [Ws−−], | [Wd−−] | | |
| Operands: | Ws ∈ [W0 . . . W15]; Wd ∈ [W0 . . . W15] | | | | | |
| Operation: | (Ws) − 2 → Wd | | | | | |
| Status | C, DC, N, OV, Z | | | | | |
| Affected: | | | | | | |
| Encoding: | 1110 | 1001 | 1Bqq | qddd | dppp | ssss |

| Description: | Subtract two from the contents of the source register | |
|---|---|---|
| | Ws and place the result in the destination register Wd. | |
| | The ‘B’ bit selects byte or word operation. | |
| | The ‘s’ bits select the address of the source register. | |
| | The ‘d’ bits select the address of the destination register. | |
| | The ‘p’ bits select the source address mode 2 (values 0-4). | |
| | The ‘q’ bits select the destination address mode 2 | |
| | (values 0-4). | |
| | See Table 1-5 and Table 1-6 for modifier addressing | |
| | information. | |
| | Note: | The extension .b in the instruction denotes a byte |
| | | operation rather than a word operation. You may |
| | | use a .w extension to denote a word operation, |
| | | but it is not required. |

| | |
|---|---|
| Words: | 1 |
| Cycles: | 1 |

| | | | |
|---|---|---|---|
| Example: | DEC2 | W5,W7 | ; Decrement |

Before Instruction
After Instruction

TABLE 70
DECF: Decrement f

| Syntax: | {label:} | DEC{.b} | f | {,Ww} | | |
|---|---|---|---|---|---|---|
| Operands: | f ∈ [0 . . . 8191] | | | | | |
| Operation: | (f) − 1 → destination designated by D | | | | | |
| Status | C, DC, N, OV, Z | | | | | |
| Affected: | | | | | | |
| Encoding: | 1110 | 1101 | 0BDf | ffff | ffff | ffff |

| Description: | Subtract one from the contents of the file register and | |
|---|---|---|
| | place the result in the destination designated by D: If the | |
| | optional Ww is specified, D = 0 and store result in Ww; | |
| | otherwise, D = 1 and store result in the file register. | |
| | The ‘B’ bit selects byte or word operation. | |
| | The ‘f’ bits select the address of the file register. | |
| | The ‘D’ bit selects the destination. | |
| | Note: | The extension .b in the instruction denotes a byte |
| | | operation rather than a word operation. You may |
| | | use a .w extension to denote a word operation, |
| | | but it is not required. |

| | |
|---|---|
| Words: | 1 |
| Cycles: | 1 |

| | | | |
|---|---|---|---|
| Example: | DECF | RAM135 | ; Decrement |

Before Instruction
After Instruction

TABLE 71
DISI: Disable Interrupts

| Syntax: | {label:} | DISI | lit14 | | | |
|---|---|---|---|---|---|---|
| Operands: | lit14 ∈[0 . . . 16384] | | | | | |
| Operation: | Disable interrupts for lit14 cycles | | | | | |
| Status | None | | | | | |
| Affected: | | | | | | |
| Encoding: | 1111 | 1100 | 00kk | kkkk | kkkk | kkkk |

| | |
|---|---|
| Description: | This instruction disables the interrupts for lit14 instruction |
| | cycles after the instruction executes. This instruction can |
| | be used before critical code sections to ensure |
| | un-interrupted execution. |
| Words: | 1 |
| Cycles: | 1 |

| | | | |
|---|---|---|---|
| Example: | DISI | #30 | ; Disable interrupts for |
| | | | next 30 instruction cycles |

Before Instruction
After Instruction

TABLE 72
DO: Initialize Hardware loop

| Syntax: | {label:} | DO | Slit16, | lit14 | | |
|---|---|---|---|---|---|---|
| Operands: | Slit16 ∈[−32768 . . . +32767]; | | | | | |
| | lit14 ∈ [0 . . . 16383] | | | | | |
| Operation: | Push Shadows | | | | | |
| | (lit14) → DOCOUNT (Loop Count Register) | | | | | |
| | (PC)+4 → PC | | | | | |
| | (PC) → DOSTART (Loop Start Register) | | | | | |
| | (PC) + (2*Slit16) → DOEND (Loop End Register) | | | | | |
| | Enable Code Looping | | | | | |
| Status | None | | | | | |
| Affected: | | | | | | |
| Encoding: | 0000 | 1000 | 00kk | kkkk | kkkk | kkkk |
| | 0000 | 0000 | nnnn | nnnn | nnnn | nnnn |

| Description: | Repeat lit14 times the code segment delineated by the | |
|---|---|---|
| | address of the instruction immediately following the DO | |
| | instruction and an end address formed by the address of | |
| | the first instruction plus offset Slit16. | |
| | The ‘k’ bits specify the loop count. | |
| | The ‘n’ bits are a signed literal that specifies the number | |
| | of instructions offset from (PC + 4) of the last instruction | |
| | executed in the loop. | |
| | Note | 1: The value k = 0 is invalid. |
| | | 2: The value n = ,−1 is invalid. The DO |
| | | instruction is not allowed to generate a DO |
| | | loop only including itself. |
| | | 3: n = 0 will generate a loop size of 1 word (same |
| | | as REPEAT instruction except instruction is |
| | | fetched every iteration). |

| | |
|---|---|
| Words: | 2 |
| Cycles: | 2 + n*(# of cycles required to execute loop) |

| | | | |
|---|---|---|---|
| Example: | DO | #5, #6 | ; Do next 5 instructions |
| | | | 6 times |

Before Instruction
After Instruction

TABLE 73
DOW: Initialize Hardware loop

| Syntax: | {label:} | DO | Slit16, | Wn | | |
|---|---|---|---|---|---|---|
| Operands: | Slit16 ∈ [−32768 . . . +32767]; | | | | | |
| | Wn ∈ [W0 . . . W15] | | | | | |
| Operation: | Push Shadows | | | | | |
| | (Wn) → DOCOUNT (Loop Count Register) | | | | | |
| | (PC)+4 → PC | | | | | |
| | (PC) → DOSTART (Loop Start Register) | | | | | |
| | (PC) + (2*Slit16) → DOEND (Loop End Register) | | | | | |
| | Enable Code Looping | | | | | |
| Status | None | | | | | |
| Affected: | | | | | | |
| | 0000 | 1000 | 1000 | 0000 | 0000 | ssss |
| Encoding: | 0000 | 0000 | nnnn | nnnn | nnnn | nnnn |

| Description: | Repeat (Wn) times the code segment delineated by the | |
|---|---|---|
| | address of the instruction immediately following the DO | |
| | instruction and an end address formed by the address | |
| | of the first instruction plus offset Slit16. | |
| | The ‘s’ bits specify the register Wn that contains the loop | |
| | count (only the 14 LSBs of (Wn) are considered). | |
| | The ‘n’ bits are a signed literal that specifies the | |
| | number of instructions offset from (PC + 4) of the | |
| | last instruction executed in the loop. | |
| | Note | 1: The value (Wn) = 0 is invalid. |
| | | 2: The value n = ,−1 is invalid. The DO |
| | | instruction is not allowed to generate a DO |
| | | loop only including itself. |
| | | 3: n = 0 will generate a loop size of 1 word (same |
| | | as REPEAT instruction except instruction is |
| | | fetched every iteration). |

| | |
|---|---|
| Words: | 2 |
| Cycles: | 2 + n*(# of cycles required to execute loop) |

| | | | |
|---|---|---|---|
| Example: | DO | #5, W6 | ; Do next 5 instructions |
| | | | (W6) times |

Before Instruction
After Instruction

TABLE 74
ED: Euclidean Distance

| Syntax: | {label:}ED | A, | Wm*Wm | ,Wxp,[Wx] | ,[Wy] | |
|---|---|---|---|---|---|---|
| | | B, | | ,Wxp,[Wx]+=kx | ,[Wy]+=ky | |
| | | | | ,Wxp,[Wx]−=kx‡ | ,[Wy]−=ky^{‡} | |
| | | | | ,Wxp,[W5+W8] | ,[W7+W8] | |
| | | | | none | none | |
| | | | | ‡ Alternate format for negative | | |
| | | | | kx, ky | | |
| Operands: | Wm*Wm ∈ {W0*W0; W1*W1; W2*W2; W3*W3} | | | | | |
| | Wxp ∈ {W0 . . . W3}; Wx ∈ {W4, W5}; kx ∈ {−6, −4, −2, 2, 4, 6}; | | | | | |
| | Wy ∈ {W6, W7}; ky ∈ {−6, −4, −2, 2, 4, 6}; | | | | | |
| Operation: | (Wm)*(Wm) → ACC(A or B); | | | | | |
| | ([Wx]−{Wy])→ Wxp; (Wx)+kx→Wx; (Wy)+ky→Wy; | | | | | |
| Status Affected: | OA, OB, SA, SB | | | | | |
| Encoding: | 1111 | 00mm | A1xx | 00ii | iijj | jj11 |

| Description: | Instruction to compute (A − B)² functions. Prefetch computes difference of | | |
|---|---|---|---|
| | prefetched values. Then, the Wm register is squared. The 32-bit result is | | |
| | sign-extended to 40-bits and written to the specified accumulator. | | |
| | Wx register specifies the prefetch of the minuend register. The prefetch is | | |
| | done with indirect, indirect with post inc/dec, | | |
| | indirect with register offset, copy | | |
| | of the other prefetch or none. Post-modify Wx as required. | | |
| | Wy register specifies the prefetch of the subtrahend register. Post-modify Wy | | |
| | as required. | | |
| | Wxp contains the difference result. | | |
| | The ‘m’ bits select the operand register Wm for the square: | | |
| | The ‘A’ bit selects the accumulator for the result. | | |
| | The ‘i’ bits select the Wx pre-fetch operation. | | |
| | The ‘j’ bits select the Wy pre-fetch operation. | | |
| | The ‘x’ bits select the pre-fetch difference Wxp destination. | | |
| | See Table 1-9 through Table 1-14 for modifier addressing information. | | |
| Words: | 1 | | |
| Cycles: | 1 | | |
| Example: | ED | A,W2*W2,W0,[W4]−=6,[W6] | ; Euclidean Distance to ACCA |

```
Before Instruction
    ACCA = 2
    ACCB = 3
    W0 = 5
    W1 = 6
    W2 = 7
    W3 = 8
    W8 = 1000
    W10 = 2000
    RAM(994) = 16
    RAM(1000) = 17
    RAM(2000) = 18
After Instruction
    ACCA = 2+7*8=58
    ACCB = 3
    W0 = 17
    W1 = 18
    W2 = 7
    W3 = 8
    W8 = 994
    W10 = 2000
    RAM(994) = 3
    RAM(1000) = 17
    RAM(2000) = 18
```

TABLE 75
EXCH: Exchange Ws and Wd

| Syntax: | {label:} | EXCH | Wns, | Wnd | | |
|---|---|---|---|---|---|---|
| Operands: | Wns ∈ [W0 . . . W15]; Wnd ∈ [W0 . . . W15] | | | | | |
| Operation: | (Wns) [symbol] (Wnd) | | | | | |
| Status Affected: | None | | | | | |
| Encoding: | 1111 | 1101 | 0000 | 0ddd | d000 | ssss |

| Description: | This instruction exchanges the contents | |
|---|---|---|
| | of two working registers. | |
| | The ‘s’ bits select the address of one of the registers. | |
| | The ‘d’ bits select the address of the other register. | |
| | Note: | Word operation is assumed. |

| | |
|---|---|
| Words: | 1 |
| Cycles: | 1 |

| | | | |
|---|---|---|---|
| Example: | EXCH | W5,W6 | ; Exchange W5 |
| | | | and W6 |

Before Instruction
After Instruction

TABLE 76
GOTO: Unconditional Branch

| Syntax: | {label:} | GOTO | lit23 | | | |
|---|---|---|---|---|---|---|
| Operands: | lit23 ∈ [0 . . . 8388606] | | | | | |
| Operation: | lit23 → PC, NOP → Instruction Register. | | | | | |
| Status Affected: | None | | | | | |
| Encoding: | | | | | | |
| 1st word | 0000 | 0100 | nnnn | nnnn | nnnn | nnn0 |
| 2nd word | 0000 | 0000 | 0000 | 0000 | 0nnn | nnnn |

| | |
|---|---|
| Description: | Unconditional branch to anywhere within the |
| | 4M instruction program memory |
| | range. GOTO is always a two-cycle instruction. |
| | The ‘n’ bits form the target address. |
| Words: | 2 |
| Cycles: | 2 |

| | | | |
|---|---|---|---|
| Example: | GOTO | label | ; Goto location at label |

Before Instruction
After Instruction

TABLE 77
GOTOW: Unconditional Indirect Branch

| Syntax: | {label:} | GOTO | Wn | | | |
|---|---|---|---|---|---|---|
| Operands: | Wn ∈[W0 . . . W15] | | | | | |
| Operation: | 0 → PC<22:17>, (Wn) → PC<16:1>, 0 → PC<0>; | | | | | |
| | NOP → Instruction Register. | | | | | |
| Status Affected: | None | | | | | |
| Encoding: | 0000 | 0001 | 0100 | 0000 | 0000 | ssss |

| | |
|---|---|
| Description: | Unconditional indirect branch within the first 64K |
| | instructions program memory |
| | range. GOTO is always a two-cycle instruction. |
| | The 16-bit value (Wn) is left |
| | shifted 1 bit, zero-extended |
| | and loaded into the PC. |
| | CALL is a two-cycle instruction. |
| | The ‘s’ bits select the address of the source register. |
| Words: | 1 |
| Cycles: | 2 |

| | | | |
|---|---|---|---|
| Example: | GOTO | W5 | ; Goto location specified |
| | | | by contents of W5 |

Before Instruction
After Instruction

TABLE 78
INC: Increment Ws

| Syntax: | {label:} | INC{.b} | Ws, | Wd | | |
|---|---|---|---|---|---|---|
| | | | [Ws], | [Wd] | | |
| | | | [Ws]++, | [Wd]++ | | |
| | | | [Ws]−−, | [Wd]−− | | |
| | | | [Ws++], | [Wd++] | | |
| | | | [Ws−−], | [Wd−−] | | |
| Operands: | Ws ∈ [W0 . . . W15]; Wd ∈ [W0 . . . W15] | | | | | |
| Operation: | (Ws) + 1 → Wd | | | | | |
| Status Affected: | C, DC, N, OV, Z | | | | | |
| Encoding: | 1110 | 1000 | 0Bqq | qddd | dppp | ssss |

| Description: | Add one to the contents of the source | |
|---|---|---|
| | register Ws and place the result in the | |
| | destination register Wd. | |
| | The ‘B’ bit selects byte or word operation. | |
| | The ‘s’ bits select the address of the source register. | |
| | The ‘d’ bits select the address of | |
| | the destination register. | |
| | The ‘p’ bits select the source | |
| | address mode 2 (values 0-4). | |
| | The ‘q’ bits select the destination | |
| | address mode 2 (values 0-4). | |
| | See Table 1-5 and Table 1-6 for | |
| | modifier addressing information. | |
| | Note: | The extension .b in the instruction |
| | | denotes a byte operation rather than a |
| | | word operation. You may use a .w |
| | | extension to denote a word operation, |
| | | but it is not required. |

| | |
|---|---|
| Words: | 1 |
| Cycles: | 1 |

| | | | |
|---|---|---|---|
| Example: | INC | W5,W7 | ; Increment |

Before Instruction
After Instruction

TABLE 79
INC2: Increment Ws by 2

| Syntax: | {label:} | INC2 | Ws, | Wd | | |
|---|---|---|---|---|---|---|
| | | | [Ws], | [Wd] | | |
| | | | [Ws]++, | [Wd]++ | | |
| | | | [Ws]−−, | [Wd]−− | | |
| | | | [Ws++], | [Wd++] | | |
| | | | [Ws−−], | [Wd−−] | | |
| Operands: | Ws ∈ [W0 . . . W15]; Wd ∈ [W0 . . . W15] | | | | | |
| Operation: | (Ws) + 2 → Wd | | | | | |
| Status Affected: | C, DC, N, OV, Z | | | | | |
| Encoding: | 1110 | 1000 | 1Bqq | qddd | dppp | ssss |

| Description: | Add two to the contents of the source | |
|---|---|---|
| | register Ws and place the result in the | |
| | destination register Wd. | |
| | The ‘B’ bit selects byte or word operation. | |
| | The ‘s’ bits select the address of the source register. | |
| | The ‘d’ bits select the address | |
| | of the destination register. | |
| | The ‘p’ bits select the source | |
| | address mode 2 (values 0-4). | |
| | The ‘q’ bits select the destination | |
| | address mode 2 (values 0-4). | |
| | See Table 1-5 and Table 1-6 for | |
| | modifier addressing information. | |
| | Note: | The extension .b in the instruction denotes a |
| | | byte operation rather than a |
| | | word operation. You may use a .w |
| | | extension to denote a word operation, |
| | | but it is not required. |

| | |
|---|---|
| Words: | 1 |
| Cycles: | 1 |

| | | | |
|---|---|---|---|
| Example: | INC | W5,W7 | ; Increment |

Before Instruction
After Instruction

TABLE 80
INCF: Increment f

| Syntax: | {label:} | INC{.b} | f | {,Ww} | | |
|---|---|---|---|---|---|---|
| Operands: | f ∈ [0 . . . 8191] | | | | | |
| Operation: | (f) + 1 → destination designated by D | | | | | |
| Status Affected: | C, DC, N, OV, Z | | | | | |
| Encoding: | 1110 | 1100 | 0BDf | ffff | ffff | ffff |

| Description: | Add one to the contents of the file | |
|---|---|---|
| | register and place the | |
| | result in the destination | |
| | designated by D: If the optional Ww is | |
| | specified, D = 0 and store result in Ww; | |
| | otherwise, D = 1 and store | |
| | result in the file register. | |
| | The ‘B’ bit selects byte or word operation. | |
| | The ‘f’ bits select the address of the file register. | |
| | The ‘D’ bit selects the destination. | |
| | Note: | The extension .b in the instruction denotes |
| | | a byte operation rather than |
| | | a word operation. You may use |
| | | a .w extension to denote a word |
| | | operation, but it is not required. |

| | |
|---|---|
| Words: | 1 |
| Cycles: | 1 |

| | | | |
|---|---|---|---|
| Example: | INC | RAM135 | ; Increment |

Before Instruction
After Instruction

TABLE 81
IOR: Inclusive Or Wb and Ws

| Syntax: | {label:} | IOR{.b} | Wb, | Ws, | Wd | |
|---|---|---|---|---|---|---|
| | | | | [Ws], | [Wd] | |
| | | | | [Ws]++, | [Wd]++ | |
| | | | | [Ws]−−, | [Wd]−− | |
| | | | | [Ws++], | [Wd++] | |
| | | | | [Ws−−], | [Wd−−] | |
| Operands: | Wb ∈ [W0 . . . W15]; Ws ∈ [W0 . . . W15]; | | | | | |
| | Wd ∈ [W0 . . . W15] | | | | | |
| Operation: | (Wb).IOR.(Ws) → Wd | | | | | |
| Status Affected: | N, Z | | | | | |
| Encoding: | 0111 | 0www | wBqq | qddd | dppp | ssss |

| | |
|---|---|
| Description: | Ior the contents of the source register |
| | Ws and the contents of the base register Wb |
| | and place the result in the destination register Wd. |
| | The ‘B’ bit selects byte or word operation. |
| | The ‘s’ bits select the address of the source register. |
| | The ‘w’ bits select the address of the base register. |
| | The ‘d’ bits select the address |
| | of the destination register: |
| | The ‘p’ bits select source address mode 2. |
| | The ‘q’ bits select destination address mode 2. |
| | See Table 1-5 and Table 1-6 for modifier |
| | addressing information. |
| | The extension .b in the instruction denotes a byte |
| | operation rather than a word |
| | operation. You may use a .w extension |
| | to denote a word operation, but it is not |
| | required. |
| Words: | 1 |
| Cycles: | 1 |

| | | | |
|---|---|---|---|
| Example: | IOR | W5,W6,W7 | ; Inclusive Or |

Before Instruction
After Instruction

TABLE 82
IORLS: Inclusive Or Wb and Short Literal

| Syntax: | {label:} | IOR{.b} | Wb | lit5 | Wd | |
|---|---|---|---|---|---|---|
| | | | | | [Wd] | |
| | | | | | [Wd]++ | |
| | | | | | [Wd]−− | |
| | | | | | [Wd++] | |
| | | | | | [Wd−−] | |
| Operands: | Wb ∈ [W0 . . . W15]; lit5 ∈ [0 . . . 31]; | | | | | |
| | Wd ∈ [W0 . . . W15] | | | | | |
| Operation: | (Wb).IOR.lit5 → Wd | | | | | |
| Status Affected: | N, Z | | | | | |
| Encoding: | 0111 | 0www | wBqq | qddd | d11k | kkkk |

| | |
|---|---|
| Description: | Compute the Inclusive Or of the contents of |
| | the base register Wb and the literal |
| | operand and place the result in |
| | the destination register Wd. |
| | The ‘B’ bit selects byte or word operation. |
| | The ‘w’ bits select the address of the base register. |
| | The ‘k’ bits provide the literal operand, |
| | a five-bit integer number. |
| | The ‘d’ bits select the address |
| | of the destination register. |
| | The ‘q’ bits select destination address mode 2. |
| | See Table 1-6 for modifier addressing information. |
| | The extension .b in the instruction denotes |
| | a byte operation rather than a word |
| | operation. You may use a .w extension to denote |
| | a word operation, but it is not |
| | required. |
| Words: | 1 |
| Cycles: | 1 |

| | | | |
|---|---|---|---|
| Example: | IOR | W5,#12,W7 | ; Add |

Before Instruction
After Instruction

TABLE 83
IORLW: Inclusive Or Literal and Wn

| Syntax: | {label:} | IOR{.b} | Slit10, | Wn | | |
|---|---|---|---|---|---|---|
| Operands: | Slit10 ∈ [−512 . . . 511]; Wn ∈ [W0 . . . W15] | | | | | |
| Operation: | Slit10.IOR.(Wn) → Wn | | | | | |
| Status Affected: | N, Z | | | | | |
| Encoding: | 1011 | 0011 | 0Bkk | kkkk | kkkk | dddd |

| Description: | Compute the Inclusive Or of the | |
|---|---|---|
| | literal operand and the contents of the working | |
| | register Wn and place the result in the | |
| | working register Wn. | |
| | The ‘B’ bit selects byte or word operation. | |
| | The ‘d’ bits select the address of the working register. | |
| | The ‘k’ bits specify the literal operand, | |
| | a signed 10-bit number. | |
| | Note: | The extension .b in the instruction |
| | | denotes a byte operation rather than a |
| | | word operation. You may use a .w extension |
| | | to denote a word operation, |
| | | but it is not required. |

| | |
|---|---|
| Words: | 1 |
| Cycles: | 1 |

| | | | |
|---|---|---|---|
| Example: | IOR | #123,W7 | ; Inclusive Or |

Before Instruction
After Instruction

TABLE 84
IORWF: Inclusive Or f and Ww

| | {label:} | IOR{.b} | f | {,Ww} | | |
|---|---|---|---|---|---|---|
| Operands: | f ∈ [0 . . . 8191] | | | | | |
| Operation: | (f).IOR.(Ww) → destination designated by D | | | | | |
| Status | N, Z | | | | | |
| Affected: | | | | | | |
| Encoding: | 1011 | 0111 | 0BDf | ffff | ffff | ffff |

| Description: | Compute the IOR of the contents of the working | |
|---|---|---|
| | register and the contents of the file register and place the | |
| | result in the destination designated by D: If the optional | |
| | Ww is specified, D = 0 and store result in Ww; | |
| | otherwise, D = 1 and store result in the file register. | |
| | The ‘B’ bit selects byte or word operation. | |
| | The ‘D’ bit selects the destination. | |
| | The ‘f’ bits select the address of the file register. | |
| | Note: | The extension .b in the instruction denotes a byte |
| | | operation rather than a word operation. You may use |
| | | a .w extension to denote a word operation, |
| | | but it is not required. |

| Words: | 1 | | | |
|---|---|---|---|---|
| Cycles: | 1 | | | |
| Example: | | IOR | RAM135, Ww | ; Inclusive |
| | | | | Or |

Before Instruction
After Instruction

TABLE 85
ITCH: Pop Shadow Registers

| Syntax: | {label:} | POP.S | | | | |
|---|---|---|---|---|---|---|
| Operands: | None | | | | | |
| Operation: | Pop shadow registers | | | | | |
| Status Affected: | All | | | | | |
| Encoding: | 1111 | 1110 | 1000 | 0000 | 0000 | 0000 |

| Description: | The values in the shadow registers are copied into | | |
|---|---|---|---|
| | the primary registers. | | |
| Words: | 1 | | |
| Cycles: | 1 | | |
| Example: | | ITCH | ; Itch |

Before Instruction
After Instruction

TABLE 86
LAC: Load Accumulator A

| Syntax: | {label:} | LAC | A, | Wns, | [, Slit4] | |
|---|---|---|---|---|---|---|
| | | | B, | [Wns], | | |
| | | | | [Wns]++ | | |
| | | | | [Wns]−− | | |
| | | | | [Wns−−], | | |
| | | | | [Wns+Wb], | | |
| | | | | [Wns+lit5] | | |
| Operands: | Wns ∈ [W0 . . . W15]; | | | | | |
| | Wb ∈ [W0 . . . W15]; lit5 ∈ [0 . . . 31] | | | | | |
| | Slit4 ∈ [−8 . . . +7] | | | | | |
| Operation: | ShiftSlit4(Extend(Wns)) → AXX | | | | | |
| Status | None | | | | | |
| Affected: | | | | | | |
| Encoding: | 1100 | 1010 | Awww | wrrr | rggg | ssss |

| Description: | Read the contents of the effective address. | |
|---|---|---|
| | Optionally shift, then place result in accumulator. | |
| | The value contained at the effective address is assumed | |
| | to be Q15 fractional data and is automatically | |
| | sign-extended (through bit 39) and zero-backfilled | |
| | (bits [15:0]) prior to shifting. | |
| | The ‘A’ bits specify the destination accumulator. | |
| | The ‘s’ bits specify the source register Wns. | |
| | The ‘g’ bits select source address mode 3. | |
| | The ‘w’ bits specify the offset amount lit5 OR | |
| | the offset register Wb. | |
| | The ‘r’ bits encode the optional operand Slit4 | |
| | which determines the amount of the accumulator preshift; | |
| | if the operand Slit4 is absent, a 0 is encoded. | |
| | See Table 1-7 for modifier addressing information. | |
| | Note: | Positive values of operand Slit4 represent |
| | | arithmetic shift right. |
| | | Negative values of operand Slit4 represent shift left. |

| Words: | 1 | | | |
|---|---|---|---|---|
| Cycles: | 1 | | | |
| Example: | | LAC | A,W5 | ; Load |
| | | | | Accumulator A |

Before Instruction
After Instruction

TABLE 87
LNK: Allocate Stack Frame

| Syntax: | {label:} | LNK | lit14 | | | |
|---|---|---|---|---|---|---|
| Operands: | lit14 Î [0 . . . 16384] | | | | | |
| Operation: | (W14) → [W15]−−; | | | | | |
| | (W15) → W14; | | | | | |
| | (W15) − lit14 → W15 | | | | | |
| Status Affected: | None | | | | | |
| Encoding: | 1111 | 1010 | 00kk | kkkk | kkkk | kkkk |

| | |
|---|---|
| Description: | This instruction allocates a stack frame |
| | of size lit14 and adjusts the stack pointer and |
| | frame pointer. |
| | The ‘k’ bits specify the size of the stack frame. |
| Words: | 1 |
| Cycles: | 1 |

TABLE 88
LSR: Logical Shift Right Ws

| | | | | |
|---|---|---|---|---|
| Syntax: | {label:} | LSR{.b} | Ws, | Wd |
| | | | [Ws], | [Wd] |
| | | | [Ws]++, | [Wd]++ |
| | | | [Ws]−−, | [Wd]−− |
| | | | [Ws++], | [Wd++] |
| | | | [Ws−−], | [Wd−−] |

| | |
|---|---|
| Operands: | Ws ∈ [W0 . . . W15]; Wd ∈ [W0 . . . W15] |
| Operation: | For word operation: |

0 → Wd<15>, (Ws<15:1>) → Wd<14:0>, (Ws<0>) → C

For byte operation:

0 → Wd<7>, (Ws<7:1>) → Wd<6:0>, (Ws<0>) → C

| | 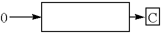 | | | | | |
|---|---|---|---|---|---|---|
| Status Affected: | C, N, OV, Z | | | | | |
| Encoding: | 1101 | 0001 | 0Bqq | qddd | dppp | ssss |

| Description: | Shift the contents of the source register Ws one bit to the right and place the | |
|---|---|---|
| | result in the destination register Wd. The Carry Flag bit is set if the LSB of | |
| | Ws is ‘1’. | |
| | The ‘B’ bit selects byte or word operation. | |
| | The ‘s’ bits select the address of the source register. | |
| | The ‘d’ bits select the address of the destination register. | |
| | The ‘p’ bits select source address mode 2. | |
| | The ‘q’ bits select destination address mode 2. | |
| | See Table 1-5 and Table 1-6 for modifier addressing information. | |
| | Note: | The extension .b in the instruction denotes a byte operation rather |
| | | than a word operation. You may use a .w extension to denote a |
| | | word operation, but it is not required. |

| | |
|---|---|
| Words: | 1 |
| Cycles: | 1 |

| | | | |
|---|---|---|---|
| Example: | LSR | W5,W6 | ; Shift right |

Before Instruction
After Instruction

TABLE 89
LSRF: Logical Shift Right f

| | | | | |
|---|---|---|---|---|
| Syntax: | {label:} | LSR{.b} | f | {,Ww} |

| | |
|---|---|
| Operands: | f ∈ [0 . . . 8191] |
| Operation: | For word operation: |

0 → Dest<15>, (f<15:1>) → Dest<14:0>, (f<0>) → C

For byte operation:

0 → Dest<7>, (f <7:1>) → Dest<6:0>, (f<0>) → C

| | 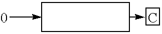 | | | | | |
|---|---|---|---|---|---|---|
| Status Affected: | C, N, OV, Z | | | | | |
| Encoding: | 1101 | 0101 | 0BDf | ffff | ffff | ffff |

| Description: | Shift the contents of the file register f one bit to the right and place the result | |
|---|---|---|
| | in the destination designated by D: If the optional Ww is specified, D = 0 and | |
| | store result in Ww; otherwise, D = 1 and store result in the file register. | |
| | The carry flag bit is set if the | |
| | LSB of the file register is ‘1’. | |
| | The ‘B’ bit selects byte or word operation. | |
| | The ‘D’ bit selects the destination. | |
| | The ‘s’ bits select the address of the working register. | |
| | The ‘f’ bits select the address of the file register. | |
| | Note: | The extension .b in the instruction denotes a byte operation rather than a |

word operation. You may use a .w extension to denote a
word operation, but it is not required.

| | |
|---|---|
| Words: | 1 |
| Cycles: | 1 |

| | | | |
|---|---|---|---|
| Example: | LSR | RAM135, Ww | ; Shift right |

Before Instruction
After Instruction

TABLE 90
MAC: Multiply and Accumulate

| Syntax: | {label:}MAC | A, | Wm*Wn | ,Wxp,[Wx] | ,Wyp,[Wy] | ,AWB |
|---|---|---|---|---|---|---|
| | | B, | | ,Wxp,[Wx]+=kx | ,Wyp,[Wy]+=ky | none |
| | | | | ,Wxp,[Wx]−=kx ‡ | ,Wyp,[Wy]−=ky ‡ | |
| | | | | ,Wxp,[W5+W8] | ,Wyp,[W7+W8] | |
| | | | | none | none | |
| | | | | ‡ Alternate format for negative kx,ky | | |
| Operands: | Wm*Wn ∈ {W0*W1; W0*W2; W0*W3; W1*W2; W1*W3; W2*W3} | | | | | |
| | Wxp ∈ {W0 . . . W3}; Wx ∈ {W4, W5}; kx ∈ {−6, −4, −2, 2, 4, 6}; | | | | | |
| | Wyp ∈ {W0 . . . W3}; Wy ∈ {W6, W7}; ky ∈ {−6, −4, −2, 2, 4, 6}; | | | | | |
| | AWB ∈ {W9, [W9]++} | | | | | |
| Operation: | (ACC(A or B)) + (Wm)*(Wn) → ACC(A or B); | | | | | |
| | ([Wx]) → Wxp; (Wx)+kx→Wx; | | | | | |
| | ([Wy]) → Wyp; (Wy)+ky→Wy; | | | | | |
| | (ACC(B or A)) rounded → AWB | | | | | |
| Status | OA, OB, SA, SB | | | | | |
| Affected: | | | | | | |
| Encoding: | 1100 | 0mmm | A0xx | yyii | iijj | jjaa |

| Description: | Signed, fractional or integer multiply the contents of two W registers. The 32-bit | | |
|---|---|---|---|
| | result is sign-extended to 40-bits and added to the specified accumulator. | | |
| | Wx register specifies the prefetch of the multiplier Wxp register. The prefetch is | | |
| | done with indirect, indirect with post inc/dec, indirect with register offset, copy of | | |
| | the other prefetch or none. Post-modify Wx as required. | | |
| | Wy register specifies the prefetch of the multiplier Wyp register. Post-modify Wy | | |
| | as required. | | |
| | AWB specifies the direct or indirect store of the convergently rounded contents | | |
| | of other accumulator, if required. | | |
| | The ‘m’ bits select the operand registers Wm and Wn for the multiply: | | |
| | The ‘A’ bit selects the accumulator for the result. The other accumulator is used | | |
| | for write back. | | |
| | The ‘i’ bits select the Wx pre-fetch operation. | | |
| | The ‘j’ bits select the Wy pre-fetch operation. | | |
| | The ‘x’ bits select the pre-fetch Wxp destination. | | |
| | The ‘y’ bits select the pre-fetch Wyp destination. | | |
| | The ‘a’ bits select the accumulator write-back destination. | | |
| | See Table 1-9 through Table 1-14 for modifier addressing information. | | |
| Words: | 1 | | |
| Cycles: | 1 | | |
| Example: | MAC | A,W2*W3,W0=[W4]− | ; Multiply and Accumulate A |
| | | =6,W1=[W6],[W9]++ | |

```
Before Instruction
      ACCA = 2
      ACCB = 3
      W0 = 5
      W1 = 6
      W2 = 7
      W3 = 8
      W8 = 1000
      W10 = 2000
      RAM(994) = 16
      RAM(1000) = 17
      RAM(2000) = 18
After Instruction
      ACCA = 2+7*8=58
      ACCB = 3
      W0 = 17
      W1 = 18
      W2 = 7
      W3 = 8
      W8 = 994
      W10 = 2000
      RAM(994) = 3
      RAM(1000) = 17
      RAM(2000) = 18
```

TABLE 91
MOV: Move Ws to Wd

| Syntax: | {label:} | MOV{.b} | Ws, | Wd | | |
|---|---|---|---|---|---|---|
| | | | [Ws], | [Wd] | | |
| | | | [Ws]++ | [Wd]++ | | |
| | | | [Ws]−− | [Wd]−− | | |
| | | | [Ws−−], | [Wd−−] | | |
| | | | [Ws+Wb], | [Wd+Wb] | | |
| | | | [Ws+lit5], | [Wd+lit5] | | |
| Operands: | Ws ∈ [W0 . . . W15]; Wd ∈ [W0 . . . W15]; | | | | | |
| | Wb ∈ [W0 . . . W15]; lit5 ∈. . . 31] | | | | | |
| Operation: | (EAs) → EAd | | | | | |
| Status | None | | | | | |
| Affected: | | | | | | |
| Encoding: | 0111 | 1www | wBhh | hddd | dggg | ssss |

| Description: | Move the contents of the source register into the | |
|---|---|---|
| | destination register. | |
| | The ‘B’ bit selects byte or word operation. | |
| | The ‘s’ bits select the address of the source register. | |
| | The ‘d’ bits select the address of the destination register. | |
| | The ‘g’ bits select source address mode 3. | |
| | The ‘h’ bits select destination address mode 3. | |
| | The ‘w’ bits define the addressing mode literal ‘lit5’ | |
| | or offset Wb; these bits are shared by source and | |
| | destination addresses. | |
| | See Table 1-7 and Table 1-8 for modifier addressing | |
| | information. | |
| | The assembly nmemonics PUSH Ws and POP Wd translate | |
| | to MOV. | |
| | Note: | The extension .b in the instruction denotes a byte |
| | | move rather than a word move. You may use |
| | | a .w extension to denote a word move, |
| | | but it is not required. |

| Words: | 1 | | | |
|---|---|---|---|---|
| Cycles: | 1 | | | |
| Example: | | MOV | W5,W6 | ; Move W5 |
| | | | | to W6 |

Before Instruction
After Instruction

TABLE 92
MOVF: Move f to destination

| Syntax: | {label:} | MOV{.b} | f | {,Ww} | | |
|---|---|---|---|---|---|---|
| Operands: | f ∈ [0 . . . 8191]; | | | | | |
| Operation: | (f) → destination designated by D | | | | | |
| Status Affected: | Z, N | | | | | |
| Encoding: | 1011 | 1111 | 1BDf | ffff | ffff | ffff |

| Description: | Move the contents of the file register to the destination | | | |
|---|---|---|---|---|
| | designated by D: if D = 0, put the value into Ww, | | | |
| | if D = 1 the only effect is to modify the status | | | |
| | flags, no writeback is required. | | | |
| | The ‘B’ bit selects byte or word operation. | | | |
| | The ‘D’ bit selects the destination, (0 for Wd, 1 for f). | | | |
| | The ‘f’ bits select the address of the file register. | | | |
| | Note: | The extension .b in the instruction denotes | | |
| | | a byte operation rather than a word operation. | | |
| | | You may use a .w extension to denote a word | | |
| | | operation, but it is not required. | | |
| Words: | 1 | | | |
| Cycles: | 1 | | | |
| Example: | | MOV | RAM433, | ; Move File register |
| | | | Ww | 433 to Ww |

Before Instruction
After Instruction

TABLE 93
MOVL: Move 16-bit literal to Wd

| Syntax: | {label:} | MOV | lit16, | Wn | | |
|---|---|---|---|---|---|---|
| Operands: | lit16 ∈ [−32768 . . . 65535]; Wn ∈ [W0 . . . W15] | | | | | |
| Operation: | lit16 → Wn | | | | | |
| Status Affected: | None | | | | | |
| Encoding: | 0010 | dddd | kkkk | kkkk | kkkk | kkkk |

| Description: | The Literal ‘k’ is loaded into Wn register. | | | |
|---|---|---|---|---|
| | The ‘d’ bits select the address of the working register. | | | |
| | The ‘k’ bits specify the value of the literal. | | | |
| Words: | 1 | | | |
| Cycles: | 1 | | | |
| Example: | | MOV | #64159, | ; Move 64159 into W5 |
| | | | W5 | |

Before Instruction
After Instruction

TABLE 94
MOVSAC: Prefetch Operands and Store Accumulator

| Syntax: | {label:} | MOVSAC | A, | ,Wxp,[Wx] | ,Wyp,[Wy] | ,AWB |
|---|---|---|---|---|---|---|
| | | | B, | ,Wxp,[Wx]+=kx | ,Wyp,[Wy]+=ky | none |
| | | | | ,Wxp,[Wx]−=kx‡ | ,Wyp,[Wy]−=ky^{‡} | |
| | | | | ,Wxp,[W5+W8] | ,Wyp,[W7+W8] | |
| | | | | none | none | |
| | | | | ‡Alternate format for negative kx, ky | | |
| Operands: | Wxp ∈ {W0 . . . W3}; Wx ∈ {W4, W5}; kx ∈ {−6, −4, −2, 2, 4, 6}; | | | | | |
| | Wyp ∈ {W0 . . . W3}; Wy ∈ {W6, W7}; ky ∈ {−6, −4, −2, 2, 4, 6}; | | | | | |
| | AWB ∈ {W9, [W9]++} | | | | | |
| Operation: | ([Wx]) → Wxp; (Wx)+kx→Wx; | | | | | |
| | ([Wy]) → Wyp; (Wy)+ky→Wy; | | | | | |
| | (ACC(B or A)) rounded → AWB | | | | | |
| Status | OA, OB, SA, SB | | | | | |
| Affected: | | | | | | |
| Encoding: | 1100 | 0111 | A0xx | yyii | Iijj | jjaa |

| Description: | Prefetch operands and optionally store accumulator results in | | |
|---|---|---|---|
| | preparation for a repeated MAC type instruction. | | |
| | Wx register specifies the prefetch of the multiplier Wxp register. | | |
| | The prefetch is done with indirect, indirect with post inc/dec, | | |
| | indirect with register offset, copy of the other prefetch or none. | | |
| | Post-modify Wx as required. | | |
| | Wy register specifies the prefetch of the multiplier Wyp register. | | |
| | Post-modify Wy as required. | | |
| | AWB specifies the direct or indirect store of the convergently rounded | | |
| | contents of other accumulator, if required. Note that the specification | | |
| | of (B or A) is consistant with the MAC instruction. For example, | | |
| | MOVSAC A, W9 will store ACCB into W9. | | |
| | The ‘A’ bit selects the other accumulator used for write back. | | |
| | The ‘i’ bits select the Wx pre-fetch operation. | | |
| | The ‘j’ bits select the Wy pre-fetch operation. | | |
| | The ‘x’ bits select the pre-fetch Wxp destination. | | |
| | The ‘y’ bits select the pre-fetch Wyp destination. | | |
| | The ‘a’ bits select the accumulator write-back destination. | | |
| | See Table 1-9 through Table 1-14 for modifier addressing information. | | |
| Words: | 1 | | |
| Cycles: | 1 | | |
| Example: | MOVSAC | A,W0,[W4]−=6,W1,[W6],W9 | ; Prefetch and move ACCB to W9 |

```
Before Instruction
      ACCA = 2
      ACCB = 3
      W0 = 5
      W1 = 6
      W2 = 7
      W3 = 8
      W8 = 1000
      W10 = 2000
      RAM(994) = 16
      RAM(1000) = 17
      RAM(2000) = 18
After Instruction
```

TABLE 95
MOVWF: Move Ww to F

| Syntax: | {label:} | MOV{.b} | Ww, | f | | |
|---|---|---|---|---|---|---|
| Operands: | f ∈ [0 . . . 8191] | | | | | |
| Operation: | (Ww) →f | | | | | |
| Status Affected: | None | | | | | |
| Encoding: | 1011 | 0111 | 1B1f | ffff | ffff | ffff |

| Description: | Move the contents of the working register into | |
|---|---|---|
| | the file register. | |
| | The ‘B’ bit selects byte or word operation. | |
| | The ‘f’ bits select the address of the file register. | |
| | Note: | The extension .b in the instruction denotes |
| | | a byte move rather than a word move. You may |
| | | use a .w extension to denote a word move, but |
| | | it is not required. |

| Words: | 1 | | | |
|---|---|---|---|---|
| Cycles: | 1 | | | |
| Example: | | MOV | Ww,213 | ; Move Ww to File |
| | | | | Register 213 |

Before Instruction
After Instruction

TABLE 96
MPY: Multiply Wm by Wn to Accumulator

| Syntax: | {label:}MPY | A, | Wm*Wn | ,Wxp,[Wx] | ,Wyp,[Wy] | |
|---|---|---|---|---|---|---|
| | | B, | | ,Wxp,[Wx]+=kx | ,Wyp,[Wy]+=ky | |
| | | | | ,Wxp,[Wx]−=kx‡ | ,Wyp,[Wy]−=ky^{‡} | |
| | | | | ,Wxp,[W5+W8] | ,Wyp,[W7+W8] | |
| | | | | none | none | |
| | | | | ‡ Alternate format for negative | | |
| | | | | kx, ky | | |
| Operands: | Wm*Wn ∈ {W0*W1; W0*W2; W0*W3; W1*W2; W1*W3; W2*W3} | | | | | |
| | Wxp ∈ {W0 . . . W3}; Wx ∈ {W4, W5}; kx ∈ {−6, −4, −2, 2, 4, 6}; | | | | | |
| | Wyp ∈ {W0 . . . W3}; Wy ∈ {W6, W7}; ky ∈ {−6, −4, −2, 2, 4, 6}; | | | | | |
| | AWB ∈ {W9, [W9]++} | | | | | |
| Operation: | (Wm)*(Wn) → ACC(A or B); | | | | | |
| | ([Wx])→ Wxp; (Wx)+kx→Wx; | | | | | |
| | ([Wy])→ Wyp; (Wy)+ky→Wy; | | | | | |
| Status | OA, OB, SA, SB | | | | | |
| Affected: | | | | | | |
| Encoding: | 1100 | 0mmm | A0xx | yyii | iijj | jj11 |

| Description: | Signed, fractional or integer multiply the contents of two W registers. The 32-bit | | |
|---|---|---|---|
| | result is sign-extended to 40-bits and stored to the specified accumulator. | | |
| | Wx register specifies the prefetch of the multiplier Wxp register. The prefetch is | | |
| | done with indirect, indirect with post inc/dec, indirect with register offset, copy of | | |
| | the other prefetch or none. Post-modify Wx as required. | | |
| | Wy register specifies the prefetch of the multiplier Wyp register. Post-modify Wy | | |
| | as required. | | |
| | The ‘m’ bits select the operand registers Wm and Wn for the multiply: | | |
| | The ‘A’ bit selects the accumulator for the result. | | |
| | The ‘i’ bits select the Wx pre-fetch operation. | | |
| | The ‘j’ bits select the Wy pre-fetch operation. | | |
| | The ‘x’ bits select the pre-fetch Wxp destination. | | |
| | The ‘y’ bits select the pre-fetch Wyp destination. | | |
| | See Table 1-9 through Table 1-13 for modifier addressing information. | | |
| Words: | 1 | | |
| Cycles: | 1 | | |
| Example: | MPY | A,W2*W3,W0,[W5]−=6,W1,[W7] | ; Multiply into |
| | | | Accumulator A |

```
Before Instruction
      ACCA = 2
      ACCB = 3
      W0 = 5
      W1 = 6
      W2 = 7
      W3 = 8
      W8 = 1000
      W10 = 2000
      RAM(994) = 16
      RAM(1000) = 17
      RAM(2000) = 18
After Instruction
      ACCA = 7*8=56
      ACCB = 3
      W0 = 17
      W1 = 18
      W2 = 7
      W3 = 8
      W8 = 994
      W10 = 2000
      RAM(994) = 16
      RAM(1000) = 17
      RAM(2000) = 18
```

TABLE 97
MPYN: Multiply −Wm by Wn to Accumulator

| Syntax: | {label:}MPYN | A, | Wm*Wn | ,Wxp,[Wx] | ,Wyp,[Wy] | |
|---|---|---|---|---|---|---|
| | | B, | | ,Wxp,[Wx]+=kx | ,Wyp,[Wy]+=ky | |
| | | | | ,Wxp,[Wx]−=kx‡ | ,Wyp,[Wy]−=ky^{‡} | |
| | | | | ,Wxp,[W5+W8] | ,Wyp,[W7+W8] | |
| | | | | none | none | |
| | | | | ‡ Alternate format for negative kx,ky | | |
| Operands: | Wm*Wn ∈ {W0*W1; W0*W2; W0*W3; W1*W2; W1*W3; W2*W3} | | | | | |
| | Wxp ∈ {W0 . . . W3}; Wx ∈ {W4, W5}; kx ∈ {−6, −4, −2, 2, 4, 6}; | | | | | |
| | Wyp ∈ {W0 . . . W3}; Wy ∈ {W6, W7}; ky ∈ {−6, −4, −2, 2, 4, 6}; | | | | | |
| | AWB ∈ {W9, [W9]++} | | | | | |
| Operation: | −(Wm)*(Wn) → ACC(A or B); | | | | | |
| | ([Wx])→ Wxp; (Wx)+kx→Wx; | | | | | |
| | ([Wy])→ Wyp; (Wy)+ky→Wy; | | | | | |
| Status | OA, OB, SA, SB | | | | | |
| Affected: | | | | | | |
| Encoding: | 1100 | 0mmm | A1xx | yyii | iijj | jj11 |

| Description: | Signed, fractional or integer multiply the contents of a W register by the negative of | | |
|---|---|---|---|
| | the contents of another W register. The 32-bit result is sign-extended to 40-bits and | | |
| | stored to the specified accumulator. | | |
| | Wx register specifies the prefetch of the multiplier Wxp register. The prefetch is | | |
| | done with indirect, indirect with post inc/dec, indirect with register offset, | | |
| | copy of the other prefetch or none. Post-modify Wx as required. | | |
| | Wy register specifies the prefetch of the multiplier Wyp register. Post-modify Wy as | | |
| | required. | | |
| | The ‘m’ bits select the operand registers Wm and Wn for the multiply: | | |
| | The ‘A’ bit selects the accumulator for the result. | | |
| | The ‘i’ bits select the Wx pre-fetch operation. | | |
| | The ‘j’ bits select the Wy pre-fetch operation. | | |
| | The ‘x’ bits select the pre-fetch Wxp destination. | | |
| | The ‘y’ bits select the pre-fetch Wyp destination. | | |
| | See Table 1-9 through Table 1-13 for modifier addressing information. | | |
| Words: | 1 | | |
| Cycles: | 1 | | |
| Example: | MPYN | A,W2*W3,W0,[W4]−=6,W1,[W6] | ; Multiply negative |
| | | | into Acc A |

```
Before Instruction
      ACCA = 2
      ACCB = 3
      W0 = 5
      W1 = 6
      W2 = 7
      W3 = 8
      W8 = 1000
      W10 = 2000
      RAM(994) = 16
      RAM(1000) = 17
      RAM(2000) = 18
After Instruction
      ACCA = −7*8=−56
      ACCB = 3
      W0 = 17
      W1 = 18
      W2 = 7
      W3 = 8
      W8 = 994
      W10 = 2000
      RAM(994) = 16
      RAM(1000) = 17
      RAM(2000) = 18
```

TABLE 98
MSC: Multiply and Subtract from Accumulator

| Syntax: | {label:}MSC | A, | Wm*Wn | ,Wxp,[Wx] | ,Wyp,[Wy] | ,AWB |
|---|---|---|---|---|---|---|
| | | B, | | ,Wxp,[Wx]+=kx | ,Wyp,[Wy]+=ky | none |
| | | | | ,Wxp,[Wx]−=kx‡ | ,Wyp,[Wy]−=ky^{‡} | |
| | | | | ,Wxp,[W5+W8] | ,Wyp,[W7+W8] | |
| | | | | none | none | |
| | | | | ‡ Alternate format for negative kx,ky | | |
| Operands: | Wm*Wn ∈ {W0*W1; W0*W2; W0*W3; W1*W2; W1*W3; W2*W3} | | | | | |
| | Wxp ∈ {W0 . . . W3}; Wx ∈ {W4, W5}; kx ∈ {−6, −4, −2, 2, 4, 6}; | | | | | |
| | Wyp ∈ {W0 . . . W3}; Wy ∈ {W6, W7}; ky ∈ {−6, −4, −2, 2, 4, 6}; | | | | | |
| | AWB ∈ {W9, [W9]++} | | | | | |
| Operation: | (ACC(A or B)) − (Wm)*(Wn) → ACC(A or B); | | | | | |
| | ([Wx])→ Wxp; (Wx)+kx→Wx; | | | | | |
| | ([Wy])→ Wyp; (Wy)+ky→Wy; | | | | | |
| | (ACC(B or A)) rounded → AWB | | | | | |
| Status | OA, OB, SA, SB | | | | | |
| Affected: | | | | | | |
| Encoding: | 1100 | 0mmm | A1xx | yyii | iijj | jjaa |

| Description: | Signed, fractional or integer multiply the contents of two W registers. The 32-bit | | |
|---|---|---|---|
| | result is sign-extended to 40-bits andsubtracted from the specified accumulator. | | |
| | Wx register specifies the prefetch of the multiplier Wxp register. The prefetch is | | |
| | done with indirect, indirect with post inc/dec, indirect with register offset, copy of | | |
| | the other prefetch or none. Post-modify Wx as required. | | |
| | Wy register specifies the prefetch of the multiplier Wyp register. Post-modify Wy | | |
| | as required. | | |
| | AWB specifies the direct or indirect store of the convergently rounded contents of | | |
| | other accumulator, if required. | | |
| | The ‘m’ bits select the operand registers Wm and Wn for the multiply: | | |
| | The ‘A’ bit selects the accumulator for the result. The other accumulator is used | | |
| | for write back. | | |
| | The ‘i’ bits select the Wx pre-fetch operation. | | |
| | The ‘j’ bits select the Wy pre-fetch operation. | | |
| | The ‘x’ bits select the pre-fetch Wxp destination. | | |
| | The ‘y’ bits select the pre-fetch Wyp destination. | | |
| | The ‘a’ bits select the accumulator write-back destination. | | |
| | See Table 1-9 through Table 1-14 for modifier addressing information. | | |
| Words: | 1 | | |
| Cycles: | 1 | | |
| Example: | MSC | A,W2*W3,W0=[W4]−=6,W1=[W6], | ; Multiply and Subtract A |
| | | W9 | |

```
Before Instruction
      ACCA = 2
      ACCB = 3
      W0 = 5
      W1 = 6
      W2 = 7
      W3 = 8
      W8 = 1000
      W10 = 2000
      RAM(994) = 16
      RAM(1000) = 17
      RAM(2000) = 18
After Instruction
      ACCA = 2+7*8=58
      ACCB = 3
      W0 = 17
      W1 = 18
      W2 = 7
      W3 = 8
      W8 = 994
      W10 = 2000
      RAM(994) = 3
      RAM(1000) = 17
      RAM(2000) = 18
```

TABLE 99
MULS: 16×16 bit Signed Multiply

| Syntax: | {label:} | MUL.SS | Wb, | Ws, | Wnd | |
|---|---|---|---|---|---|---|
| | | | | [Ws], | | |
| | | | | [Ws]++, | | |
| | | | | [Ws]−−, | | |
| | | | | [Ws++], | | |
| | | | | [Ws−−], | | |
| Operands: | Wb ∈ [W0 . . . W15]; | | | | | |
| | Ws ∈ [W0 . . . W15]; | | | | | |
| | Wnd ∈ [W0,W2,W4,W6,W8,W10,W12,W14] | | | | | |
| Operation: | signed (Wb) * signed (Ws) → {Wnd+1, Wnd} | | | | | |
| Status Affected: | None | | | | | |
| Encoding: | 1011 | 1001 | 1www | wddd | dppp | ssss |

| Description: | ULS performs a 16-bit × 16-bit multiply, with | | | |
|---|---|---|---|---|
| | the result stored in two successive working registers. | | | |
| | Both source operands are interpreted as two's- | | | |
| | complement signed integers. | | | |
| | The ‘w’ bits select the address of the base register | | | |
| | The ‘s’ bits select the address of the source register. | | | |
| | The ‘p’ bits select source address mode 2. | | | |
| | The ‘d’ bits select the address of the destination | | | |
| | for the product LSBs, the register ‘d+1’ is the | | | |
| | destination of the product MSBs. | | | |
| | See Table 1-5 for modifier addressing information. | | | |
| | Note: | This instruction operates in word mode only. | | |
| Words: | 1 | | | |
| Cycles: | 1 | | | |
| Example: | | MUL.SS | W5, W6, | ; Multiply |
| | | | W8 | W5*W6 to |
| | | | | W9:W8 |

Before Instruction
After Instruction

TABLE 100
MULSU: 16×16 bit Signed-Unsigned Multiply

| Syntax: | {label:} | MUL.SU | Wb, | Ws, | Wnd | |
|---|---|---|---|---|---|---|
| | | | | [Ws], | | |
| | | | | [Ws]++, | | |
| | | | | [Ws]−−, | | |
| | | | | [Ws++], | | |
| | | | | [Ws−−], | | |
| Operands: | Wb ∈ [W0 . . . W15]; | | | | | |
| | Ws ∈ [W0 . . . W15]; | | | | | |
| | Wnd ∈ [W0,W2,W4,W6,W8,W10,W12,W14] | | | | | |
| Operation: | signed (Wb) * unsigned (Ws) → {Wnd+1, Wnd} | | | | | |
| Status Affected: | None | | | | | |
| Encoding: | 1011 | 1001 | 0www | wddd | dppp | ssss |

| Description: | MULSU performs a 16-bit × 16-bit multiply, with | | | |
|---|---|---|---|---|
| | the result stored in two successive working registers. | | | |
| | The first source operands is interpreted as a two's- | | | |
| | complement signed integer and the second source | | | |
| | operand is interpreted as an unsigned integer. | | | |
| | The ‘w’ bits select the address of the base register | | | |
| | The ‘s’ bits select the address of the source register. | | | |
| | The ‘p’ bits select source address mode 2. | | | |
| | The ‘d’ bits select the address of the | | | |
| | destination for the product LSBs, the register ‘d+1’ | | | |
| | is the destination of the product MSBs. | | | |
| | See Table 1-5 for modifier addressing information. | | | |
| | Note: | This instruction operates in word mode only. | | |
| Words: | 1 | | | |
| Cycles: | 1 | | | |
| Example: | | MUL.SU | W5, W6, | ; Multiply W5*W6 |
| | | | W8 | to W9:W8 |

Before Instruction
After Instruction

TABLE 101
MULSULS: 16×16 bit Signed Multiply Unsigned Short Literal

| Syntax: | {label:} | MUL.SU | Wb, | lit5, | Wnd | |
|---|---|---|---|---|---|---|
| Operands: | Wb ∈ [W0 . . . W15]; | | | | | |
| | lit5 ∈ [0 . . . 31]; | | | | | |
| | Wnd ∈ [W0,W2,W4,W6,W8,W10,W12,W14] | | | | | |
| Operation: | signed (Wb) * unsigned lit5 → {Wnd+1, Wnd} | | | | | |
| Status Affected: | None | | | | | |
| Encoding: | 1011 | 1001 | 1www | wddd | d11k | kkkk |

| Description: | MULSLS performs a 16-bit × 16-bit multiply, with | |
|---|---|---|
| | the result stored in two successive working registers. | |
| | The source operands is interpreted as a two's- | |
| | complement signed integer and the literal is | |
| | interpreted as an unsigned integer. | |
| | The ‘k’ bits define a 5-bit unsigned integer literal. | |
| | The ‘w’ bits select the address of the base register. | |
| | The ‘d’ bits select the address of the destination | |
| | for the product LSBs, the register ‘d+1’ is the | |
| | destination of the product MSBs. | |
| | Note: | This instruction operates in word mode only. |

| Words: | 1 | | | |
|---|---|---|---|---|
| Cycles: | 1 | | | |
| Example: | | MUL.SU | W6, #13, | ; Multiply W6 times 13 |
| | | | W8 | into W9:W8 |

Before Instruction
After Instruction

TABLE 102
MULU: 16×16 bit Unsigned Multiply

| Syntax: | {label:} | MUL.UU | Wb, | Ws, | Wnd | |
|---|---|---|---|---|---|---|
| | | | | [Ws], | | |
| | | | | [Ws]++, | | |
| | | | | [Ws]−−, | | |
| | | | | [Ws++], | | |
| | | | | [Ws−−], | | |
| Operands: | Wb ∈ [W0 . . . W15]; | | | | | |
| | Ws ∈ [W0 . . . W15]; | | | | | |
| | Wnd ∈ [W0,W2,W4,W6,W8,W10,W12,W14] | | | | | |
| Operation: | unsigned (Wb) * unsigned (Ws) → {Wnd+1, Wnd} | | | | | |
| Status Affected: | None | | | | | |
| Encoding: | 1011 | 1000 | 0www | wddd | dppp | ssss |

| Description: | MULU performs a 16-bit × 16-bit multiply, with | | | |
|---|---|---|---|---|
| | the result stored in two successive working registers. | | | |
| | Both source operands are interpreted as unsigned | | | |
| | integers. | | | |
| | The ‘w’ bits select, the address of the base register. | | | |
| | The ‘s’ bits select the address of the source register. | | | |
| | The ‘p’ bits select source address mode 2. | | | |
| | The ‘d’ bits select the address of the | | | |
| | destination for the product LSBs, the register ‘d+1’ | | | |
| | is the destination of the product MSBs. | | | |
| | See Table 1-5 for modifier addressing information. | | | |
| | Note: | This instruction operates in word mode only. | | |
| Words: | 1 | | | |
| Cycles: | 1 | | | |
| Example: | | MUL.UU | W5, W6, | ; Multiply W5*W6 |
| | | | W8 | to W9:W8 |

Before Instruction
After Instruction

TABLE 103
MULULS: 16×16 bit Unsigned Multiply Short Literal

| Syntax: | {label:} | MULULS | Wb, | lit5, | Wnd | |
|---|---|---|---|---|---|---|
| Operands: | Wb ∈ [W0 . . . W15]; | | | | | |
| | lit5 ∈ [0 . . . 31]; | | | | | |
| | Wnd ∈ [W0,W2,W4,W6,W8,W10,W12,W14] | | | | | |
| Operation: | unsigned (Wb) * unsigned lit5 → {Wnd+1, Wnd} | | | | | |
| Status Affected: | None | | | | | |
| Encoding: | 1011 | 1000 | 0www | wddd | d11k | kkkk |

| Description: | MULULS performs a 16-bit × 16-bit multiply, with | |
|---|---|---|
| | the result stored in two successive working registers. | |
| | Both operands are interpreted as unsigned integers. | |
| | The ‘k’ bits define a 5-bit unsigned integer literal.. | |
| | The ‘w’ bits select the address of the base register. | |
| | The ‘d’ bits select the address of the destination | |
| | for the product LSBs, the register ‘d+1’ is | |
| | the destination of the product MSBs. | |
| | Note: | This instruction operates in word mode only. |

| Words: | 1 | | | |
|---|---|---|---|---|
| Cycles: | 1 | | | |
| Example: | | MUL.UU | W6, #13, | ; Multiply W6 times 13 |
| | | | W8 | into W9:W8 |

Before Instruction
After Instruction

TABLE 104
MULUS: 16×16 bit Unsigned-Signed Multiply

| Syntax: | {label:} | MUL.US | Wb, | Ws, | Wnd | |
|---|---|---|---|---|---|---|
| | | | | [Ws], | | |
| | | | | [Ws]++, | | |
| | | | | [Ws]−−, | | |
| | | | | [Ws++], | | |
| | | | | [Ws−−], | | |
| Operands: | Wb ∈ [W0 . . . W15]; | | | | | |
| | Ws ∈ [W0 . . . W15]; | | | | | |
| | Wnd ∈ [W0,W2,W4,W6,W8,W10,W12,W14] | | | | | |
| Operation: | unsigned (Wb) * signed (Ws) → {Wnd+1, Wnd} | | | | | |
| Status Affected: | None | | | | | |
| Encoding: | 1011 | 1000 | 1www | wddd | dppp | ssss |

| Description: | MULUS performs a 16-bit × 16-bit multiply, with | |
|---|---|---|
| | the result stored in two successive working registers. | |
| | The first source operands is interpreted as an | |
| | unsigned integer and the second source operand is | |
| | interpreted as a two's-complement signed integer. | |
| | The ‘w’ bits select the address of the base register. | |
| | The ‘s’ bits select the address of the source register. | |
| | The ‘p’ bits select source address mode 2. | |
| | The ‘d’ bits select the address of the destination | |
| | for the product LSBs, the register ‘d+1’ is the | |
| | destination of the product MSBs. | |
| | See Table 1-5 for modifier addressing information. | |
| | Note: | This instruction operates in word mode only. |

| Words: | 1 | | | |
|---|---|---|---|---|
| Cycles: | 1 | | | |
| Example: | | MUL.US | W5, W6, | ; Multiply W5*W6 |
| | | | W8 | to W9:W8 |

Before Instruction
After Instruction

TABLE 105
MULWF: 8-bit × 8-bit Multiply

| Syntax: | {label:} | MUL{.b} | f | | | |
|---|---|---|---|---|---|---|
| Operands: | f ∈ [0 . . . 8191] | | | | | |
| Operation: | If byte mode, (Ww)<7:0> * (f)<7:0> → W2 | | | | | |
| | If word mode, (Ww) * (f) → W3:W2 | | | | | |
| Status Affected: | None | | | | | |
| Encoding: | 1011 | 1100 | 0B0f | ffff | ffff | ffff |

| Description: | Multiply the working register and the file register | |
|---|---|---|
| | and place the result in the W3:W2 register pair. | |
| | The ‘B’ bit selects byte or word operation. | |
| | The ‘f’ bits select the address of the file register. | |
| | Note: | Word operation is assumed. |

| Words: | 1 | | | |
|---|---|---|---|---|
| Cycles: | 1 | | | |
| Example: | | MUL | RAM135 | ; Multiply Ww |
| | | | | by RAM135 |

Before Instruction
After Instruction

TABLE 106
NEG: Negate Ws

| Syntax: | {label:} | NEG{.b} | Ws, | Wd | | |
|---|---|---|---|---|---|---|
| | | | [Ws], | [Wd] | | |
| | | | [Ws]++, | [Wd]++ | | |
| | | | [Ws]−−, | [Wd]−− | | |
| | | | [Ws++], | [Wd++] | | |
| | | | [Ws−−], | [Wd−−] | | |
| Operands: | Ws ∈ [W0 . . . W15]; Wd ∈ [W0 . . . W15] | | | | | |
| Operation: | \overline{(Ws)}+ 1 → Wd | | | | | |
| Status Affected: | C, DC, N, OV, Z | | | | | |
| Encoding: | 1110 | 1010 | 0Bqq | qddd | dppp | ssss |

| Description: | Compute the 2's complement of the | |
|---|---|---|
| | contents of the source register Ws and place | |
| | the result in the destination register Wd. | |
| | The ‘B’ bit selects byte or word operation. | |
| | The ‘s’ bits select the address of the source register. | |
| | The ‘d’ bits select the address of the destination | |
| | register. | |
| | The ‘p’ bits select the source address mode 2 | |
| | (values 0-4). | |
| | The ‘q’ bits select the destination address | |
| | mode 2 (values 0-4). | |
| | See Table 1-5 and Table 1-6 for modifier addressing | |
| | information. | |
| | Note: | The extension .b in the instruction |
| | | denotes a byte operation rather than a word |
| | | operation. You may use a .w extension |
| | | to denote a word operation, but it is |
| | | not required. |

| | | | |
|---|---|---|---|
| Words: | 1 | | |
| Cycles: | 1 | | |
| Example: | NEG | W5,W7 | ; Negate |
| | Before Instruction | | |
| | After Instruction | | |

TABLE 107
NEGAB: Negate Accumulators

| Syntax: | {label:} | NEG | A | | | |
|---|---|---|---|---|---|---|
| | | | B | | | |
| Operands: | None | | | | | |
| Operation: | if (NEGAB A) then −ACCA → ACCA | | | | | |
| | if (NEGAB B) then −ACCB → ACCB | | | | | |
| Status Affected: | OA, OB, SA, SB | | | | | |
| Encoding: | 1100 | 1011 | A001 | 0000 | 0000 | 0000 |

| | |
|---|---|
| Description: | Negate Accumulator. |
| | The ‘A’ bits specify the selected accumulator. |
| Words: | 1 |
| Cycles: | 1 |

| | | | |
|---|---|---|---|
| Example: | NEG | B | ; Negate ACCB, result to |
| | | | ACCB |

Before Instruction
After Instruction

TABLE 108
NEGF: Negate f

| Syntax: | {label:} | NEG{.b} | f | {,Ww} | | |
|---|---|---|---|---|---|---|
| Operands: | f ∈ [0 . . . 8191] | | | | | |
| Operation: | \overline{(f)}+ 1 → destination designated by D | | | | | |
| Status Affected: | C, DC, N, OV, Z | | | | | |
| Encoding: | 1110 | 1110 | 0BDf | ffff | ffff | ffff |

| Description: | Compute the 2's complement of the contents of the | |
|---|---|---|
| | file register and place the result in the destination | |
| | designated by 0: If the optional Ww is specified, | |
| | D=0 and store result in Ww; otherwise, | |
| | D=1 and store result in the file register. | |
| | The ‘B’ bit selects byte or word operation. | |
| | The ‘f’ bits select the address of the file register. | |
| | The ‘D’ bit selects the destination. | |
| | Note: | The extension .b in the instruction |
| | | denotes a byte operation rather than a |
| | | word operation. You may use a .w extension |
| | | to denote a word operation, |
| | | but it is not required. |

| | |
|---|---|
| Words: | 1 |
| Cycles: | 1 |

| | | | |
|---|---|---|---|
| Example: | NEG | RAM135 | ; Negate |

Before Instruction
After Instruction

TABLE 109
NOP: No Operation

| Syntax: | {label:} | NOP | | | | |
|---|---|---|---|---|---|---|
| Operands: | None | | | | | |
| Operation: | No Operation | | | | | |
| Status Affected: | None | | | | | |
| Encoding: | 0000 | 0000 | xxxx | xxxx | xxxx | xxxx |

| | |
|---|---|
| Description: | No Operation is performed. |
| | The ‘x’ bits can take any value. |
| Words: | 1 |
| Cycles: | 1 |

| | | |
|---|---|---|
| Example: | NOP | ; No |
| | | operation |

Before Instruction
After Instruction

TABLE 110
NOPR: No Operation

| Syntax: | {label:} | NOPR | | | | |
|---|---|---|---|---|---|---|
| Operands: | None | | | | | |
| Operation: | No Operation | | | | | |
| Status Affected: | None | | | | | |
| Encoding: | 1111 | 1111 | xxxx | xxxx | xxxx | xxxx |

| | |
|---|---|
| Description: | No Operation is performed. |
| | The ‘x’ bits can take any value. |
| Words: | 1 |
| Cycles: | 1 |

| | | |
|---|---|---|
| Example: | NOPR | ; No |
| | | Opeation |

Before Instruction
After Instruction

TABLE 111
POP: Pop top of Return Stack

| | | | |
|---|---|---|---|
| Syntax: | {label:} | POP | f |

| Operands: | f ∈ [0 . . . 65534] | | | | | |
|---|---|---|---|---|---|---|
| Operation: | (W15)+2 → W15 | | | | | |
| | (TOS) → f | | | | | |
| Status Affected: | None | | | | | |
| Encoding: | 1111 | 1001 | ffff | ffff | ffff | ffff |

| Description: | The stack pointer (W15) is pre-incremented | |
|---|---|---|
| | and Top of Stack (TOS) value is pulled | |
| | off the stack and written to the file register. | |
| | Note: | This instruction operates in word |
| | | mode only. |

| | |
|---|---|
| Words: | 1 |
| Cycles: | 1 |

| | | | |
|---|---|---|---|
| Example: | POP | RAM135 | ; Pop |

Before Instruction
After Instruction

TABLE 112
PUSH: Push top of return stack (TOS)

| Syntax: | {label:} | PUSH | f | | | |
|---|---|---|---|---|---|---|
| Operands: | f ∈ [0 . . . 65534] | | | | | |
| Operation: | f → TOS | | | | | |
| | (W15)−2 → W15 | | | | | |
| Status Affected: | None | | | | | |
| Encoding: | 1111 | 1000 | ffff | ffff | ffff | ffff |

| Description: | The file register contents are written to the Top | |
|---|---|---|
| | of Stack (TOS) location. Then the stack pointer | |
| | (W15) is post decremented. | |
| | Note: | This instruction operates in word mode only. |

| | |
|---|---|
| Words: | 1 |
| Cycles: | 1 |

| | | | |
|---|---|---|---|
| Example: | PUSH | RAM135 | ; Push |

Before Instruction
After Instruction

TABLE 113
RCALL: Relative Call

| Syntax: | {label:} | RCALL | Slit16 | | | |
|---|---|---|---|---|---|---|
| Operands: | Slit16 ∈ [−32768 . . . +32767] | | | | | |
| Operation: | (PC) +2→PC, | | | | | |
| | (PC<15:0>)→TOS, | | | | | |
| | (W15)+2 → W15 | | | | | |
| | (PC<23:16>)→TOS, | | | | | |
| | (W15)+2 → W15 | | | | | |
| | (PC)+(2 * Slit16)→PC, NOP→Instruction Register. | | | | | |
| Status Affected: | None | | | | | |
| Encoding: | 0000 | 0111 | nnnn | nnnn | nnnn | nnnn |

| | |
|---|---|
| Description: | Subroutine call with a jump up to 32K |
| | instructions from the current location. |
| | First, return address (PC + 2) is pushed onto the return |
| | stack (20-bits wide). |
| | Then the sign extended 17-bit value (2 * Slit16) is |
| | added to the contents of the PC and the result is stored |
| | into the PC. RCALL is a two-cycle instruction. |
| Words: | 1 |
| Cycles: | 2 |

| | | | |
|---|---|---|---|
| Example: | RCALL | label | ; Call subroutine |

Before Instruction
After Instruction

TABLE 114
RCALLW: Computed Call

| Syntax: | {label:} | RCALL | Wn | | | |
|---|---|---|---|---|---|---|
| Operands: | Wn ∈ [W0 . . . W15] | | | | | |
| Operation: | (PC) +2 → PC, | | | | | |
| | (PC<15:0>) → TOS, | | | | | |
| | (W15)+2 → W15 | | | | | |
| | (PC<23:16>) → TOS, | | | | | |
| | (W15)+2 → W15 | | | | | |
| | (PC) + (2 * (Wn)) → PC, NOP → Instruction | | | | | |
| | Register. | | | | | |
| Status Affected: | None | | | | | |
| Encoding: | 0000 | 0001 | 0010 | 0000 | 0000 | ssss |

| | |
|---|---|
| Description: | Computed subroutine call with a jump up to 32K |
| | instructions forward or back from the current location. |
| | First, return address (PC + 2) is pushed onto the |
| | return stack. |
| | Then the sign extended 17-bit value (2 * (Wn)) is |
| | added to the contents of the PC and the result is |
| | stored into the PC. RCALLW is a two-cycle |
| | instruction. |
| Words: | 1 |
| Cycles: | 2 |

| | | | |
|---|---|---|---|
| Example: | RCALL | W11 | ; Call subroutine at |
| | | | PC+W11 |

Before Instruction
After Instruction

TABLE 115
REPEAT: Repeat next instruction n times

| Syntax: | {label:} | REPEAT | lit14 | | | |
|---|---|---|---|---|---|---|
| Operands: | lit14 ∈ [1 . . . 16383] | | | | | |
| Operation: | (lit14) → LCR (Loop Count Register) | | | | | |
| | (PC)+2 → PC | | | | | |
| | Enable Code Looping | | | | | |
| Status Affected: | None | | | | | |
| Encoding: | 0000 | 1001 | 00kk | kkkk | kkkk | kkkk |

| | |
|---|---|
| Description: | The instruction immediately following the REPEAT |
| | instruction is repeated lit14 times. The repeated |
| | instruction is held in the instruction register for |
| | all iterations and so is fetched only once (during |
| | the REPEAT instruction, as would be expected). The |
| | first iteration of the repeated instruction pre-fetches |
| | the next instruction. |
| | The repeat count is decremented during each iteration. |
| | When it equals zero, the pre-fetch instruction is staged |
| | into the instruction and normal execution continues. |
| | The repeated instruction can be interrupted before any |
| | iteration, but only by a priority 1 (fast context switch) |
| | interrupt. Subsequent interrupts must be held pending |
| | until the repeat operation is complete. Note that nested |
| | repeats (e.g. from within the interrupt service routine) |
| | are not supported. |
| | The ‘k’ bits are an unsigned literal that specifies |
| | the loop count. |
| Words: | 1 |
| Cycles: | 1 + lit14 |

| | | | |
|---|---|---|---|
| Example: | REPEAT | #5 | ; Repeat next instruction |
| | | | 5 times |

Before Instruction
After Instruction

TABLE 116
REPEATW: Repeat next instruction Wn times

| Syntax: | {label:} | REPEAT | Wn | | | |
|---|---|---|---|---|---|---|
| Operands: | Wn ∈ [W0 . . . W15] | | | | | |
| Operation: | (Wn) → LCR (Loop Count Register) | | | | | |
| | (PC)+2 → PC | | | | | |
| | Enable Code Looping | | | | | |
| Status Affected: | None | | | | | |
| Encoding: | 0000 | 1001 | 1000 | 0000 | 0000 | ssss |

| | |
|---|---|
| Description: | The instruction immediately following the REPEAT |
| | instruction is repeated (Wn) times. The repeated |
| | instruction is held in the instruction register |
| | for all iterations and so is fetched only once |
| | (during the REPEAT instruction, as would be |
| | expected). The first iteration of the repeated |
| | instruction pre-fetches the next instruction. |
| | The repeat count is decremented during each |
| | iteration. When it equals zero, the pre-fetch |
| | instruction is staged into the instruction and |
| | normal execution continues. |
| | The repeated instruction can be interrupted |
| | before any iteration, but only by a priority 1 |
| | (fast context switch) interrupt. Subsequent |
| | interrupts must be held pending until the repeat |
| | operation is complete. Note that nested repeats |
| | (e.g. from within the interrupt service routine) |
| | are not supported. |
| | The ‘s’ bits specify the Wn register that |
| | contains the loop count. |
| Words: | 1 |
| Cycles: | 1 + (Wn) |

| | | | |
|---|---|---|---|
| Example: | REPEAT | W6 | ; Repeat next instruction |
| | | | (W6) times |

Before Instruction
After Instruction

TABLE 117
RESET: Reset

| Syntax: | {label:} | RESET | | | | |
|---|---|---|---|---|---|---|
| Operands: | none | | | | | |
| Operation: | Force all registers and flag bits that are affected by | | | | | |
| | a \overline{MCLR} reset to their reset condition. | | | | | |
| Status Affected: | None | | | | | |
| Encoding: | 1111 | 1110 | 0000 | 0000 | 0000 | 0000 |

| | |
|---|---|
| Description: | This instruction provides a way to execute a |
| | software reset. |
| Words: | 1 |
| Cycles: | 1 |

| | | |
|---|---|---|
| Example: | RESET | ; Reset |

Before Instruction
After Instruction

TABLE 118
RLC: Rotate Left Ws through Carry

| | | | | |
|---|---|---|---|---|
| Syntax: | {label:} | RLC{.b} | Ws, | Wd |
| | | | [Ws], | [Wd] |
| | | | [Ws]++, | [Wd]++ |
| | | | [Ws]−−, | [Wd]−− |
| | | | [Ws++], | [Wd++] |
| | | | [Ws−−], | [Wd−−] |

| | |
|---|---|
| Operands: | Ws ∈ [W0 . . . W15]; Wd ∈ [W0 . . . W15] |
| Operation: | For word operation: |

(C) → Wd<0>, (Ws<14:0>) → Wd<15:1>, (Ws<15>) → C

For byte operation:

(C) → Wd<0>, (Ws<6:0>) → Wd<7:1>, (Ws<7>) → C

| | 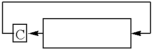 | | | | | |
|---|---|---|---|---|---|---|
| Status Affected: | C, N, Z | | | | | |
| Encoding: | 1101 | 0010 | 1Bqq | qddd | dppp | ssss |

| Description: | Rotate the contents of the source register Ws one bit to the left through | |
|---|---|---|
| | the carry flag and place the result in the destination register Wd. | |
| | The ‘B’ bit selects byte or word operation. | |
| | The ‘s’ bits select the address of the source register. | |
| | The ‘d’ bits select the address of the destination register. | |
| | The ‘p’ bits select source address mode 2. | |
| | The ‘q’ bits select destination address mode 2. | |
| | See Table 1-5 and Table 1-6 for modifier addressing information. | |
| | Note: | The extension .b in the instruction denotes a byte operation rather than a |
| | | word operation. You may use a .w extension to denote a word |
| | | operation, but it is not required. |

| | |
|---|---|
| Words: | 1 |
| Cycles: | 1 |

| | | | |
|---|---|---|---|
| Example: | RLC | W5, W6 | ; Rotate left |

Before Instruction
After Instruction

TABLE 119
RLCF: Rotate Left f through Carry

| | | | | |
|---|---|---|---|---|
| Syntax: | {label:} | RLC{.b} | f | {,Ww} |

| | |
|---|---|
| Operands: | f ∈ [0 . . . 8191] |
| Operation: | For word operation: |

(C) → Dest<0>, (f <14:0>) → Dest<15:1>, (f<15>) → C

For byte operation:

(C) → Dest<0>, (f<6:0>) → Dest<7:1>, (f<7>) → C

| | 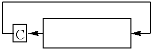 | | | | | |
|---|---|---|---|---|---|---|
| Status Affected: | C, N, Z | | | | | |
| Encoding: | 1101 | 0110 | 1BDf | ffff | ffff | ffff |

| Description: | Rotate the contents of the file register f one bit to the left through the carry | |
|---|---|---|
| | flag and place the result in the destination designated by D: If | |
| | the optional Ww is specified, D = 0 and store result in Ww; | |
| | otherwise, D = 1 and store result in the file register. | |
| | The ‘B’ bit selects byte or word operation. | |
| | The ‘D’ bit selects the destination. | |
| | The ‘f’ bits select the address of the file register. | |
| | Note: | The extension .b in the instruction denotes a byte operation rather than a |
| | | word operation. You may use a .w extension to denote a |
| | | word operation, but it is not required. |

| | |
|---|---|
| Words: | 1 |
| Cycles: | 1 |

| | | | |
|---|---|---|---|
| Example: | RLC | RAM135, Ww | ; Rotate left |

Before Instruction
After Instruction

TABLE 120
RLNC: Rotate Left Ws (No Carry)

| | | | | |
|---|---|---|---|---|
| Syntax: | {label:} | RLNC{.b} | Ws, | Wd |
| | | | [Ws], | [Wd] |
| | | | [Ws]++, | [Wd]++ |
| | | | [Ws]−−, | [Wd]−− |
| | | | [Ws++], | [Wd++] |
| | | | [Ws−−], | [Wd−−] |

| | |
|---|---|
| Operands: | Ws ∈ [W0 . . . W15]; Wd ∈ [W0 . . . W15] |
| Operation: | For word operation: |

(Ws<14:0>) → Wd<15:1>, (Ws<15>) → Wd<0>

For byte operation:

(Ws<6:0>) → Wd<7:1>, (Ws<7>) → Wd<0>

| | 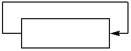 | | | | | |
|---|---|---|---|---|---|---|
| Status Affected: | N, Z | | | | | |
| Encoding: | 1101 | 0010 | 0Bqq | qddd | dppp | ssss |

| Description: | Rotate the contents of the source register Ws one bit to the left and place the result | |
|---|---|---|
| | in the destination register Wd. The Carry Flag bit is not affected. | |
| | The ‘B’ bit selects byte or word operation. | |
| | The ‘s’ bits select the address of the source register. | |
| | The ‘d’ bits select the address of the destination register. | |
| | The ‘p’ bits select source address mode 2. | |
| | The ‘q’ bits select destination address mode 2. | |
| | See Table 1-5 and Table 1-6 for modifier addressing information. | |
| | Note: | The extension .b in the instruction denotes a byte operation rather than a |

word operation. You may use a .w extension to denote a word operation,
but it is not required.

| | |
|---|---|
| Words: | 1 |
| Cycles: | 1 |

| | | | |
|---|---|---|---|
| Example: | RLNC | W5, W6 | ; Rotate left |

Before Instruction
After Instruction

TABLE 121
RLNCF: Rotate Left f (No Carry)

| | | | | |
|---|---|---|---|---|
| Syntax: | {label:} | RLNC{.b} | f | {,Ww} |

| | |
|---|---|
| Operands: | f ∈ [0 . . . 8191] |
| Operation: | For word operation: |

(f<14:0>) → Dest<15:1>, (f<15>) → Dest<0>

For byte operation:

(f<6:0>) → Dest<7:1>, (f<7>) → Dest<0>

| | 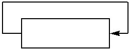 | | | | | |
|---|---|---|---|---|---|---|
| Status Affected: | N, Z | | | | | |
| Encoding: | 1101 | 0110 | 0BDf | ffff | ffff | ffff |

| Description: | Rotate the contents of the file register f one bit to the left and place the result in the | |
|---|---|---|
| | destination designated by D: If the optional Ww is specified, D = 0 and store result in | |
| | Ww; otherwise, D = 1 and store result in the file register. The carry flag bit is not | |
| | affected. | |
| | The ‘B’ bit selects byte or word operation. | |
| | The ‘D’ bit selects the destination. | |
| | The ‘f’ bits select the address of the file register. | |
| | Note: | The extension .b in the instruction denotes a byte operation rather than a |

word operation. You may use a .w extension to denote a word operation,
but it is not required.

| | |
|---|---|
| Words: | 1 |
| Cycles: | 1 |

| | | | |
|---|---|---|---|
| Example: | RLNC | RAM135, Ww | ; Rotate left |

Before Instruction
After Instruction

TABLE 122
RRC: Rotate Right Ws through Carry

| | | | | |
|---|---|---|---|---|
| Syntax: | {label:} | RRC{.b} | Ws, | Wd |
| | | | [Ws], | [Wd] |
| | | | [Ws]++, | [Wd]++ |
| | | | [Ws]−−, | [Wd]−− |
| | | | [Ws++], | [Wd++] |
| | | | [Ws−−], | [Wd−−] |

| | |
|---|---|
| Operands: | Ws ∈ [W0 . . . W15]; Wd ∈ [W0 . . . W15] |
| Operation: | For word operation: |

(C) → Wd<15>, (Ws<15:1>) → Wd<14:0>, (Ws<0>) → C

For byte operation:

(C) → Wd<7>, (Ws<7:1>) → Wd<6:0>, (Ws<0>) → C

| | 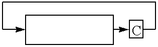 | | | | | |
|---|---|---|---|---|---|---|
| Status Affected: | C, N, Z | | | | | |
| Encoding: | 1101 | 0011 | 1Bqq | qddd | dppp | ssss |

| Description: | Rotate the contents of the source register Ws one bit to the right through the carry | |
|---|---|---|
| | flag and place the result in the destination register Wd. | |
| | The ‘B’ bit selects byte or word operation. | |
| | The ‘s’ bits select the address of the source register. | |
| | The ‘d’ bits select the address of the destination register. | |
| | The ‘p’ bits select source address mode 2. | |
| | The ‘q’ bits select destination address mode 2. | |
| | See Table 1-5 and Table 1-6 for modifier addressing information. | |
| | Note: | The extension .b in the instruction denotes a byte operation rather than a |
| | | word operation. You may use a .w extension to denote a word operation, |
| | | but it is not required. |

| | |
|---|---|
| Words: | 1 |
| Cycles: | 1 |

| | | | |
|---|---|---|---|
| Example: | RRC | W5,W6 | ; Rotate right |

Before Instruction
After Instruction

TABLE 123
RRCF: Rotate Right f through Carry

| | | | | |
|---|---|---|---|---|
| Syntax: | {label:} | RRC{.b} | f | {,Ww} |

| | |
|---|---|
| Operands: | f ∈ [0 . . . 8191] |
| Operation: | For word operation: |

(C) → Dest<15>, (f<15:1>) → Dest<14:0>, (f<0>) → C

For byte operation:

(C) → Dest<7>, (f<7:1>) → Dest<6:0>, (f<0>) → C

| | 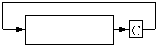 | | | | | |
|---|---|---|---|---|---|---|
| Status Affected: | C, N, Z | | | | | |
| Encoding: | 1101 | 0111 | 1BDf | ffff | ffff | ffff |

| Description: | Rotate the contents of the file register f one bit to the left through the carry flag and | |
|---|---|---|
| | place the result in the destination designated by D: If the optional Ww is specified, | |
| | D = 0 and store result in Ww; otherwise, D = 1 and store result in the file register.. | |
| | The ‘B’ bit selects byte or word operation. | |
| | The ‘D’ bit selects the destination. | |
| | The ‘f’ bits select the address of the file register. | |
| | Note: | The extension .b in the instruction denotes a byte operation rather than a |
| | | word operation. You may use a .w extension to denote a word operation, |
| | | but it is not required. |

| | |
|---|---|
| Words: | 1 |
| Cycles: | 1 |

| | | | |
|---|---|---|---|
| Example: | RRC | RAM135, Ww | ; Rotate right |

Before Instruction
After Instruction

TABLE 124
RRNC: Rotate Right Ws (No Carry)

| Syntax: | {label:} | RRNC{.b} | Ws, | Wd | | |
|---|---|---|---|---|---|---|
| | | | [Ws], | [Wd] | | |
| | | | [Ws]++, | [Wd]++ | | |
| | | | [Ws]−−, | [Wd]−− | | |
| | | | [Ws++], | [Wd++] | | |
| | | | [Ws−−], | [Wd−−] | | |
| Operands. | Ws ∈ [W0 . . . W15]; Wd ∈ [W0 . . . W15] | | | | | |
| Operation: | For word operation: | | | | | |
| | (Ws<15:1>) → Wd<14:0>, (Ws<0>) → Wd<15> | | | | | |
| | For byte operation: | | | | | |
| | (Ws<7:1>) → Wd<6:0>, (Ws<0>) → Wd<7> | | | | | |
| | 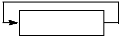 | | | | | |
| Status | N, Z | | | | | |
| Affected: | | | | | | |
| Encoding: | 1101 | 0011 | 0Bqq | qddd | dppp | ssss |

| Description: | Rotate the contents of the source register Ws one bit to | |
|---|---|---|
| | the right and place the result in the destination register | |
| | Wd. The Carry Flag bit is not affected. | |
| | The ‘B’ bit selects byte or word operation. | |
| | The ‘s’ bits select the address of the source register. | |
| | The ‘d’ bits select the address of the destination register. | |
| | The ‘p’ bits select source address mode 2. | |
| | The ‘q’ bits select destination address mode 2. | |
| | See Table 1-5 and Table 1-6 for modifier addressing | |
| | information. | |
| | Note: | The extension .b in the instruction denotes a byte |
| | | operation rather than a word operation. You may |
| | | use a .w extension to denote a word operation, |
| | | but it is not required. |

| | |
|---|---|
| Words: | 1 |
| Cycles: | 1 |

| | | | |
|---|---|---|---|
| Example: | RRNC | W5,W6 | ; Rotate right |

Before Instruction
After Instruction

TABLE 125
RRNCF: Rotate Right f (No Carry)

| Syntax: | {label:} | RRNC{.b} | f | {,Ww} | | |
|---|---|---|---|---|---|---|
| Operands: | f ∈ [0 . . . 8191] | | | | | |
| Operation: | For word operation: | | | | | |
| | (f<15:1>) → Dest<14:0>, (f<0>) → Dest<15> | | | | | |
| | For byte operation: | | | | | |
| | (f<7:1>) → Dest<6:0>, (f<0>) → Dest<7> | | | | | |
| | 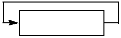 | | | | | |
| Status Affected: | N, Z | | | | | |
| Encoding: | 1101 | 0111 | 0BDf | ffff | ffff | ffff |

| Description: | Rotate the contents of the file register f one bit to the | |
|---|---|---|
| | and place the result in the destination designated by | |
| | D: If the optional Ww is specified, D=0 and store | |
| | result in Ww; otherwise, D=1 and store result in the | |
| | file register. The carry flag bit is not affected. | |
| | The ‘B’ bit selects byte or word operation. | |
| | The ‘D’ bit selects the destination. | |
| | The ‘f’ bits select the address of the file register. | |
| | Note: | The extension .b in the instruction denotes a |
| | | byte operation rather than a word operation. |
| | | You may use a .w extension to denote a word |
| | | operation, but it is not required. |

| | |
|---|---|
| Words: | 1 |
| Cycles: | 1 |

| | | | |
|---|---|---|---|
| Example: | RRNC | RAM135, Ww | ; Rotate right |

Before Instruction
After Instruction

TABLE 126
SAC: Store Accumulator

| Syntax: | {label:} | SAC | A, | Wnd, | [, Slit4] | |
|---|---|---|---|---|---|---|
| | | | B, | [Wnd], | | |
| | | | | [Wnd]++ | | |
| | | | | [Wnd]−− | | |
| | | | | [Wnd−−], | | |
| | | | | [Wnd+Wb], | | |
| | | | | [Wnd+lit5] | | |
| Operands: | Wnd ∈ [W0 . . . W15]; | | | | | |
| | Wb ∈ [W0 . . . W15]; lit5 ∈ [0 . . . 31] | | | | | |
| | Slit4 ∈ [−8 . . . +7] | | | | | |
| Operation: | Shift_{Slit4}(ACC) (optional); (ACC[31:16]) → Wnd | | | | | |
| Status | None | | | | | |
| Affected: | | | | | | |
| Encoding: | 1100 | 1100 | Awww | wrrr | rhhh | ssss |

| Description: | Optionally shift accumulator, then store truncated | |
|---|---|---|
| | accumulator, ACC[31:16], to the destination | |
| | effective address. | |
| | The ‘A’ bits specify the source accumulator. | |
| | The ‘s’ bits specify the destination register Wnd. | |
| | The ‘h’ bits select destination address mode 3. | |
| | The ‘w’ bits specify the offset amount lit5 OR the offset | |
| | register Wb. | |
| | The ‘r’ bits encode the optional operand Slit4 which | |
| | determines the amount of the accumulator preshift; if the | |
| | operand Slit4 is absent, a 0 is encoded. | |
| | See Table 1-7 for modifier addressing information. | |
| | Note: | Positive values of operand Slit4 represent |
| | | arithmetic shift right. Negative values of |
| | | operand Slit4 represent shift left. |

| | |
|---|---|
| Words: | 1 |
| Cycles: | 1 |

| | | | |
|---|---|---|---|
| Example: | SAC | A,W5 | ; Store |
| | | | Accumulator A |

Before Instruction
After Instruction

TABLE 127
SCRATCH: Push Shadow Registers

| Syntax: | {label:} | PUSH.S | | | | |
|---|---|---|---|---|---|---|
| Operands: | None | | | | | |
| Operation: | Push shadow registers. Shadowed registers include | | | | | |
| | W0 . . . W15 and STA-TUS. | | | | | |
| Status Affected: | None | | | | | |
| Encoding: | 1111 | 1110 | 1010 | 0000 | 0000 | 0000 |

| | |
|---|---|
| Description: | The contents of the primary registers are copied |
| | into the shadow registers. |
| Words: | 1 |
| Cycles: | 1 |

| | | |
|---|---|---|
| Example: | PUSH.S | ; Push registers to shadows |

Before Instruction
After Instruction

TABLE 128
SETF: Set or Ww

| Syntax: | {label:} | SETM{.b} | f | | | |
|---|---|---|---|---|---|---|
| | | | Ww | | | |
| Operands: | f ∈ [0 . . . 8191] | | | | | |
| Operation: | 0xFFFF → destination designated by D | | | | | |
| Status Affected: | None | | | | | |
| Encoding: | 1110 | 1111 | 1BDf | ffff | ffff | ffff |

| Description: | Set the register designated by D: If the optional Ww is | |
|---|---|---|
| | specified, D = 0 and set Ww; | |
| | otherwise, D = 1 and set the file register. | |
| | The ‘B’ bit selects byte or word operation. | |
| | The ‘f’ bits select the address of the file register. | |
| | The ‘D’ bit selects the destination. | |
| | Note: | The extension .b in the instruction denotes a |
| | | byte operation rather than a word |
| | | operation. You may use a .w extension |
| | | to denote a word operation, but it is |
| | | not required. |

| | |
|---|---|
| Words: | 1 |
| Cycles: | 1 |

| | | | |
|---|---|---|---|
| Example: | SETM | 345 | ; Set |
| | | | location |
| | | | 345 |

Before Instruction
After Instruction

TABLE 129
SFTAC: Arithmetic Shift Accumulator

| Syntax: | {label:} | SFTAC | A, | Wb | | |
|---|---|---|---|---|---|---|
| | | | B, | | | |
| Operands: | Wb ∈ [W0 . . . W15] | | | | | |
| Operation: | Shift_{(Wb)}(ACC) | | | | | |
| Status Affected: | OA, OB, SA, SB | | | | | |
| Encoding: | 1100 | 1000 | A000 | 0000 | 0000 | ssss |

| | |
|---|---|
| Description: | Arithmetic shift of accumulator. |
| | The contents of Ws are used as the shift amount. Only |
| | the least significant 5 bits of the Ws are used. If |
| | Ws<4:0> is positive, the shift is a right shift |
| | by Ws<4:0> bits. If Ws<4:0> is negative, |
| | the shift is a left shift by −Ws<4:0> bits. |
| | The ‘A’ bit selects the accumulator for the result. |
| | The ‘s’ bits select the address of the shift count |
| | register. |
| Words: | 1 |
| Cycles: | 1 |

| | | | |
|---|---|---|---|
| Example: | SFTAC | A,W5 | ; Shift Accumulator A right |
| | | | (W5) bits |

Before Instruction
After Instruction

TABLE 130
SFTACK: Arithmetic Shift Accumulator

| Syntax: | {label:} | SFTAC | A, | Slit5 | | |
|---|---|---|---|---|---|---|
| | | | B, | | | |
| Operands: | Slit5 ∈ [−16 . . . 15] | | | | | |
| Operation: | Shiftₖ(ACC) | | | | | |
| Status Affected: | OA, OB, SA, SB | | | | | |
| Encoding: | 1100 | 1000 | A100 | 0000 | 000k | kkkk |

| | |
|---|---|
| Description: | Arithmetic shift of accumulator. |
| | The Slit5 is used as the shift amount. If Slit5 is |
| | positive, the shift is a right shift by Slit5 bits. |
| | If Slit5 is negative, the shift is a left shift |
| | by −Slit5 bits. |
| | The ‘A’ bit selects the accumulator for the result. |
| | The ‘k’ bits determine the number of bits to be shifted. |
| Words: | 1 |
| Cycles: | 1 |

| | | | |
|---|---|---|---|
| Example: | SFTAC | B,5 | ; Shift Accumulator B right |
| | | | five bits |

Before Instruction
After Instruction

TABLE 131
SL: Shift Left Ws

| Syntax: | {label:} | SL{.b} | Ws, | Wd | | |
|---|---|---|---|---|---|---|
| | | | [Ws], | [Wd] | | |
| | | | [Ws]++, | [Wd]++ | | |
| | | | [Ws]−−, | [Wd]−− | | |
| | | | [Ws++], | [Wd++] | | |
| | | | [Ws−−], | [Wd−−] | | |
| Operands. | Ws ∈ [W0 . . . W15]; Wd ∈ [W0 . . . W15] | | | | | |
| Operation: | For word operation: | | | | | |
| | (Ws<15>) → C, (Ws<14:0>) → Wd<15:1>, | | | | | |
| | 0 → Wd<0> | | | | | |
| | For byte operation: | | | | | |
| | (Ws<7>) → C, (Ws<6:0>) → Wd<7:1>, 0 → Wd<0> | | | | | |
| | 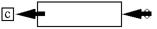 | | | | | |
| Status Affected: | C, N, OV, Z | | | | | |
| Encoding: | 1101 | 0000 | 0Bqq | qddd | dppp | ssss |

| Description: | Shift the contents of the source register Ws one bit to | |
|---|---|---|
| | the left and place the result in the destination register | |
| | Wd. Shift ‘0’ into the LSB of Wd. The Carry Flag is | |
| | set if the MSB of Ws is ‘1’. | |
| | The ‘B’ bit selects byte or word operation. | |
| | The ‘s’ bits select the address of the source register. | |
| | The ‘d’ bits select the address of the destination | |
| | register. | |
| | The ‘p’ bits select source address mode 2. | |
| | The ‘q’ bits select destination address mode 2. | |
| | See Table 1-5 and Table 1-6 for modifier addressing | |
| | information. | |
| | Note: | The extension .b in the instruction denotes a |
| | | byte operation rather than a word operation. |
| | | You may use a .w extension to denote a word |
| | | operation, but it is not required. |

| | |
|---|---|
| Words: | 1 |
| Cycles: | 1 |

| | | | |
|---|---|---|---|
| Example: | SL | W5,W6 | ; Rotate right |

Before Instruction
After Instruction

TABLE 132
SLEEP: Enter SLEEP mode

| Syntax: | {label:} | SLEEP | lit4 | | | |
|---|---|---|---|---|---|---|
| Operands: | lit4 ∈ [0 . . . 15] | | | | | |
| Operation: | 0 → WDT, | | | | | |
| | 0 → WDT prescaler count, | | | | | |
| | 1 → TO | | | | | |
| | 0 → PD | | | | | |
| | Enter sleep mode (lit4) | | | | | |
| Status Affected: | \overline{TO} \overline{PD} | | | | | |
| Encoding: | 1111 | 1110 | 0100 | 0000 | 0000 | kkkk |

| | |
|---|---|
| Description: | The power-down status bit, \overline{PD} is cleared. Time-out |
| | status bit, \overline{TO} is set. The Watchdog Timer and its |
| | prescaler are cleared. The processor is put into |
| | SLEEP mode selected by lit4. |
| Words: | 1 |
| Cycles: | 1 |

| | | | |
|---|---|---|---|
| Example: | SLEEP | 0 | ; Turn off the device |
| | | | oscillator. |

Before Instruction
After Instruction

TABLE 133
SLW: Shift Left by Wns

| Syntax: | {label:} | SL | Wb, | Wns, | Wnd | |
|---|---|---|---|---|---|---|
| Operands: | Wb ∈ [W0 . . . W15]; Wns ∈ [W0 . . .W15]; | | | | | |
| | Wnd ∈ [W0 . . . W15] | | | | | |
| Operation: | Wns<3:0>→Shift_Val | | | | | |
| | 0→Shift_In<39:16> | | | | | |
| | Wb<15:0>→Shift_In<15:0> | | | | | |
| | 0→Shift_Out<39:16+Shift_Val> | | | | | |
| | Shift_In<15:01>→Shift_Out<15+Shift_Val:Shift_Val> | | | | | |
| | If Wns<4>==0: (less than 16) | | | | | |
| | 0→CARRY1<15:0> | | | | | |
| | Shift_Out<31:16>→CARRY0<15:0> | | | | | |
| | Shift_Out<15:0>→Wnd<15:0> | | | | | |
| | If Wns<4>==1: (16 or greater) | | | | | |
| | Shift_Out<31:16>→CARRY1<15:0> | | | | | |
| | Shift_Out<15:0>→CARRY0<15:0> | | | | | |
| | 0→Wnd<15:0> | | | | | |
| Status | C,SZ,Z | | | | | |
| Affected: | | | | | | |
| Encoding: | 1101 | 1101 | 0www | wddd | d000 | ssss |

| | |
|---|---|
| Description: | Shift left the contents of the source register Wb by Wns bits |
| | (up to 31 positions), placing the result in the destination |
| | register Wnd. Bits that are shifted beyond the leftmost |
| | position of the source are stored in the CARRY1 and |
| | CARRY0 registers. |
| | The Z and SZ bits will be set if the value placed in Wnd |
| | is zero and cleared otherwise. The C bit will be set if |
| | any of the bits shifted out were set (in other words, |
| | if the resultant CARRY is non-zero) and cleared otherwise. |
| | Note: This instruction operates in word mode only. |
| Words: | 1 |
| Cycles: | 1 |

TABLE 134
SRAC: Store Rounded Accumulator

| Syntax: | {label:} | SAC.R | A, | Wnd, | [, Slit4] | |
|---|---|---|---|---|---|---|
| | | | B, | [Wnd], | | |
| | | | | [Wnd]++ | | |
| | | | | [Wnd]−− | | |
| | | | | [Wnd−−], | | |
| | | | | [Wnd+Wb], | | |
| | | | | [Wnd+lit5] | | |
| Operands: | Wnd ∈ [W0 . . . W15]; | | | | | |
| | Wb ∈ [W0 . . . W15]; lit5 ∈ [0 . . . 31] | | | | | |
| | Slit4 ∈ [−8 . . . +7] | | | | | |
| Operation: | Shift_{Slit4}(ACC) (optional); | | | | | |
| | Round(ACC);(ACC[31:16]) → Wnd | | | | | |
| Status | None | | | | | |
| Affected: | | | | | | |
| Encoding: | 1100 | 1101 | Awww | wrrr | rhhh | ssss |

| Description: | Optionally shift accumulator, round and store convergent | |
|---|---|---|
| | rounded accumulator, ACC, to the destination effective | |
| | address. | |
| | The ‘A’ bits specify the source accumulator. | |
| | The ‘s’ bits specify the destination register Wnd. | |
| | The ‘h’ bits select destination address mode 3. | |
| | The ‘w’ bits specify the offset amount lit5 OR the offset | |
| | register Wb. | |
| | The ‘r’ bits encode the optional operand Slit4 which | |
| | determines the amount of the accumulator preshift; if the | |
| | operand Slit4 is absent, a 0 is encoded. | |
| | See Table 1-7 for modifier addressing information. | |
| | Note: | Positive values of operand Slit4 represent |
| | | arithmetic shift right. Negative values of operand |
| | | Slit4 represent shift left. |

| | |
|---|---|
| Words: | 1 |
| Cycles: | 1 |

| | | | |
|---|---|---|---|
| Example: | SAC.R | B,W5 | ; Store RoundedAccumulator |

Before Instruction
After Instruction

TABLE 135
SUB: Subtract Ws from Wb

| Syntax: | {label:} | SUB{.b} | Wb, | Ws, | Wd | |
|---|---|---|---|---|---|---|
| | | | | [Ws], | [Wd] | |
| | | | | [Ws]++, | [Wd]++ | |
| | | | | [Ws]−−, | [Wd]−− | |
| | | | | [Ws++], | [Wd++] | |
| | | | | [Ws−−], | [Wd−−] | |
| Operands: | Wb ∈ [W0 . . . W15]; Ws ∈ [W0 . . . W15]; | | | | | |
| | Wd ∈ [W0 . . . W15] | | | | | |
| Operation: | (Wb) − (Ws) → Wd | | | | | |
| Status Affected: | C, DC, N, OV, Z | | | | | |
| Encoding: | 0101 | 0www | wBqq | qddd | dppp | ssss |

| Description: | Subtract the contents of the source register Ws | |
|---|---|---|
| | from the contents of the base register Wb and place | |
| | the result in the destination | |
| | register Wd. | |
| | The ‘B’ bit selects byte or word operation. | |
| | The ‘s’ bits select the address of the source register. | |
| | The ‘w’ bits select the address of the base register. | |
| | The ‘d’ bits select the address of the destination | |
| | register. | |
| | The ‘p’ bits select source address mode 2. | |
| | The ‘q’ bits select destination address mode 2. | |
| | See Table 1-5 and Table 1-6 for modifier | |
| | addressing information. | |
| | Note: | The extension .b in the instruction denotes a |
| | | byte operation rather than a word operation. |
| | | You may use a .w extension to denote a word |
| | | operation, but it is not required. |

| Words: | 1 | | | |
|---|---|---|---|---|
| Cycles: | 1 | | | |
| Example: | | SUB | W5,W6,W7 | ; Subtract W5 |
| | | | | from W6 |

Before Instruction
After Instruction

TABLE 136
SUBAB: Subtract Accumulators

| Syntax: | {label:} | SUB | A | | | |
|---|---|---|---|---|---|---|
| | | | B | | | |
| Operands: | none | | | | | |
| Operation: | if (SUBAB A) then ACCA − ACCB → ACCA | | | | | |
| | if (SUBAB B) then ACCB − ACCA → ACCB | | | | | |
| Status Affected: | OA, OB, SA, SB | | | | | |
| Encoding: | 1100 | 1011 | A011 | 0000 | 0000 | 0000 |

| Description: | Subtract Accumulators and write results to selected | | | |
|---|---|---|---|---|
| | accumulator. | | | |
| | The ‘A’ bits specify the destination accumulator. | | | |
| Words: | 1 | | | |
| Cycles: | 1 | | | |
| Example: | | SUB | B | ; Subtract ACCA from ACCB, result |
| | | | | to ACCB |

Before Instruction
After Instruction

TABLE 137
SUBB: Subtract Ws from Wb with Borrow

| Syntax: | {label:} | SUBB{.b} | Wb, | Ws, | Wd | |
|---|---|---|---|---|---|---|
| | | | | [Ws], | [Wd] | |
| | | | | [Ws]++, | [Wd]++ | |
| | | | | [Ws]−−, | [Wd]−− | |
| | | | | [Ws++], | [Wd++] | |
| | | | | [Ws−−], | [Wd−−] | |
| Operands: | Wb ∈ [W0 . . . W15]; Ws ∈ [W0 . . . W15]; | | | | | |
| | Wd ∈ [W0 . . . W15] | | | | | |
| Operation: | (Wb) − (Ws) − (\overline{C}) → Wd | | | | | |
| Status Affected: | C, DC, N, OV, Z | | | | | |
| Encoding: | 0101 | 1www | wBqq | qddd | dppp | ssss |

| Description: | Subtract the contents of the source register Ws | |
|---|---|---|
| | and the Carry flag from the contents of the base | |
| | register Wb and place the result in the | |
| | destination register Wd. | |
| | The ‘B’ bit selects byte or word operation. | |
| | The ‘s’ bits select the address of the source | |
| | register. | |
| | The ‘w’ bits select the address of the base | |
| | register. | |
| | The ‘d’ bits select the address of the destination | |
| | register. | |
| | The ‘p’ bits select source address mode 2. | |
| | The ‘q’ bits select destination address mode 2. | |
| | See Table 1-5 and Table 1-6 for modifier | |
| | addressing information. | |
| | Note: | The extension .b in the instruction denotes |
| | | a byte operation rather than a word operation. |
| | | You may use a .w extension to denote a word |
| | | operation, but it is not required. |

| Words: | 1 | | | |
|---|---|---|---|---|
| Cycles: | 1 | | | |
| Example: | | SUBB | W5,W6,W7 | ; Subtract |

Before Instruction
After Instruction

TABLE 138
SUBBFW: Subtract f and Carry bit from Ww

| Syntax: | {label:} | SUBRB{.b} | f | {,Ww} | | |
|---|---|---|---|---|---|---|
| Operands: | f ∈ [0 . . . 8191] | | | | | |
| Operation: | (Ww) − (f) − (\overline{C}) → destination designated by D | | | | | |
| Status Affected: | C, DC, N, OV, Z | | | | | |
| Encoding: | 1011 | 1101 | 1BDf | ffff | ffff | ffff |

| Description: | Subtract the contents of the file register and | |
|---|---|---|
| | the carry bit from the contents of the working | |
| | register and place the result in the destination | |
| | designated by D: If the optional Ww is specified, | |
| | D = 0 and store result in Ww; otherwise, | |
| | D = 1 and store result in the file | |
| | register. | |
| | The ‘B’ bit selects byte or word operation. | |
| | The ‘D’ bit selects the destination. | |
| | The ‘f’ bits select the address of the file register. | |
| | Note: | The extension .b in the instruction denotes a |
| | | byte operation rather than a word operation. |
| | | You may use a .w extension to denote a word |
| | | operation, but it is not required. |

| Words: | 1 | | | |
|---|---|---|---|---|
| Cycles: | 1 | | | |
| Example: | | SUBRB | RAM135, | ; Subtract |
| | | | Ww | |

Before Instruction
After Instruction

TABLE 139
SUBBLS: Subtract Short Literal from Wb with Borrow

| Syntax: | {label:} | SUBB{.b} | Wb, | lit5, | Wd | |
|---|---|---|---|---|---|---|
| | | | | | [Wd] | |
| | | | | | [Wd]++ | |
| | | | | | [Wd]−− | |
| | | | | | [Wd++] | |
| | | | | | [Wd−−] | |
| Operands: | Wb ∈ [W0 . . . W15]; lit5 ∈ [0 . . . 31]; | | | | | |
| | Wd ∈ [W0 . . . W15] | | | | | |
| Operation: | (Wb) − lit5 − (\overline{C}) → Wd | | | | | |
| Status Affected: | C, DC, N, OV, Z | | | | | |
| Encoding: | 0101 | 1www | wBqq | qddd | d11k | kkkk |

| Description: | Subtract the literal operand and the Carry | |
|---|---|---|
| | bit from the contents of the base register Wb | |
| | and place the result in the destination register Wd. | |
| | The ‘B’ bit selects byte or word operation. | |
| | The ‘w’ bits select the address of the base | |
| | register. | |
| | The ‘k’ bits provide the literal operand, a five-bit | |
| | integer number. | |
| | The ‘d’ bits select the address of the destination | |
| | register. | |
| | The ‘q’ bits select destination address mode 2. | |
| | See Table 1-6 for modifier addressing | |
| | information. | |
| | Note: | The extension .b in the instruction denotes a |
| | | byte operation rather than a word operation. |
| | | You may use a .w extension to denote a word |
| | | operation, but it is not required. |

| Words: | 1 | | | |
|---|---|---|---|---|
| Cycles: | 1 | | | |
| Example: | | SUBB | W5,#12,W7 | ; Subtract |

Before Instruction
After Instruction

TABLE 140
SUBBLW: Subtract Wn from Literal with Borrow

| Syntax: | {label:} | SUBB{.b} | Slit10, | Wn | | |
|---|---|---|---|---|---|---|
| Operands: | Slit10 ∈ [−512 . . . 511]; Wn ∈ [W0 . . . W15] | | | | | |
| Operation: | Slit10 − (Wn) − (\overline{C}) → Wn | | | | | |
| Status Affected: | C, DC, N, OV, Z | | | | | |
| Encoding: | 1011 | 0001 | 1Bkk | kkkk | kkkk | dddd |

| Description: | Subtract the literal operand and the Carry | |
|---|---|---|
| | bit from the contents of the working register Wn | |
| | and place the result in the working register Wn. | |
| | The ‘B’ bit selects byte or word operation. | |
| | The ‘d’ bits select the address of the working | |
| | register. | |
| | The ‘k’ bits specify the literal operand, a signed | |
| | 10-bit number. | |
| | Note: | The extension .b in the instruction denotes a |
| | | byte operation rather than a word operation. |
| | | You may use a .w extension to denote a word |
| | | operation, but it is not required. |

| Words: | 1 | | | |
|---|---|---|---|---|
| Cycles: | 1 | | | |
| Example: | | SUBB | #123,W7 | ; Subtract |

Before Instruction
After Instruction

TABLE 141
SUBBR: Subtract Wb from Ws with Borrow

| Syntax: | {label:} | SUBBR{.b} | Wb, | Ws, | Wd | |
|---|---|---|---|---|---|---|
| | | | | [Ws], | [Wd] | |
| | | | | [Ws]++, | [Wd]++ | |
| | | | | [Ws]−−, | [Wd]−− | |
| | | | | [Ws++], | [Wd++] | |
| | | | | [Ws−−], | [Wd−−] | |
| Operands: | Wb ∈ [W0 . . . W15]; Ws ∈ [W0 . . . W15]; | | | | | |
| | Wd ∈ [W0 . . . W15] | | | | | |
| Operation: | (Ws) − (Wb) − (\overline{C}) → Wd | | | | | |
| Status | C, DC, N, OV, Z | | | | | |
| Affected: | | | | | | |
| Encoding: | 0001 | 1www | wBqq | qddd | dppp | ssss |

| Description: | Subtract the contents of the base register Wsb and | |
|---|---|---|
| | the Carry flag from the contents of the source | |
| | register Ws and place the result in the destination | |
| | register Wd. | |
| | The ‘B’ bit selects byte or word operation. | |
| | The ‘s’ bits select the address of the source | |
| | register. | |
| | The ‘w’ bits select the address of the base | |
| | register. | |
| | The ‘d’ bits select the address of the destination | |
| | register. | |
| | The ‘p’ bits select source address mode 2. | |
| | The ‘q’ bits select destination address mode 2. | |
| | See Table 1-5 and Table 1-6 for modifier | |
| | addressing information. | |
| | Note: | The extension .b in the instruction denotes a |
| | | byte operation rather than a word operation. You |
| | | may use a .w extension to denote a word |
| | | operation, but it is not required. |

| Words: | 1 | | | |
|---|---|---|---|---|
| Cycles: | 1 | | | |
| Example: | | SUBBR | W5,W6,W7 | ; Subtract W6 from W5 |
| | | | | with borrow |

Before Instruction
After Instruction

TABLE 142
SUBBRLS: Subtract Wb from Short Literal with Borrow

| Syntax: | {label:} | SUBBR{.b} | Wb, | lit5 | Wd | |
|---|---|---|---|---|---|---|
| | | | | | [Wd] | |
| | | | | | [Wd]++ | |
| | | | | | [Wd]−− | |
| | | | | | [Wd++] | |
| | | | | | [Wd−−] | |
| Operands: | Wb ∈ [W0 . . . W15]; lit5 ∈ [0 . . . 31]; | | | | | |
| | Wd ∈ [W0 . . . W15] | | | | | |
| Operation: | lit5 − (Wb) − (\overline{C}) → Wd | | | | | |
| Status Affected: | C, DC, N, OV, Z | | | | | |
| Encoding: | 0001 | 1www | wBqq | qddd | d11k | kkkk |

| Description: | Subtract the contents of the base register Wb | |
|---|---|---|
| | and the Carry flag from lit5 and place the result in | |
| | the destination register Wd. | |
| | The ‘B’ bit selects byte or word operation. | |
| | The ‘w’ bits select the address of the base | |
| | register. | |
| | The ‘k’ bits provide the literal operand, a five-bit | |
| | integer number. | |
| | The ‘d’ bits select the address of the destination | |
| | register. | |
| | The ‘q’ bits select destination address mode 2. | |
| | See Table 1-5 and Table 1-6 for modifier | |
| | addressing information. | |
| | Note: | The extension .b in the instruction denotes a |
| | | byte operation rather than a word operation. |
| | | You may use a .w extension to denote a word |
| | | operation, but it is not required. |

| Words: | 1 | | | |
|---|---|---|---|---|
| Cycles: | 1 | | | |
| Example: | | SUBBR | W5,#12,W7 | ; Subtract W5 |
| | | | | from 12 |

Before Instruction
After Instruction

TABLE 143
SUBBWF: Subtract Ww and Carry bit from f

| Syntax: | {label:} | SUBB{.b} | f | {,Ww} | | |
|---|---|---|---|---|---|---|
| Operands: | f ∈ [0 . . . 8191] | | | | | |
| Operation: | (f) − (Ww) − (\overline{C}) → destination designated by D | | | | | |
| Status Affected: | (C), DC, N, OV, Z | | | | | |
| Encoding: | 1011 | 0101 | 1BDf | ffff | ffff | ffff |

| Description: | Subtract the contents of the working register | |
|---|---|---|
| | and the carry bit from the contents of the file | |
| | register and place the result in the destination | |
| | designated by D: If the optional Ww is specified, | |
| | D = 0 and store result in Ww; otherwise, D = 1 | |
| | and store result in the file register. | |
| | The ‘B’ bit selects byte or word operation. | |
| | The ‘D’ bit selects the destination. | |
| | The ‘f’ bits select the address of the file register. | |
| | Note: | The extension .b in the instruction denotes a |
| | | byte operation rather than a word operation. |
| | | You may use a .w extension to denote a word |
| | | operation, but it is not required. |

| Words: | 1 | | | |
|---|---|---|---|---|
| Cycles: | 1 | | | |
| Example: | | SUBB | RAM135, | ; Subtract |
| | | | Ww | |

Before Instruction
After Instruction

TABLE 144
SUBFW: Subtract f from Ww

| Syntax: | {label:} | SUBR{.b} | f | {,Ww} | | |
|---|---|---|---|---|---|---|
| Operands: | f ∈ [0 . . . 8191] | | | | | |
| Operation: | (Ww) − (f) → destination designated by D | | | | | |
| Status Affected: | C, DC, N, OV, Z | | | | | |
| Encoding: | 1011 | 1101 | 0BDf | ffff | ffff | ffff |

| Description: | Subtract the contents of the file | |
|---|---|---|
| | register from the contents of the working | |
| | register and place the result in the destination | |
| | designated by D: If the optional Ww is specified, | |
| | D = 0 and store result in Ww; otherwise, D = 1 | |
| | and store result in the file register. | |
| | The ‘B’ bit selects byte or word operation. | |
| | The ‘D’ bit selects the destination. | |
| | The ‘f’ bits select the address of the file register. | |
| | Note: | The extension .b in the instruction denotes a |
| | | byte operation rather than a word operation. |
| | | You may use a .w extension to denote a word |
| | | operation, but it is not required. |

| Words: | 1 | | | |
|---|---|---|---|---|
| Cycles: | 1 | | | |
| Example: | | SUBR | RAM135, | ; Subtract |
| | | | ww | |

Before Instruction
After Instruction

TABLE 145
SUBLS: Subtract Short Literal from Wb

| Syntax: | {label:} | SUB{.b} | Wb, | lit5, | Wd | |
|---|---|---|---|---|---|---|
| | | | | | [Wd] | |
| | | | | | [Wd]++ | |
| | | | | | [Wd]−− | |
| | | | | | [Wd++] | |
| | | | | | [Wd−−] | |
| Operands: | Wb ∈ [W0 . . . W15]; lit5 ∈ [0 . . . 31]; | | | | | |
| | Wd ∈ [W0 . . . W15] | | | | | |
| Operation: | (Wb) − lit5 → Wd | | | | | |
| Status Affected: | C, DC, N, OV, Z | | | | | |
| Encoding: | 0101 | 0www | wBqq | qddd | d11k | kkkk |

| Description: | Subtract the literal operand from the contents of the | |
|---|---|---|
| | base register Wb and place the result in the | |
| | destination register Wd. | |
| | The ‘B’ bit selects byte or word operation. | |
| | The ‘w’ bits select the address of the base register. | |
| | The ‘k’ bits provide the literal operand, a five-bit | |
| | integer number. | |
| | The ‘d’ bits select the address of the destination | |
| | register. | |
| | The ‘q’ bits select destination address mode 2. | |
| | See Table 1-6 for modifier addressing information. | |
| | Note: | The extension .b in the instruction denotes |
| | | a byte operation rather than a word operation. |
| | | You may use a .w extension to denote a word |
| | | operation, but it is not required. |

| Words: | 1 | | | |
|---|---|---|---|---|
| Cycles: | 1 | | | |
| Example: | | SUB | W5,#12,W7 | ; Subtract |

Before Instruction
After Instruction

TABLE 146
SUBLW: Subtract Wn from Literal

| Syntax: | {label:} | SUB{.b} | Slit10, | Wn | | |
|---|---|---|---|---|---|---|
| Operands: | Slit10 ∈ [−512 . . . 511]; Wn ∈ [W0 . . . W15] | | | | | |
| Operation: | Slit10 − (Wn) → Wn | | | | | |
| Status Affected: | C, DC, N, OV, Z | | | | | |
| Encoding: | 1011 | 0001 | 0Bkk | kkkk | kkkk | dddd |

| Description: | Subtract the working register from the contents of the | |
|---|---|---|
| | literal operand and place the result in the working | |
| | register Wn. | |
| | The ‘B’ bit selects byte or word operation. | |
| | The ‘d’ bits select the address of the working register. | |
| | The ‘k’ bits specify the literal operand, a signed 10-bit | |
| | number. | |
| | Note: | The extension .b in the instruction denotes |
| | | a byte operation rather than a word operation. |
| | | You may use a .w extension to denote a word |
| | | operation, but it is not required. |

| | |
|---|---|
| Words: | 1 |
| Cycles: | 1 |

| | | | |
|---|---|---|---|
| Example: | SUB | #123,W7 | ; Subtract |

Before Instruction
After Instruction

TABLE 147
SUBR: Subtract Wb from Ws

| Syntax: | {label:} | SUBR{.b} | Wb, | Ws, | Wd | |
|---|---|---|---|---|---|---|
| | | | | [Ws], | [Wd] | |
| | | | | [Ws]++, | [Wd]++ | |
| | | | | [Ws]−−, | [Wd]−− | |
| | | | | [Ws++], | [Wd++] | |
| | | | | [Ws−−], | [Wd−−] | |
| Operands: | Wb ∈ [W0 . . . W15]; Ws ∈ [W0 . . . W15]; | | | | | |
| | Wd ∈ [W0 . . . W15] | | | | | |
| Operation: | (Ws) − (Wb) → Wd | | | | | |
| Status Affected: | C, DC, N, OV, Z | | | | | |
| Encoding: | 0001 | 0www | wBqq | qddd | dppp | ssss |

| Description: | Subtract the contents of the base register Wb from | |
|---|---|---|
| | the contents of the source register Ws and place the | |
| | result in the destination register Wd. | |
| | The ‘B’ bit selects byte or word operation. | |
| | The ‘s’ bits select the address of the source register. | |
| | The ‘w’ bits select the address of the base register. | |
| | The ‘d’ bits select the address of the destination | |
| | register. | |
| | The ‘p’ bits select source address mode 2. | |
| | The ‘q’ bits select destination address mode 2. | |
| | See Table 1-5 and Table 1-6 for modifier addressing | |
| | information. | |
| | Note: | The extension .b in the instruction denotes |
| | | a byte operation rather than a word operation. |
| | | You may use a .w extension to denote a word |
| | | operation, but it is not required. |

| Words: | 1 | | | |
|---|---|---|---|---|
| Cycles: | 1 | | | |
| Example: | | SUBR | W5,W6,W7 | ; Subtract W6 from W5 |

Before Instruction
After Instruction

TABLE 148
SUBRLS: Subtract Wb from Short Literal

| Syntax: | {label:} | SUBR{.b} | Wb, | lit5 | Wd | |
|---|---|---|---|---|---|---|
| | | | | | [Wd] | |
| | | | | | [Wd]++ | |
| | | | | | [Wd]−− | |
| | | | | | [Wd++] | |
| | | | | | [Wd−−] | |
| Operands: | Wb ∈ [W0 . . . W15]; lit5 ∈ [0 . . . 31]; | | | | | |
| | Wd ∈ [W0 . . . W15] | | | | | |
| Operation: | lit5 − (Wb) → Wd | | | | | |
| Status Affected: | C, DC, N, OV, Z | | | | | |
| Encoding: | 0001 | 0www | wBqq | qddd | d11k | kkkk |

| Description: | Subtract the contents of the base register Wb from | |
|---|---|---|
| | the lit5 and place the result in the destination | |
| | register Wd. | |
| | The ‘B’ bit selects byte or word operation. | |
| | The ‘w’ bits select the address of the base register. | |
| | The ‘k’ bits provide the literal operand, a five-bit | |
| | integer number. | |
| | The ‘d’ bits select the address of the destination | |
| | register. | |
| | The ‘q’ bits select destination address mode 2. | |
| | See Table 1-5 and Table 1-6 for modifier addressing | |
| | information. | |
| | Note: | The extension .b in the instruction denotes |
| | | a byte operation rather than a word operation. |
| | | You may use a .w extension to denote a word |
| | | operation, but it is not required. |

| Words: | 1 | | | |
|---|---|---|---|---|
| Cycles: | 1 | | | |
| Example: | | SUBR | W5,#12,W7 | ; Subtract W5 from 12 |

Before Instruction
After Instruction

TABLE 149
SUBWF: Subtract Ww from f

| Syntax: | {label:} | SUB{.b} | f | {,Ww} | | |
|---|---|---|---|---|---|---|
| Operands: | f ∈ [0 . . . 8191] | | | | | |
| Operation: | (f) − (Ww) → destination designated by D | | | | | |
| Status Affected: | C, DC, N, OV, Z | | | | | |
| Encoding: | 1011 | 0101 | 0BDf | ffff | ffff | ffff |

| Description: | Subtract the contents of the working register from | |
|---|---|---|
| | the contents of the file register and place the result in | |
| | the destination designated by D: If the optional Ww | |
| | is specified, D = 0 and store result in Ww; otherwise, | |
| | D = 1 and store result in the file register. | |
| | The ‘B’ bit selects byte or word operation. | |
| | The ‘D’ bit selects the destination. | |
| | The ‘f’ bits select the address of the file register. | |
| | Note: | The extension .b in the instruction denotes a |
| | | byte operation rather than a word operation. |
| | | You may use a .w extension to denote a word |
| | | operation, but it is not required. |

| Words: | 1 | | | |
|---|---|---|---|---|
| Cycles: | 1 | | | |
| Example: | | SUB | RAM135, ww | ; Subtract |

Before Instruction
After Instruction

TABLE 150
SWAP: Byte or Nibble Swap Wn

| Syntax: | {label:} | SWAP | Wn | | | |
|---|---|---|---|---|---|---|
| Operands: | Wn ∈ [W0 . . . W15] | | | | | |
| Operation: | If B=0; (Wn)<15:8> [symbol] (Wn)<7:0> | | | | | |
| | If B=1; (Wn)<7:4> [symbol] (Wn)<3:0> | | | | | |
| Status Affected: | None | | | | | |
| Encoding: | 1111 | 1101 | 1B00 | 0000 | 0000 | ssss |

| Description: | If in word mode, byte swap Wn register. | |
|---|---|---|
| | If in byte mode, nibble swap Wn register. Wn<15:8> | |
| | are unaffected. | |
| | The ‘B’ bit selects byte or word operation. | |
| | The ‘s’ bits select the address of the working | |
| | register. | |
| | Note: | The extension .b in the instruction denotes a |
| | | byte operation rather than a word operation. |
| | | You may use a .w extension to denote a word |
| | | operation, but it is not required. |

| Words: | 1 | | | |
|---|---|---|---|---|
| Cycles: | 1 | | | |
| Example: | | SWAP | W11 | ; Swap Bytes |

Before Instruction
After Instruction

TABLE 151
TBLRDH: Table Read High

| Syntax: | {label:} | TBLRDH{.b} | [Ws], | Wd | | |
|---|---|---|---|---|---|---|
| | | | [Ws]++, | [Wd] | | |
| | | | [Ws]−−, | [Wd]++ | | |
| | | | [Ws++], | [Wd]−− | | |
| | | | [Ws−−], | [Wd++] | | |
| | | | | [Wd−−] | | |
| Operands: | Ws ∈ [W0 . . . W15]; Wd ∈ [W0 . . . W15] | | | | | |
| Operation: | In Word Mode: | | | | | |
| | Program Mem [(PAGNUM),(Ws)]<23:16> → Wd <7:0> | | | | | |
| | 0 → Wd <15:8> | | | | | |
| | In Byte Mode: | | | | | |
| | If LSB(Ws)=1, 0 → Wd<7:0> | | | | | |
| | Else if LSB(Ws)=0, Program Mem [(PAGNUM),Ws)] | | | | | |
| | <23:16>→Wd<7:0> | | | | | |
| Status | None | | | | | |
| Affected: | | | | | | |
| Encoding: | 1011 | 1010 | 1Bqq | qddd | dppp | ssss |

| Description: | This instruction is used to read the contents of program | |
|---|---|---|
| | memory. | |
| | The program memory address is calculated by | |
| | concatenating the contents of the 8-bit Table Pointer | |
| | (PAGNUM) register with the contents of the Ws register. | |
| | Because the Ws value is always used as an address, the | |
| | direct form of the first operand is invalid. | |
| | The program memory word is stored in the location | |
| | indicated by the Wd operand. | |
| | For this instruction, the upper 8 bits of the program | |
| | memory word (extended with ‘0’s) are read. | |
| | The ‘B’ bit selects byte or word operation. | |
| | The ‘s’ bits select the address of the source (address) | |
| | register. | |
| | The ‘d’ bits select the address of the destination (data) | |
| | register. | |
| | The ‘p’ bits select source address mode 2. | |
| | The ‘q’ bits select destination address mode 2. | |
| | Note: | The extension .b in the instruction denotes a byte |
| | | move rather than a word move. You may use a .w |
| | | extension to denote a word move, but it is not |
| | | required. |

| Words: | 1 | | | |
|---|---|---|---|---|
| Cycles: | 2 | | | |
| Example: | | TBLRDH | W5, W6 | ; Read Program Memory High |

Before Instruction
After Instruction

TABLE 152
TBLRDL: Table Read Low

| Syntax: | {label:} | TBLRDL{.b} | [Ws], | Would | | |
|---|---|---|---|---|---|---|
| | | | [Ws]++, | [Wd] | | |
| | | | [Ws]−−, | [Wd]++ | | |
| | | | [Ws++], | [Wd]−− | | |
| | | | [Ws−−], | [Wd++] | | |
| | | | | [Wd−−] | | |
| Operands: | Ws ∈ [W0 . . . W15]; Wd ∈ [W0 . . . W15] | | | | | |
| Operation: | In Word Mode: | | | | | |
| | Program Mem [(PAGNUM),(Ws)] <15:0> → Wd | | | | | |
| | In Byte Mode: | | | | | |
| | If LSB(Ws)=1, Program Mem [(PAGNUM),Ws)] | | | | | |
| | <15:8> → Wd<7:0> | | | | | |
| | Else if LSB(Ws)=0, Program Mem [(PAGNUM),(Ws)] | | | | | |
| | <7:0> → Wd<7:0> | | | | | |
| Status | None | | | | | |
| Affected: | | | | | | |
| Encoding: | 1011 | 1010 | 0Bqq | qddd | dppp | ssss |

| Description: | This instruction is used to read the contents of program | |
|---|---|---|
| | memory. | |
| | The program memory address is calculated by | |
| | concatenating the contents of the 8-bit Table Pointer | |
| | (PAGNUM) register with the contents of the Ws register. | |
| | Because the Ws value is always used as an address, | |
| | the direct form of the first operand is invalid. | |
| | The program memory word is stored in the location | |
| | indicated by the Wd operand. | |
| | For this instruction, the lower 16 bits of the | |
| | program memory word are read. | |
| | The ‘B’ bit selects byte or word operation. | |
| | The ‘s’ bits select the address of the source (address) | |
| | register. | |
| | The ‘d’ bits select the address of the destination (data) | |
| | register. | |
| | The ‘p’ bits select source address mode 2. | |
| | The ‘q’ bits select destination address mode 2. | |
| | Note: | The extension .b in the instruction denotes a byte |
| | | move rather than a word move. You may use a .w |
| | | extension to denote a word move, but it is |
| | | not required. |

| Words: | 1 | | |
|---|---|---|---|
| Cycles: | 2 | | |
| Example: | TBLRDL | W5, W6 | ; Read Program Mememory Low |

Before Instruction
After Instruction

TABLE 153
TBLWTH: Table Write High

| Syntax: | {label:} | TBLWTH | Ws, | [Wd] | | |
|---|---|---|---|---|---|---|
| | | | [Ws], | [Wd]++ | | |
| | | | [Ws]++, | [Wd]−− | | |
| | | | [Ws]−−, | [Wd++] | | |
| | | | [Ws++], | [Wd−−], | | |
| | | | [Ws−−], | | | |
| Operands: | Ws ∈ [W0 . . . W15]; Wd ∈ [W0 . . . W15] | | | | | |
| Operation: | In Word Mode: | | | | | |
| | (Ws)<7:0>→ Program Mem [(PAGNUM),(Wd)] <23:16> | | | | | |
| | In Byte Mode: | | | | | |
| | If LSB(Wd)=1, NOP | | | | | |
| | Else if LSB(Wd)=0, Ws<7:0>→ Program Mem | | | | | |
| | [(PAGNUM),(Wd)]<23:16> | | | | | |
| Status | None | | | | | |
| Affected: | | | | | | |
| Encoding: | 1011 | 1011 | 1Bqq | qddd | dppp | ssss |

| Description: | This instruction is used to write the contents of | |
|---|---|---|
| | Program Memory. | |
| | The program memory address is calculated by | |
| | concatenating the contents of the 8-bit Table Pointer | |
| | (PAGNUM) register with the result of the Wd operand. | |
| | Because the Wd value is always used as an address, the | |
| | direct form of the second operand is invalid. | |
| | The contents of the Ws operand are stored into program | |
| | memory at the location indicated by the Wd operand. | |
| | This instruction writes the upper 8 bits of the program | |
| | memory word. | |
| | The ‘B’ bit selects byte or word operation. | |
| | The ‘s’ bits select the address of the source (data) | |
| | register. | |
| | The ‘d’ bits select the address of the destination (address) | |
| | register. | |
| | The ‘p’ bits select source address mode 2. | |
| | The ‘q’ bits select destination address mode 2. | |
| | Note: | The extension .b in the instruction denotes a byte |
| | | move rather than a word move. You may use a .w |
| | | extension to denote a word move, but it is not |
| | | required. |

| Words: | 1 | | |
|---|---|---|---|
| Cycles: | 2 | | |
| Example: | TBLWTH | W5, W6 | ; Load Program Memory High |

Before Instruction
After Instruction

TABLE 154
TBLWTL: Table Write Low

| Syntax: | {label:} | TBLWTL{.b} | Ws, | [Wd] | | |
|---|---|---|---|---|---|---|
| | | | [Ws], | [Wd]++ | | |
| | | | [Ws]++, | [Wd]−− | | |
| | | | [Ws]−−, | [Wd++] | | |
| | | | [Ws++], | [Wd−−], | | |
| | | | [Ws−−], | | | |
| Operands: | Ws ∈ [W0 . . . W15]; Wd ∈ [W0 . . . W15] | | | | | |
| | S ∈ [0, 1] (default = 0) | | | | | |
| Operation: | In Word Mode: | | | | | |
| | (Ws) → Program Mem [(PAGNUM),(Wd)] <15:0> | | | | | |
| | In Byte Mode: | | | | | |
| | If LSB(Ws)=1, Ws<7:0> → Program Mem | | | | | |
| | [(PAGNUM),(Wd)] <15:8> | | | | | |
| | Else if LSB(Wd)=0, Ws<7:0> → Program Mem | | | | | |
| | [(PAGNUM),(Wd)] <7:0> | | | | | |
| Status | None | | | | | |
| Affected: | | | | | | |
| Encoding: | 1011 | 1011 | 0Bqq | qddd | dppp | ssss |

| Description: | This instruction is used to program the contents of | |
|---|---|---|
| | Program Memory. | |
| | The program memory address is calculated by | |
| | concatenating the contents of the 8-bit Table Pointer | |
| | (PAGNUM) register with the result of the Wd operand. | |
| | Because the Wd value is always used as an address, | |
| | the direct form of the second operand is invalid. | |
| | The contents of the Ws operand are stored into program | |
| | memory at the location indicated by the Wd operand. | |
| | This instruction writes the lower 16 bits of the program | |
| | memory word. | |
| | The ‘B’ bit selects byte or word operation. | |
| | The ‘s’ bits select the address of the source (data) | |
| | register. | |
| | The ‘d’ bits select the address of the destination (address) | |
| | register. | |
| | The ‘p’ bits select source address mode 2. | |
| | The ‘q’ bits select destination address mode 2 | |
| | Note: | The extension .b in the instruction denotes a byte |
| | | move rather than a word move. You may use a .w |
| | | extension to denote a word move, but it is not |
| | | required. |

| Words: | 1 | | | |
|---|---|---|---|---|
| Cycles: | 2 | | | |
| Example: | | TBLWTL | W5, W6 | ; Load Program Memory Low |

Before Instruction
After Instruction

TABLE 155
ULNK: De-allocate Stack Frame

| Syntax: | {label:} | ULNK | | | | |
|---|---|---|---|---|---|---|
| Operands: | None | | | | | |
| Operation: | W14→ W15; | | | | | |
| | [W15++] → W14 | | | | | |
| Status Affected: | None | | | | | |
| Encoding: | 1111 | 1010 | 1000 | 0000 | 0000 | 0000 |

| | |
|---|---|
| Description: | This instruction de-allocates a stack frame and adjusts |
| | the stack pointer and frame pointer. |
| Words: | 1 |
| Cycles: | 1 |

| | | |
|---|---|---|
| Example: | ULNK | ; Deallocate stack |
| | | frame |

TABLE 156
TRAP: Trap to vector(lit1) with lit16

| Syntax: | {label:} | TRAP | lit1, | lit16 | | |
|---|---|---|---|---|---|---|
| Operands: | lit1 ∈ [0,1]; | | | | | |
| | lit16 ∈ [0 . . . 65535] | | | | | |
| Operation: | (PC) +2 → PC, | | | | | |
| | (PC<15:0>) → TOS, | | | | | |
| | (W15)+2 → W15 | | | | | |
| | (PC<23:16>) → TOS, | | | | | |
| | (W15)+2 → W15 | | | | | |
| | Vector(lit1) → PC; | | | | | |
| | lit16 → TOS | | | | | |
| Status Affected: | None | | | | | |
| Encoding: | 0000 | 101n | kkkk | kkkk | kkkk | kkkk |

| | |
|---|---|
| Description: | This instruction allows instruction expansion. |
| | The instruction will call a vector location with |
| | the lit16 value pushed onto the stack. |
| Words: | 1 |
| Cycles: | 2 |

| | | |
|---|---|---|
| Example: | TRAP | #0,#0x5A5A |

TABLE 157
XOR: Exclusive or Wb and Ws

| Syntax: | {label:} | XOR{.b} | Wb, | Ws, | Wd | |
|---|---|---|---|---|---|---|
| | | | | [Ws], | [Wd] | |
| | | | | [Ws]++, | [Wd]++ | |
| | | | | [Ws]−−, | [Wd]−− | |
| | | | | [Ws++], | [Wd++] | |
| | | | | [Ws−−], | [Wd−−] | |
| Operands: | Wb ∈ [W0 . . . W15]; Ws ∈ [W0 . . . W15]; Wd ∈ | | | | | |
| | [W0 . . . W15] | | | | | |
| Operation: | (Wb).XOR.(Ws) → Wd | | | | | |
| Status Affected: | N, Z | | | | | |
| Encoding: | 0110 | 1www | wBqq | qddd | dppp | ssss |

| Description: | Compute Exclusive OR of the contents of the source | |
|---|---|---|
| | register Ws and the contents of the base register4 Wb | |
| | and place the result in the destination register Wd. | |
| | The ‘B’ bit selects byte or word operation. | |
| | The ‘s’ bits select the address of the source register. | |
| | The ‘w’ bits select the address of the base register. | |
| | The ‘d’ bits select the address of the | |
| | destination register. | |
| | The ‘p’ bits select source address mode 2. | |
| | The ‘q’ bits select destination address mode 2. | |
| | See Table 1-5 and Table 1-6 for modifier | |
| | addressing information. | |
| | Note: | The extension .b in the instruction denotes a |
| | | byte operation rather than a word operation. |
| | | You may use a .w extension to denote a |
| | | word operation, but it is not required. |

| | |
|---|---|
| Words: | 1 |
| Cycles: | 1 |

| | | | |
|---|---|---|---|
| Example: | XOR | W5,W6,W7 | ; Xor |

Before Instruction
After Instruction

TABLE 158
XORLS: Exclusive Or Wb and Short Literal

| Syntax: | {label:} | XOR{.b} | Wb, | lit5, | Wd | |
|---|---|---|---|---|---|---|
| | | | | | [Wd] | |
| | | | | | [Wd]++ | |
| | | | | | [Wd]−− | |
| | | | | | [Wd++] | |
| | | | | | [Wd−−] | |
| Operands: | Wb ∈ [W0 . . . W15]; lit5 ∈ [0 . . . 31]; Wd ∈ | | | | | |
| | [W0 . . . W15] | | | | | |
| Operation: | (Wb).XOR.lit5 → Wd | | | | | |
| Status Affected: | N, Z | | | | | |
| Encoding: | 0110 | 1www | wBqq | qddd | d11k | kkkk |

| Description: | Compute the Exclusive Or of the contents of | |
|---|---|---|
| | the base register Wb and the literal operand | |
| | and place the result in the destination register Wd. | |
| | The ‘B’ bit selects byte or word operation. | |
| | The ‘w’ bits select the address of the base register. | |
| | The ‘k’ bits provide the literal operand, a | |
| | five-bit integer number. | |
| | The ‘d’ bits select the address of the | |
| | destination register. | |
| | The ‘q’ bits select destination address mode 2. | |
| | See Table 1-6 for modifier addressing information. | |
| | Note: | The extension .b in the instruction denotes a |
| | | byte operation rather than a word operation. |
| | | You may use a .w extension to denote a |
| | | word operation, but it is not required. |

| | |
|---|---|
| Words: | 1 |
| Cycles: | 1 |

| | | | |
|---|---|---|---|
| Example: | XOR | W5,#12,W7 | ; |
| | | | Exclusive |
| | | | Or |

Before Instruction
After Instruction

TABLE 159
XORLW: Exclusive Or Literal and Wn

| Syntax: | {label:} | XOR{.b} | Slit10, | Wn | | |
|---|---|---|---|---|---|---|
| Operands: | Slit10 ∈ [−512 . . . 511]; Wn ∈ [W0 . . . W15] | | | | | |
| Operation: | Slit10.XOR.(Wn) → Wn | | | | | |
| Status Affected: | N, Z | | | | | |
| Encoding: | 1011 | 0010 | 1Bkk | kkkk | kkkk | dddd |

| Description: | Compute the Exclusive Or of the literal operand and | |
|---|---|---|
| | the contents of the working register Wn and place the | |
| | result in the working register Wn. | |
| | The ‘B’ bit selects byte or word operation. | |
| | The ‘d’ bits select the address of the working register. | |
| | The ‘k’ bits specify the literal operand, | |
| | a signed 10-bit number. | |
| | Note: | The extension .b in the instruction denotes |
| | | a byte operation rather than a word operation. |
| | | You may use a .w extension to denote a |
| | | word operation, but it is not required. |

| | |
|---|---|
| Words: | 1 |
| Cycles: | 1 |

| | | | |
|---|---|---|---|
| Example: | XOR | #123,W7 | ; |
| | | | Exclusive |
| | | | Or |

Before Instruction
After Instruction

TABLE 160
XORWF: Exclusive Or f and Ww

| Syntax: | {label:} | ADD{.b} | f | {,Ww} | | |
|---|---|---|---|---|---|---|
| Operands: | f ∈ [0 . . . 8191] | | | | | |
| Operation: | (f).XOR.(Ww) → destination designated by D | | | | | |
| Status Affected: | N, Z | | | | | |
| Encoding: | 1011 | 0110 | 1BDf | ffff | ffff | ffff |

| Description: | Compute the XOR of the contents of the working | |
|---|---|---|
| | register and the contents of the file register and place | |
| | the result in the destination designated by D: If the | |
| | optional Ww is specified, D = 0 and store result | |
| | in Ww; otherwise, D = 1 and store | |
| | result in the file register. | |
| | The ‘B’ bit selects byte or word operation. | |
| | The ‘D’ bit selects the destination. | |
| | The ‘f’ bits select the address of the file register. | |
| | Note: | The extension .b in the instruction denotes a |
| | | byte operation rather than a word operation. |
| | | You may use a .w extension to denote |
| | | a word operation, but it is not required. |

| | |
|---|---|
| Words: | 1 |
| Cycles: | 1 |

| | | | |
|---|---|---|---|
| Example: | XOR | RAM135, | ; |
| | | Ww | Exclusive |
| | | | Or |

Before Instruction
After Instruction

Instruction Operation Details

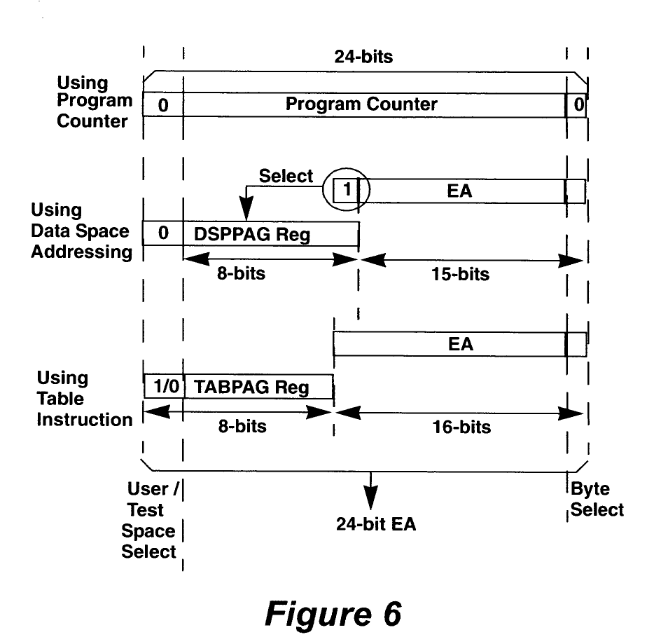

An explanation of the instruction operation details are enhanced by reference to several figures, specifically FIGS. 6-23 and 174.

Implied W Register Utilization

Certain W registers have implied utilization in the instruction set. W0-W3 are used as the operands for DSP instructions. W4-W7 are used as the prefetch addresses for DSP instructions. W14 is the frame pointer utilized by the LNK and ULNK instructions. W15 acts as the stack pointer.

TABLE 161
Implied W Register Utilization

| Register | |
|---|---|
| W0 | MAC operand; Default Ww |
| W1 | MAC operand |
| W2 | MAC operand; MULWF product LSB |
| W3 | MAC operand; MULWF product MSB |
| W4 | MAC prefetch address |
| W5 | MAC prefetch address |
| W6 | MAC prefetch address |
| W7 | MAC prefetch address |
| W8 | MAC prefetch offset |
| W9 | MAC write back address |
| W10 | |
| W11 | |
| W12 | |
| W13 | |
| W14 | Frame Pointer |
| W15 | Stack Pointer |

Default Ww

W0 serves as the default Ww register for file register instructions. In this capacity, Ww acts as the W register in C16 and C18 compatible instructions.

Byte Operations

When a byte is moved into a W register, the byte is written into the LSbyte of the register and the MSbyte is left alone. Byte operations on the registers will operate on the LSbyte of the register. The MSbyte of the register is left alone. For byte operations, the status flags will be adjusted to respond to the <7:0> bits of the register. For example, the carry bit will originate from ALU<7>. When a byte is moved from a W register, the source is the LSbyte and it overwrites the target byte in the memory. Other bytes are not affected.

Byte Operations in Bit Instructions—W Registers

The Bit operation instructions that use the W registers can address bytes or words without the requirement for a B bit. These instructions include BCLR, BSET, BSW.C, BSW.Z, BTG, BTST.C, BTST.Z, BTSTS.C, BTSTS.Z, BTST.C and BTST.Z. This works by making the bit field selection look at the LSB of the word or byte being addressed by the W register. If the address of the word or byte LSB is one, then zero that LSB and set the MSB of the bit selection field.
W0=1000
W1=1001
BCLR W0,#5; Clear 5th bit in word 1000
BCLR W0,#13; Clear 13th bit in word 1000
BCLR W1,#5; Clear 5th bit in byte 1001, same as
   clear 13th bit in word 1000.
BCLR W1,#13; Invalid, same as
   clear 13th bit in word 1000.
      Using 10-Bit Literals

The instructions that have 10-bit literals have byte and word modes. For byte instructions, the literal is truncated at 8 bits. If the user specifies a signed value {−128 . . . −1}, the truncated 2's compliment is coded. Unsigned values may range from {0 . . . 255}. For word instructions, the literal is sign extended to 16-bits.

TABLE 162
10-BIT LITERAL CODING

| Literal | If B=0 (Word) | If B=1 (Byte) |
|---|---|---|
| Value | kk kkkk kkkk | kk kkkk kkkk |
| −512 | 10 0000 0000 | n/a |
| −511 | 10 0000 0001 | n/a |
| −129 | 11 0111 1111 | n/a |
| −128 | 11 1000 0000 | 11 1000 0000 |
| −2 | 11 1111 1110 | 11 1111 1110 |
| −1 | 11 1111 1111 | 11 1111 1111 |
| 0 | 00 0000 0000 | 00 0000 0000 |
| 1 | 00 0000 0001 | 00 0000 0001 |
| 2 | 00 0000 0010 | 00 0000 0010 |
| 127 | 00 0111 1111 | 00 0111 1111 |
| 128 | 00 1000 0000 | 00 1000 0000 |
| 255 | 00 1111 1111 | 00 1111 1111 |
| 256 | 01 0000 0000 | n/a |
| 511 | 11 1111 1111 | n/a |

Program Memory Addressing

Program memory contains a user space and a test space. The most significant bit (PMA<23>) of the program memory address selects user/test space. The least significant bit (PMA<0>) selects a byte for data addressing and table addressing modes.

Program memory addresses coded into instructions are coded in a lit23 or Slit16 format. The lit23 format encodes a direct address that represents PMA<22:0>. PMA<23> is not user space and is not encoded. The Slit16 format encodes an instruction count offset. The is added to the PC to generate the next address. The Slit15 format does not encode the PMA<0>bit as it represents an instruction count. The Slit16<15> bit is sign extended when to the PC.

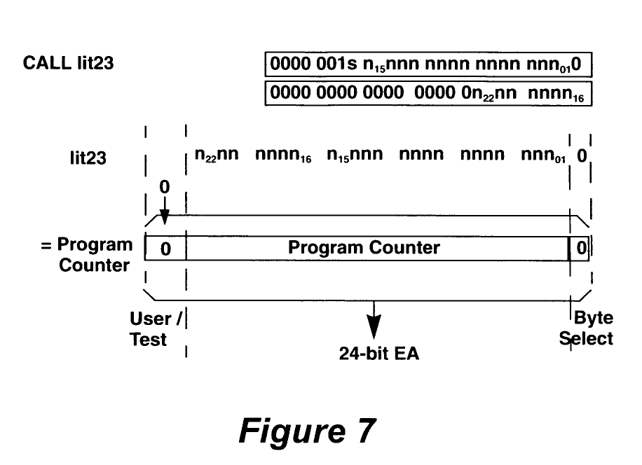

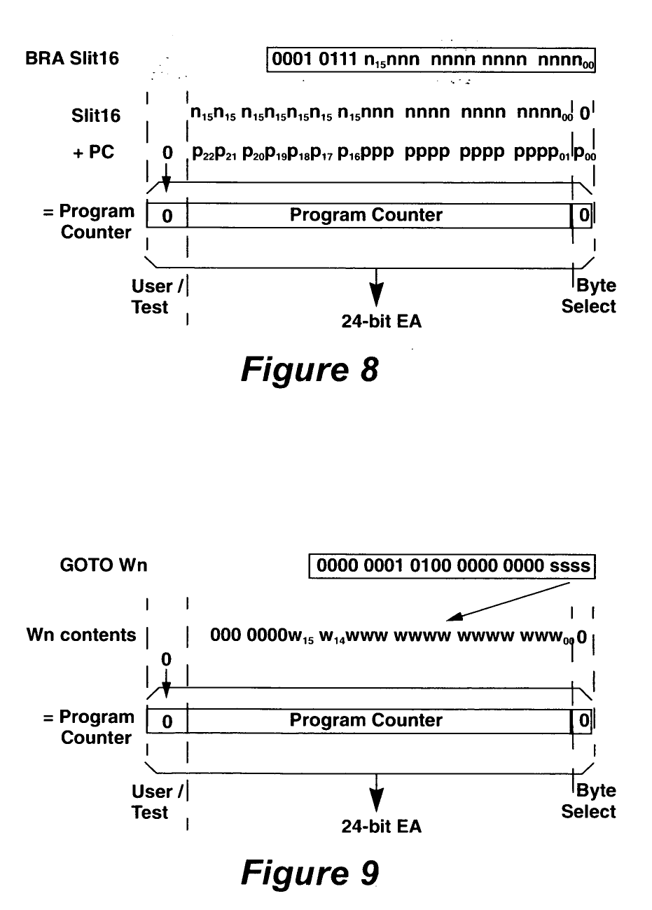

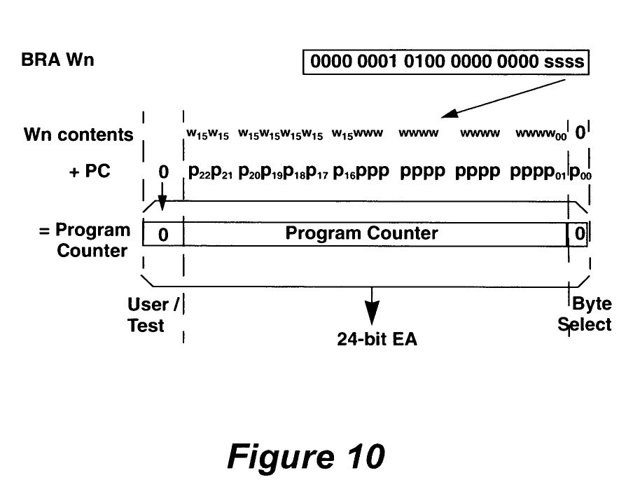

FIG. 6 shows a block diagram illustrating a Program Memory Addressing Scheme. FIG. 7 shows a block diagram illustrating a illustrating a “CALL lit23” Map to the am Counter. FIG. 8 shows a block diagram illustrating a “BRA SLIT16” Map to the Program Counter. FIG. 9 shows a block diagram illustrating a “GOTO Wn” Map to the Program Counter. FIG. 10 shows a block diagram illustrating a “BRA Wn” Map to the Program Counter.

Shadows

Shadow registers are 1 level deep mini-stack registers attached to several key user registers. A PUSH.S will copy the user registers to the shadows and a POP.S will copy the shadows back to the user registers. Shadow registers are attached to W0 . . . W15, the STATUS register, and the LCR,LSR,LER registers used by DO and REPEAT instructions.

MAC

The MAC instruction is a pipelined instruction. The first pipeline stage generates the effective addresses of the X and Y data and fetches the X and Y data. The second pipeline stage computes the multiply and accumulate, storing the results into the accumulator.

Forms

The MAC instruction, and variants, can have several formats. Fundamentally, it must specify a target accumulator and a multiplicand and multiplier (ACC=X*Y). For Example:
MAC A,W0*W1

The MAC can also specify a prefetch for the next X or Y operand. The assembler can discriminate the X or Y prefetch based on the register used as the indirect address. [W4] or [W5] specifies the X prefetch and [W6] or [W7] specifies the Y prefetch. If a prefetch is specified, it must have a prefetch destination register. Legal forms of prefetch include:
MAC A,W0*W1,W0, [W4];X only
MAC A,W0*W1,W1, [W6];Y only
MAC A,W0*W1,W0, [W4],W1,[W6];X,Y

A write back can be specified. The write back uses the W9 register as the destination address. In this way, the assembler can discern the write back option.
MAC A,W0*W1, [W9];WBack only
MAC A,W0*W1,W0,[W6],W9 ;Y,WBack
MAC A,W0*W1,W0,[W4],[W9];X,Wback
MAC A,W0*W1,W0,[W4],W1,[W6],W9
   Squaring Operations

Squaring in the DSP engine is done with the square PLA opcodes. These are variants of the MAC and MPY opcodes.

For Example:
MAC B,W0*W0,W0,[W4],W1,[W6]+=2,W9

This instruction will multiply W0 time W0 and write the result in ACCB while doing the prefetch and write back. The assembler can tell that a MAC or MPY should translate to SQRAC or SQR instructions by finding the Wm*Wm format.

File Registers

File registers include parts of user RAM area and the Special Function Registers (SFR). The file register space is 8192 bytes. The file registers are directly addressable using the f field in the file register instructions.

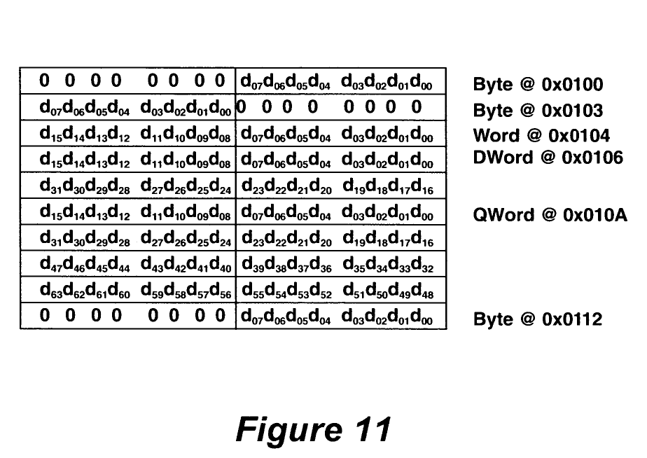

All data addresses are byte addresses. When using byte instructions, the bytes are addressed directly. When using word instructions, the address must be word aligned. The least significant address bit must be 0. FIG. 11 shows a block diagram illustrating a Data Alignment in Memory.

Carry and Borrow in PIC Instructions

The PIC uses one unified carry and borrow bit, the C bit in the status register. The following examples show the functionality of the carry/borrow.

If a normal add generates a carry out of the 15th bit, the carry bit is set.

$$\begin{matrix}ADD 1 + 65535 \\ 1 = 0000 \; 0000 \; 0000 \; 0001 \\ \underline{+ 65535 = 1111 \; 1111 \; 1111 \; 1111} \\ 0 = 0000 \; 0000 \; 0000 \; 0000 \\ C = 1 \\ Z = 1 \\ N = 0 \\ OV = 0\end{matrix}$$

An ass carry will use the carry bit as an additional input. If the add generates a carry out of the 15th bit, the carry bit is set.

$$\begin{matrix}\begin{matrix}ADD C 1 + 65535 , no carry in \\ 1 = 0000 \; 0000 \; 0000 \; 0001 \\ + 65535 = 1111 \; 1111 \; 1111 \; 1111 \\ \underline{C = 0} \\ 0 = 0000 \; 0000 \; 0000 \; 0000 \\ C = 1 \\ Z = 1 \\ N = 0 \\ OV = 0\end{matrix} \\ \begin{matrix}ADD C 1 + 65535 , carry in \\ 1 = 0000 \; 0000 \; 0000 \; 0001 \\ + 65535 = 1111 \; 1111 \; 1111 \; 1111 \\ \underline{C = 1} \\ 0 = 0000 \; 0000 \; 0000 \; 0000 \\ C = 1 \\ Z = 0 \\ N = 0 \\ OV = 0\end{matrix}\end{matrix}$$

A subtract instruction inverts the bits of the subtrahend, forces the carry in to 1 and does an add. This has the effect of generating the 2's compliment of the subtrahend. If the add generates a carry out of the 15th bit, the carry bit is set. However, in the case of a subtract, the carry bit is viewed as a BORROW bit. So a 1 in the carry bit indicates no borrow. A 0 in the carry bit indicates a borrow.

Subtracting 3−2 generates no borrow, so the C bit is 1.

$$\begin{matrix}SUB 3 - 2 \\ 3 = 0000 \; 0000 \; 0000 \; 0011 \\ + not 2 = 1111 \; 1111 \; 1111 \; 1101 \\ \underline{C = 1} \\ 1 = 0000 \; 0000 \; 0000 \; 0001 \\ C = 1 \\ Z = 0 \\ N = 0 \\ OV = 0\end{matrix}$$

Subtracting 3−3 generates no borrow, so the C bit is 1. The Z bit indicates a zero result.

$$\begin{matrix}SUB 3 - 3 \\ 3 = 0000 \; 0000 \; 0000 \; 0011 \\ + not 3 = 1111 \; 1111 \; 1111 \; 1100 \\ \underline{C = 1} \\ 0 = 0000 \; 0000 \; 0000 \; 0000 \\ C = 1 \\ Z = 1 \\ N = 0 \\ OV = 0\end{matrix}$$

Subtracting 2−3 generates a borrow, so the C bit is 0. The N bit indicates a negative result.

$$\begin{matrix}SUB 2 - 3 \\ 2 = 0000 \; 0000 \; 0000 \; 0010 \\ + not 3 = 1111 \; 1111 \; 1111 \; 1100 \\ \underline{C = 1} \\ - 1 = 1111 \; 1111 \; 1111 \; 1111 \\ C = 0 \\ Z = 0 \\ N = 1 \\ OV = 0\end{matrix}$$

A subtract with borrow instruction inverts the bits of the subtrahend, leaves the carry at its previous state and does an add. This has the effect of generating the 2's compliment of the subtrahend while inputing a BORROW bit.

Subtract/borrow 3−2 with no borrow in generates no borrow, so the C bit is 1.

$$\begin{matrix}SUBB 3 - 2 , no borrow in \\ 3 = 0000 \; 0000 \; 0000 \; 0011 \\ + not 2 = 1111 \; 1111 \; 1111 \; 1101 \\ \underline{C = 1} \\ 1 = 0000 \; 0000 \; 0000 \; 0001 \\ C = 1 \\ Z = 0 \\ N = 0 \\ OV = 0\end{matrix}$$

Subtract/borrow 3−2 with borrow in generates no borrow, so the C bit is 1. The result is 0, so the Z bit is set.

$$\begin{matrix}SUBB 3 - 2 , borrow in \\ 3 = 0000 \; 0000 \; 0000 \; 0011 \\ + not 2 = 1111 \; 1111 \; 1111 \; 1101 \\ \underline{C = 0} \\ 0 = 0000 \; 0000 \; 0000 \; 0000 \\ C = 1 \\ Z = 1 \\ N = 0 \\ OV = 0\end{matrix}$$

Subtract/borrow 2−3 with borrow in generates a borrow, so the C bit is 0. The N bit indicates a negative result.

$$\begin{matrix}SUBB 2 - 3 , borrow in \\ 2 = 0000 \; 0000 \; 0000 \; 0010 \\ + not 3 = 1111 \; 1111 \; 1111 \; 1100 \\ \underline{C = 0} \\ - 2 = 1111 \; 1111 \; 1111 \; 1110 \\ C = 0 \\ Z = 0 \\ N = 1 \\ OV = 0\end{matrix}$$

Overflow Conditions

When doing 2's compliment mathematics, the OV flag indicates an overflow. When doing multi-word math, the overflow is ignored until the most significant operation.

$$\begin{matrix}\begin{matrix}SUB 32760 -- 32768 \\ 32760 = 0111 \; 1111 \; 1111 \; 1000 \\ + not 32768 = 0111 \; 1111 \; 1111 \; 1111 \\ \underline{C = 1} \\ - 8 = 1111 \; 1111 \; 1111 \; 1000 \\ C = 0 \\ Z = 0 \\ N = 1 \\ OV = 1\end{matrix} \\ \begin{matrix}SUB - 32760 - 32767 \\ - 32760 = 1000 \; 0000 \; 0000 \; 1000 \\ + not 32767 = 1000 \; 0000 \; 0000 \; 0001 \\ \underline{ C = 1} \\ 10 = 0000 \; 0000 \; 0000 \; 1010 \\ C = 1 \\ Z = 0 \\ N = 0 \\ OV = 1\end{matrix}\end{matrix}$$

Branch Conditions

Conditional branch instructions are valid after compare or subtract instructions. The compare is minuend-subtrahend and the condition tests are in the same order. For example, BGT will be true if the minuend is greater than the subtrahend or (minuend>subtrahend).

TABLE 163
Table 163: Branch conditions

| Instruction | | Status Test |
|---|---|---|
| BRA | C, Slit16 | C |
| BRA | GE, Slit16 | (\overline{N}&&\overline{OV}) ∥ (N&&OV) |
| BRA | GEU, Slit16 | C |
| BRA | GT, Slit16 | (\overline{Z}&&\overline{N}&&\overline{OV}) ∥ (\overline{Z}&&N&&OV) |
| BRA | GTU, Slit16 | C&&\overline{Z} |
| BRA | LE, Slit16 | Z ∥ (\overline{N}&&OV) ∥ (N&&\overline{OV}) |
| BRA | LEU, Slit16 | \overline{C}∥ Z |
| BRA | LT, Slit16 | (N&&OV) ∥ (N&&\overline{OV}) |
| BRA | LTU, Slit16 | \overline{C} |
| BRA | N, Slit16 | N |
| BRA | NC, Slit16 | \overline{C} |
| BRA | NN, Slit16 | \overline{N} |
| BRA | NOV, Slit16 | \overline{OV} |
| BRA | NZ, Slit16 | \overline{Z} |
| BRA | OV, Slit16 | OV |
| BRA | Z, Slit16 | Z |

TABLE 164
EXAMPLE BRANCH COMPARISON TESTS

| Minu | Subtr | C | Z | N | OV | LT | LTU | LE | LEU | GE | GEU | GT | GTU |
|---|---|---|---|---|---|---|---|---|---|---|---|---|---|
| 3 | 2 | 1 | 0 | 0 | 0 | 0 | 0 | 0 | 0 | 1 | 1 | 1 | 1 |
| 3 | 3 | 1 | 1 | 0 | 0 | 0 | 0 | 1 | 1 | 1 | 1 | 0 | 0 |
| 2 | 3 | 0 | 0 | 1 | 0 | 1 | 1 | 1 | 1 | 0 | 0 | 0 | 0 |
| 32760 | −32768 | 0 | 0 | 1 | 1 | 0 | 1 | 0 | 1 | 1 | 0 | 1 | 0 |
| -or- | 32768 | | | | | | | | | | | | |
| 32760 | | | | | | | | | | | | | |
| −32760 | 32767 | 1 | 0 | 0 | 1 | 1 | 0 | 1 | 0 | 0 | 1 | 0 | 1 |
| -or- | 32767 | | | | | | | | | | | | |
| 32776 | | | | | | | | | | | | | |

Stack Operation

The dsPIC stack is a software stack implemented in user RAM area. While the device has provisions to allow pointer manipulation on any of the 16 W registers, W15 is the assumed stack pointer.

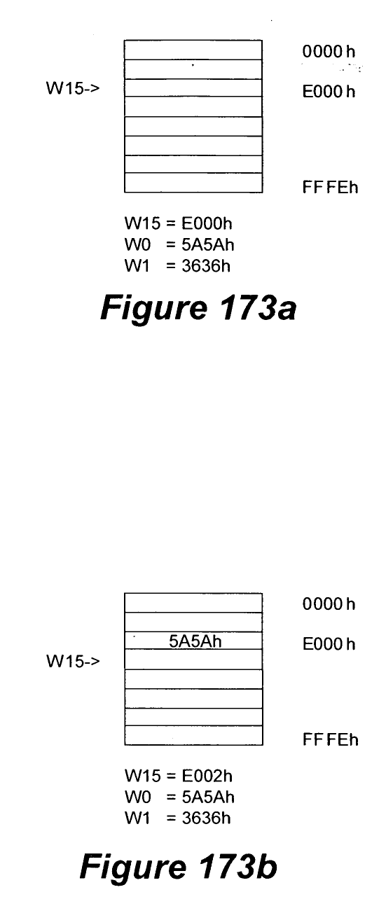

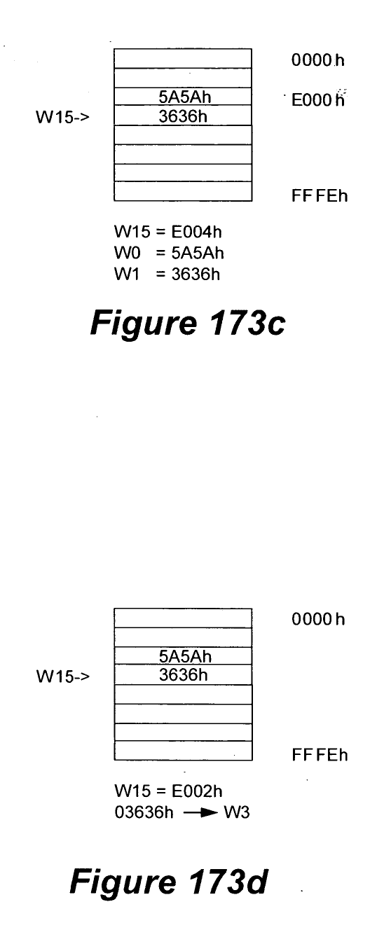

The stack starts at lower memory and grows towards high memory. The stack pointer points to the next available location. The stack pointer is manipulated with the source and destination addressing modes as shown in Table 192 and Table 193. With respect to FIGS. 173a-d, a push is MOV W0,[W15]++ and a pop is MOV [W15−−],W0.

FIG. 173a shows a block diagram illustrating a stack pointer at initialization. FIG. 173b shows a block diagram illustrating a stack pointer after a PUSH operation (MOV W0,[W15]++). FIG. 173c shows a block diagram illustrating a stack pointer after a PUSH operation (MOV W1,[W15]++). FIG. 173d shows a block diagram illustrating a stack pointer after a POP operation (MOV [W15−−,W3).

Multi-Word Move Operations

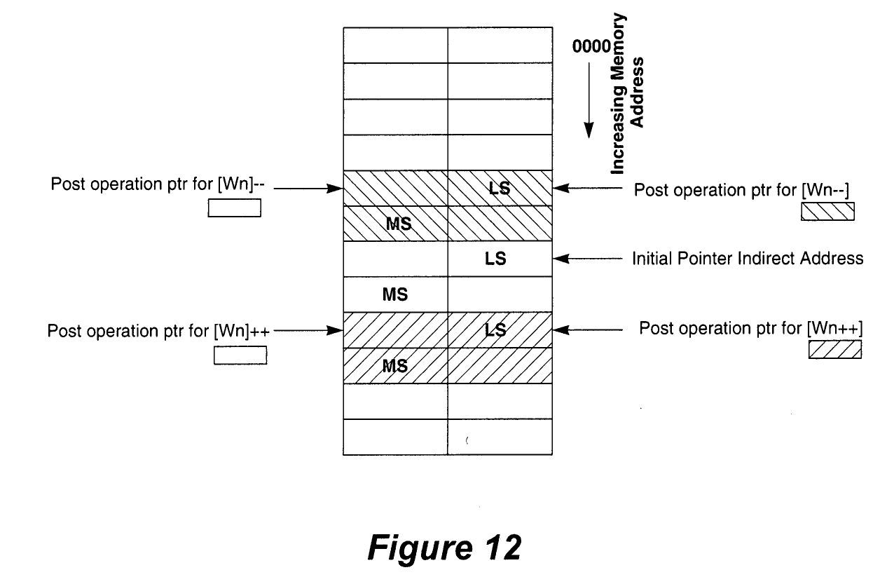

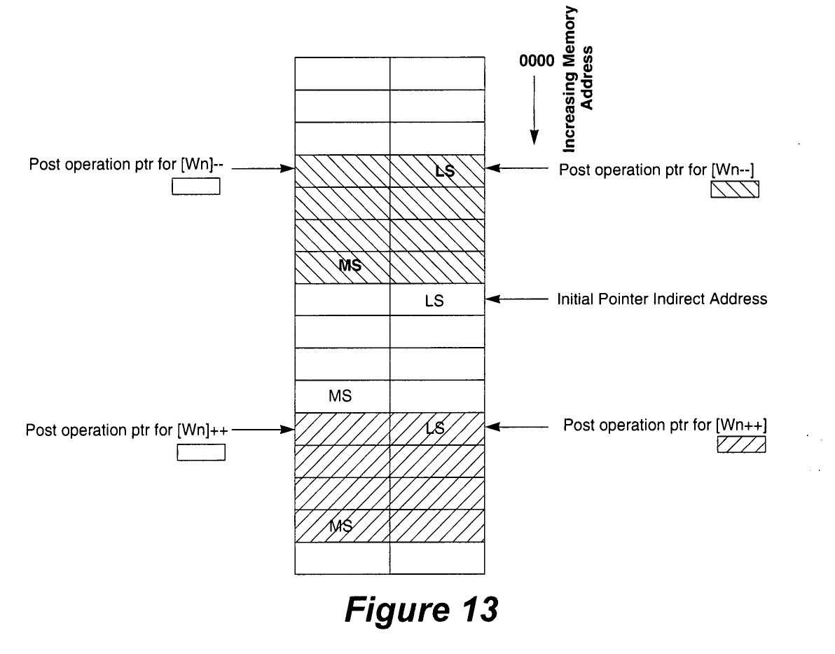

The multi-word move instructions manipulated with the source and destination addressing modes as shown in Table 192 and Table 193. FIG. 12 shows a block diagram illustrating a MOV.D operation. FIG. 13 shows a block diagram illustrating a MOV.Q operation.

TABLE 165
STDW OPERATION

| Instr. | | | | | | |
|---|---|---|---|---|---|---|
| Cycle | Ws | [Ws] | [Ws++] | [Ws−−] | [Ws]++ | [Ws]−− |
| Q1 | | Ws=Ws+2 | Ws=Ws+6 | Ws=Ws−2 | | |
| Q2 | W(nd)? Ws | W(nd+1)? (Ws) | W(nd+1)? (Ws) | Ws(nd+1)? (Ws) | W(nd)? (Ws) | W(nd)? (Ws) |
| | | | | | Ws=Ws+2 | Ws=Ws+2 |
| Q3 | | Ws=Ws−2 | Ws=Ws−2 | Ws=Ws−2 | | |
| Q4 | W(nd+1)? W(s+1) | W(nd)? (Ws) | W(nd)? (Ws) | W(nd)? (Ws) | W(nd+1)? (Ws) | W(nd+1)? (Ws) |
| | | | | | Ws=Ws+2 | Ws=Ws−6 |

TABLE 166
LDDW OPERATION

| Instr. | | | | | | |
|---|---|---|---|---|---|---|
| Cycle | Ws | [Ws] | [Ws++] | [Ws−−] | [Ws]++ | [Ws]−− |
| Q1 | | Ws=Ws+2 | Ws=Ws+6 | Ws=Ws−2 | | |
| Q2 | Ws? W(nd) | (Ws)? W(nd+1)∈ | (Ws)? W(nd+1) | (Ws)? W(nd+1) | (Ws)? W(nd) | (Ws)? W(nd) |
| | | | | | Ws=Ws+2 | Ws=Ws+2 |
| Q3 | | Ws=Ws−2 | Ws=Ws−2 | Ws=Ws−2 | | |
| Q4 | W(s+1) ? W(nd+1) | (Ws)? W(nd) | (Ws)? W(nd) | (Ws)? W(nd) | (Ws)? W(nd+1) | (Ws)? W(nd+1) |
| | | | | | Ws=Ws+2 | Ws=Ws−6 |

TABLE 167
STQW OPERATION

| Instr. | | | | | | |
|---|---|---|---|---|---|---|
| Cycle | Ws | [Ws] | [Ws++] | [Ws−−] | [Ws]++ | [Ws]−− |
| Q1 | | Ws=Ws+6 | Ws=Ws+14 | Ws=Ws−2 | | |
| Q2 | W(nd)? Ws | W(nd+3)? (Ws) | W(nd+3)? (Ws) | W(nd+3)? (Ws) | W(nd)? (Ws) | W(nd)? (Ws) |
| | | | | | Ws=Ws+2 | Ws=Ws+2 |
| Q3 | | Ws=Ws−2 | Ws=Ws−2 | Ws=Ws−2 | | |
| Q4 | W(nd+1)? W(s+1) | W(nd+2)? (Ws) | W(nd+2)? (Ws) | W(nd+2)? (Ws) | W(nd+1)? (Ws) | W(nd+1)? (Ws) |
| | | | | | Ws=Ws+2 | Ws=Ws+2 |
| Q1 | | Ws=Ws−2 | Ws=Ws−2 | Ws=Ws−2 | | |
| Q2 | W(nd+2)? W(s+2) | W(nd+1)? (Ws) | W(nd+1)? (Ws) | W(nd+1)? (Ws) | W(nd+2)? (Ws) | W(nd+2)? (Ws) |
| | | | | | Ws=Ws+2 | Ws=Ws+2 |
| Q3 | | Ws=Ws−2 | Ws=Ws−2 | Ws=Ws−2 | | |
| Q4 | W(nd+3)? W(s+3) | W(nd)? (Ws) | W(nd)? (Ws) | W(nd)? (Ws) | W(nd+3)? (Ws) | W(nd+3)? (Ws) |
| | | | | | Ws=Ws+2 | Ws=Ws−14 |

TABLE 168
LDQW OPERATION

| Instr. | | | | | | |
|---|---|---|---|---|---|---|
| Cycle | Ws | [Ws] | [Ws++] | [Ws−−] | [Ws]++ | [Ws]−− |
| Q1 | | Ws=Ws+6 | Ws=Ws+14 | Ws=Ws−2 | | |
| Q2 | Ws? W(nd) | W(s+3)? W(nd+3) | W(s+3)? W(nd+3) | W(s+3)? W(nd+3) | W(nd)? (Ws) | W(nd)? (Ws) |
| | | | | | Ws=Ws+2 | Ws=Ws+2 |
| Q3 | | Ws=Ws−2 | Ws=Ws−2 | Ws=Ws−2 | | |
| Q4 | W(s+1)? W(nd+1) | W(s+2)? W(nd+2) | W(s+2)? W(nd+2) | W(s+2)? W(nd+2) | W(s+1)? W(nd+1) | W(s+1)? W(nd+1) |
| | | | | | Ws=Ws+2 | Ws=Ws+2 |
| Q1 | | Ws=Ws−2 | Ws=Ws−2 | Ws=Ws−2 | | |
| Q2 | W(s+2)? W(nd+2) | W(s+1)? W(nd+1) | W(s+1)? W(nd+1) | W(s+1)? W(nd+1) | W(s+2)? W(nd+2) | W(s+2)? W(nd+2) |
| | | | | | Ws=Ws+2 | Ws=Ws+2 |
| Q3 | | Ws=Ws−2 | Ws=Ws−2 | Ws=Ws−2 | | |
| Q4 | W(s+3)? W(nd+3) | Ws? W(nd) | Ws? W(nd) | Ws? W(nd) | W(s+3)? W(nd+3) | W(s+3)? W(nd+3) |
| | | | | | Ws=Ws+2 | Ws=Ws−14 |

Link and Unlink Instructions

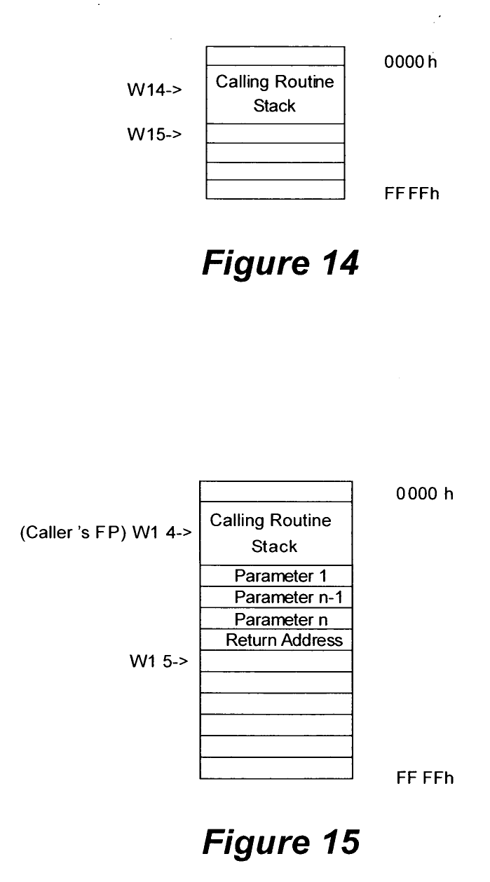

The link and unlink instructions assume that W15 is a stack pointer and W14 is a frame pointer. The link instruction is used during a calling sequence. FIG. 14 shows a block diagram illustrating a stack at the beginning of a calling sequence. Before calling the subroutine, the parameters of the routine are pushed on the stack.

PUSH W0 ;Push parameter 1
PUSH W1 ;Push parameter n−1
PUSH W2 ;Push parameter n
CALL SUBR

FIG. 15 shows a block diagram illustrating a stack at the entry to a routine.

SUBR: LNK 2 ;Allocate 2 words

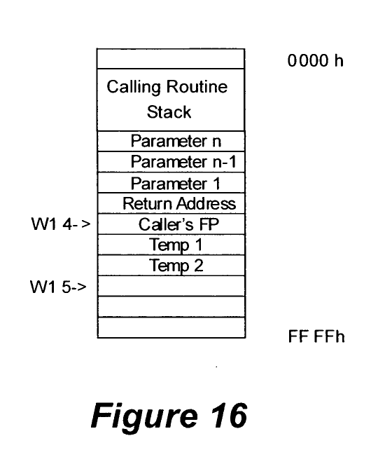

The LNK instruction will push the calling routines FP onto the stack. The new FP will be set to point to the current stack pointer. Then the literal is subtracted from the stack pointer which reserves the amount of memory allocated. FIG. 16 shows a block diagram illustrating a stack after a LNK instruction.

Inside of the routine, the stack is used to save values. [W14+n] will access the Temp locations used by the routine. [W14−n] is used to access the parameters.

At the end of the routine, the ULNK instruction will copy the FP to the stack pointer then POP the callers FP back to the FP.

ULNK ;De-allocate frame

This returns the stack back to the state in FIG. 15.

A return instruction will return to the caller. The caller is responsible for removing the parameters from the stack.

RETURN
POP W2 ;Unload parameter 1
POP W1 ;Unload parameter n−1
POP W0 ;Unload parameter n

This returns the stack back to the state in FIG. 14.
Multi-Word Shift Instructions

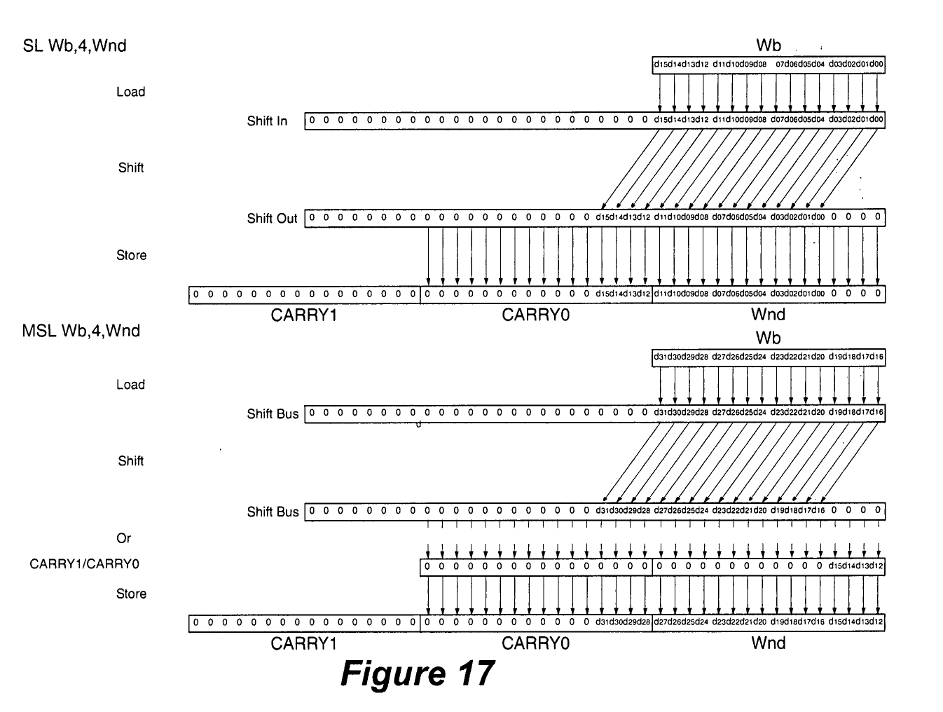

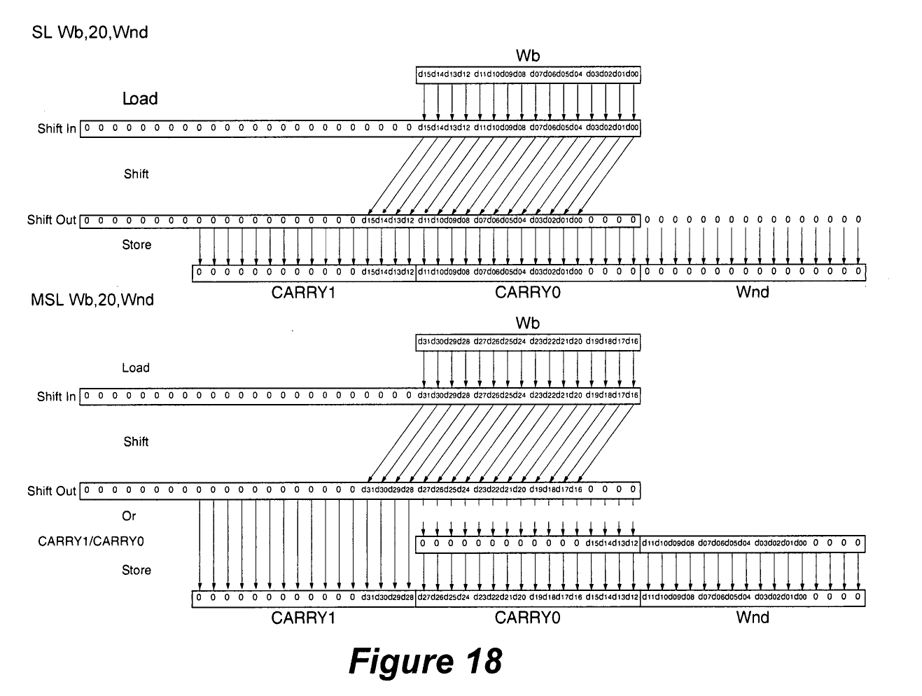

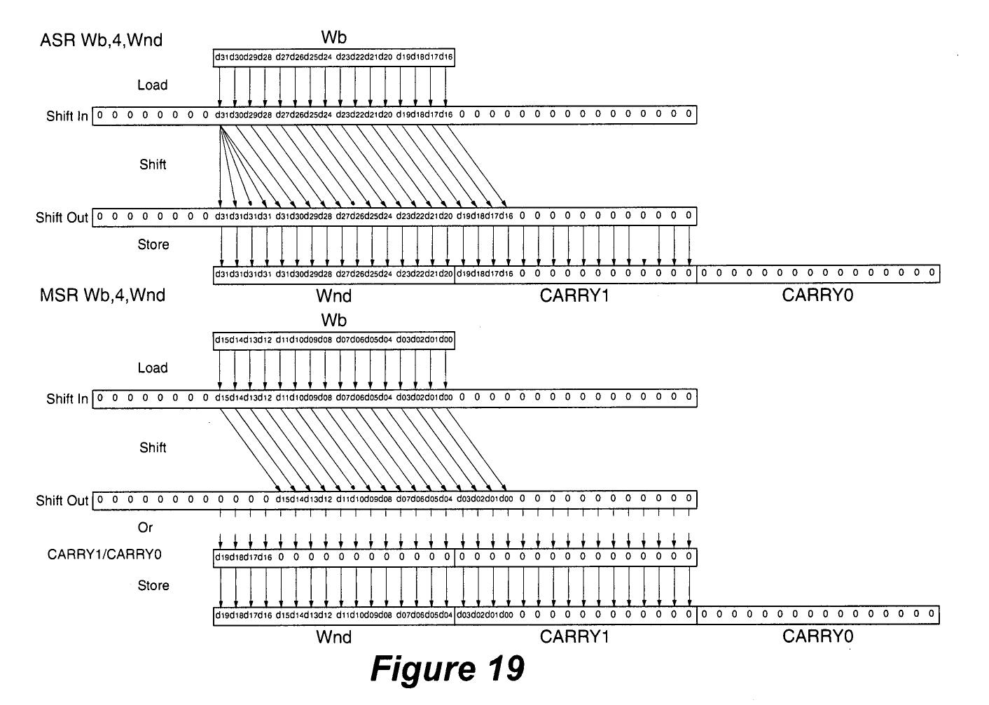

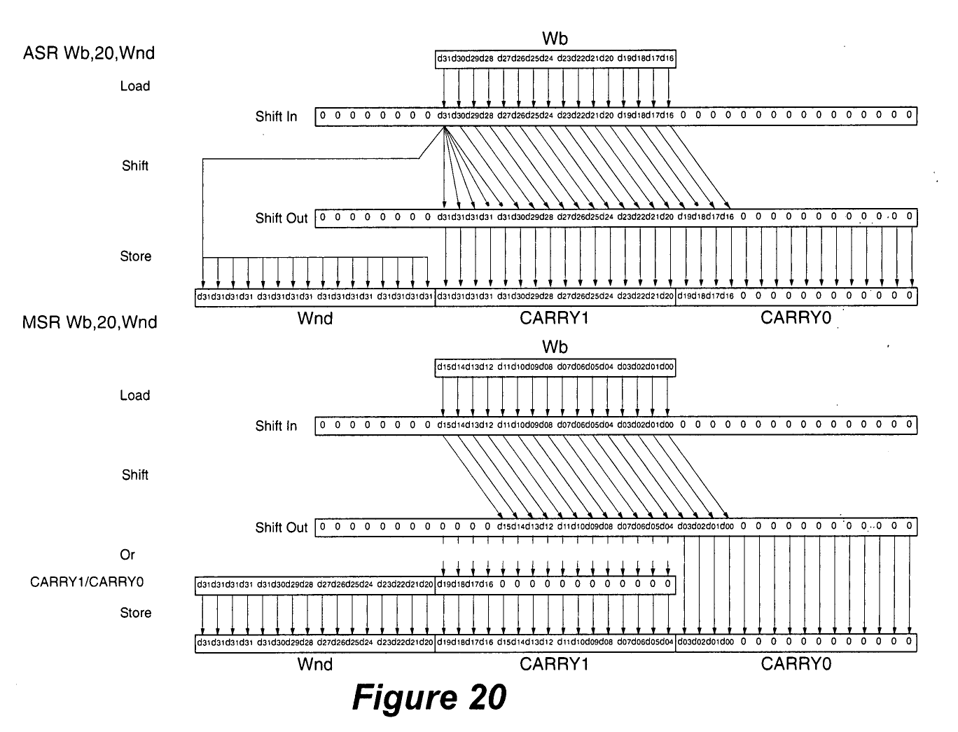

The CARRY1 and CARRY0 registers hold the temporary values of the shift. FIG. 17 shows a block diagram illustrating a Multi-Word Left Shift by 4 Instruction Execution. FIG. 18 shows a block diagram illustrating a Multi-Word Left Shift by 20 Instruction Execution. FIG. 19 shows a block diagram illustrating a Multi-Word Right Shift by 4 Instruction Execution. FIG. 20 shows a block diagram illustrating a Multi-Word Right Shift by 20 Instruction Execution. The multi word shift instructions rely on additional special registers.

32-Bit Left Shifts

The multi-word left shift instructions utilize the shifter associated with the ACCn registers. The instruction can shift 0 to 31 positions. Although the shifter can only implement shifts of up to 15 positions to the left, by rearranging the storing into the destination registers an apparent shift of 31 positions may be obtained.

The Multi-Word Left Shift By 4 Instruction Execution (see FIG. 17) provides an example where the shift amount is 15 or less. The Wnd destination register is aligned with the source and the CARRY0 register contains the shift out results. The CARRY1 register is unused and remains cleared. When the next 16-bit word is shifted, the results are OR'ed with the contents of the CARRY0 register, providing the shift in from the previous shift. The SLMK instruction may be repeated for each 16-bit segment of the multi-word shift.

The Multi-Word Left Shift By 20 Instruction Execution (see FIG. 18) provides an example where the shift amount is 16 or more. Here, the Wnd destination register is aligned to the right of the source, CARRY0 is aligned with the source and the CARRY1 register contains the shift out results. When the next 16-bit word is shifted, the results are OR'ed with the contents of the CARRY1 and CARRY0 register, providing the shift in from the previous shift. The SLMK instruction may be repeated for each 16-bit segment of the multi-word shift.

Note the shifter is shifting (20-16), making the shift equivalent to the previous example. When the instruction detects a shift value greater than 15, it is only necessary to realign the result registers and perform a smaller shift.

32-Bit RIGHT Shifts

The multi-word right shift instructions are similar to the left shifts. The Multi-Word Right Shift By 4 Instruction Execution (see FIG. 19) provides an example where the shift amount is 15 or less. The Wnd destination register is aligned with the source and the CARRY1 register contains the shift out results. The CARRY0 register is unused and remains cleared. When the next 16-bit word is shifted, the results are OR'ed with the contents of the CARRY1 register, providing the shift in from the previous shift. The SLMK instruction may be repeated for each 16-bit segment of the multi-word shift.

The Multi-Word Right Shift By 20 Instruction Execution (see FIG. 20) provides an example where the shift amount is 16 or more. Here, the Wnd destination register is aligned to the left of the source, CARRY1 is aligned with the source and the CARRY0 register contains the shift out results. When the next 16-bit word is shifted, the results are OR'ed with the contents of the CARRY1 and CARRY0 register, providing the shift in from the previous shift. The SLMK instruction may be repeated for each 16-bit segment of the multi-word shift.

Note that the examples given show arithmetic shifts. If logical shifts are used, zeros would replace the sign bits.

16-Bit Shifts

The ASR, LSR and SL instructions allow for shifts of 16-bit words. The shift value should be limited to 15 positions by the user for useful results.

Multi-Word Shifts on Words Longer Than 32 Bits

The MSL and MSR instructions allow for shifts of words greater than 32 bits. This may be useful for IP addresses or encription keys. Note that the shift is still limited up to 31 positions. For example, to shift a 64 bit word:

```
; W3...W0 - source word (ms...ls)
; W7...W4 - destination word (ms...ls)
; W8 - shift value (0..31)
Code:  LSR  W3,W8,W7
    MSR  W2,W8,W6
    MSR  W1,W8,W5
    MSR  W0,W8,W4
```

Multi-Word Rotates

Because the CARRY registers are readable, the multi-word shift instructions may be used for rotates. For example, to left rotate a 16 bit word:

| ; W1 - source word | |
|---|---|
| ; W0 - destination word (default Ww) | |
| ; W8 - rotate value (0..15) | |
| Code: | SL W1,W8,W0 |
| | IOR CARRY0,Ww |

For example, to left rotate a 32 bit word:

| ; W1...W0 - source word (ms...ls) | |
|---|---|
| ; W3...W2 - destination word (ms...ls) | |
| ; W4 - rotate value (0..31) | |
| ; W5,W6 - temporaries | |
| Code: | SL W0,W4,W2 |

| | |
|---|---|
| MSL | W1,W4,W3 |
| MOV | CARRY0,W5 |
| MOV | CARRY1,W6 |
| IOR | W5,W2,W2 ;carry0+dest(ls) |
| IOR | W6,W3,W3 ;carry1+dest(ms) |

Using the MSL and MSR instructions, rotates of greater word lengths may be achieved.

DSP Data Formats

Integer and Fractional Data

The dsPIC DSP core supports integer and fractional data operations. Data format selection is made by the IF bit in the DSP control register CORCON<0>. Setting this bit to “1” selects integer mode; setting this bit to “0” selects fractional mode.

Integer data is inherently represented as a signed two's-complement value, where the MSB is defined as a sign bit. Generally speaking, the range of an N-bit two's complement integer is −2^{N-1} to 2^{N-1}−1. For a 16-bit integer, the data range is −32768 (0x8000) to 32767 (0x7FFF), including 0 (see FIG. 1). For a 32-bit integer, the data range is −2,147,483,648 (0x8000 0000) to 2,147,483,645 (0x7FFF FFFF).

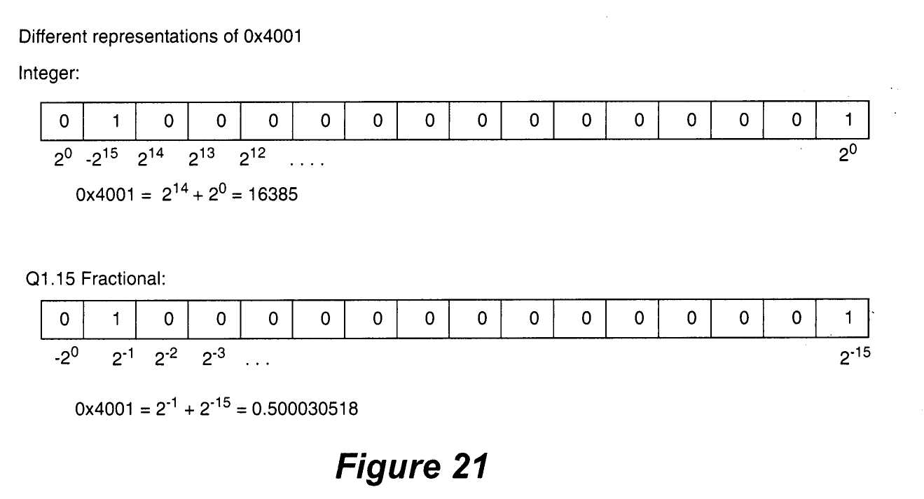

When the dsPIC is in fractional mode, data is represented as a two's complement fraction where the MSB is defined as a sign bit and the radix point is implied to lie just after the sign bit (Q1.X format). The range of an N-bit two's complement fraction with this implied radix point is −1.0 to (1-2^{1-N}). For a 16-bit fraction, the Q1.15 data range is −1.0 (0x8000) to 0.999969482 (0x7FFF), including 0 (see FIG. 1) and has a precision of 3.01518×10⁻⁵. In fractional mode, the 16×16 dsPIC multiplier generates a Q1.31 product which has a precision of 4.65661×10⁻¹⁰. FIG. 21 shows a block diagram illustrating a 16-Bit integer and fractional modes.

Super Saturation Mode

The SATMOD bit, CORCON<3>, enables Super Saturation mode and expands the dynamic range of the accumulators by using 8 guard bits. When the SATMOD bit is set to “1”, Super Saturation mode is enabled and the 40-bit accumulators support an integer range of −5.498×10¹¹ (0x80 0000 0000) to 5.498×10¹¹ (0x7F FFFF FFFF). In fractional mode, the guard bits of the accumulator do not modify the location of the radix point and the 40-bit accumulators use Q9.31 fractional format. Note that all fractional operation results are stored in the 40-bit accumulator justified with a Q1.31 radix point. As in integer mode, the guard bits merely increase the dynamic range of the accumulator. Q9.31 fractions have a range of −256.0 (0x80 0000 0000) to (256.0−4.65661×10⁻¹⁰) (0x7F FFFF FFFF). See Section 2.3.3 of the Core DOS for a description of the dsPIC overflow and saturation modes.

Scaling and Normalizing With FBCL Instruction

To minimize quantization errors that are associated with data processing using DSP instructions, it is important to utilize the complete available resolution of the dsPIC register set. This may require scaling data up to avoid underflows (i.e., when processing data from a 12-bit ADC) or scaling data down to avoid overflows (i.e., when sending data to a 10-bit DAC). The scaling which must be performed to minimize quantization errors depends on the dynamic range of the input data which is operated on, and the requirements of the dynamic range of the output data. At times these conditions may be known apriori and fixed scaling may be employed. Other times, scaling conditions may be not be fixed or known, and then dynamic scaling must be used to process data.

The Find First Bit Change Left (FBCL) instruction can effeciently be used to perform dynamic scaling. The FBCL function determines the exponent of the byte or word which it operates on (namely the amount which the value may be shifted before overflowing), and stores the exponent such that it may be used to later scale the value by shifting. The exponent is determined by detecting the first bit change starting from the sign bit and working towards the LSB. Scaling Examples shows data with various dynamic ranges, their exponents, and the value after scaling each data to maximize the dynamic range.

TABLE 169
SCALING EXAMPLES

| | | Scaled Value for |
|---|---|---|
| | | Max Dynamic Range |
| Data Value | Exponent | (Data Value << Exponent) |
| 0x0001 | 14 | 0x4000 |
| 0x0002 | 13 | 0x4000 |
| 0x0004 | 12 | 0x4000 |
| 0x0100 | 6 | 0x4000 |
| 0x0101 | 6 | 0x4040 |
| 0x01FF | 6 | 0x7FC0 |
| 0x0806 | 3 | 0x4030 |
| 0x2007 | 1 | 0x400E |
| 0x4800 | 0 | 0x4800 |
| 0x7000 | 0 | 0x7000 |
| 0x8000 | 0 | 0x8000 |
| 0x900A | 0 | 0x900A |
| 0xE001 | 2 | 0x8004 |
| 0xFF07 | 7 | 0x8380 |
| 0xFFFF | 0 | 0xFFFF* |

*A “hole” where FBCL fails to detect the correct exponent

As a practical example, assume that block processing is performed on a sequence of data with very low dynamic range stored in Q1.15 fractional format. To minimize quantization errors, the data may be scaled up to prevent any quantization loss which may occur as it is processed. The FBCL instruction can be executed on the sample with the largest magnitude to determine the optimal scaling value for processing the data. Note that scaling the data up is performed by left shifting the data (see Section 2.2 of the Core DOS for a description of the Barrel Shifter). This is demonstrated with the code snippet below.

| ; assume W0 contains the largest absolute value of the data | |
|---|---|
| block | |
| ; assume W4 points to the beginning of the data block | |
| ; assume the block of data contains BLOCK_SIZE words | |
| ; determine the exponent to use for scaling | |
| FBCL | W0, W2 ; store exponent in W2 |
| ; scale the entire data block by the optimal amount before | |
| processing | |
| DO | SCALE_LOOP, BLOCK_SIZE |
| MOV | [W4], W1 |
| ; move the next data sample to W1 | |
| SLW | W1, W2, W3 |
| ; shift W1 by W2 bits and store to W3 | |
| SCALE_LOOP: | |
| MOV | W3, [W4]++ |

;store scaled input (overwrite original)
; now process the data
; (processing block goes here)

Accumulator Normalization With FBCL

The process of scaling a quantized value for its maximum dynamic range is known as normalization (the data in the third column in Table 169: Scaling Examples, contains normalized data). Accumulator normalization is a technique used to ensure that the accumulator is properly aligned before storing data from the accumulator, and the FBCL instruction facilitates this function.

The two 40-bit accumulators each have 8 guard bits which expand the accumulator from Q1.31 to Q9.31 when operating in Super Saturation mode. Even in Super Saturation mode the Store Accumulator (SAC) instruction only stores 16-bit data (in Q1.15 format) from ACC<31:16>.

Proper data alignment for storing the contents of the accumulator may be achieved by scaling the accumulator down if the guard bits are in use, or scaling the accumulator up if all of the accumulator high bits are not being used. To perform such scaling, the FBCL instruction must operate on the guard bits in byte mode and it must operate on the high accumulator in word mode. If a shift is required, the ALU's 40-bit shifter is employed using the SFTAC instruction to perform the scaling. Listed below is a code snippet for accumulator normalization.

| ; assume an operation in ACCA has just completed (status bits | |
|---|---|
| are intact) | |
| ; assume the processor is in super saturation mode | |
| ; assume W4 points to the ACCA guard byte (0x44) | |
| ; assume W5 points to the ACCA high word (0x42) | |
| BOA FBCL_GUARD | ; if overflow we right shift |
| FBCL_HI: | |
| FBCL [W5], W0 | ; extract exponent for left shift |
| BRA SHIFT_ACC | ; branch to the shift |
| FBCL_GUARD: | |
| FBCL.B [W4], W0 | ; extract exponent for right shift |
| ADDLS.B W0, 8, W0 | ; adjust the sign for right shift |
| SHIFT_ACC: | |
| SFTAC W0 | ; shift the accumulator to normalize |

The above code assumes that negative values are returned by FBCL to facilitate scaling up.
DO Operations

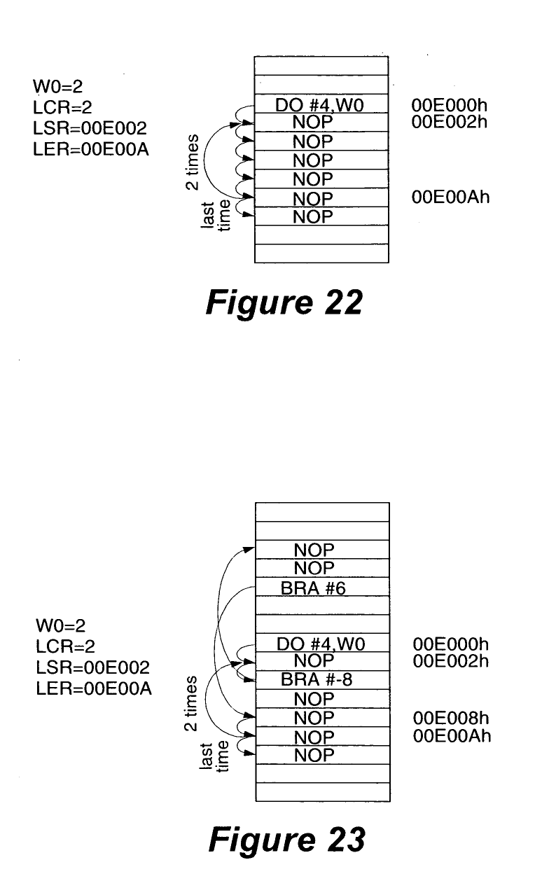

The DO instructions implement simple looping. The instruction will execute a set of instructions a certain number of times. The loop count is selected with a constant or a W register. The loop will be executed n+1 times. For a W register, only the LS 14-bits are significant. The DO instruction loads the LSR register with the value of the PC after the DO instruction. It adds the loop offset to that PC and loads that value to the LER register. It then continues to execute code starting with PC+2 until the PC matches the LER. When PC matches LER, the loop count is compared to negative. If not, the PC is loaded with the LSR value to branch back to the loop start. The loop count is decremented. When the loop count compares negative, the next sequential instruction executes. The instructions in the loop need not be consecutive. FIG. 22 shows a block diagram illustrating a DO operation. FIG. 23 shows a block diagram illustrating an alternate embodiment of the DO operation.

The instruction set coding is illustrated with reference to Tables 2 through 162 which depict the PLA mnemonic for each instruction, its assembly syntax, a corresponding description and its corresponding 24 bit opcode. Each of these opcodes is unique and provides a basis for the instruction fetch/decode 110 to derive and transmit different control signals to each processor element to selectively involve that element in the instruction processing. Table 188 sets forth status flag operations for the instruction set.

The instruction set may be grouped into the following functional categories: move instructions; math instructions; rotate/shift instructions; bit instructions; DSP instructions; skip instructions; flow instructions and stack instructions.

Table 190 depicts addressing modes for source registers. Table 191 depicts addressing modes for destination registers. Table 190 depicts offset addressing modes for WSO source registers. Table 193 depicts offset addressing modes for WSO destination registers. Tables 194 through 199 depict examples of prefetch operations and MAC operations. Collectively, the Tables illustrate the composition of the instruction op-code, the mnemonics that are assigned to the opcodes and details of the operation of the instruction.

The following terms, used in the Appendices, are intended to specify an illustrative embodiment of a processor, such as a digital signal controller, that may be used to implement the instruction set according to the present invention: “RoadRunner” and “dsPIC.” Other embodiments may be implemented as a matter of design choice.

Address Generator Units

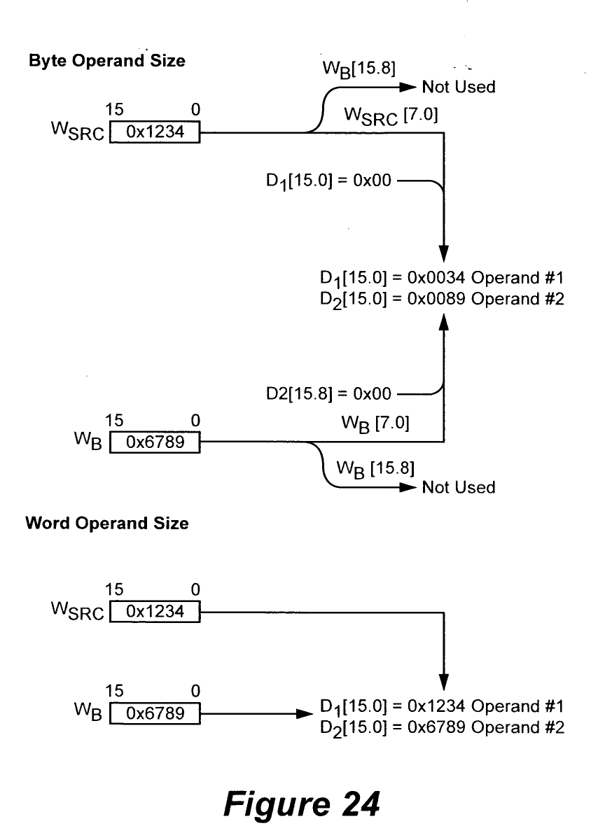

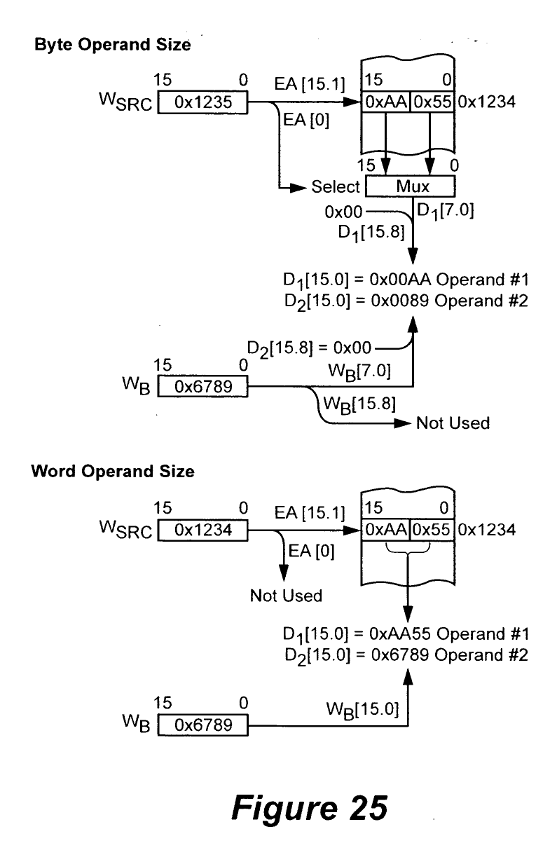

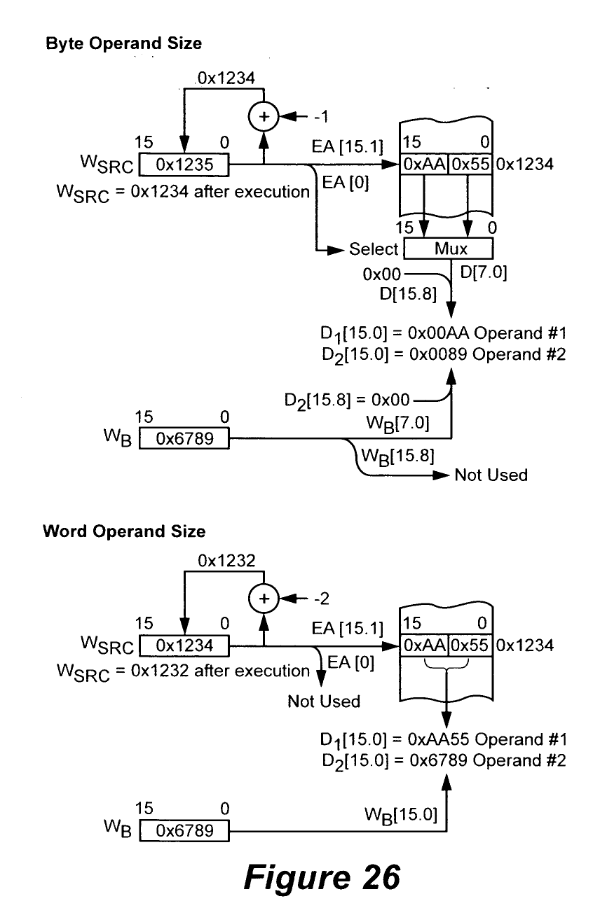

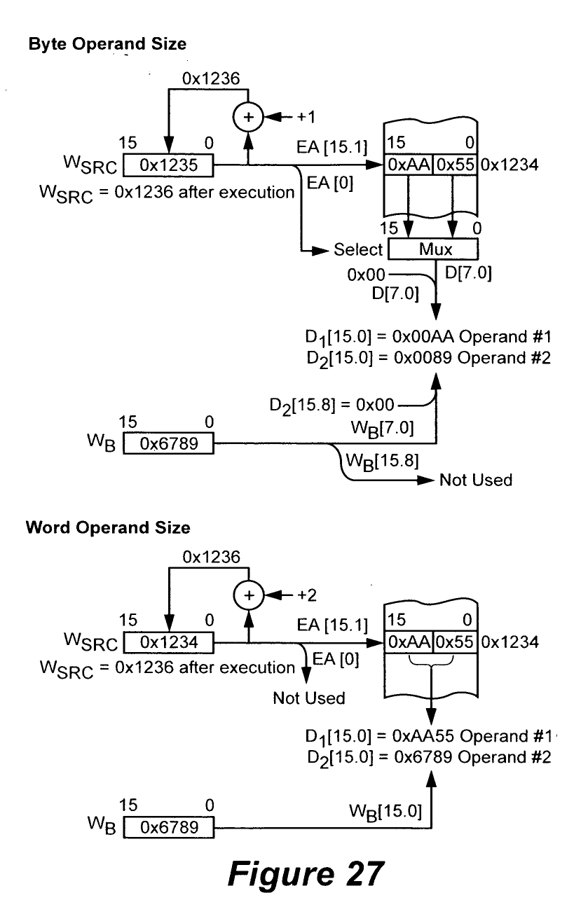

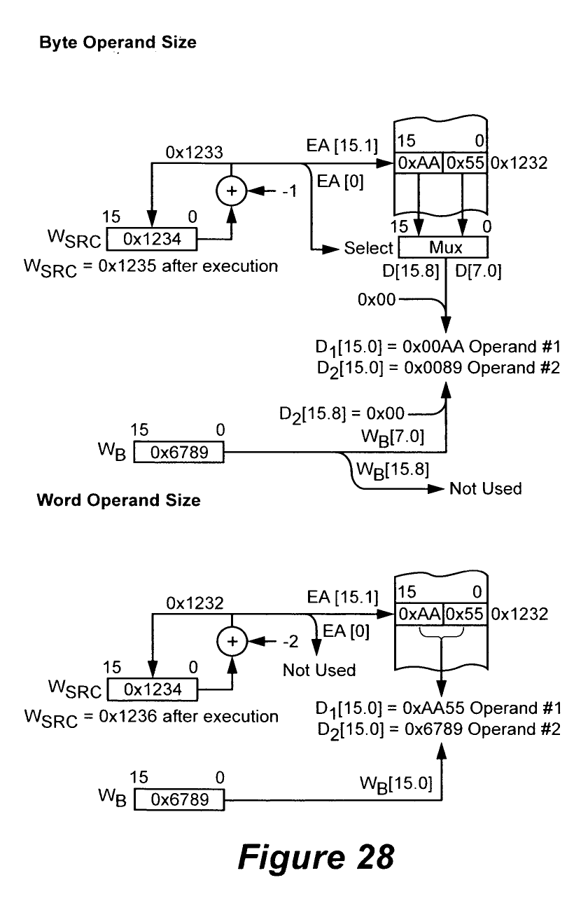

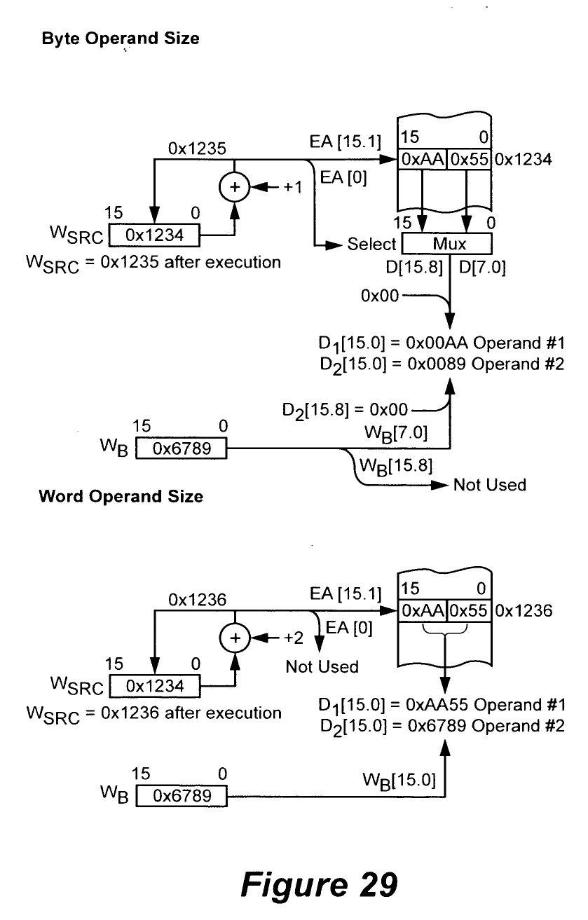

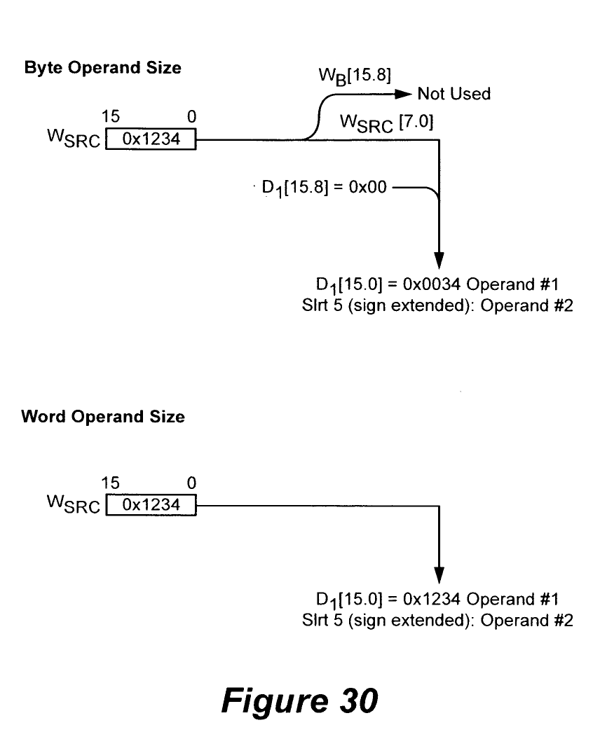

The following description is enhanced by reference to FIGS. 24-81. FIG. 24 shows a block diagram illustrating a Register Direct mode. FIG. 25 shows a block diagram illustrating an alternate Register Indirect addressing mode. FIG. 26 shows a block diagram illustrating a Register Indirect with Post-Decrement addressing mode. FIG. 27 shows a block diagram illustrating a Register Indirect with Post-Increment addressing mode. FIG. 28 shows a block diagram illustrating a Register Indirect with Pre-Decrement addressing mode. FIG. 29 Register Indirect with Pre-Increment Addressing mode. FIG. 30 shows a block diagram illustrating a Register Direct with 5-bit signed Literal Operation mode.

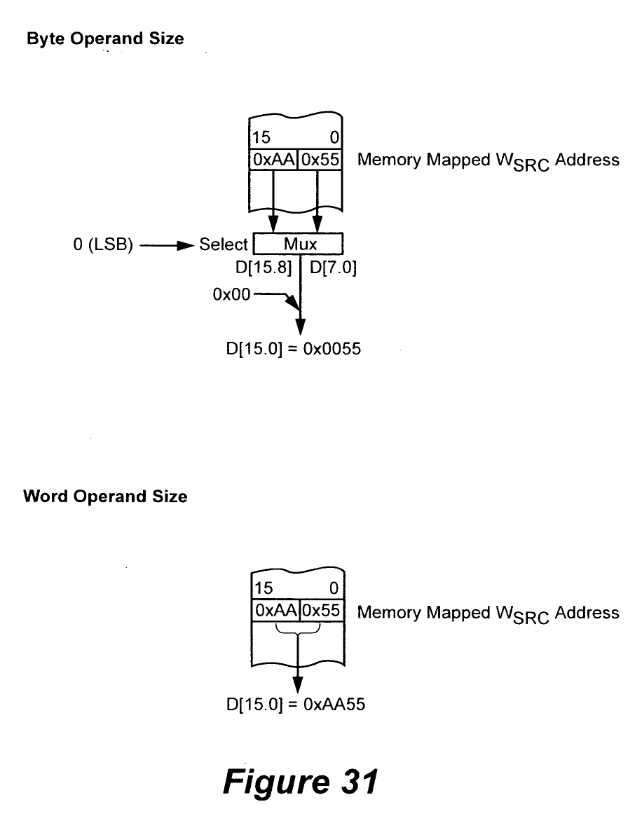

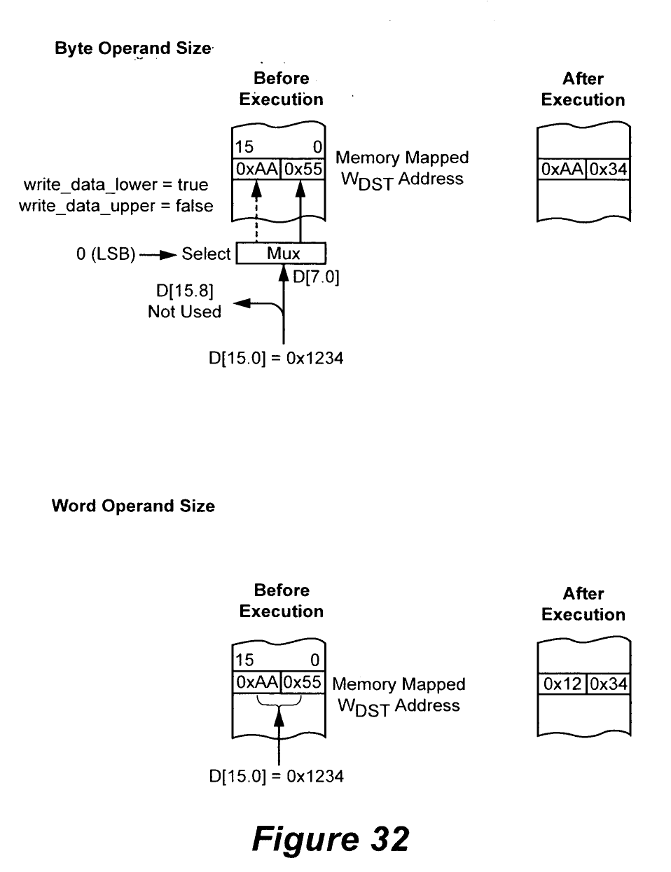

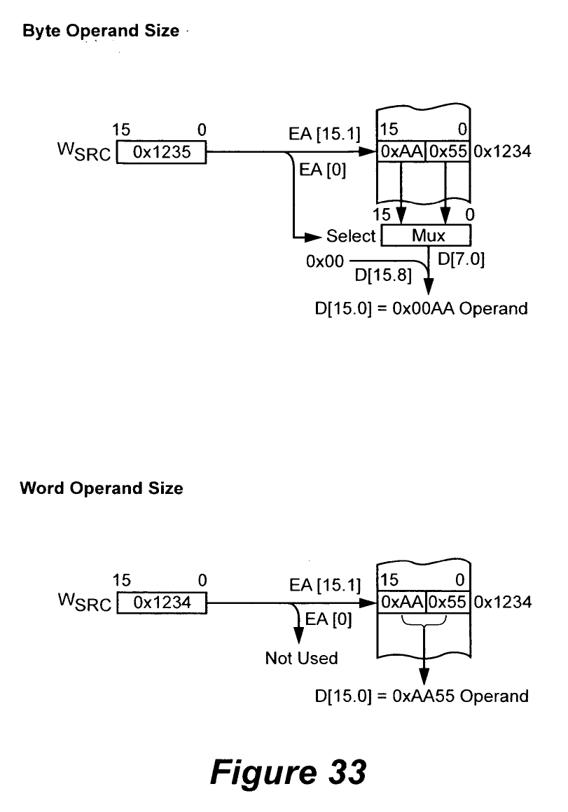

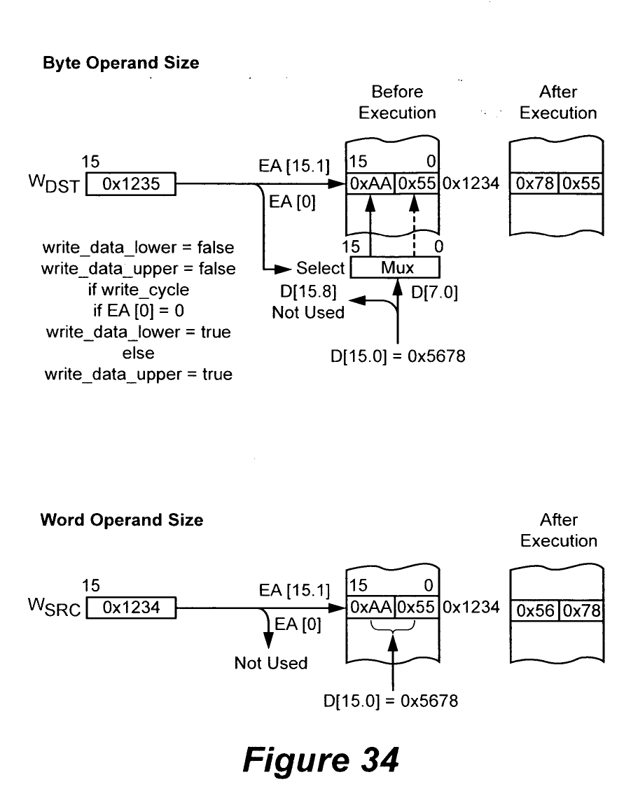

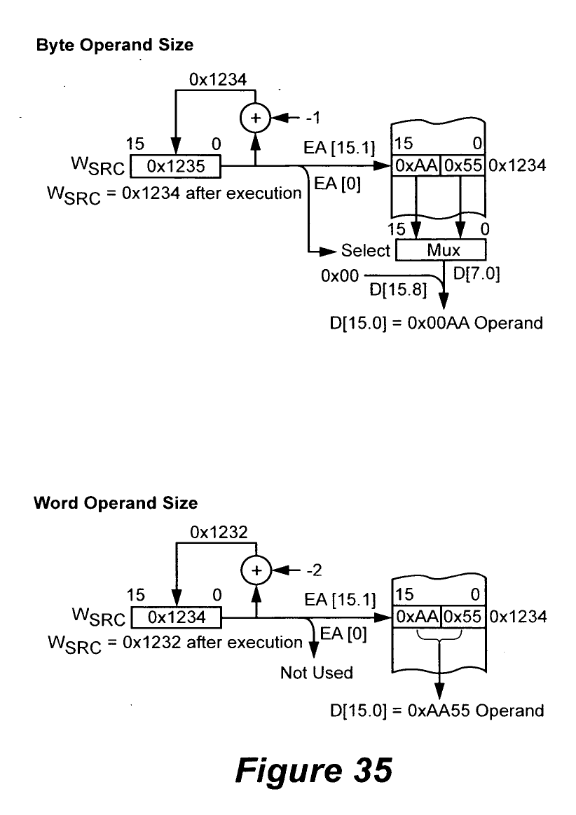

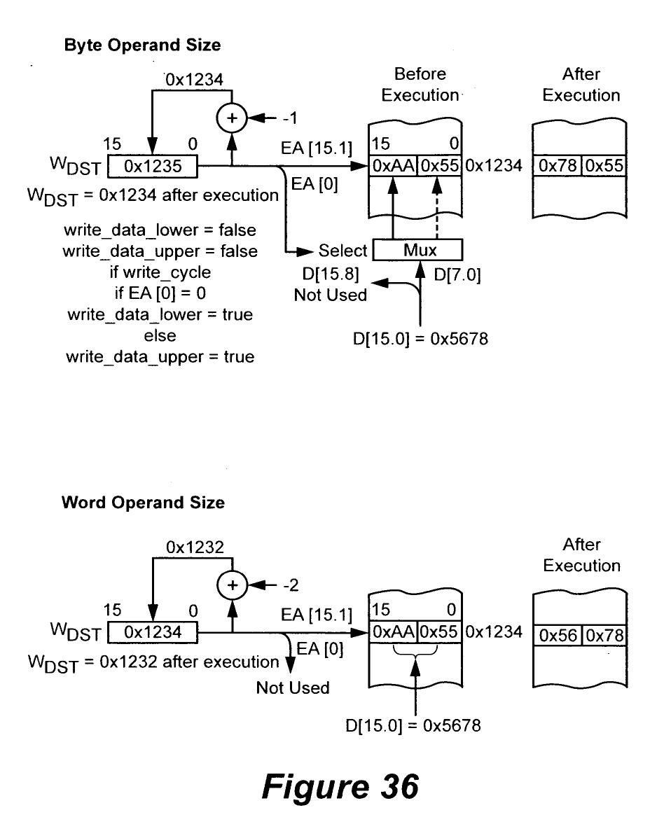

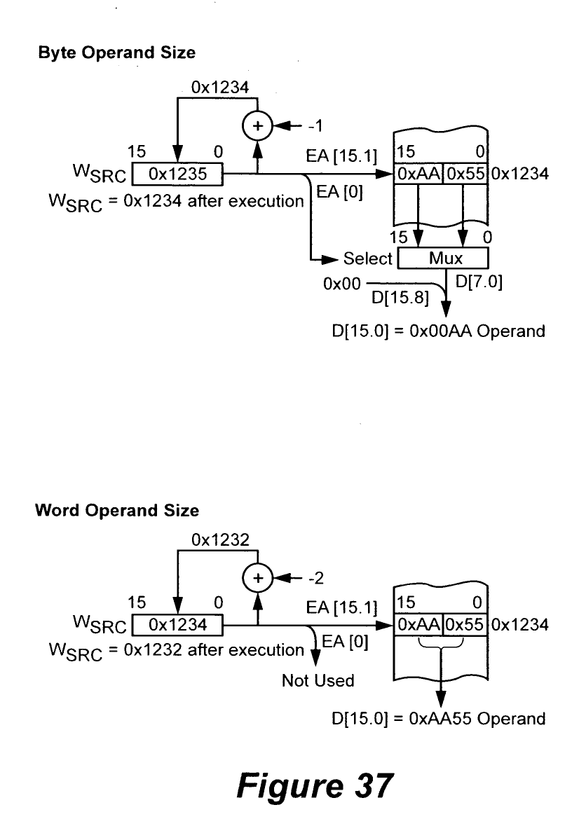

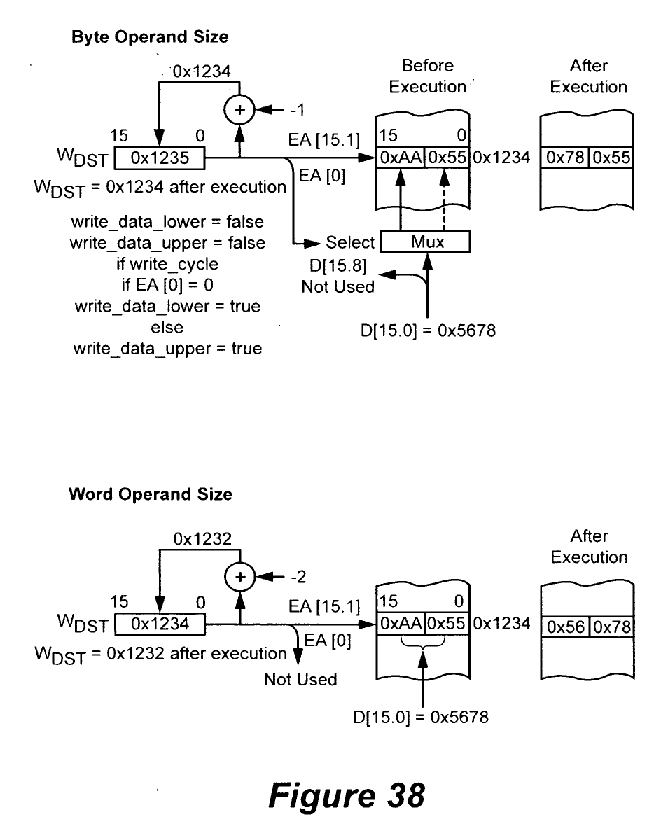

FIG. 31 shows a block diagram illustrating a Register Direct, Operand Source mode. FIG. 32 shows a block diagram illustrating a Register Indirect, Result Destination mode. FIG. 33 shows a block diagram illustrating a Register Indirect, Operand Source mode. FIG. 34 shows a block diagram illustrating a Register Indirect, Result Destination mode. FIG. 35 shows a block diagram illustrating a Register Indirect with Post Decrement, Source Operand mode. FIG. 36 shows a block diagram illustrating a Register Indirect with Post Decrement, Result Destination mode. FIG. 37 shows a block diagram illustrating a Register Indirect with Post Increment, Operand Source mode. FIG. 38 shows a block diagram illustrating a Register Indirect with Post Increment, Result Destination mode.

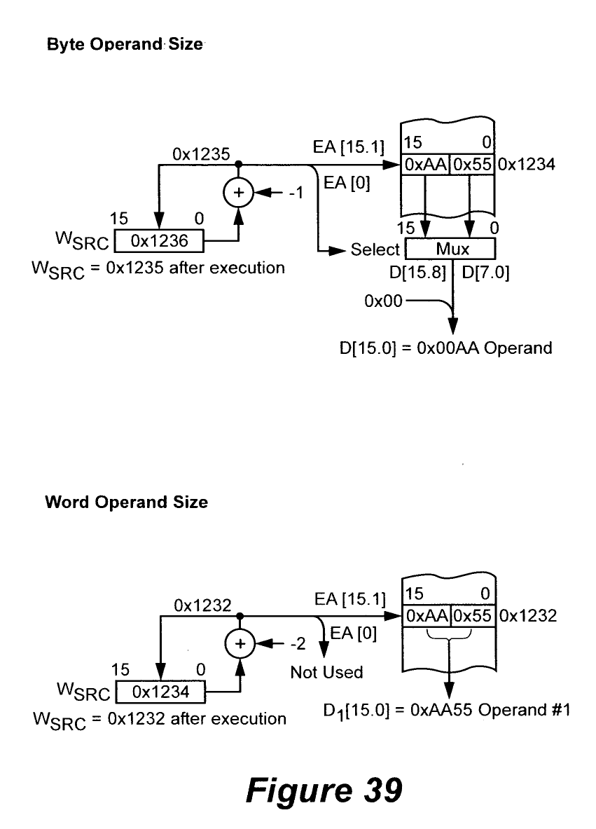

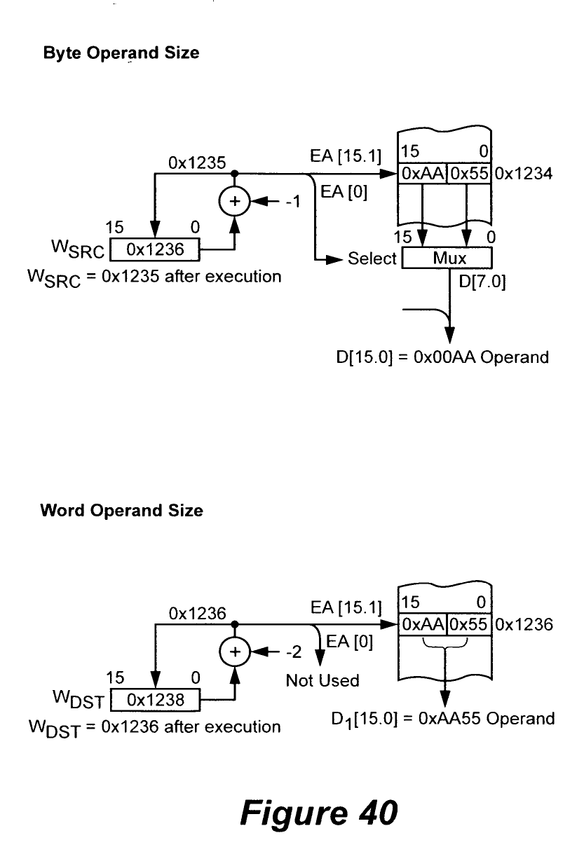

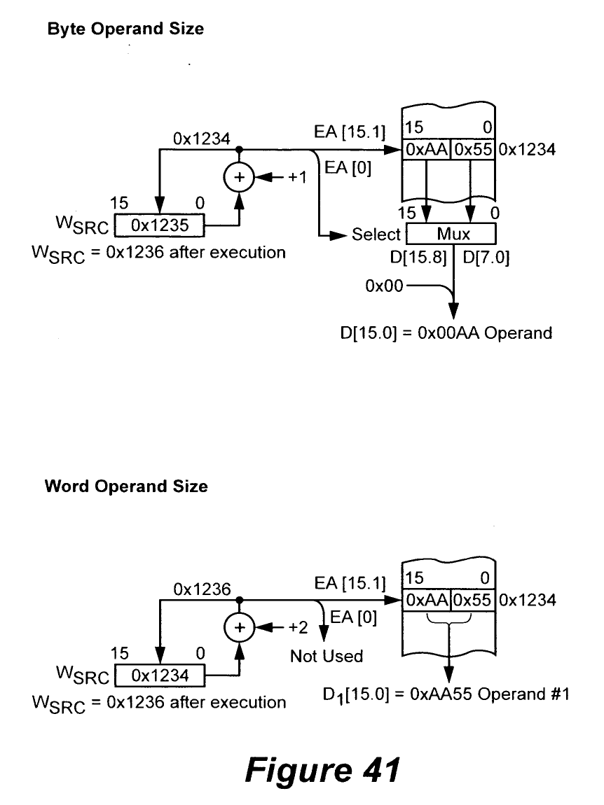

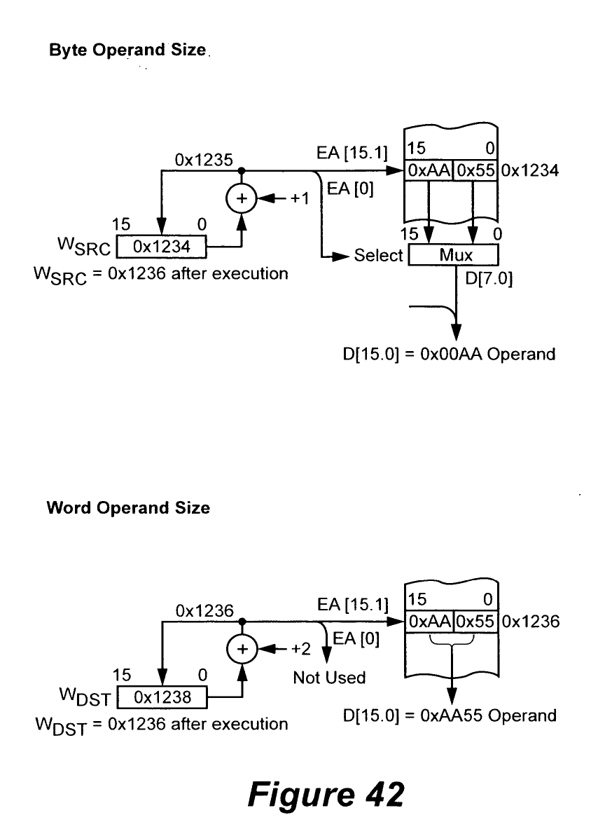

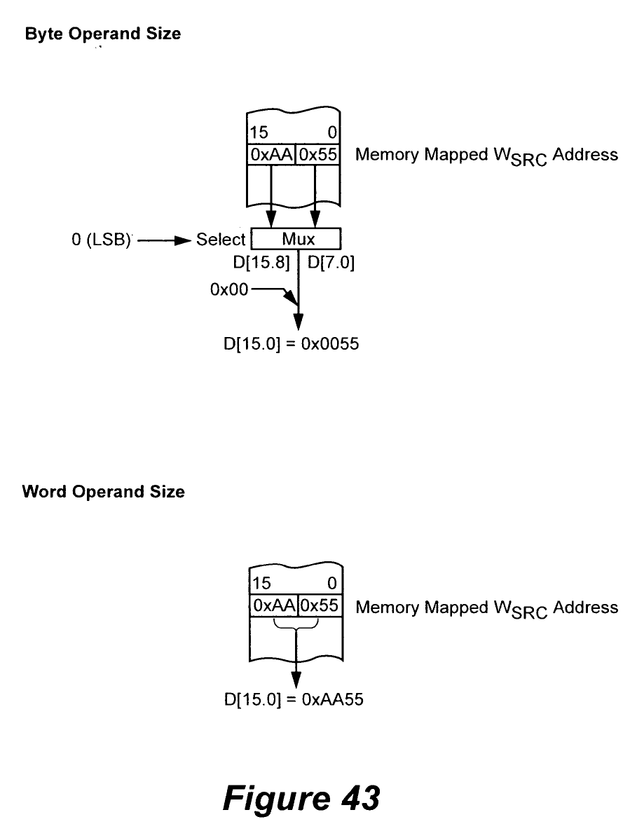

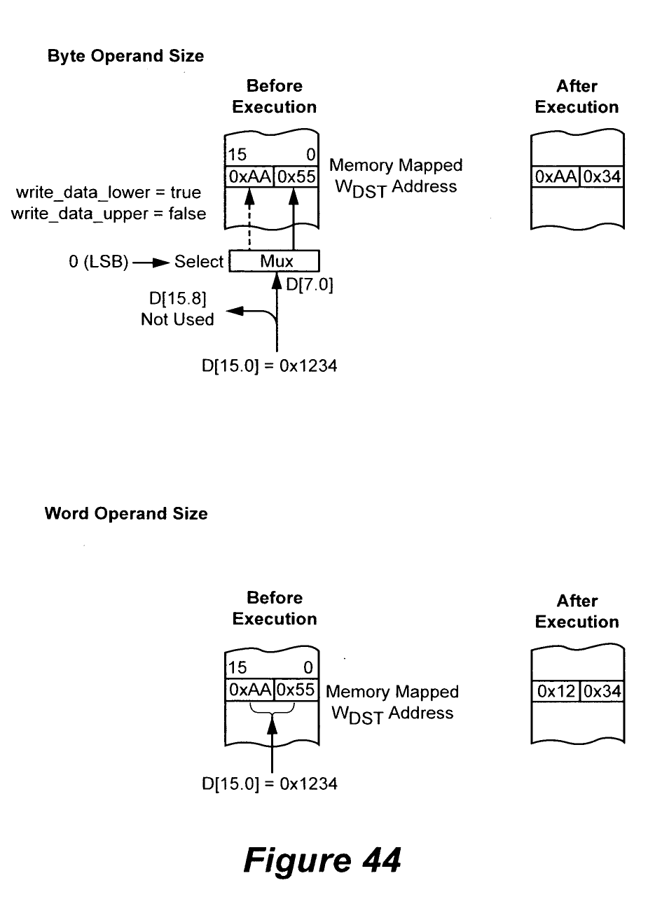

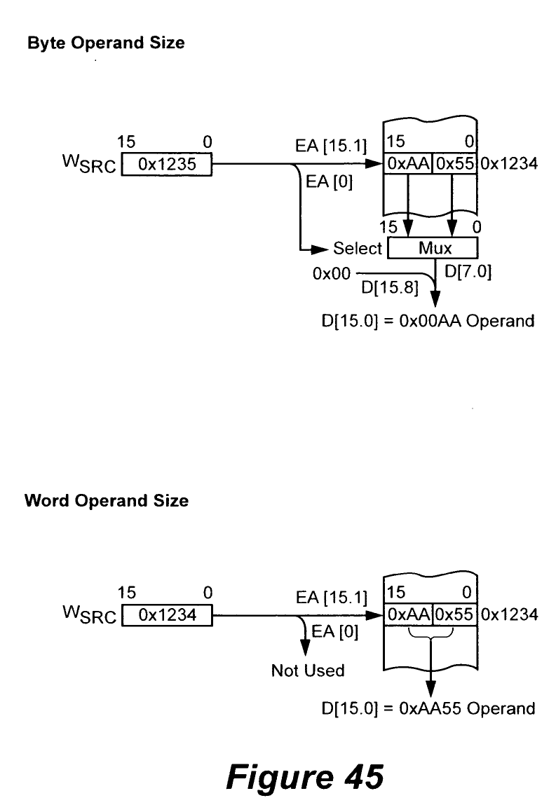

FIG. 39 shows a block diagram illustrating a Register Indirect with Pre-Decrement, Source Operand mode. FIG. 40 shows a block diagram illustrating a Register Indirect with Pre-Decrement, Result Destination mode. FIG. 41 shows a block diagram illustrating a Register Indirect with Pre-Increment, Source Operand mode. FIG. 42 shows a block diagram illustrating a Register Indirect with Pre-Increment, Result Destination mode. FIG. 43 shows a block diagram illustrating a Register Direct, Operand Source mode. FIG. 44 shows a block diagram illustrating a Register Direct, Result Destination mode. FIG. 45 shows a block diagram illustrating a Register Indirect, Source Operand mode.

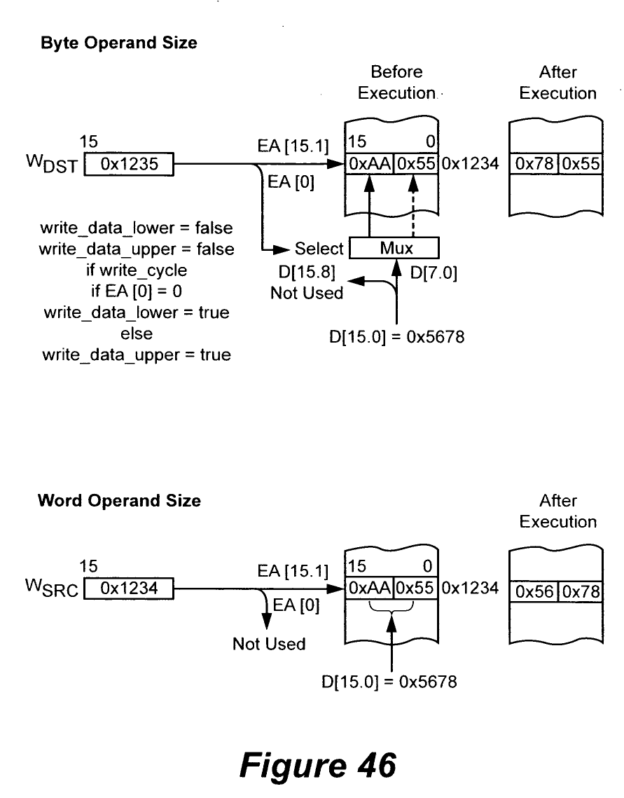

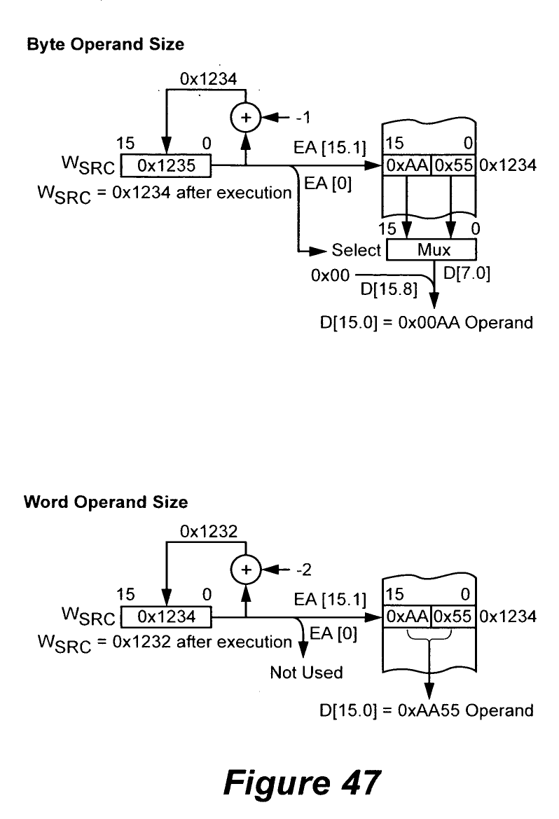

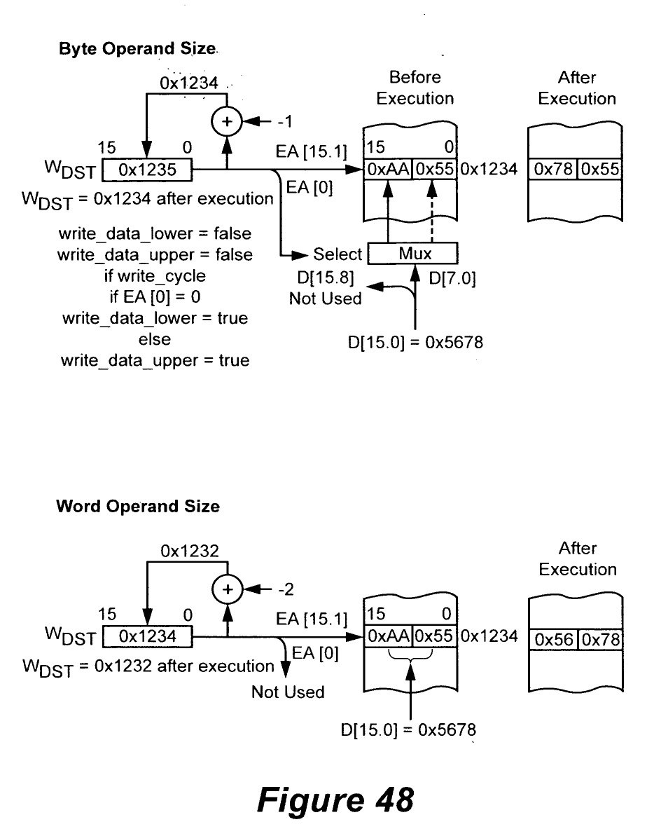

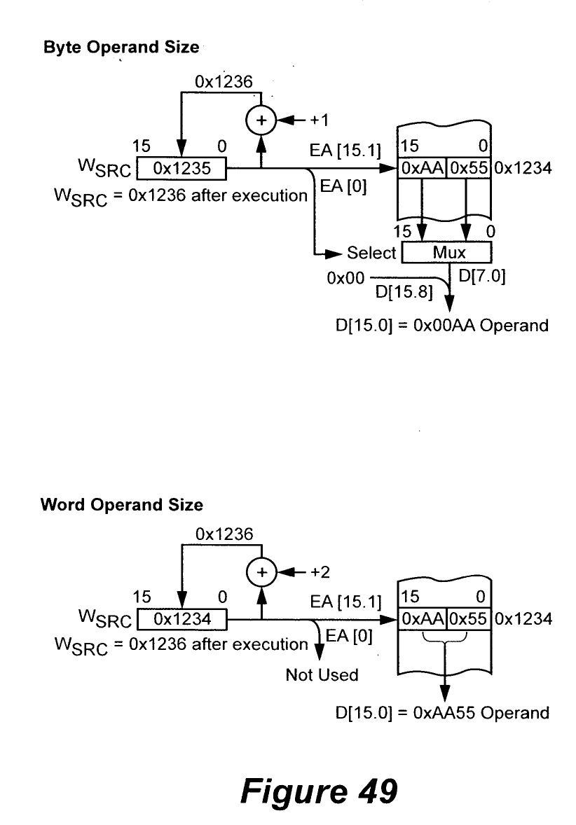

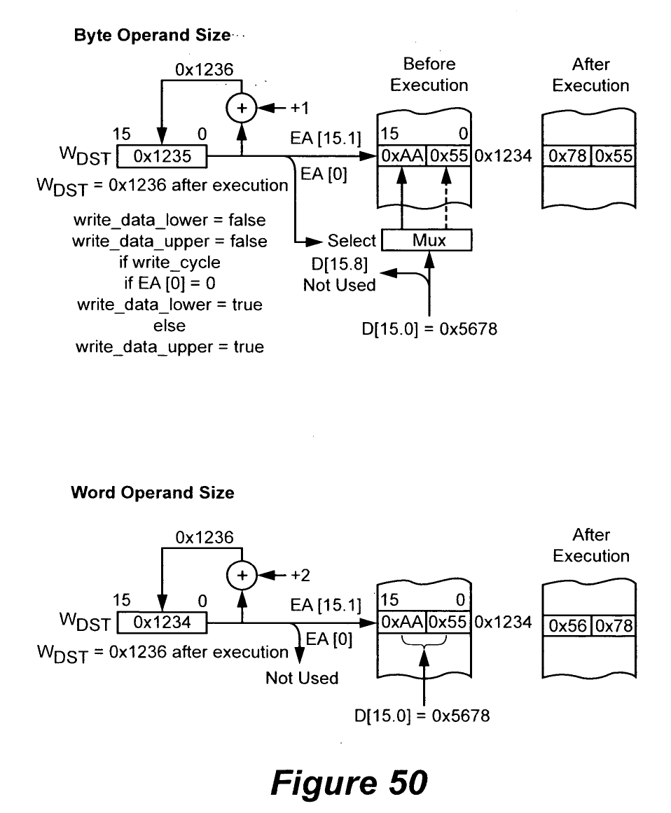

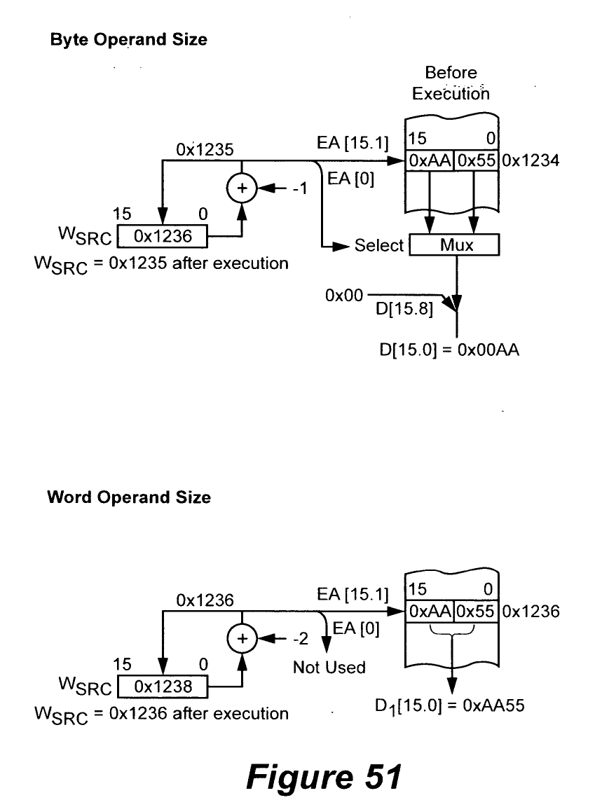

FIG. 46 shows a block diagram illustrating a Register Indirect, Result Destination mode. FIG. 47 shows a block diagram illustrating a Register Indirect with Post Decrement, Source Operand mode. FIG. 48 shows a block diagram illustrating a Register Indirect with Post Decrement, Result Destination mode. FIG. 49 shows a block diagram illustrating a Register Indirect with Post Increment, Source Operand mode. FIG. 50 shows a block diagram illustrating a Register Indirect with Post Increment, Result Destination mode. FIG. 51 shows a block diagram illustrating a Register Indirect with Pre-Decrement, Source Operand mode.

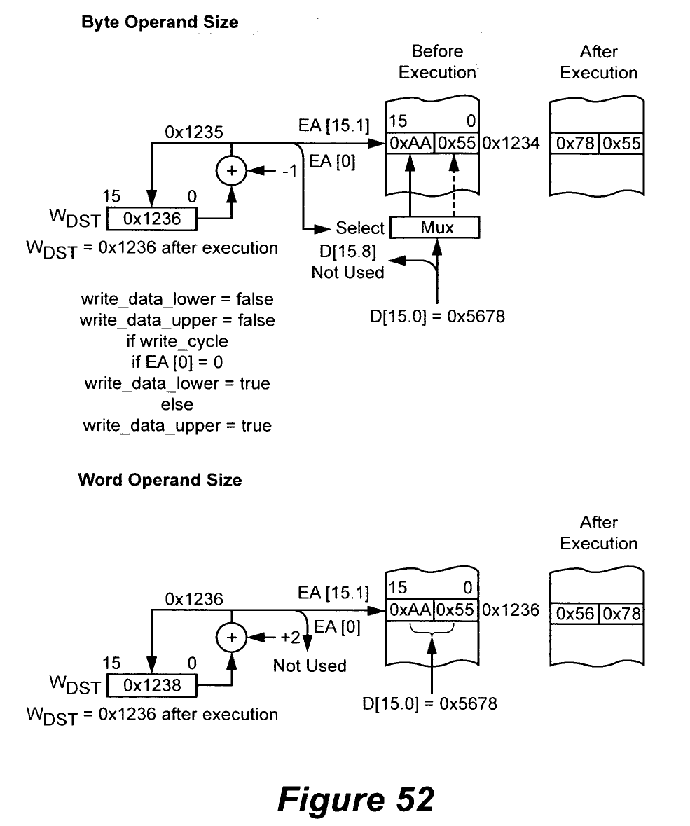

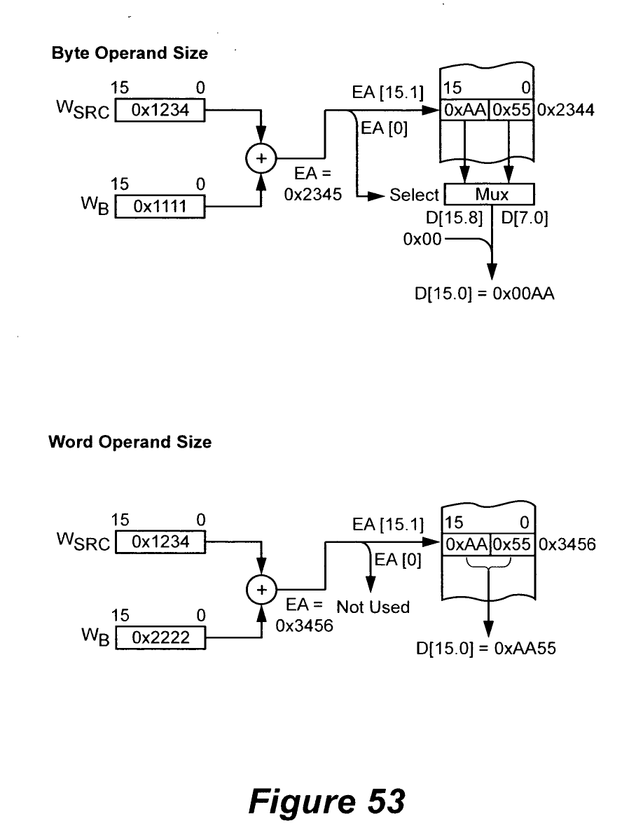

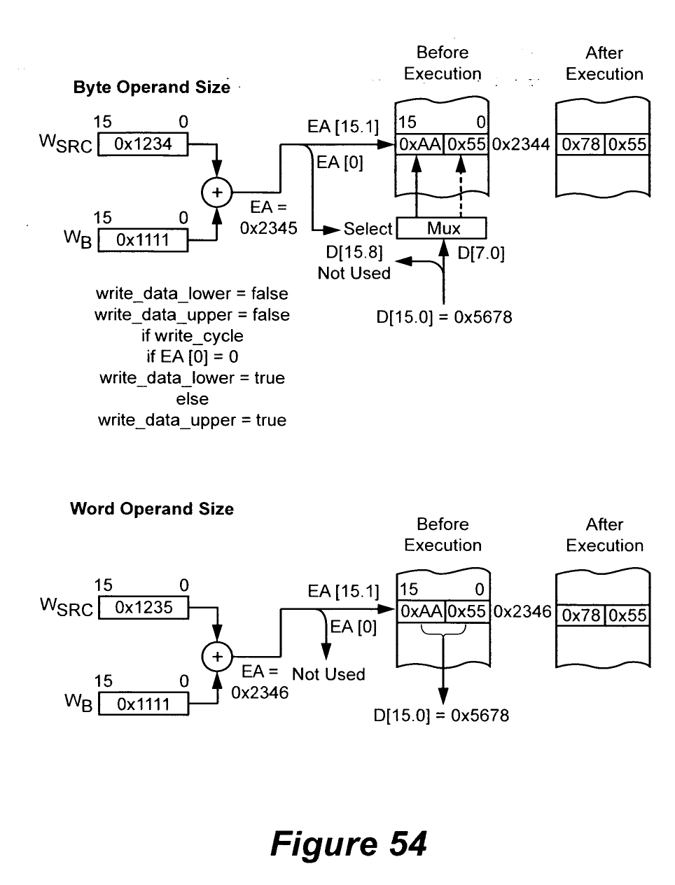

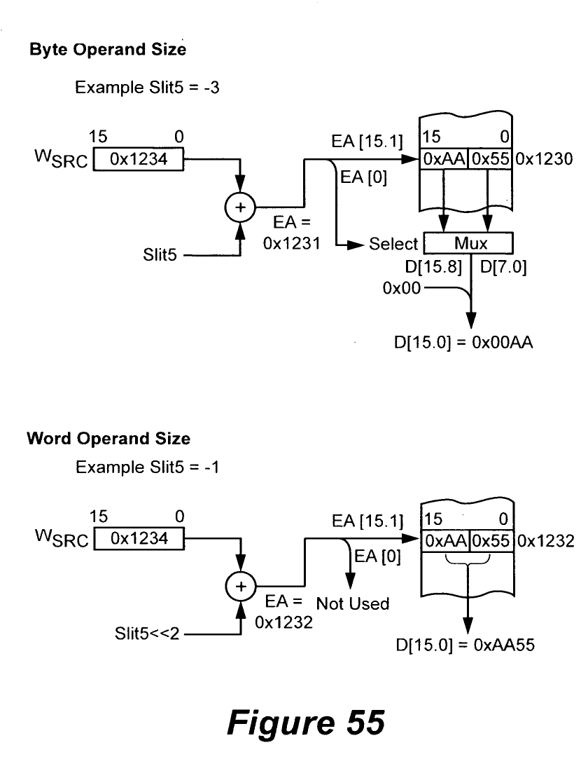

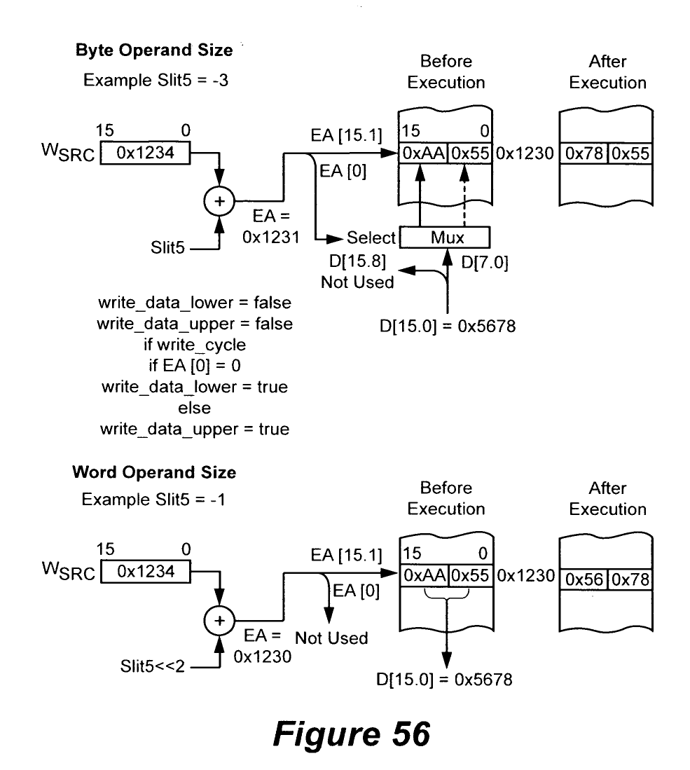

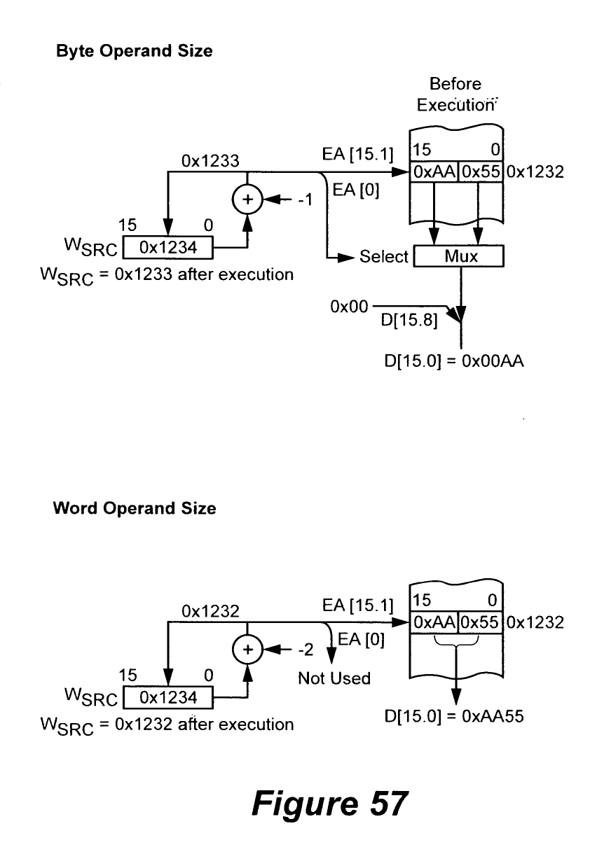

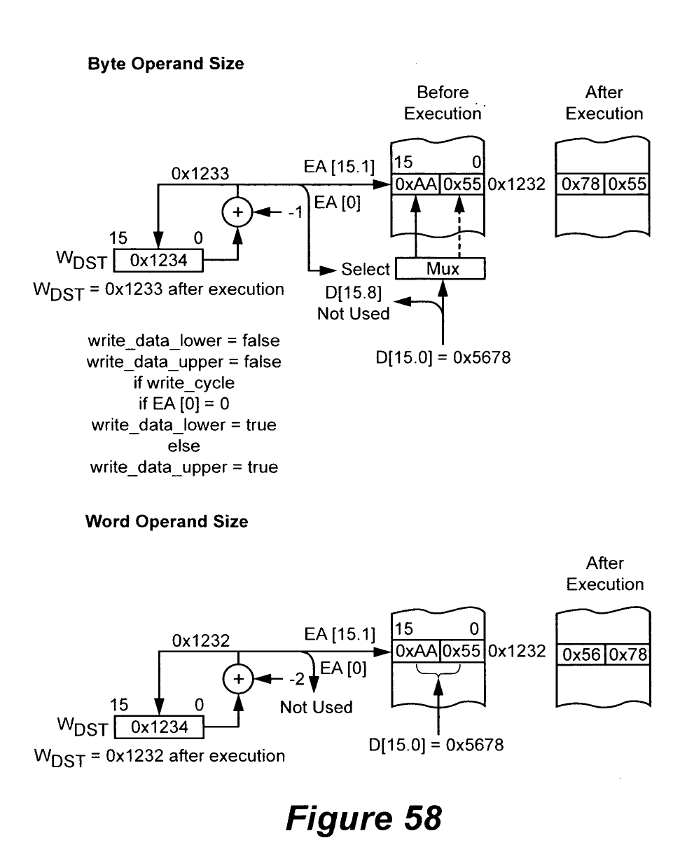

FIG. 52 shows a block diagram illustrating a Register Indirect with Pre-Decrement, Result Destination mode. FIG. 53 shows a block diagram illustrating a Register Indirect with Register Offset, Operand Source mode. FIG. 54 shows a block diagram illustrating a Register Indirect with Register Offset, Result Destination mode. FIG. 55 shows a block diagram illustrating a Register Indirect with Constant Offset, Source Operand mode. FIG. 56 shows a block diagram illustrating a Register Indirect with Constant Offset, Result Destination mode. FIG. 57 shows a block diagram illustrating a Register Indirect with Pre-Decrement, Source Operand mode. FIG. 58 shows a block diagram illustrating a Register Indirect with Pre-Decrement, Result Destination mode.

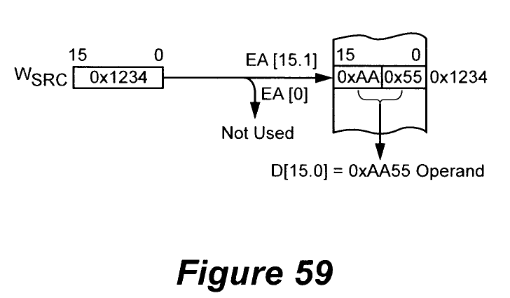

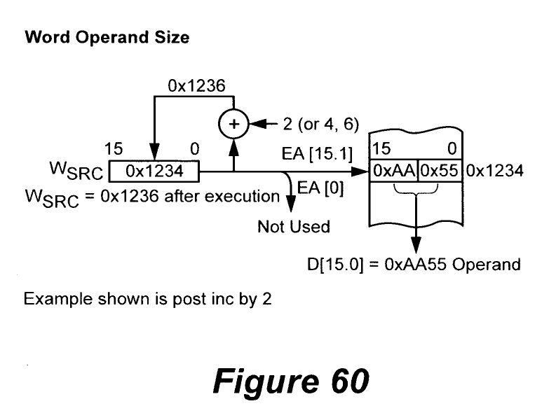

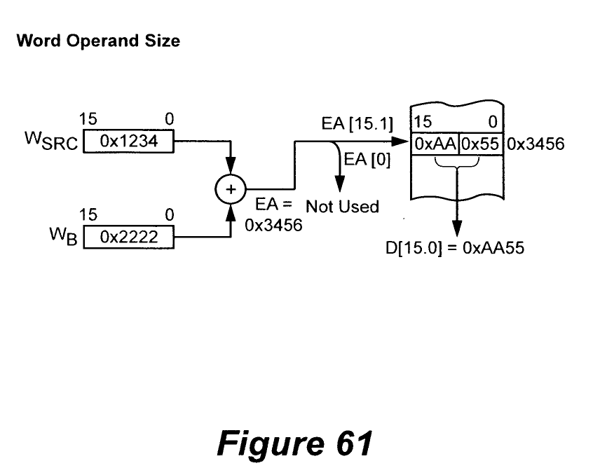

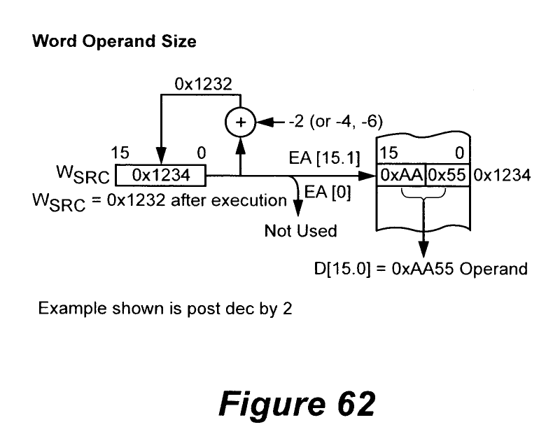

FIG. 59 shows a block diagram illustrating a Register Indirect mode. FIG. 60 shows a block diagram illustrating a Register Indirect with Post Increment mode. FIG. 61 shows a block diagram illustrating a Register Indirect with Register Offset Operand Source mode. FIG. 62 shows a block diagram illustrating a Register Indirect with Post Decrement mode.

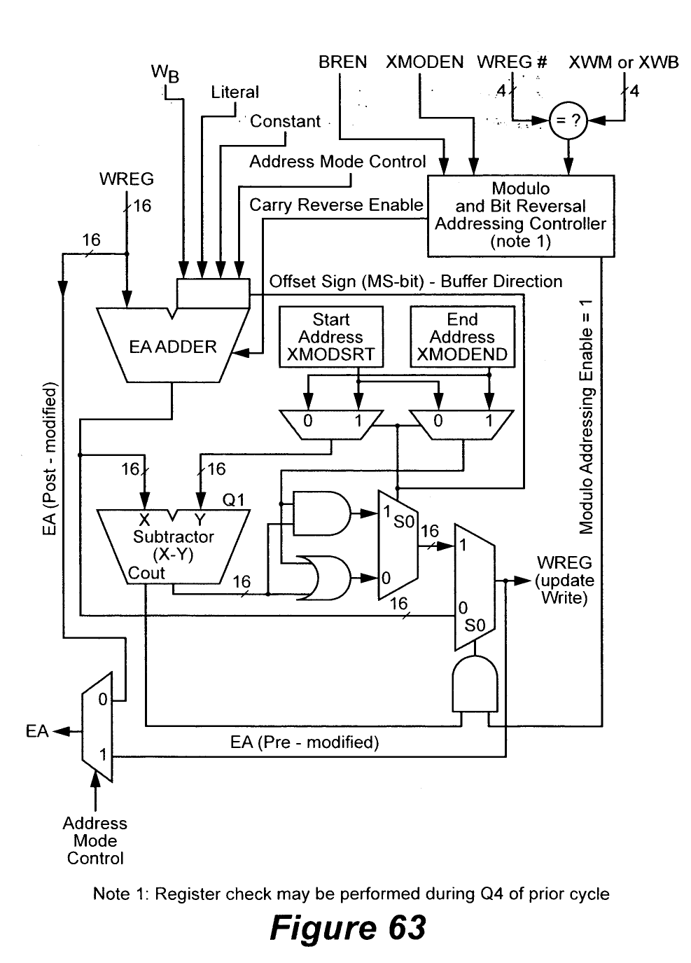

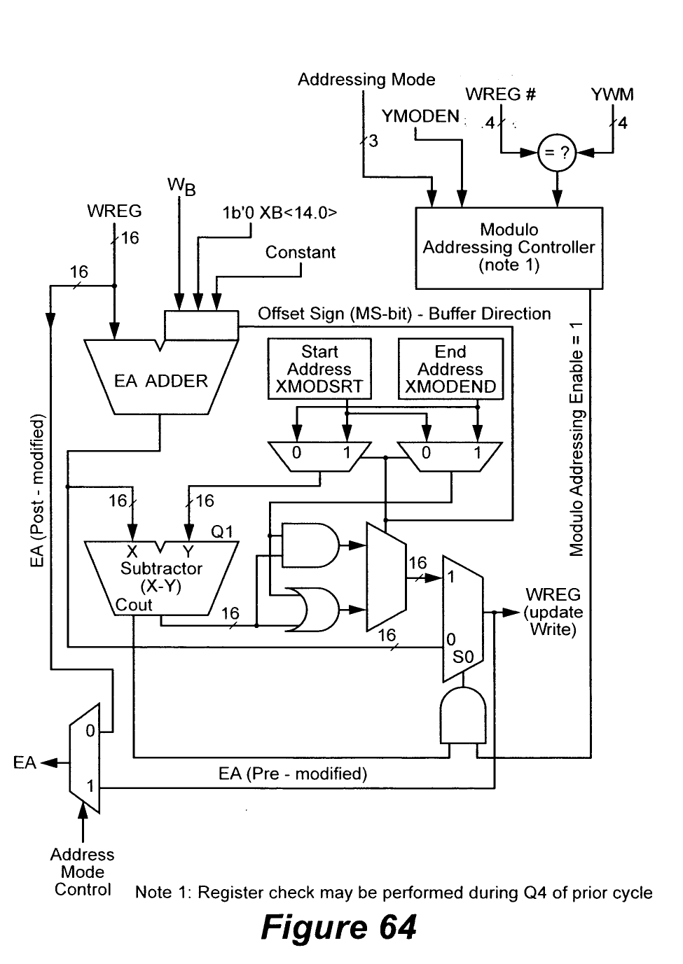

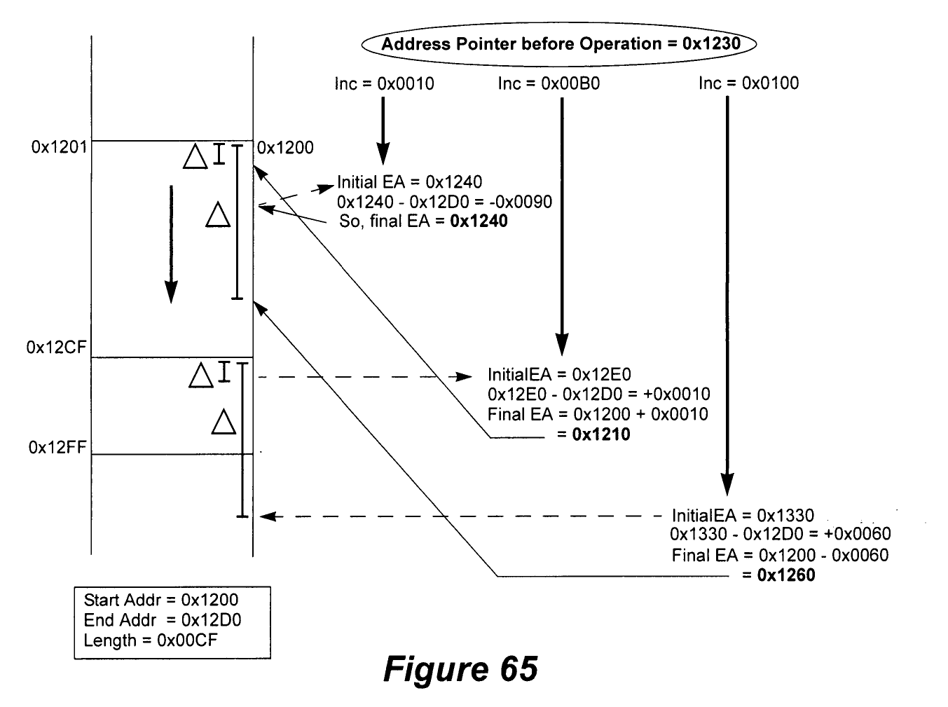

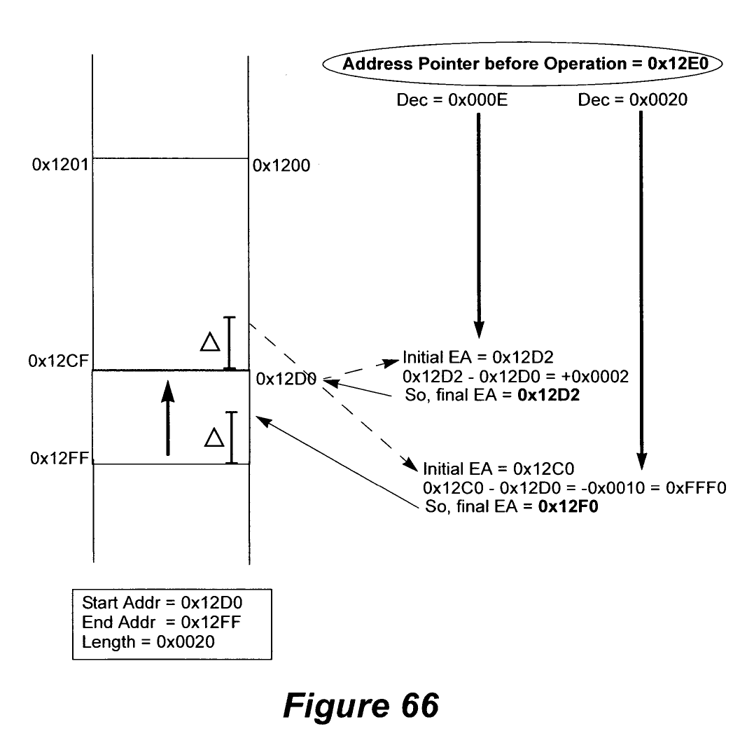

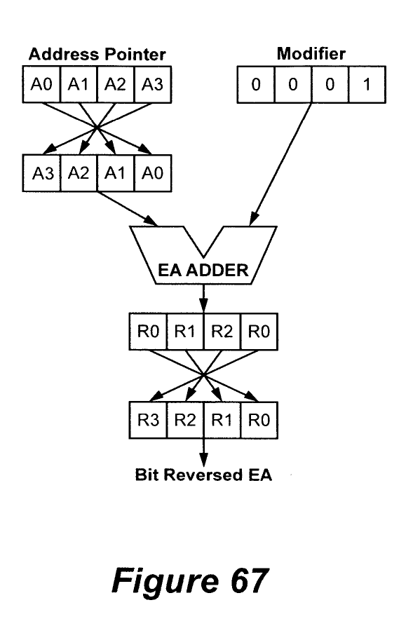

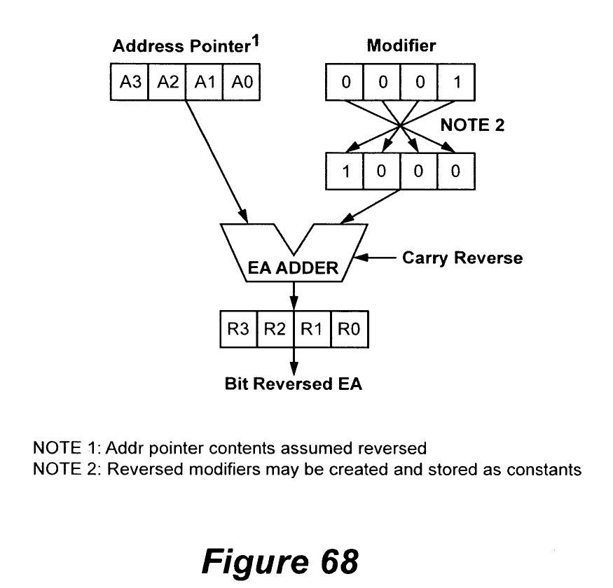

FIG. 63 shows a block diagram illustrating an X AGU. FIG. 64 shows a block diagram illustrating a Y AGU. FIG. 65 shows a block diagram illustrating an Incrementing Buffer Modulo addressing operation. FIG. 66 shows a block diagram illustrating a Decrementing Buffer Modulo addressing operation. FIG. 67 shows a block diagram illustrating a Bit Reversed EA calculation. FIG. 68 shows a block diagram illustrating a Alternative Bit Reversed EA calculation method.

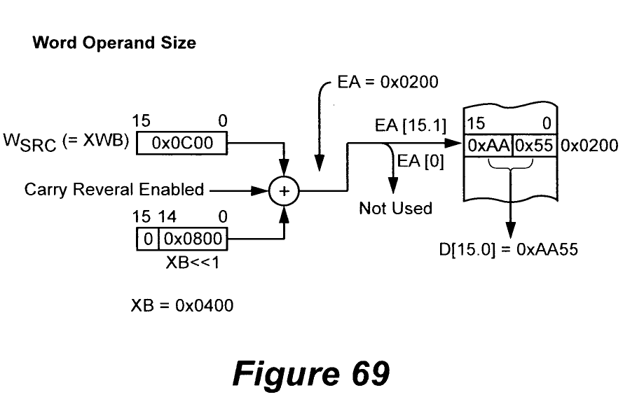

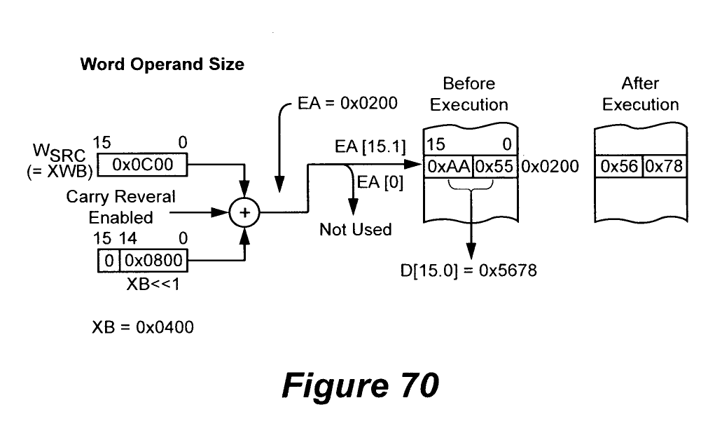

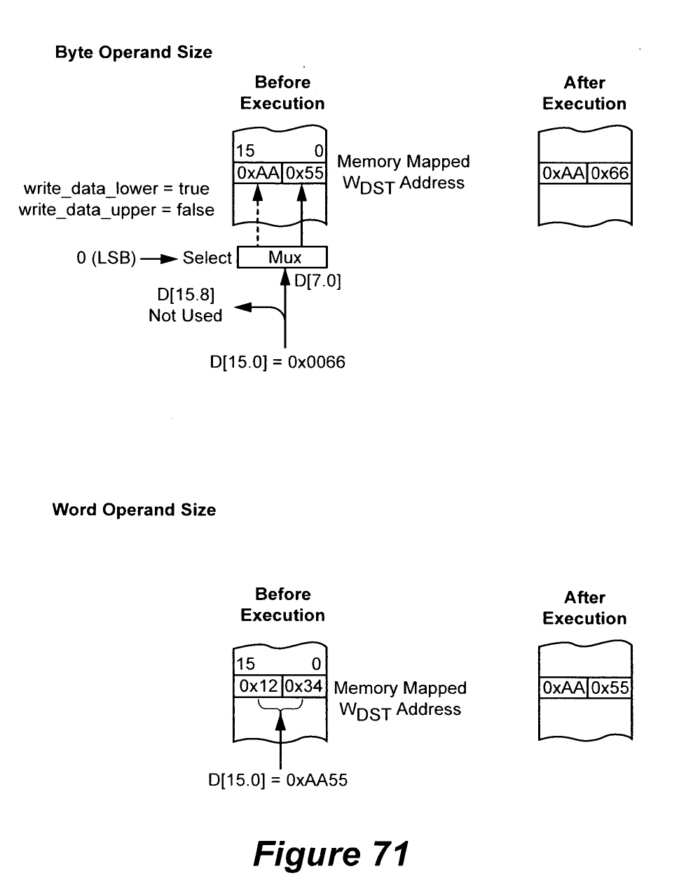

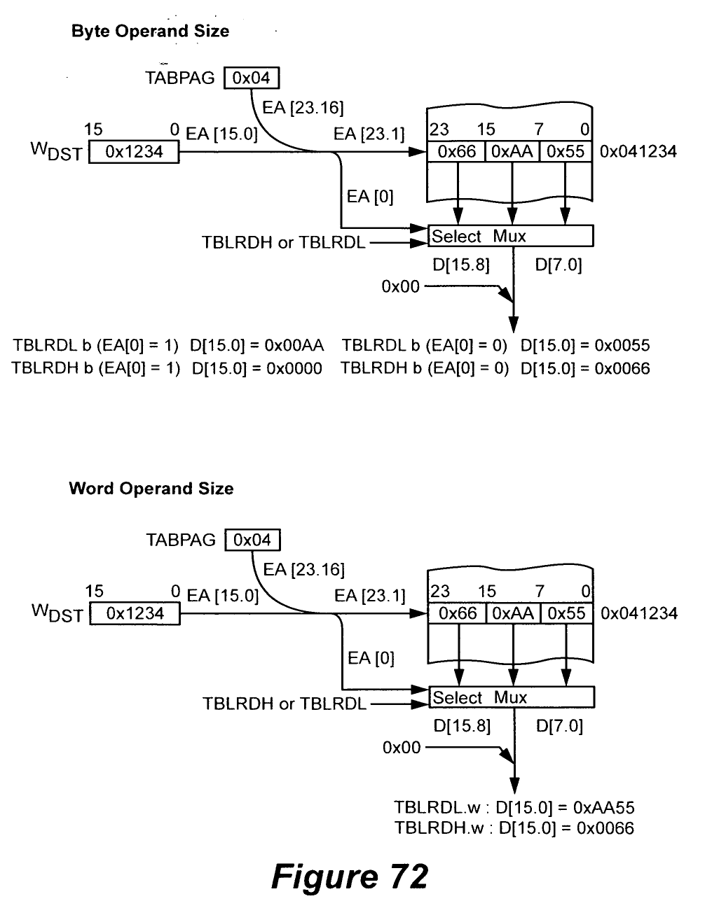

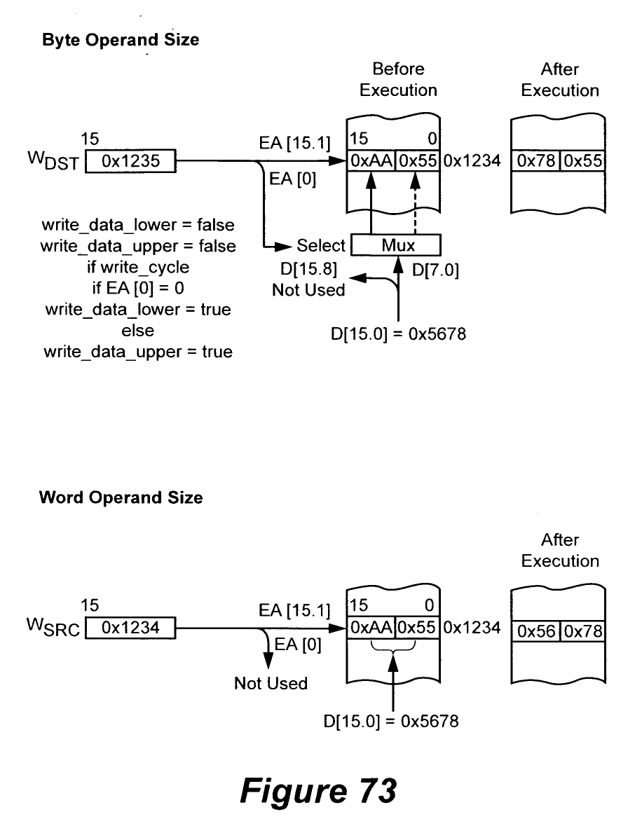

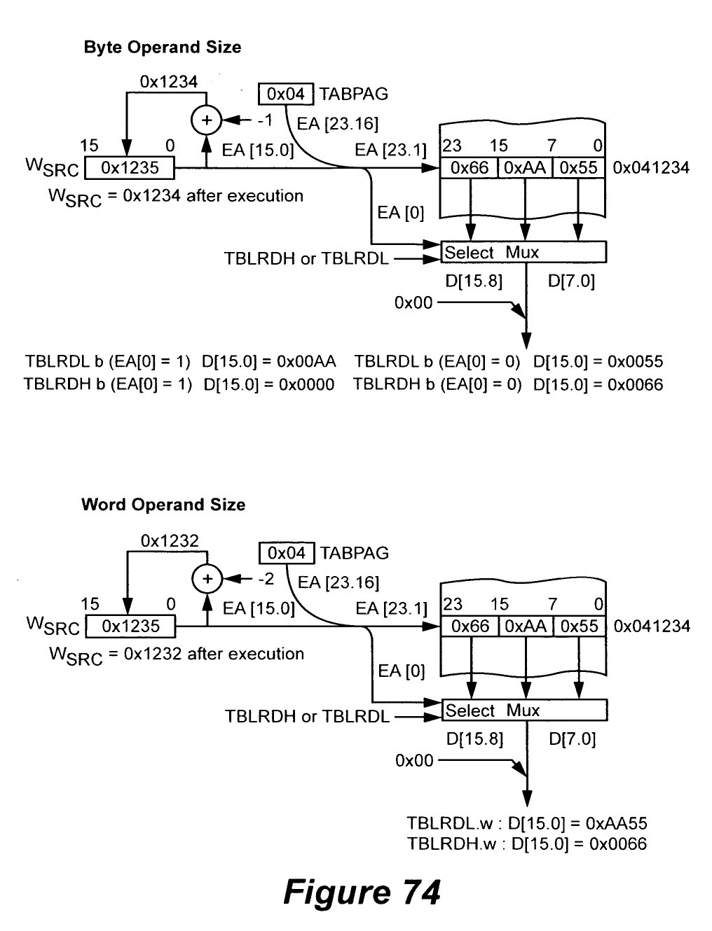

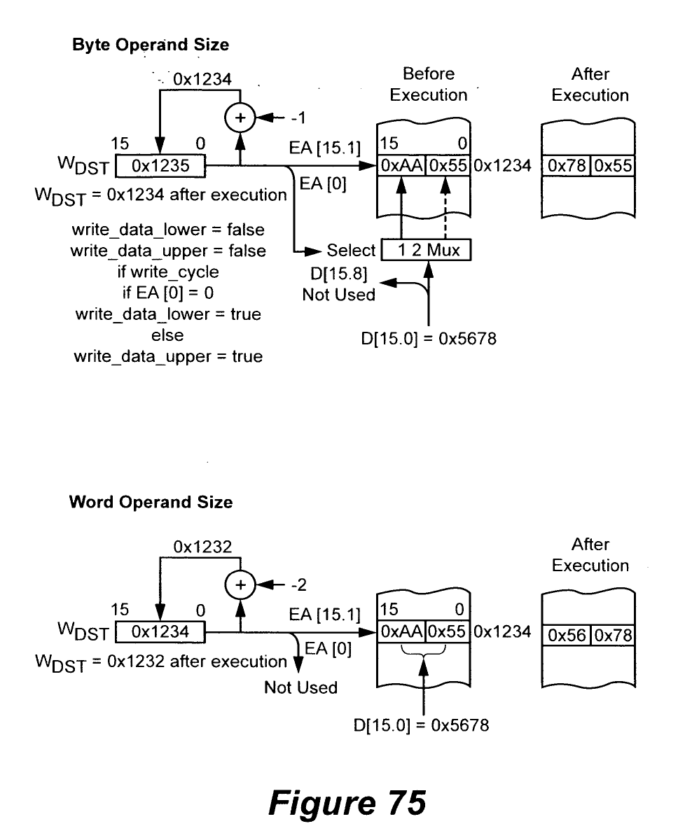

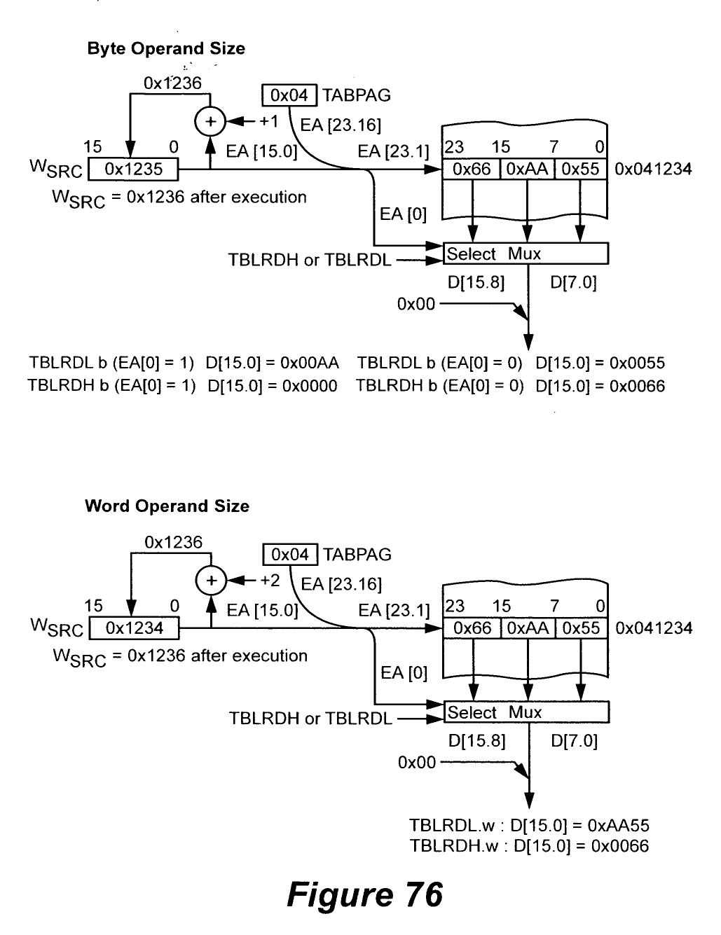

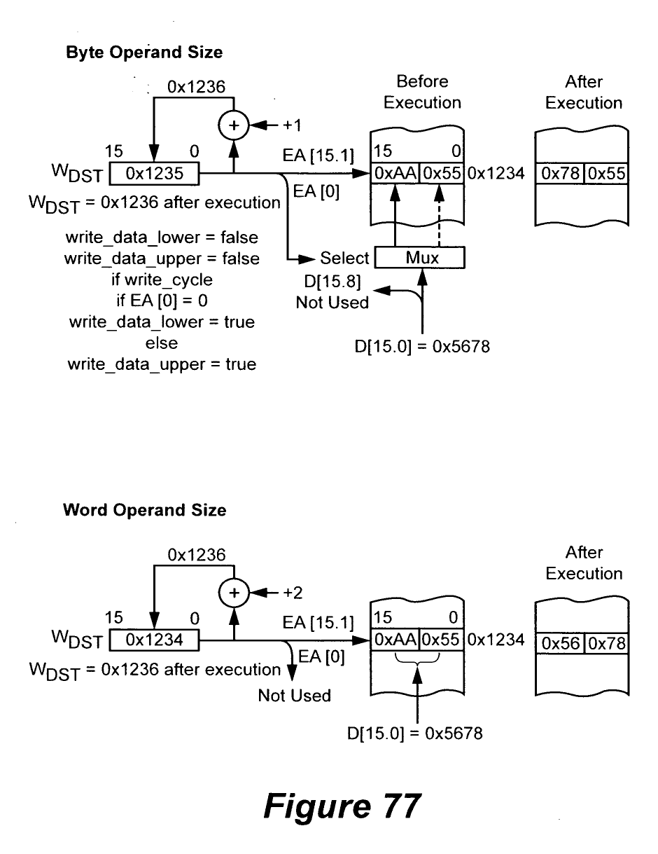

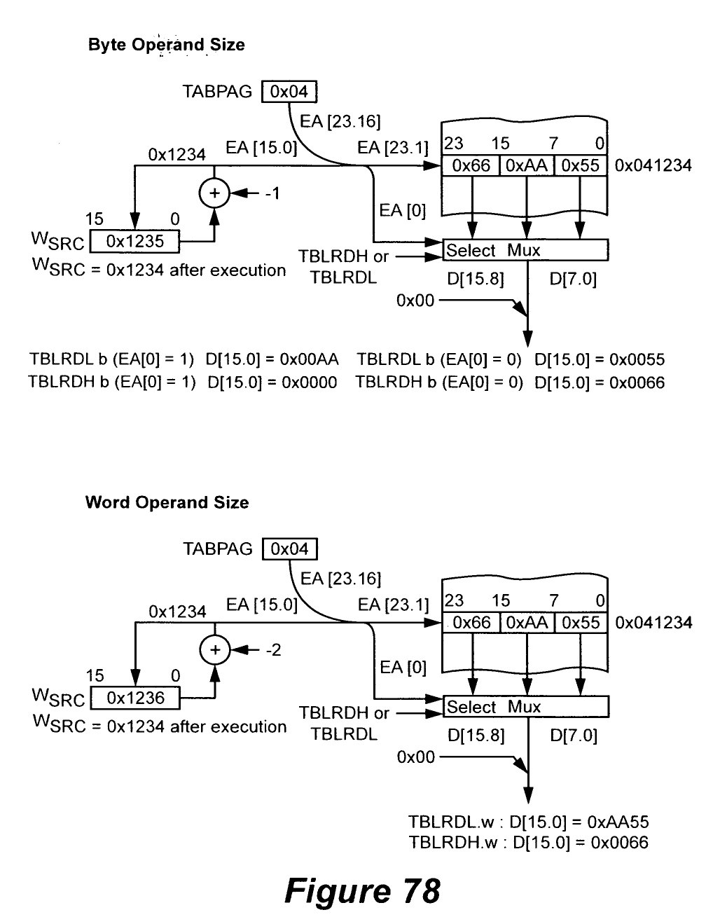

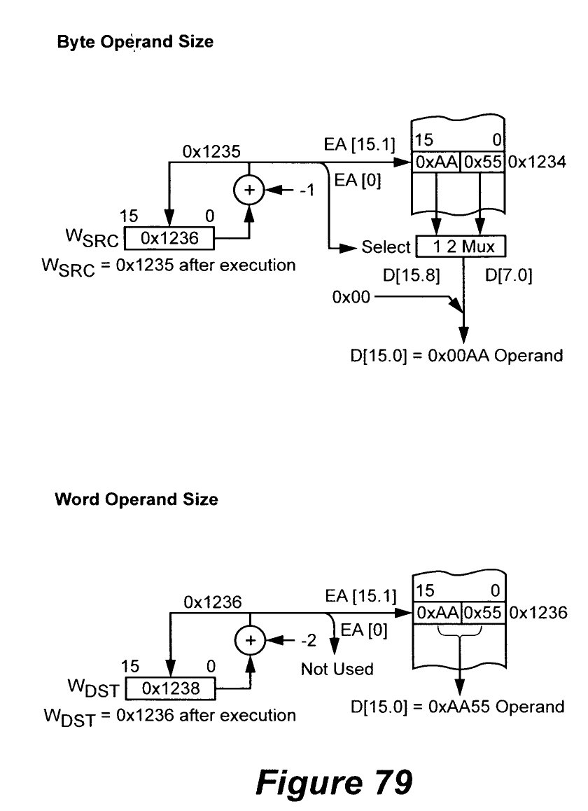

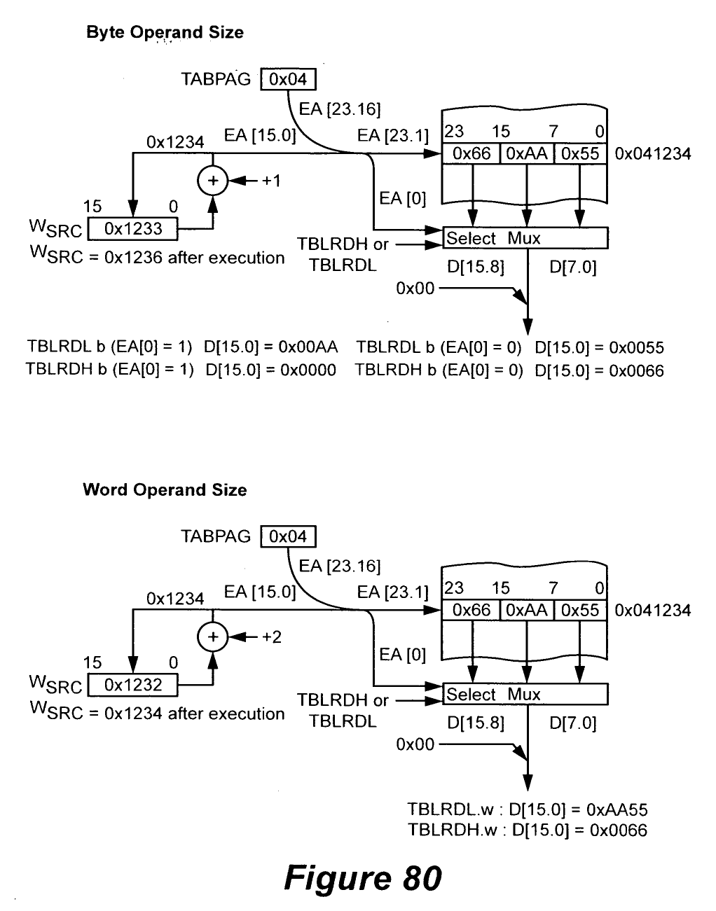

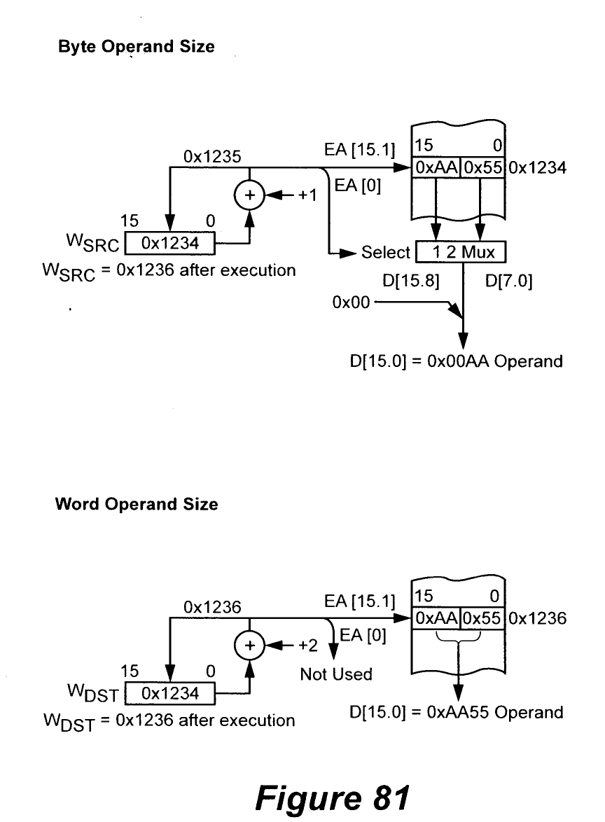

FIG. 69 shows a block diagram illustrating a Bit Reversed Addressing, Source Operand mode. FIG. 70 shows a block diagram illustrating a Bit Reversed Addressing, Destination Operand mode. FIG. 71 shows a block diagram illustrating a Register Indirect, Table Read Operand Destination mode. FIG. 72 shows a block diagram illustrating a Register Indirect, Table Read Operand Source mode. FIG. 73 shows a block diagram illustrating a Register Indirect, Table Read Result Destination mode. FIG. 74 shows a block diagram illustrating a Register Indirect with Post Decrement, Table Read Source Operand mode. FIG. 75 shows a block diagram illustrating a Register Indirect with Post Decrement, Table Read Result Destination mode. FIG. 76 shows a block diagram illustrating a Register Indirect with Post Increment, Table Read Operand Source mode. FIG. 77 shows a block diagram illustrating a Register Indirect with Post Increment, Table Read Result Destination mode. FIG. 78 shows a block diagram illustrating a Register Indirect with Pre-Decrement, Table Read Source Operand mode. FIG. 79 shows a block diagram illustrating a Register Indirect with Pre-Decrement, Table Read Result Destination mode. FIG. 80 shows a block diagram illustrating a Register Indirect with Pre-Increment, Table Read Source Operand mode. FIG. 81 shows a block diagram illustrating a Register Indirect with Pre-Increment, Table Read Result Destination.

The dsPIC core contains two independent address generator units. The X AGU is for MCU and DSP instructions. The Y AGU is for DSP MAC class of instructions only. They are capable of supporting three types of data addressing:
Linear addressing
Modulo (circular) addressing
Bit Reversed addressing (X AGU only)

Linear and modulo data addressing modes can be applies to data space or program space. Although bit reversed addressing will work with any EA calculation, by definition it is only applicable to data space.

Data Space Organization

Although the data space memory is organized as 16-bit words, all effective addresses (EAs) point to bytes. Instructions can thus access any byte or aligned words (data words at an even address). Misaligned word accesses are not supported, and if attempted will initiate an address error trap. The LS-bit of the EA is used to determine upper or lower byte access. The LS-bit becomes a ‘don't care’ for word accesses. Each memory (or register where appropriate) must provide independent upper and lower byte write lines to support byte writes. In addition, a muliplexor must be included to route the LS byte of an operand to the upper or lower byte of the target EA word for both reads and writes.

When executing instructions which require just one source operand to be fetched from data space, the X AGU is used to calculate the effective address. The AGU can generate an address to point to anywhere in the 64K byte data space. It supports all addressing modes, modulo addressing for low overhead circular buffers, and bit reversed addressing to facilitate FFT data reorganization.

When executing instructions which require two source operands to be concurrently fetched (i.e. the MAC class of DSP instructions), both the X and Y AGUs are used simultaneously and the data space is split into two independent address spaces, X and Y. The Y AGU supports register indirect post-modified and modulo addressing only. Note that the data write phase of the MAC class of instruction does not split X and Y address space. The write EA is calculated using the X AGU and the data space is configured for full 64Kbyte access.

In the split data space mode, some W register address pointers are dedicated to AGU X, others to AGU Y (see FIGS. 63 and 64, respectively). The EAs of each operand must therefore be restricted to be within different address spaces. If they are not, one of the EAs will be outside the address space of the corresponding data space (and will fetch the bus default value, 0x0000).

Instruction Addressing Modes

While alternate addressing modes are possible with the present invention, the basic set of addressing modes for this illustrative example are shown in Table 170. Note that, ‘Wn+=’ indicates that the contents of Wn is added to something to form the effective address which is then written back into Wn. ‘Wn+’ indicates that the contents of Wn is added to something to form the effective address but the contents of Wn remain unchanged.

The addressing modes in Table 170 form the basis of three groups of addressing modes optimized to support specific instruction features. They are Mode 1, Mode 2 and Mode 3. The DSP MAC and derivative instructions are an exception where the addressing modes are encoded differently. This set of addressing modes is referred to as Mode 4. Refer to dsPIC Instruction Set DOS for full details.

TABLE 170
Fundamental Addressing Modes Suported

| Addressing Mode | Function | Description |
|---|---|---|
| Register Direct | EA = Wn | Wn is the EA |
| Register Indirect | EA = [Wn] | The contents of Wn forms |
| | | the EA |
| Register Indirect Post- | EA = [Wn]+= 1 | The contents of Wn forms |
| modified | EA = [Wn]−= 1 | the EA which is post- |
| | | modified by a |
| | | constant value |
| Register Indirect Pre- | EA = [Wn+= 1] | Wn is pre-modified by a |
| modified | EA = [Wn−= 1] | signed constant value to |
| | | form the EA |
| Register Indirect with | EA = [Wn + Wb] | The sum of Wn and Wb |
| Register Offset | | forms the EA |
| Register Indirect with | EA = [Wn + | The sum of Wn and |
| Constant Offset | constant] | a signed constant |
| | | value forms the EA |

EA = effective address
All address modification values (except Wb) are scaled for word access

All but a few instructions support both 8-bit and 16-bit operand data sizes. In order to efficiently accommodate this requirement, all effective addresses are byte aligned. As the data space is 16-bits wide, the following consequences must be understood.
1. Miss-aligned word accesses are not supported. All word effective addresses must be even (the LS-bit of the EA is ignored by the data space memory).

2. The LS-bit of the effective address is used to select which byte (upper or lower) is multiplexed onto bits [7:0] of the data bus for byte sized accesses.

3. Post and pre-modification of a register by a constant value to create a new effective address must take into account of the data size accessed. All constant values, whether implied (e.g. post-inc) or declared (e.g. post-modify with S5lit) are scaled by a factor of 2 for word accesses. For example:

[Ws]+=1 will post-modify data source pointer Ws by 1 for a byte access, and by 2 for a word access. [Ws]+=Slit5 will post-modify data source pointer Ws by Slit5 for byte accesses and Slit5<<1 (shift left by 1) for word accesses. Finally, register offsets are not scaled.

Unless otherwise noted, it is assumed that all addresses and addressing modes refer to byte size accesses. All addressing modes which have to calculate the EA (pre-modified, register offset and constant offset) have very tight timing requirements which may require some instruction addressing sequence restrictions.

Mode 1

Mode 1 determines the addressing mode for one of the two operand sources required for the three operand instructions (found in categories ‘MATH’ and ‘SKIP’). These instructions are of the form:
Result=Operand 1 <function> Operand 2

Operand1 is always a register (i.e. the addressing mode can only be register direct) which is referred to as Wb. Operand 2 is fetched from data memory based upon the addressing mode selected by Mode 1. Mode 1 therefore defines one of the source operand addressing modes and implies that of the other source operand.

In addition, Mode 1 may also provide a signed 5-bit constant (literal) as the operand. In this case, the instruction is of the form:
Result=Operand 1 <function> signed literal

Operand 1 is always a register (i.e. the addressing mode can only be register direct) which is selected from the Ws field in the instruction. The 4-bit Wb field forms the 4 LS-bits of a signed constant. It is concatenated with the LS-bit of the three bit Mode 1 field to form the 5-bit signed constant value.

In summary, Mode 1 supports the addressing modes shown in Table 171

TABLE 171
Mode 1 Addressing Mode Definition

| Mode1 | Operand 1 | | Operand 2 | |
|---|---|---|---|---|
| Bit Encoding | Function | Description | Function | Description |
| 000 | EA = Wb | Register direct | EA = Ws | Register direct |
| 001 | EA = Wb | Register direct | EA = [Ws] | Register indirect |
| 010 | EA = Wb | Register direct | EA = [Ws]−= 1 | Register indirect post- |
| | | | | decremented |
| 011 | EA = Wb | Register direct | EA = [Ws]+= 1 | Register indirect post-incremented |
| 100 | EA = Wb | Register direct | EA = [Ws−=1] | Register indirect pre-decremented |
| 101 | EA = Wb | Register direct | EA = [Ws+=1] | Register indirect pre-incremented |
| 110 | EA = Ws | Register direct | Operand 2 = S5lit | 5-bit signed literal |
| 111 | | | | |

Mode 1, Register Direct

Addressing Mode 1, Submode 0 is register direct. The implied effective address is the memory mapped address of register Ws. Rather than executing a memory fetch, it may be preferable to perform two W-array fetches if bussing allows. The operand is contained in Ws as shown in FIG. 24.

Mode 1, Register Indirect

Addressing Mode 1, Submode 1 is register indirect. The effective address contained in register Ws points to the operand as shown in FIG. 25.

Mode 1, Register Indirect with Post Decrement

Addressing Mode 1, Submode 2 is register indirect with post decrement. The effective address contained in register Ws points to the operand. Ws is then post decremented as shown in FIG. 26.

Mode 1, Register Indirect with Post Increment

Addressing Mode 1, Submode 3 is register indirect with post increment. The effective address contained in register Ws points to the operand. Ws is then incremented as shown in FIG. 27.

Mode 1, Register Indirect with Pre Decrement

Addressing Mode 1, Submode 4 is register indirect with pre-decrement. Register Ws is decremented to form the effective address which points to the operand as shown in FIG. 28.

Mode 1, Register Indirect with Pre Increment

Addressing Mode 1, Submode 5 is register indirect with pre increment. Register Ws is incremented to form the effective address which points to the operand as shown in FIG. 29.

Mode 1, Register Direct with 5-Bit Signed Literal

Addressing Mode 1, Submode 6/7 is register direct with 5-bit signed literal. As shown in FIG. 30, operand 1 is contained in Ws. Operand 2 is the 5-bit signed literal embedded within the instruction. The 4-bit Wb field forms the 4 LS-bits of a signed constant. It is concatenated with the LS-bit of the three bit Mode 1 field to form the 5-bit signed constant value.

Mode 2

Mode 2 determines the addressing mode for either the result destination or a source operand, depending upon instruction requirements. It follows the same definition for each encoding as Mode 1 except that it applies to only one operand. The Mode 1 signed 5-bit constant value mode makes little sense where Mode 2 is used, and is therefore not supported. In summary, Mode 2 supports the addressing mode shown in Table 172.

TABLE 172
Mode 2 Addressing Mode Definition

| Mode 2 | | | |
|---|---|---|---|
| Bit | Function | Function | |
| Encoding | (Source) | (Destination) | Description |
| 000 | EA = Wsrc | EA = Wdst | Register direct |
| 001 | EA = [Wsrc] | EA = [Wdst] | Register direct |
| 010 | EA = [Wsrc]−= 1 | EA = [Wdst]−= 1 | Register indirect post- |
| | | | decremented |
| 011 | EA = [Wsrc]+= 1 | EA = [Wdst]+= 1 | Register indirect post- |
| | | | incremented |
| 100 | EA = [Wsrc−=1] | EA = [Wdst−=1] | Register indirect pre- |
| | | | decremented |
| 101 | EA = [Wsrc+=1] | EA = [Wdst+=1] | Register indirect pre- |
| | | | incremented |
| 110 | Unused | Unused | |
| 111 | Unused | Unused | |

Mode 2, Register Direct

Addressing Mode 2, Submode 0 is register direct. The implied effective address is the memory mapped address of register Wsrc or Wdst. The operand is contained in Wsrc as shown in FIG. 31, or the result is written to Wdst as shown in FIG. 32. In both cases, Wsrc or Wdst is accessed through addressing its memory mapped image. Note that, as the EA is implicitly defined as a word address, byte data size accesses will only be able to read or write the LS byte<7:0> (LS-bit of the EA is always clear) in this addressing mode. Rather than executing a memory fetch, it may be preferable to perform two W-array fetches if bussing allows???

Mode 2, Register Indirect

Addressing Mode 2, Submode 1 is register indirect. The effective address contained in register Wsrc points to the operand as shown in FIG. 33, or Wdst points to the result destination as shown in FIG. 34.

Mode 2, Register Indirect with Post Decrement

Addressing Mode 2, Submode 2 is register indirect with post decrement. The effective address contained in register Wsrc points to the operand, or the effective address contained in register Wdst points to the result destination. Wsrc or Wdst is then post decremented as shown in FIG. 35 and FIG. 36.

Mode 2, Register Indirect with Post Decrement

Addressing Mode 2, Submode 3 is register indirect with post decrement. The effective address contained in register Wsrc points to the source operand, or the effective address contained in register Wdst points to the result destination. Wsrc or Wdst are then decremented as shown in FIG. 37 and FIG. 38.

Mode 2, Register Indirect with Pre Decrement

Addressing Mode 2, Submode 4 is register indirect with pre decrement. Register Wsrc or Wdst is decremented to form the effective address which points to the operand as shown in FIG. 39 and FIG. 40

Mode 2, Register Indirect with Pre Increment

Addressing Mode 2, Submode 5 is register indirect with pre increment. Register Wsrc or Wdst is incremented to form the effective address which points to the operand as shown in FIG. 41 and FIG. 42.

Mode 3

Mode 3 is used by ‘MOVE’ and some of the DSP class instructions where addressing flexibility is important. It follows the same definition for each encoding as Mode 1 except that it uses the Wb field as an address operand (instead of a data operand). In addition, Mode 3 also supports register with register offset addressing mode, sometimes referred to as register indexed.

The 5-bit signed constant required by Submode 6/7 is created by concatenating the Wb field with the LS-bit of the 3-bit Mode 3 field. For the MOV instruction, the Mode 3 addressing modes can differ for the source and destination EA. However, the 4-bit Wb field is shared between both source and destination (but typically only used by one). In summary, Mode 3 supports the addressing mode shown in Table 173.

TABLE 173
Mode 3 Addressing mode Definition

| Mode 3 | | |
|---|---|---|
| Bit Encoding | Function | Description |
| 000 | EA = Wn | Register direct |
| 001 | EA = [Wn] | Register direct |
| 010 | EA = [Wdst]−= 1 | Register indirect post-decremented |
| 011 | EA = [Wdst]+= 1 | Register indirect post-incremented |
| 100 | EA = [Wdst−= 1] | Register indirect pre-decrement |
| 101 | EA = [Wn + Wb] | Register indirect with register offset |
| 110 | EA = [Wn + S5lit] | Register indirect with signed 5-bit |
| 111 | | constant value offset (note 1) |

Mode 3, Register Direct

Addressing Mode 3, Submode 0 is register direct. The implied effective address is the memory mapped address of register Wsrc or Wdst. The operand is contained in Wsrc as shown in FIG. 43, or the result is written to Wdst as shown in FIG. 44. In both cases, Wsrc or Wdst is accessed through addressing its memory mapped image. Rather than executing a memory fetch, it may be preferable to perform two W-array fetches if bussing allows.

Mode 3, Register Indirect

Addressing Mode 3, Submode 1 is register indirect. The effective address contained in register Wsrc points to the operand as shown in FIG. 45, or Wdst points to the result destination as shown in FIG. 46.

Mode 3, Register Indirect with Post Decrement

Addressing Mode 3, Submode 2 is register indirect with post decrement. The effective address contained in register Wsrc points to the operand, or the effective address contained in register Wdst points to the result destination. Wsrc or Wdst is then post decremented as shown in FIG. 47 and FIG. 48.

Mode 3, Register Indirect with Post Modification

Addressing Mode 3, Submode 3 is register indirect with post-increment. The effective address contained in register Wsrc points to the operand or the effective address contained in register Wdst points to the result destination. Wsrc or Wdst are then incremented as shown in FIG. 49 and FIG. 50.

Mode 3, Register Indirect with Pre Decrement

Addressing Mode 2, Submode 4 is register indirect with pre decrement. Register Wsrc or Wdst is decremented to form the effective address which points to the operand as shown in FIG. 51 and FIG. 52.

Mode 3, Register Indirect with Register Offset

Addressing Mode 3, Submode 5 is register indirect with register offset. For an operand read, the effective address of the operand is formed by adding the contents of Wsrc and Wb as shown in FIG. 53. For a result destination write, the effective address of the operand is formed by adding the contents of Wdst and Wb as shown in FIG. 54. Wb, Wsc or Wdst are not modified by these operations unless bit reversed addressing (described elsewhere in this specification) is enabled, in which case Wsc and/or Wdst are updated with the new EA. This is the only addressing mode which operates in a meaningful way with bit reversed addressing.

Mode 3, Register Indirect with Constant Offset

Addressing Mode 3, Submode 6/7 is register indirect with constant offset. For an operand read, the effective address of the operand is formed by adding the contents of Wsrc and a 5-bit signed literal, as shown in FIG. 55. For a result destination write, the effective address of the operand is formed by adding the contents of Wdst and a 5-bit signed literal as shown in FIG. 56. Wsc or Wdst are not modified by these operations. The 4-bit Wb field forms the 4 LS-bits of the signed constant. It is concatenated with the LS-bit of the three bit Mode 1 field to form a 5-bit signed constant value If the 5-bit signed literal equals 0, this addressing mode is interpreted as register indirect with a pre-decrement.

Mode 4

The dual source operand DSP instructions (MAC, CLRAC, MPYAC & MOVAC) utilize a simplified set of addressing modes (Mode 4) to allow the user to effectively manipulate the data pointers through register indirect tables.

Wsrc must be a member of the set {W4, W5, W6, W7}. For data reads, W4 and W5 will always be directed to the X AGU and W6 and W7 will always be directed to the Y AGU. The effective addresses generated (before and after modification) must therefore be valid addresses within X data space for W4 and W5, and Y data space for W6 and W7. Register indirect with register offset addressing is only available for W5 (in X space) and W7 (in Y space).

In summary, Mode 4 supports the addressing modes shown in Table 174 for X data space and those shown in Table 175 for Y data space.

TABLE 174
Mode 4 Addressing Mode Definition for X Data Space

| Mode 4 | | |
|---|---|---|
| Bit Encoding | Function | Description |
| 0000 | EA = [W 4 ] | Register indirect |
| 0001 | EA = [W 4 ]+=2 | Register indirect post-inc by 2 |
| 0010 | EA = [W 4 ]+=4 | Register indirect post-inc by 4 |
| 0011 | EA = [W 4 ]+=6 | Register indirect post-inc by 6 |
| 0100 | None | Disable data pre-fetch |
| 0101 | EA = [W 4 ]−=6 | Register indirect post-dec by 6 |
| 0110 | EA = [W 4 ]−=4 | Register indirect post-dec by 4 |
| 0111 | EA = [W 4 ]−=2 | Register indirect post-dec by 2 |
| 1000 | EA = [W 5 ] | Register indirect |
| 1001 | EA = [W 5 ]+=2 | Register indirect post-inc by 2 |
| 1010 | EA = [W 5 ]+=4 | Register indirect post-inc by 4 |
| 1011 | EA = [W 5 ]+=6 | Register indirect post-inc by 6 |
| 1100 | EA = [W 5 +W 8 ] | Register indirect with register |
| | | offset (indexed) |
| 1101 | EA = [W 5 ]−=6 | Register indirect post-dec by 6 |
| 1110 | EA = [W 5 ]−=4 | Register indirect post-dec by 4 |
| 1111 | EA = [W 5 ]−=2 | Register indirect post-dec by 2 |

Mode 4 instructions are word sized only, so post-modification values are already scaled appropriately

Addressing mode defined by read address space

TABLE 175
Mode 4 Addressing mode Definition for Y Data Space

| Mode 4 | | |
|---|---|---|
| Bit Encoding | Function | Description |
| 0000 | EA = [W 6] | Register indirect |
| 0001 | EA = [W 6]+ = 2 | Register indirect post-inc by 2 |
| 0010 | EA = [W 6]+ = 4 | Register indirect post-inc by 4 |
| 0011 | EA = [W 6]+ = 6 | Register indirect post-inc by 6 |
| 0100 | None | Disable data pre-fetch |
| 0101 | EA = [W 6]− = 6 | Register indirect post-dec by 6 |
| 0110 | EA = [W 6]− = 4 | Register indirect post-dec by 4 |
| 0111 | EA = [W 6]− = 2 | Register indirect post-dec by 2 |
| 1000 | EA = [W 7] | Register indirect |
| 1001 | EA = [W 7]+ = 2 | Register indirect post-inc by 2 |
| 1010 | EA = [W 7]+ = 4 | Register indirect post-inc by 4 |
| 1011 | EA = [W 7]+ = 6 | Register indirect post-inc by 6 |
| 1100 | EA = [W 7 + W 8] | Register indirect with register offset |
| 1101 | EA = [W 7]− = 6 | Register indirect post-dec by 6 |
| 1110 | EA = [W 7]− = 4 | Register indirect post-dec by 4 |
| 1111 | EA = [W 7]− = 2 | Register indirect post-dec by 2 |

Mode 4 instructions are word sized only, so post-modification values are already scaled appropriately
Addressing mode defined by read address space
Mode 4, Register Indirect

Addressing Mode 4, Submodes 0 & 8 are register indirect. The effective address contained in register Wsrc points to the operand as shown in FIG. 59. Only word sized operands are allowed.

Mode 4, Register Indirect with Post Increment

Addressing Mode 4, Submodes 1, 2, 3, 9, 10 & 11 are register indirect with post increment. The effective address contained in register Wsrc points to the operand. Wsrc is then post incremented by 2, 4 or 6 as shown in FIG. 60. Misaligned word fetches are possible if Wsrc contains an odd value. Should this occur, an address error trap will be generated.

Mode 4, Pre-Fetch Inhibit

Addressing mode Mode 4, Submode 4 will inhibit a data fetch from X or Y address space. No target registers are modified.

Mode 4, Register Indirect with Register Offset

Addressing Mode 4, Submodes 12 is register indirect with register offset. The effective address of the operand is formed by adding the contents of Wsrc (W5 or W7) and W8 as shown in FIG. 61. The offset register is fixed as W8. Neither Wsrc or W8 are not modified by these operations. This addressing mode operates in an identical manner to that of Mode 3 register indirect with register offset, in which the offset register (W8 in this case) is not automatically scaled for word accesses. Consequently, misaligned word fetches are possible if W8 contains an odd value. Should this occur, an address error trap will be generated.

Addressing Mode 4, Submodes 5, 6, 7, 13, 14 & 15 are register indirect with post decrement. The effective address contained in register Wsrc points to the operand. Wsrc is then post decremented by 2, 4 or 6 as shown in FIG. 62. Misaligned word fetches are possible if Wsrc contains an odd value. Should this occur, an address error trap will be generated.

X AGU

The X AGU supports all addressing modes including modulo addressing and bit reversed addressing. A block diagram is shown in FIG. 63. The basic elements are now described.

Effective Address Adder

The effective address (EA) adder generates the effective addresses for all instruction using X data space prior to modification by modulo addressing. It supports all addressing modes including bit reversed addressing. The adder accepts the source or destination W register on the A input and either of the following on B input based upon which addressing mode is required.
1. Offset (Wb) register contents
2. Signed 5-bit literal, Slit5
3. Constant value of: 0, +1, +2, +4, +6, −1, −2, −4 or −6
   The value range for Slit5 is −16<=Slit5<=+15.
   Modulo and Bit Reversed Addressing Controller

The Modulo and Bit Reversed Addressing Controller block enables or disables these addressing modes, and provides the appropriate control signals to the rest of the AGU. If modulo and bit reversed addressing are disabled, the EA adder result passes unmodified to the AGU output.

Modulo Addressing Comparator/Subtractor

Modulo addressing relies on automatic correction of any generated EA such that it is forced back into the selected circular buffer address range. For an incrementing buffer, the offset sign is positive. The end address is therefore routed to the subtractor, and subtracted from the new EA. If the result is negative, the address is within the buffer boundaries and will propagate unchanged. If the result is positive (including zero), indicating the EA has passed the end address, it is logically ORed with the start address. This is equivalent to adding it to the start address to create the wrap address for a start address on a ‘zero’ power of two boundary.

For a decrementing buffer, the offset sign is negative. The start address is therefore routed to the subtractor, and subtracted from the new EA. If the result is positive, the address is within the buffer boundaries and will propagate unchanged. If the result is negative, indicating the EA has passed the start address, it is logically AND'ed with the start address. This is equivalent to adding it (a negative value) to the start address to create the wrap address for an end address on a ‘ones’ address boundary.

Y AGU

As the Y AGU is only used by the MAC class of DSP instructions, its function is restricted to supporting post-modified register indirect (using a constant modifier) and modulo addressing. A block diagram is shown in FIG. 64. The basic elements are now described.

Effective Address Adder

The effective address (EA) Adder generates the effective addresses for all instruction using Y data space prior to modification by modulo addressing. It supports post-modified register indirect (using a constant modifier). It does not support bit reversed addressing. The adder accepts the source or destination W register on the A input and a constant (0, +2, +4, +6, −2, −4 or −6) on B input, depending upon the post modified constant declared the instruction.

Modulo Addressing Controller

The Modulo Addressing Controller block enables or disables modulo addressing, and provides the appropriate control signals to the rest of the AGU. If modulo addressing is disabled, the EA adder result passes unmodified to the AGU output.

Modulo Addressing Comparator/Subtractor

Modulo addressing relies on automatic correction of any generated EA such that it is forced back into the selected circular buffer address range. For an incrementing buffer, the offset sign is positive. The end address is therefore routed to the subtractor, and subtracted from the new EA. If the result is negative, the address is within the buffer boundaries and will propagate unchanged. If the result is positive (including zero), indicating the EA has passed the end address, it is logically ORed with the start address. This is equivalent to adding it to the start address to create the wrap address for a start address on a ‘zero’ power of two boundary.

For a decrementing buffer, the offset sign is negative. The start address is therefore routed to the subtractor, and subtracted from the new EA. If the result is positive, the address is within the buffer boundaries and will propagate unchanged. If the result is negative, indicating the EA has passed the start address, it is logically AND'ed with the start address. This is equivalent to adding it (a negative value) to the start address to create the wrap address for an end address on a ‘ones’ address boundary.

Modulo Addressing

Modulo addressing is a method of providing an automated means to support circular data buffers using hardware. The objective is to remove the need for software to perform data address boundary checks when executing tightly looped code as is typical in many DSP algorithms.

dsPIC modulo addressing can operate in either data or program space (since the data pointer mechanism is essentially the same for both). One circular buffer can be supported in each of the X (which also provides the pointers into Program space) and Y data spaces. Modulo addressing can operate on any W register pointer.

In order to minimize the hardware size for modulo addressing support, certain usage restrictions may be imposed. In summary, any one circular buffer can only be allowed to operate in one direction as the buffer start address (for incrementing buffers) or end address (for decrementing buffers) is restricted based upon the direction of the buffer. The direction is determined from the address offset sign.

Start and End Address

The modulo addressing scheme requires that either a starting or an end address be specified and loaded into the 16-bit modulo buffer address registers, XMODSRT, XModeND, YMODSRT, YModeND.

The data buffer start address is arbitrary but must be at a ‘zero’, power of two boundary for incrementing address buffers. It can be any address for decrementing address buffers. For example, if the buffer size (modulus value) is chosen to be 100 bytes (0x64), then the buffer start address for an incrementing buffer must contain 7 least significant zeros. Valid start addresses may therefore be 0xXX00 and 0xXX80 where ‘x’ is any hexadecimal value. Adding the buffer length to this value will give the end address to be written into X/YModeND. For example, if the start address was chosen to be 0x2000, then the X/YModeND would be set to (0x2000+0x0064)=0x2064. Note that the last physical address of the buffer will be at end address −1 because the buffer range is 0 to 0x63. ‘Starting address’ refers to the smallest address boundary of the circular buffer. The initial entry address (first access of the buffer) may point to any address within the modulus range.

The data buffer end address is arbitrary but must be at a ‘ones’ boundary for decrementing buffers. It can be at any address for an incrementing buffer. For example, if the buffer size (modulus value) is chosen to be 100 bytes (0x64), then the buffer end address for an incrementing buffer must contain 7 least significant ones. Valid end addresses may therefore be 0xXXFF and 0xXX7F where ‘X’ is any hexadecimal value. Subtracting the buffer length from this value the adding 1 will give the start address to be written into X/YMODSRT. For example, if the end address was chosen to be 0x207F, then the start address would be (0x207F−0x0064+1)=0x201C, which is the first physical address of the buffer.

In an incrementing buffer, the modulo addressing hardware performs the address correction by subtracting the buffer end address from the EA and, if the result is positive, adding it to the start address. As the start address is on a ‘zero’, power of two boundary, the addition may be performed by a logical OR operation.

In a decrementing buffer, the modulo addressing hardware performs the address correction by subtracting the buffer start address from the EA and, if the result is negative, adding it to the end address. As the end address is on a ‘ones’ boundary, the addition may be performed by a logical AND operation. All modulo addressing EA calculations assume word size data (LS-bit of every EA is always clear). The XM value may scaled accordingly to generate compatible (byte) addresses, leaving the LS-bit of all EAs clear.

Buffer Length

The data buffer length can be any value up to 64K words. The buffer length is not used in this scheme to correct buffer addresses or determine modulo range.

W Address Register Selection

The modulo and bit reversed addressing control register MODCON<15:0> contains enable flags plus W register field to specify the W address registers. The XWM and YWM fields selects which registers will operate with modulo addressing. If XWM=15, AGU X modulo addressing is disabled. Similarly, if YWM=15, AGU Y modulo addressing is disabled.

Modulo addressing and bit reversed addressing should not be enabled together. In the event that the user attempts to do this, bit reversed addressing will assume priority when active and X modulo addressing will be disabled.

The X address space pointer W register (XWM) to which modulo addressing is to be applied, is stored in MODCON<3:0> (see Table 176). Modulo addressing is enabled for X data space when XWM is set to any value other than 15 and the XModeN bit is set at MODCON[15].

The Y address space pointer W register (YWM) to which modulo addressing is to be applied, is stored in MODCON<7:4> (see Table 177). Modulo addressing is enabled for Y data space when YWM is set to any value other than 15 and the YModeN bit is set at MODCON[14].

Modulo Addressing Applicability

Modulo addressing can be applied to the effective address (EA) calculation associated with any W register. It is important to realize that the address boundaries checks look for addresses less than or greater than the upper (for incrementing buffers) and lower (for decrementing buffers) boundary addresses (not just equal to). Address changes may therefore jump over boundaries and still be adjusted correctly.

TABLE 176
MODCON, Modulo & Bit Reversed addressing Control Register
(0xxxxx)
Upper Half:

| | | | | | | | |
|---|---|---|---|---|---|---|---|
| R/W-0 | R/W-0 | U | U | R/W-0 | R/W-0 | R/W-0 | R/W-0 |
| XModeN | YModeN | — | — | BWM3 | BWM2 | BWM1 | BWM0 |
| bit 15 | | | | | | | bit 8 |

Lower Half:

| | | | | | | | |
|---|---|---|---|---|---|---|---|
| R/W-0 | R/W-0 | R/W-0 | R/W-0 | R/W-0 | R/W-0 | R/W-0 | R/W-0 |
| YWM3 | YWM2 | YWM1 | YWM0 | XWM3 | XWM2 | XWM1 | XWM0 |
| bit 7 | | | | | | | bit 0 |

| | |
|---|---|
| 15 | XModeN: X AGU Modulus Addressing Enable |
| | 1 = X AGU Modulus Addressing enabled |
| | 0 = X AGU Modulus Addressing disabled |
| 14 | YModeN: Y AGU Modulus Addressing Enable |
| | 1 = Y AGU Modulus Addressing enabled |
| | 0 = Y AGU Modulus Addressing disabled |
| 13 | Unused |
| 12 | Unused |
| 11-8 | BWM: X AGU Register Select for Bit Reversed Addressing |
| | 0000 = W0 selected for bit reversed addressing |
| | \|\| |
| | 1110 = W14 selected for bit reversed addressing |
| | 1111 = W15 bit reversed addressing disabled |
| 7-4 | YWM: Y AGU W Register Select for Modulo Addressing |
| | 0000 = W0 selected for modulo addressing |
| | \|\| |
| | 1110 = W14 selected for modulo addressing |
| | 1111 = W15 modulo addressing disabled |
| 3-0 | XWM: X AGU W Register Select for Modulo Addressing |
| | 0000 = W0 selected for modulo addressing |
| | \|\| |
| | 1110 = W14 selected for modulo addressing |
| | 1111 = W15 modulo addressing disabled |

Legend
R = Readable bit
W = Writable bit
U = Unimplemented bit, read as ‘0’
−n = Value at POR
1 = bit is set
0 = bit is cleared
x = bit is unknown

TABLE 177
XMODSRT, X AGU Modulo addressing Start Register (XXXX h)
Upper Half:

| | | | | | | | |
|---|---|---|---|---|---|---|---|
| R/W-0 | R/W-0 | R/W-0 | R/W-0 | R/W-0 | R/W-0 | R/W-0 | R/W- |
| | | | | | | | 0 |
| XS15 | XS14 | XS13 | XS12 | XS11 | XS10 | XS9 | XS8 |
| bit 15 | | | | | | | bit 8 |

Lower Half:

| | | | | | | | |
|---|---|---|---|---|---|---|---|
| R/W-0 | R/W-0 | R/W-0 | R/W-0 | R/W-0 | R/W-0 | R/W-0 | R/W- |
| | | | | | | | 0 |
| XS7 | XS6 | XS5 | XS4 | XS3 | XS2 | XS1 | XS0 |
| bit 7 | | | | | | | bit 0 |

| | |
|---|---|
| 15-0 | XS: X AGU Modulo Addressing Start Address |

Legend
R = Readable bit
W = Writable bit
U = Unimplemented bit, read as ‘0’
−n = Value at POR
1 = bit is set
0 = bit is cleared
x = bit is unknown

TABLE 178
XModeND, X AGU Modulo addressing END Register (XXXX h)
Upper Half:

| | | | | | | | |
|---|---|---|---|---|---|---|---|
| R/W-0 | R/W-0 | R/W-0 | R/W-0 | R/W-0 | R/W-0 | R/W-0 | R/W- |
| | | | | | | | 0 |
| XE15 | XE14 | XE13 | XE12 | XE11 | XE10 | XE9 | XE8 |
| bit 15 | | | | | | | bit 8 |

Lower Half:

| | | | | | | | |
|---|---|---|---|---|---|---|---|
| R/W-0 | R/W-0 | R/W-0 | R/W-0 | R/W-0 | R/W-0 | R/W-0 | R/W- |
| | | | | | | | 0 |
| XE7 | XE6 | XE5 | XE4 | XE3 | XE2 | XE1 | XE0 |
| bit 7 | | | | | | | bit 0 |

| | |
|---|---|
| 15-0 | XE: X AGU Modulo Addressing End Address |

Legend
R = Readable bit
W = Writable bit
U = Unimplemented bit, read as ‘0’
−n = Value at POR
1 = bit is set
0 = bit is cleared
x = bit is unknown

TABLE 179
YMODSRT, Y AGU Modulo addressing Start Register (XXXX h)
Upper Half:

| | | | | | | | |
|---|---|---|---|---|---|---|---|
| R/W-0 | R/W-0 | R/W-0 | R/W-0 | R/W-0 | R/W-0 | R/W-0 | R/W- |
| | | | | | | | 0 |
| YS15 | YS14 | YS13 | YS12 | YS11 | YS10 | YS9 | YS8 |
| bit 15 | | | | | | | bit 8 |

Lower Half:

| | | | | | | | |
|---|---|---|---|---|---|---|---|
| R/W-0 | R/W-0 | R/W-0 | R/W-0 | R/W-0 | R/W-0 | R/W-0 | R/W- |
| | | | | | | | 0 |
| YS7 | YS6 | YS5 | YS4 | YS3 | YS2 | YS1 | YS0 |
| bit 7 | | | | | | | bit 0 |

| | |
|---|---|
| 15-0 | YS: Y AGU Modulo Addressing Start Address |

Legend
R = Readable bit
W = Writable bit
U = Unimplemented bit, read as ‘0’
−n = Value at POR
1 = bit is set
0 = bit is cleared
x = bit is unknown

TABLE 180
YModeND, Y AGU Modulo addressing END Register (XXXX h)
Upper Half:

| | | | | | | | |
|---|---|---|---|---|---|---|---|
| R/W-0 | R/W-0 | R/W-0 | R/W-0 | R/W-0 | R/W-0 | R/W-0 | R/W- |
| | | | | | | | 0 |
| YE15 | YE14 | YE13 | YE12 | YE11 | YE10 | YE9 | YE8 |
| bit 15 | | | | | | | bit 8 |

Lower Half:

| | | | | | | | |
|---|---|---|---|---|---|---|---|
| R/W-0 | R/W-0 | R/W-0 | R/W-0 | R/W-0 | R/W-0 | R/W-0 | R/W- |
| | | | | | | | 0 |
| YE7 | YE6 | YE5 | YE4 | YE3 | YE2 | YE1 | YE0 |
| bit 7 | | | | | | | bit 0 |

| | |
|---|---|
| 15-0 | YE: X AGU Modulo Addressing End Address |

Legend
R = Readable bit
W = Writable bit
U = Unimplemented bit, read as ‘0’
−n = Value at POR
1 = bit is set
0 = bit is cleared
x = bit is unknown

Modulo Addressing Restrictions

As stated above, for an incrementing buffer the circular buffer start address (lower boundary) is arbitrary but must be at a ‘zero’, power of two boundary. For a decrementing buffer, the circular buffer end address is arbitrary but must be at a ‘ones’ boundary. With this scheme, there are no restriction regarding how much an EA calculation can exceeds the address boundary being checked, and still be successfully corrected. Once configured, the direction of successive addresses into a buffer cannot be changed. Although all EA's will continue to be generated correctly irrespective of offset sign, only one address boundary is checked for each type of buffer. Accessing an incrementing buffer with a decrementing address could result in the address decrementing through the start address. If this occurs, an out of range address will be detected but the address wrap operation will fail unless the end address is on a ‘ones’ address boundary (because the addition is simplified to an OR operation). For example, if the start address=0x2000, end addresses that will support a bi-directional buffer include 0x200F, 0x203F or any modulo 2 length buffer. As similar augment applies to accessing a decrementing buffer with an incrementing address.

Modulo Addressing Timing

Modulo addressing can operate on both source and destination operands (i.e. for data reads and writes). Consequently, it must meet timing for the standard instruction cycle timing. Ideally, all AGU adder results should be stable by the end of Q1 (for reads and stack writes) or Q3 (for writes or stack reads). Effective address selection should occur on rising Q2 or Q4. The W address register update (when required) should occur during Q2.

Alternatively, each AGU could be built as an asynchronous block allowing the address calculation and selection to ripple through. However, it is highly likely that this will result in many spurious address transitions which could effect power consumption if allowed to propagate too far.

Bit Reversed Addressing

Bit reversed addressing is intended to simplify data re-ordering for radix-2 FFT algorithms. It is supported by the X AGU only. The carry propagation direction for a bit reversed EA calculation is changed to most significant bit to least significant bit. The modifier (a constant value or register contents) must also be regarded as having its bit order reversed. For example, for a 16 entry buffer (words & byte data size implications are discussed later), the address pointer and result are bit re-ordered as shown in FIG. 67.

This example shows a pointer being incremented by one by an adder with a conventional carry direction. The modifier is presented in normal bit order (ls-bit to the right). The address pointer is a bit reversed EA and is presented in reversed bit order (LS-bit to the left). The address and result must be flipped around a pivot point in the middle of the address length in order for this to work with a conventional adder. The problem arises when the buffer length is a variable which makes the bit swap operation unreasonably complex (the pivot point varies). An alternative is to keep the address source and destination in reversed order and use a bit reversed modifier with a reversed carry adder as shown in FIG. 68. The net result is the same but the only operand requiring reversal is the modifier. As this is a constant, the reversed value does not need to be created for each calculation.

Table 181 shows the result of traversing the entire buffer, starting at address 0. Other modifier values will produce a bit-reversed address sequence, but only this one is reported to be of any real use.

TABLE 181
Bit Reversed Address Sequence (16-Entry)
Bit Reversed Address

| A0 | A1 | A2 | A3 |
|---|---|---|---|
| 0 | 0 | 0 | 0 |
| 1 | 0 | 0 | 0 |
| 0 | 1 | 0 | 0 |
| 1 | 1 | 0 | 0 |
| 0 | 0 | 1 | 0 |
| 1 | 0 | 1 | 0 |
| 0 | 1 | 1 | 0 |
| 1 | 1 | 1 | 0 |
| 0 | 0 | 0 | 1 |
| 1 | 0 | 0 | 1 |
| 0 | 1 | 0 | 1 |
| 1 | 1 | 0 | 1 |
| 0 | 0 | 1 | 1 |
| 1 | 0 | 1 | 1 |
| 0 | 1 | 1 | 1 |
| 1 | 1 | 1 | 1 |

Bit reversed addressing is only supported by the X AGU. The address adder carry reverse signal (see FIG. 63) is asserted when:
1. XWB (W register selection) in the XMOD register is any value other than 15 (it is assumed that nobody will ever want to bit reverse address the stack) and
2. the BREN bit is set in the XBREV register and
3. the addressing mode is register in direct with post-increment.

XB<14:0> is the bit reversed address modifier which is typically a constant, indirectly representing the size of the FFT data buffer. The XB values required to provide the correct bit reversal ‘pivot’ points for various size buffers are shown in Table 182. All bit reversed EA calculations assume word size data (LS-bit of every EA is always clear). The XB value is scaled accordingly to generate compatible (byte) addresses.

TABLE 182
Address Modifier Values

| Buffer Size | 12-bit Bit Reversed | XB Scaled for |
|---|---|---|
| (words) | Address Modifier (XB) | Word Sized Data |
| 32768 | 0x4000 | 0x8000 |
| 16384 | 0x2000 | 0x4000 |
| 8192 | 0x1000 | 0x2000 |
| 4096 | 0x0800 | 0x1000 |
| 2048 | 0x0400 | 0x0800 |
| 1024 | 0x0200 | 0x0400 |
| 512 | 0x0100 | 0x0200 |
| 256 | 0X0080 | 0x0100 |
| 128 | 0x0040 | 0x0080 |
| 64 | 0x0020 | 0x0040 |
| 32 | 0x0010 | 0x0020 |
| 16 | 0x0008 | 0x0010 |
| 8 | 0x0004 | 0x0008 |
| 4 | 0x0002 | 0x0004 |
| 2 | 0x0001 | 0x0002 |

As can be seen from FIG. 68, requiring that both the address modifier (constant) and the address in the W pointer are always in bit reversed format simplifies the hardware. Adding two bit reversed values though the adder with carry reversed enabled, will produce the correct bit reversed result. When enabled, bit reversed addressing will only be executed with register indirect with post increment addressing and word sized data. It will not function for all other addressing modes or byte sized data (normal addresses will be generated). When bit reversed addressing is active, the W address pointer will always be added to the address modifier (XB) and the offset associated with the register indirect addressing mode will be ignored. In addition, as word sized data is a requirement, the LS-bit of the EA is ignored (and always clear). An example word swap using bit reversed addressing is:
MOV [W9], W0
MOV [W8], [W9]+
MOV W0, [W8]+

See in particular FIGS. 69 and 70.

TABLE 183
XBREV, X AGU Bit Reversal addressing Control Register (xxxx h)
Upper Half:

| | | | | | | | |
|---|---|---|---|---|---|---|---|
| R/W-0 | R/W-0 | R/W-0 | R/W-0 | R/W-0 | R/W-0 | R/W-0 | R/W- |
| | | | | | | | 0 |
| BREN | XB14 | XB13 | XB12 | XB11 | XB10 | XB9 | XB8 |
| bit 15 | | | | | | | bit 8 |

Lower Half:

| | | | | | | | |
|---|---|---|---|---|---|---|---|
| R/W-0 | R/W-0 | R/W-0 | R/W-0 | R/W-0 | R/W-0 | R/W-0 | R/W- |
| | | | | | | | 0 |
| XB7 | XB6 | XB5 | XB4 | XB3 | XB2 | XB1 | XB0 |
| bit 7 | | | | | | | bit 0 |

| | |
|---|---|
| 15 | BREN: Bit Reversed Addressing (X AGU) Enable |
| | 1 = Bit Reversed Addressing enabled |
| | 0 = Bit Reversed Addressing disabled |
| 14-0 | XB<14:0>: X AGU bit reversed Modifier |
| | e.g. XB<14:0> = 0x0080; modifier for a 128 point radix-2 FFT |

Legend
R = Readable bit
W = Writable bit
U = Unimplemented bit, read as ‘0’
−n = Value at POR
1 = bit is set
0 = bit is cleared
x = bit is unknown

Many applications require significant amounts of fixed data (e.g. MELP) which can only be held in non-volatile memory. This data can also exceed the 32K word limit of data space memory. Consequently, this data will have to reside in on-chip program FLASH, ROM or in external program space. In order to accommodate this requirement, two addressing options are provided.
1. The table instructions allows direct movement of word and byte data respectively between program and data space without passing through an intermediate register.
2. The upper part of data space may be configured to map into a 16K word segment of program space.

The operation of these addressing options is discussed elsewhere in this specification. The following sections revisit the table instructions, in particular the addressing modes supported.

Table Instruction Operation

There are four ‘table’ instructions as shown in Table 184 that operate with Mode 2 addressing modes for both operand source and destination. They operate in a manner similar to that for data space access except that the EA for program space (source or destination) is concatenated with a 8-bit page register, TABPAG<7:0> to create a 24-bit address. All table instructions treat the program memory as 16-bit wide, byte addressable (i.e. same as data space). Program space EA[24:1] forms the 24-bit program memory address and the EA[0] becomes a byte select bit. The TBLRDL and TBLWTL instructions are dedicated to accessing the LS program word.

The program word is viewed as a 32-bit entity which consists of a 24-bit program word plus an 8-bit ‘phantom’ byte (MS-byte). This allows TBLRDH and TBLWTH instructions (which are dedicated to accessing the MS program word) to maintain orthogonality with TBLRDL and TBLWTL. For TBLRDH and TBLWTH instructions, EA[0] remains a byte select bit but physical memory is only present in the LS-byte (EA[0]=0). A byte read of the MS-byte (EA[0]=1) will return 0x00.

Table Read Operation

The program memory is always read as 24-bit long words. The LS-bit of the EA is used by the TBLRDL and TBLWTL (if required) to select required byte of the LS program word. Table 184 indicates which instruction and data width will access the various parts of the program word.

TABLE 184
Table Instruction Summary

Program Space
Data Move Function

| Instruction | EA[0] | Source | Destination |
|---|---|---|---|
| TBLRDH.w 1 | x | [EAsrc]<31:16> | [EAdst]<15:0> |
| TBLRDH.b | 0 | [EAsrc]<16:23> | [EAdst]<7:0> |
| TBLRDH.b 1 | 1 | [EAsrc]<31:24> | [EAdst]<7:0> |
| TBLRDL.w | x | [EAsrc]<15:0> | [EAdst]<15:0> |
| TBLRDL.b | 0 | [EAsrc]<7:0> | [EAdst]<7:0> |
| TBLRDL.b | 1 | [EAsrc]<15:8> | [EAdst]<7:0> |

MS-byte read will return 0x00

TBLRDH.w reads a data word from [EAsrc]<31:16>, though [EAsrc]<31:24> will equal 0x00. TBLRDH.b reads a data byte from [EAsrc]<31:24> (always equal to 0x00) or [EAsrc]<16:23> based on the state of EA[0]. The data byte is transferred into destination EA[7:0].

TBLRDL.w reads a data word from [EAsrc]<15:0>. TBLRDL.b reads a data byte from [EAsrc]<15:0> or [EAsrc]<7:0> based on the state of EA[0]. The data byte is transferred into destination EA[7:0].

For most applications, it is assumed that only the LS word of the program word will be used for data storage. The MS byte of the program word would then typically contain an illegal instruction trap to prevent the machine from ever inadvertently attempting to execute data. However, TBLRDH is provided to allow the use of all program memory for data storage if desired.

Table Writes

Mode 2 Addressing for Program Space

Mode 2 determines the addressing mode for the operand source/destination in program space or the operand source/destination from data space, depending upon instruction requirements. It follows the same definition for each encoding as Mode 1 except that it applies to only one operand. The Mode 1 signed 5-bit constant value mode makes little sense where Mode 2 is used, and is therefore not supported.

In summary, Mode 2 for program space data accesses supports the addressing mode shown in Table 185. Mode 2 Submode 0 is meaningless for TBLRD source and TBLWT destination operands as the program memory must be addressed with a pointer. The following addressing mode descriptions are for table read operations.

TABLE 185
Mode 2 Addressing Mode Definition (Program Space)

| Mode 2 | | | |
|---|---|---|---|
| Bit | Function | Function | |
| Encoding | (Source) | (Destination) | Description |
| 000 | EA = Wsrc 1 | EA = Wdst 2 | Register direct |
| 001 | EA = [Wsrc] | EA = [Wdst] | Register indirect |
| 010 | EA = [Wsrc]− = 1 | EA = [Wdst]− = 1 | Register indirect |
| | | | post-decremented |
| 011 | EA = [Wsrc]+ = 1 | EA = [Wdst]+ = 1 | Register indirect |
| | | | post-incremented |
| 100 | EA = [Wsrc− = 1] | EA = [Wdst− = 1] | Register indirect |
| | | | pre-decremented |
| 101 | EA = [Wsrc+ = 1] | EA = [Wdst+ = 1] | Register indirect |
| | | | pre-incremented |
| 110 | Unused | Unused | |
| 111 | Unused | Unused | |

Note,
this is not meaningful for TBLRD or TBLWT instructions

Mode 2, Register Direct

Addressing Mode 2, Submode 0 is register direct. The implied effective address is the memory mapped address of register Wdst. The table read result is written to Wdst as shown in FIG. 71. Wdst is accessed through addressing its memory mapped image. Note that register direct for the operand source of a table read, and the operand destination for a table write has no meaning. The X AGU would generate an EA which would address the memory mapped version of Wsrc or Wdst. When concatenated with the TABPAG register, this address will be the same but within a program space page.

Mode 2, Register Indirect

Addressing Mode 2, Submode 1 is register indirect. The effective address contained in register Wsrc points to the operand as shown in FIG. 72, or Wdst points to the result destination as shown in FIG. 73. For table read instructions, TABPAG<7:0> is concatenated onto the source EA to form the 24-bit program space EA.

Mode 2, Register Indirect with Post Decrement

Addressing Mode 2, Submode 2 is register indirect with post decrement. The effective address contained in register Wsrc points to the operand, or the effective address contained in register Wdst points to the result destination. Wsrc or Wdst is then post decremented as shown in FIG. 74 and FIG. 75.

Mode 2, Register Indirect with Post Increment

Addressing Mode 2, Submode 3 is register indirect with post increment. The effective address contained in register Wsrc points to the source operand, or the effective address contained in register Wdst points to the result destination. Wsrc or Wdst are then incremented as shown in FIG. 76 and FIG. 77.

Mode 2, Register Indirect with Pre Decrement

Addressing Mode 2, Submode 4 is register indirect with pre decrement. Register Wsrc or Wdst is decremented to form the effective address which points to the operand as shown in FIG. 78 and FIG. 79.

Mode 2, Register Indirect with Pre Increment

Addressing Mode 2, Submode 5 is register indirect with pre increment. Register Wsrc or Wdst is incremented to form the effective address which points to the operand as shown in FIG. 80 and FIG. 81.

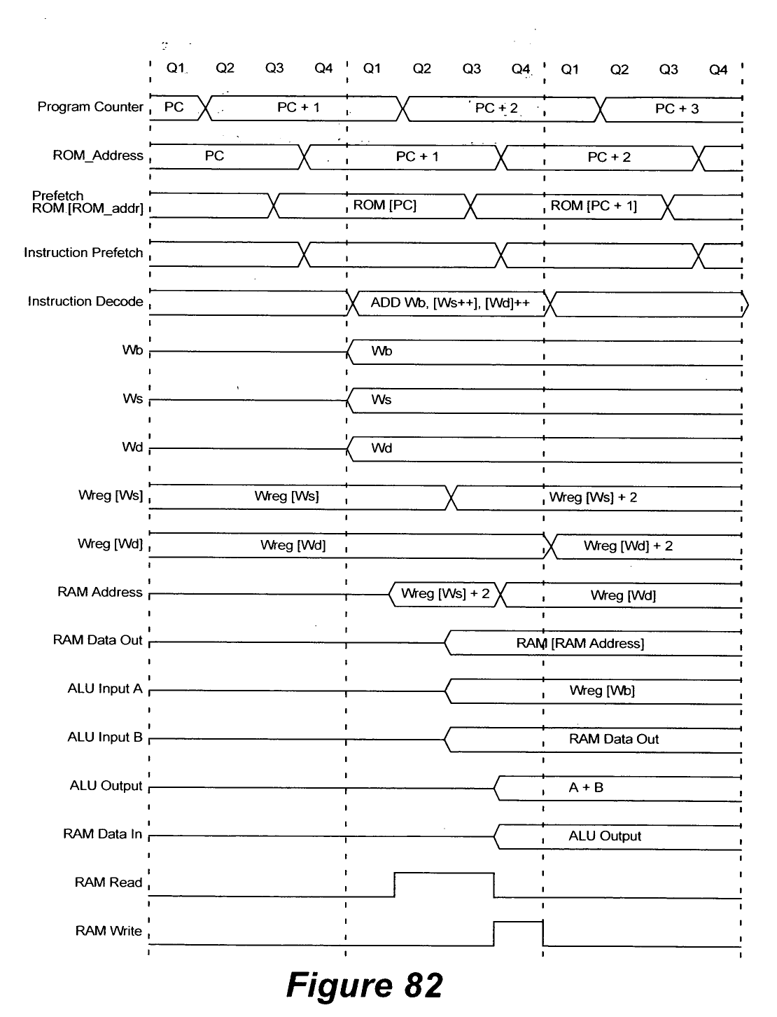

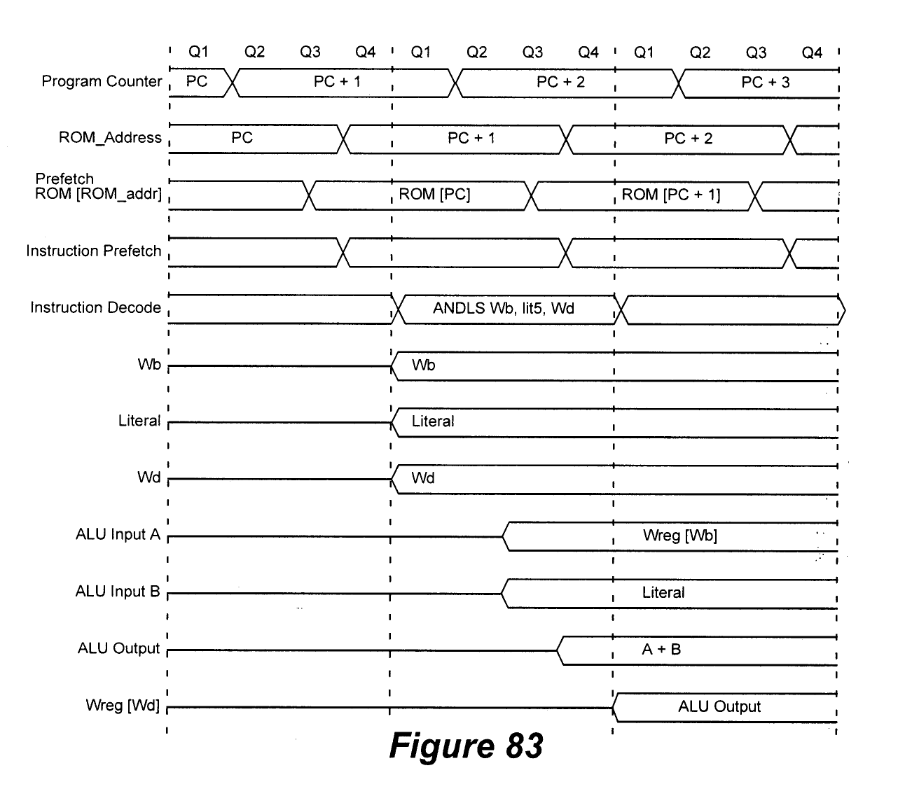

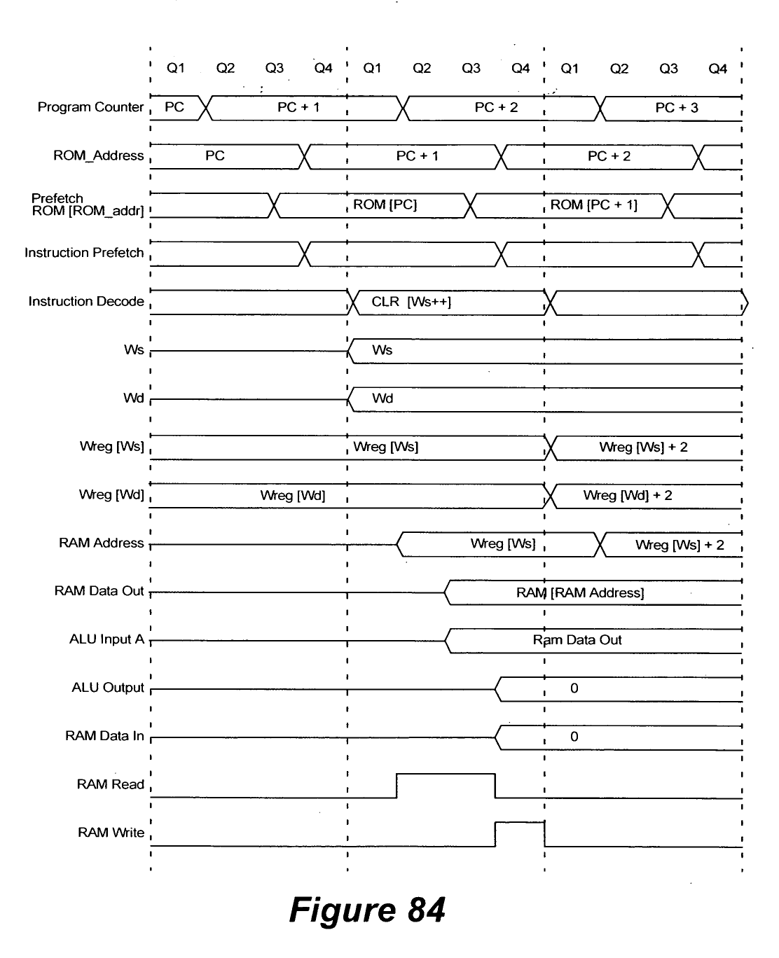

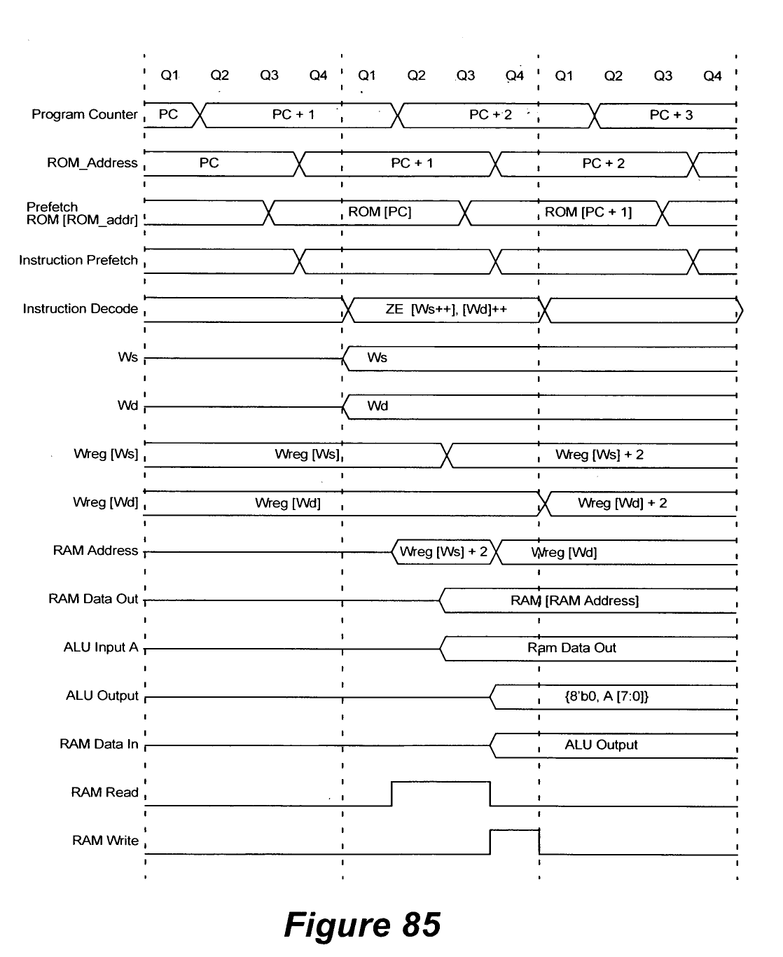

FIG. 82 shows a timing diagram illustrating a XOR, the SUBR, the SUBR, the SUB B, the SUB, the MOVE, the IOR, the AND, the ADDC and the ADD operations. FIG. 83 shows a timing diagram illustrating a XORLS, the SUBRLS, the SUBLS, the SUBBRLS, the SUBLS, the IORLS, the ANDLS, the ADCCLS and the ADDCLS operations. FIG. 84 shows a timing diagram illustrating a COR, the INC2, the DEC2, the DEC COM, the NEG and the NCTM operations. FIG. 85 shows a timing diagram illustrating a ASR, the LSR, the ZE, the SE, the SL, the RLC, the RLNC, the RRC and the RRNC operation.

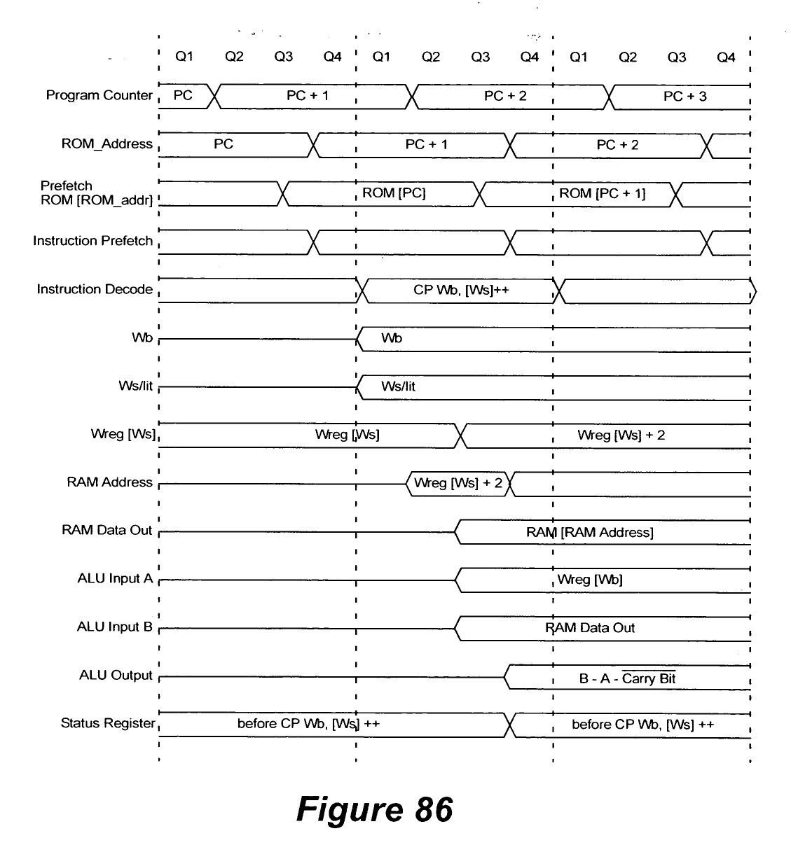

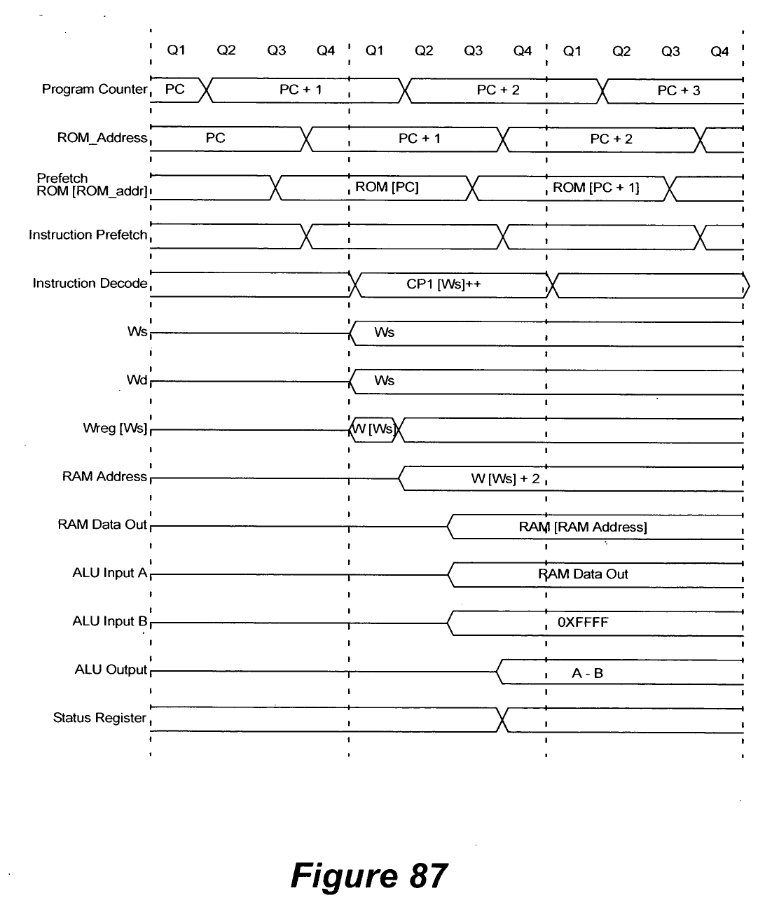

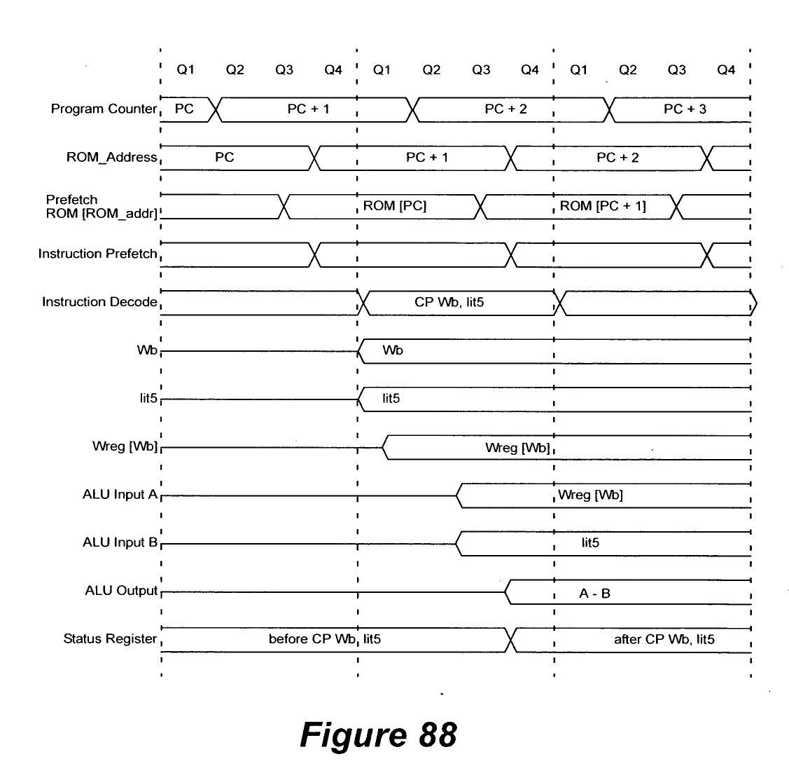

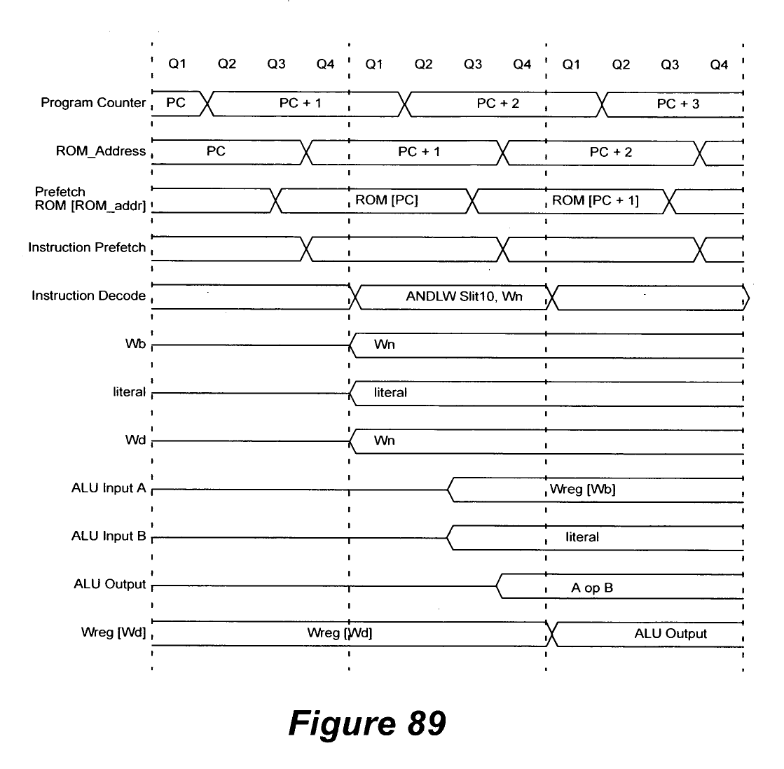

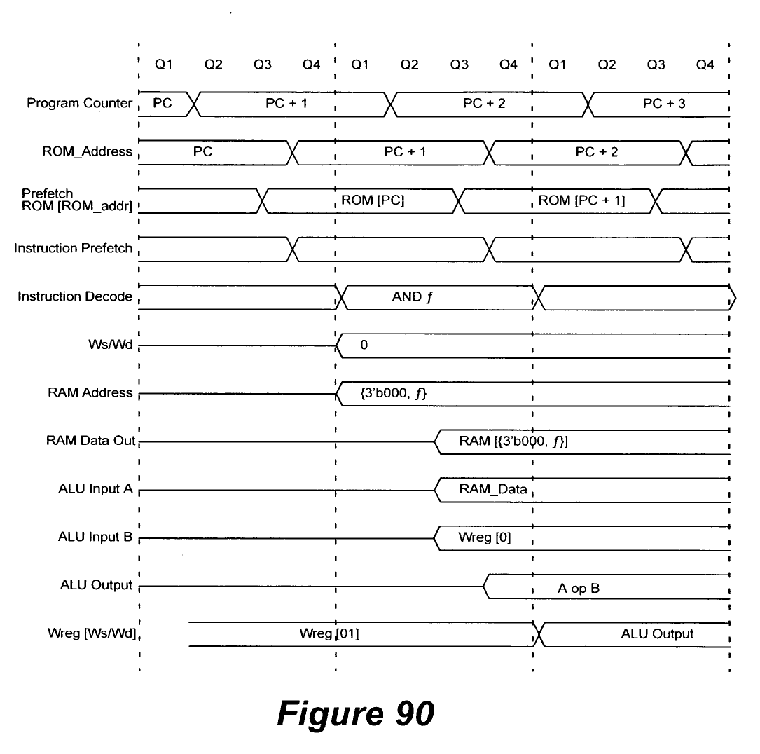

FIG. 86 shows a timing diagram illustrating a CPB and the CP operations. FIG. 87 shows a timing diagram illustrating a CP1 and the CP0 operations. FIG. 88 shows a timing diagram illustrating a CPBLS and the CPBLS operations. FIG. 89 shows a timing diagram illustrating a XORLW, the SUBLW, the SUBBBLW, the MOVLW, the MOVL, the IORLW, the ANDLW, the ADDLW and the ADDCLW operations. FIG. 90 shows a timing diagram illustrating a ASRF, the SLF, the LSRF, the RRNCF, the RRCF, the RLNCF, the RLCF, the XORWF, the SUBWS, the SUBBWS, the SUBFW, the SUBDFW, the MOVFW, the MOV, the IORWV, the ANDWF, the ADDWFC and the ADDWF operations.

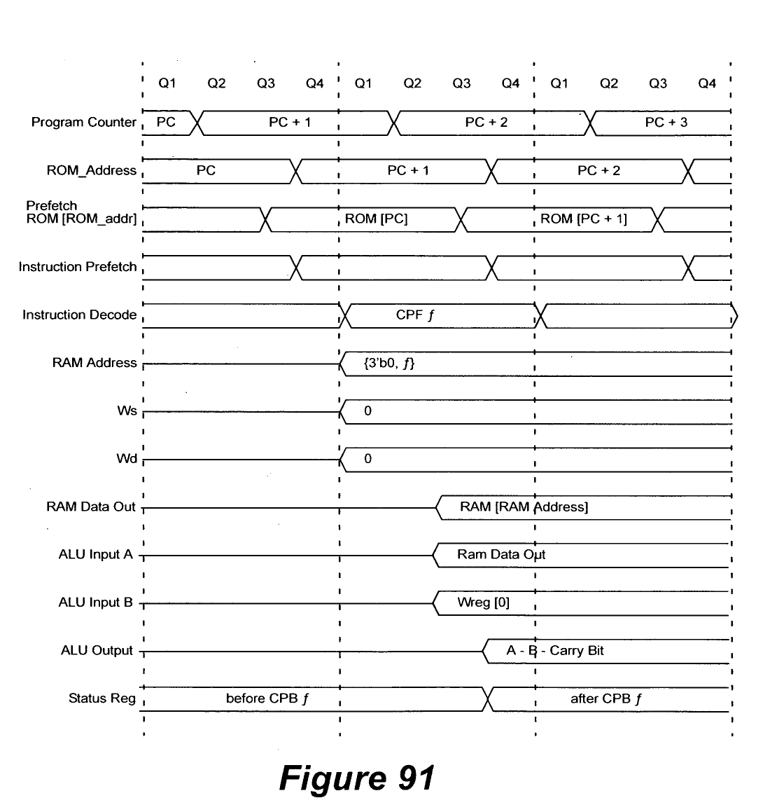

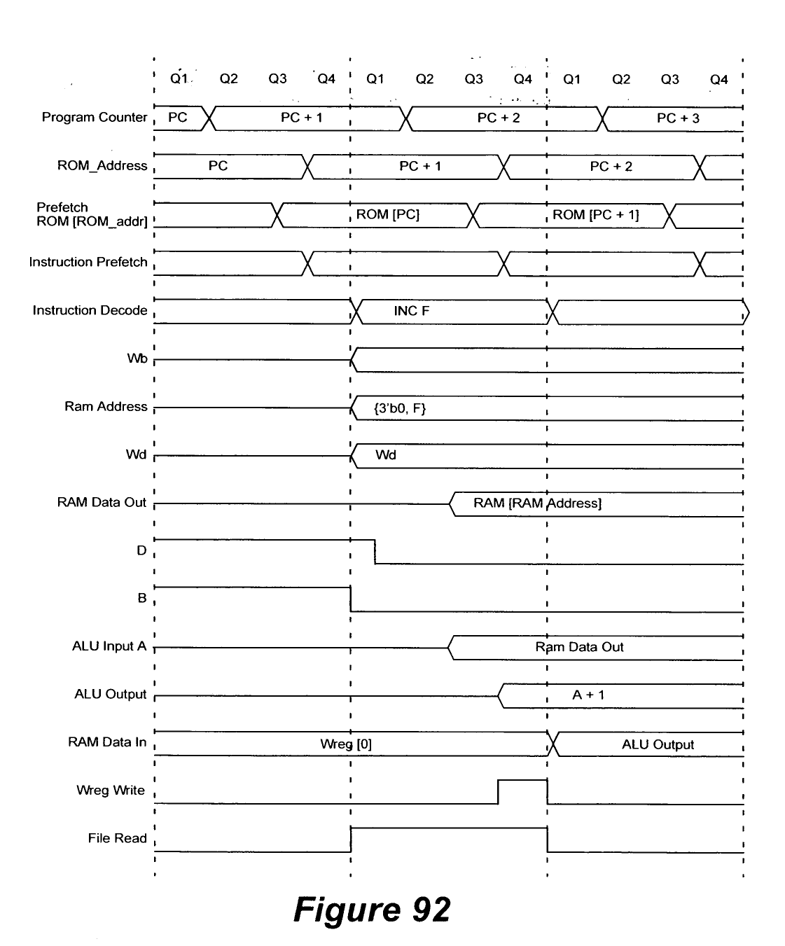

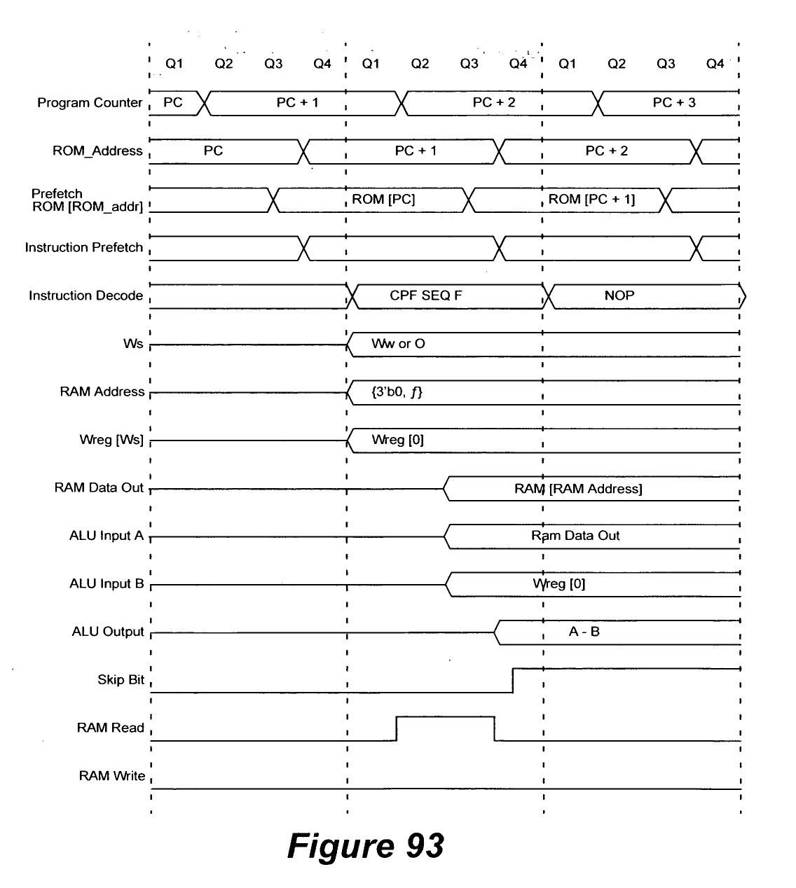

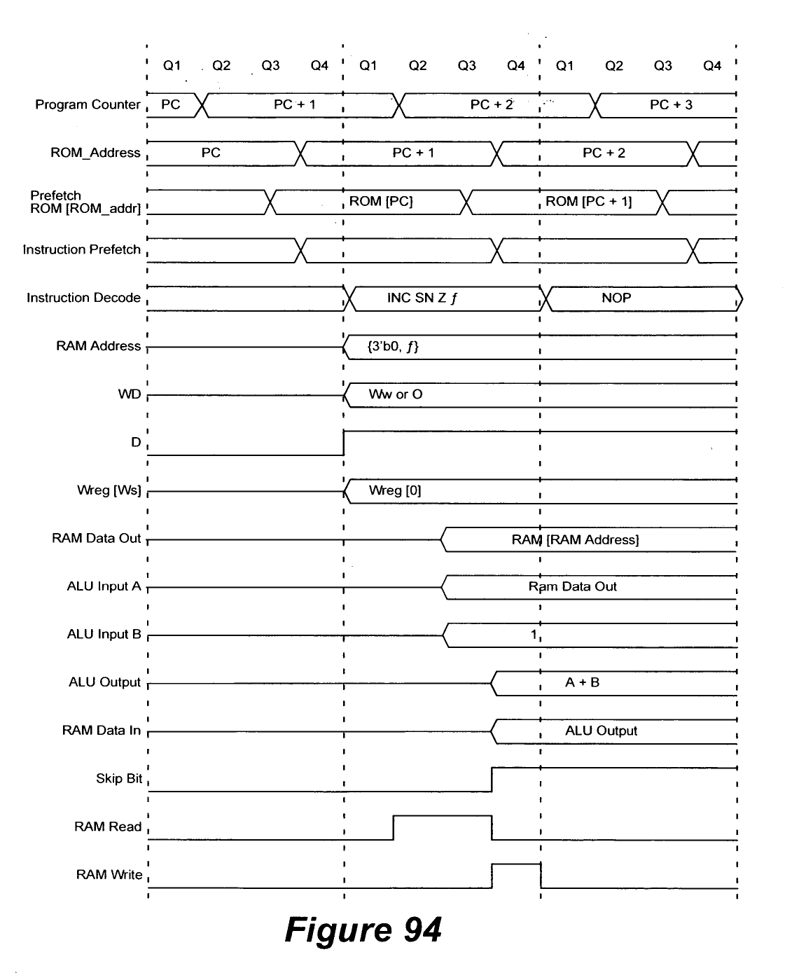

FIG. 91 shows a timing diagram illustrating a CPFB, the CPF1, the CPF0 and the CPF operations. FIG. 92 shows a timing diagram illustrating a INCF, the DECF, the NEGF, the SETF, the COMF and the CLRF operations. FIG. 93 shows a timing diagram illustrating a CPFSEQ, the FPFSGT, the CPFSLT and the CPFSNE operations. FIG. 94 shows a timing diagram illustrating an INCFSNZ, the INCFSA, the DECFSNZ, and the DECFSZ operations.

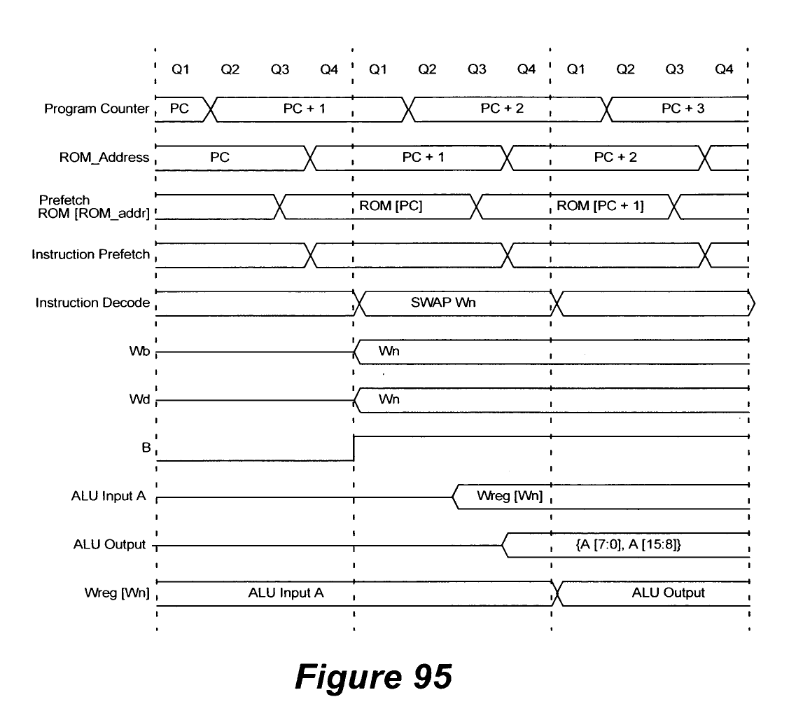

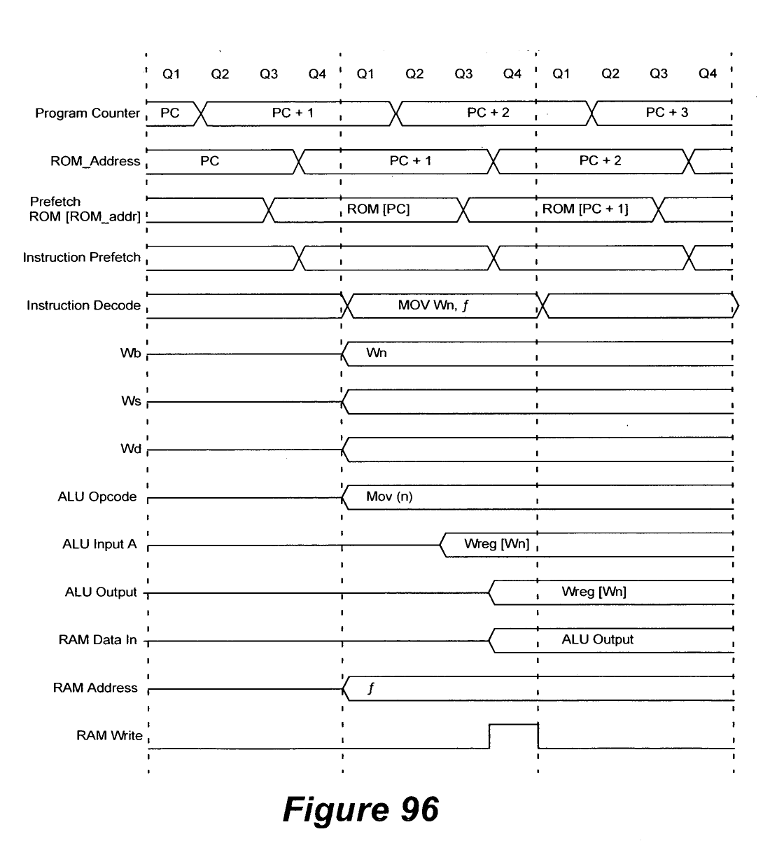

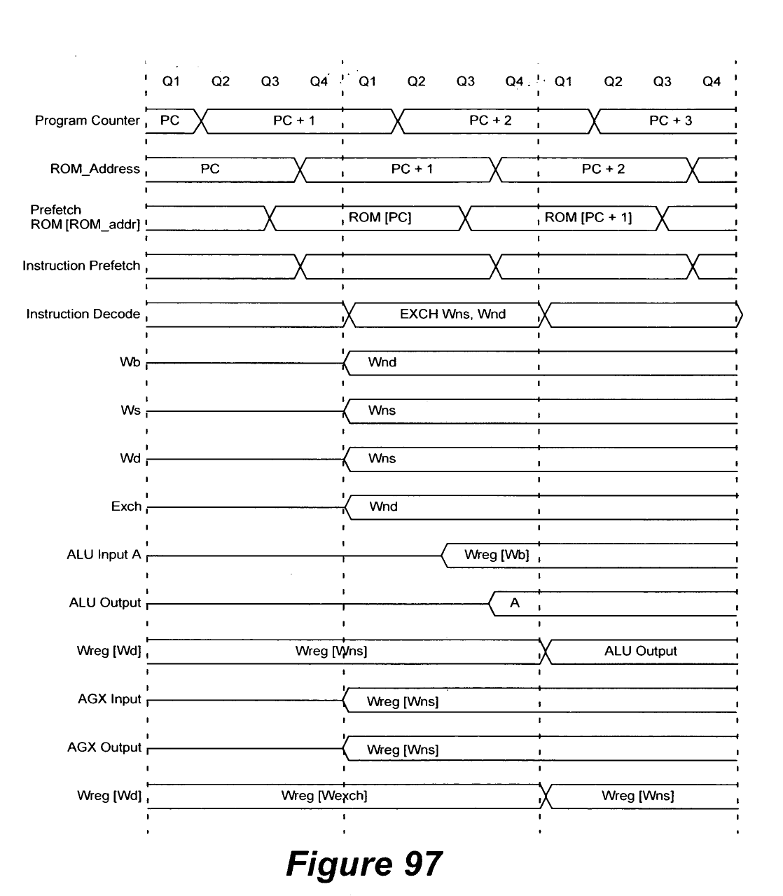

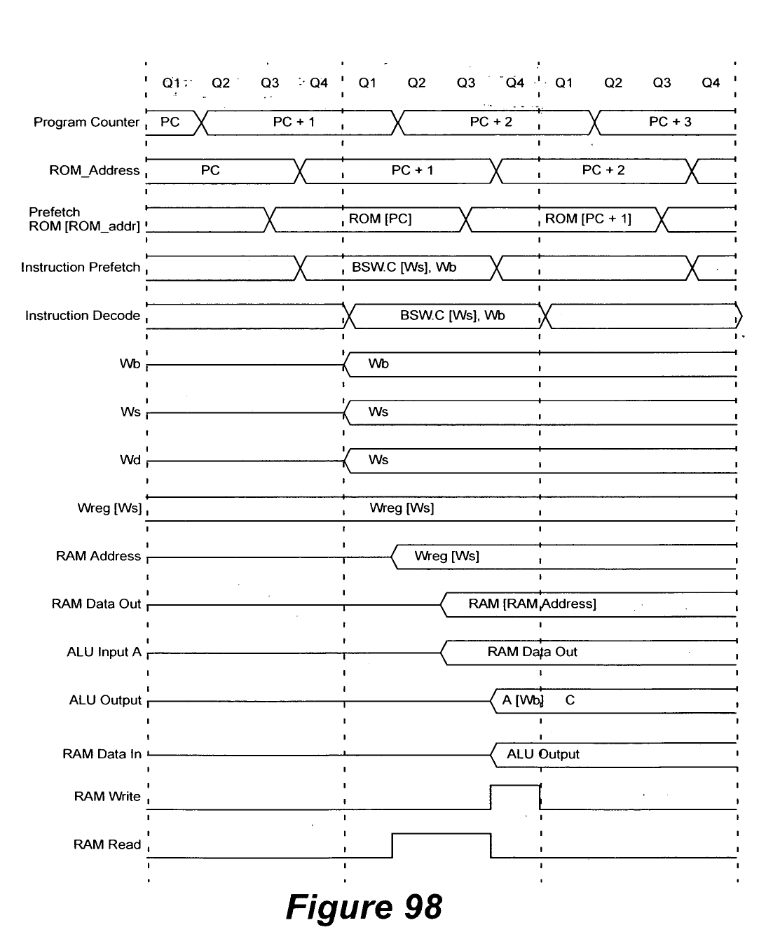

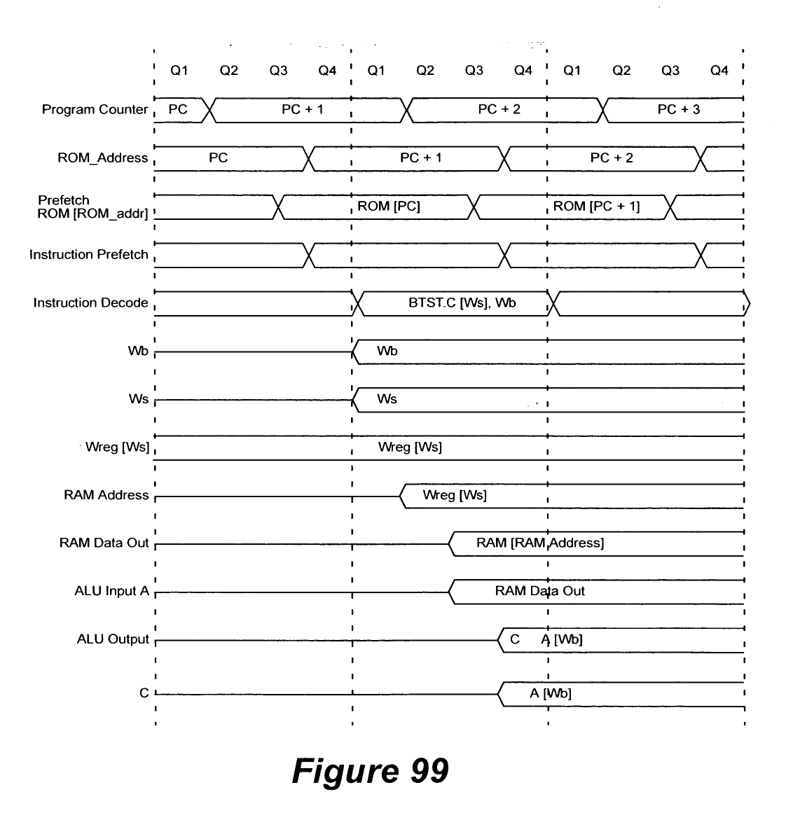

FIG. 95 shows a timing diagram illustrating a SWAP operation. FIG. 96 shows a timing diagram illustrating a STW operation. FIG. 97 shows a timing diagram illustrating a EXCH operation. FIG. 98 shows a timing diagram illustrating a BSW operation. FIG. 99 shows a timing diagram illustrating a BTSTW operation.

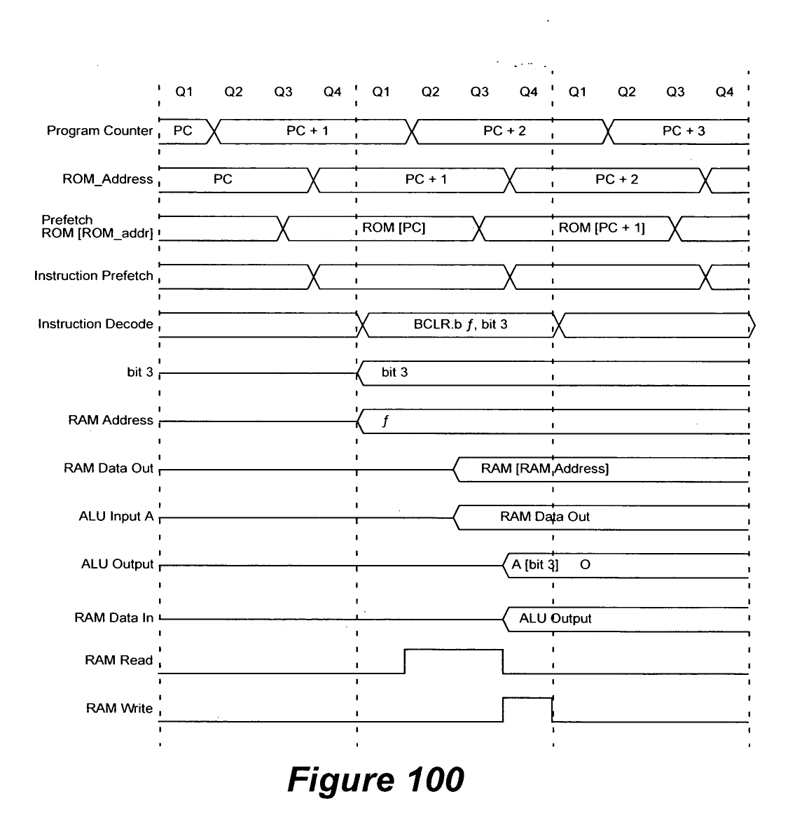

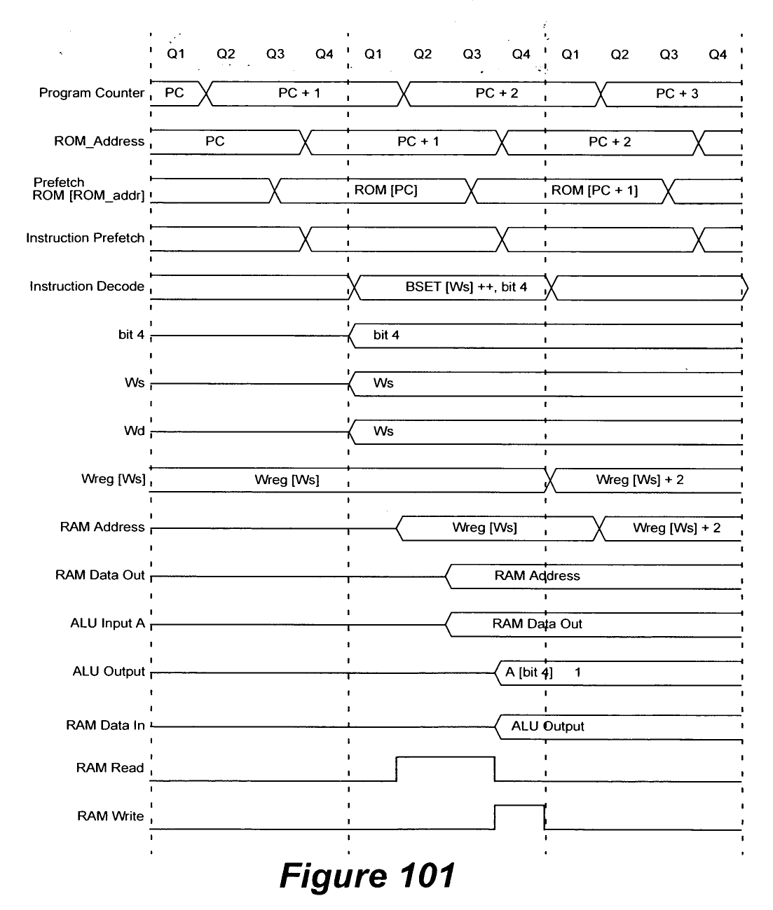

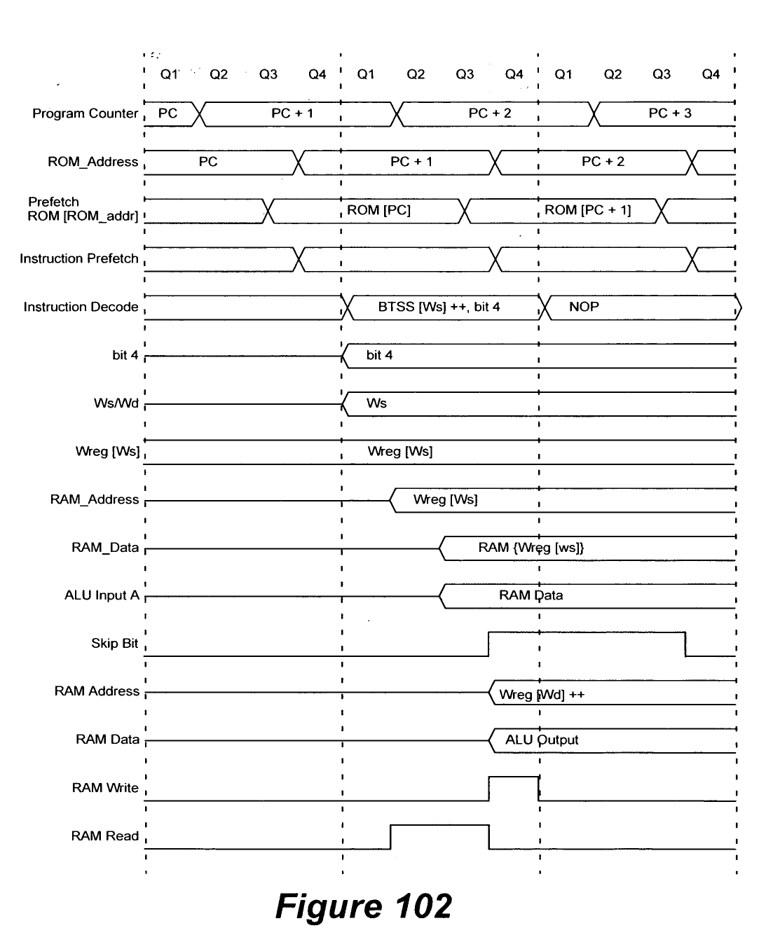

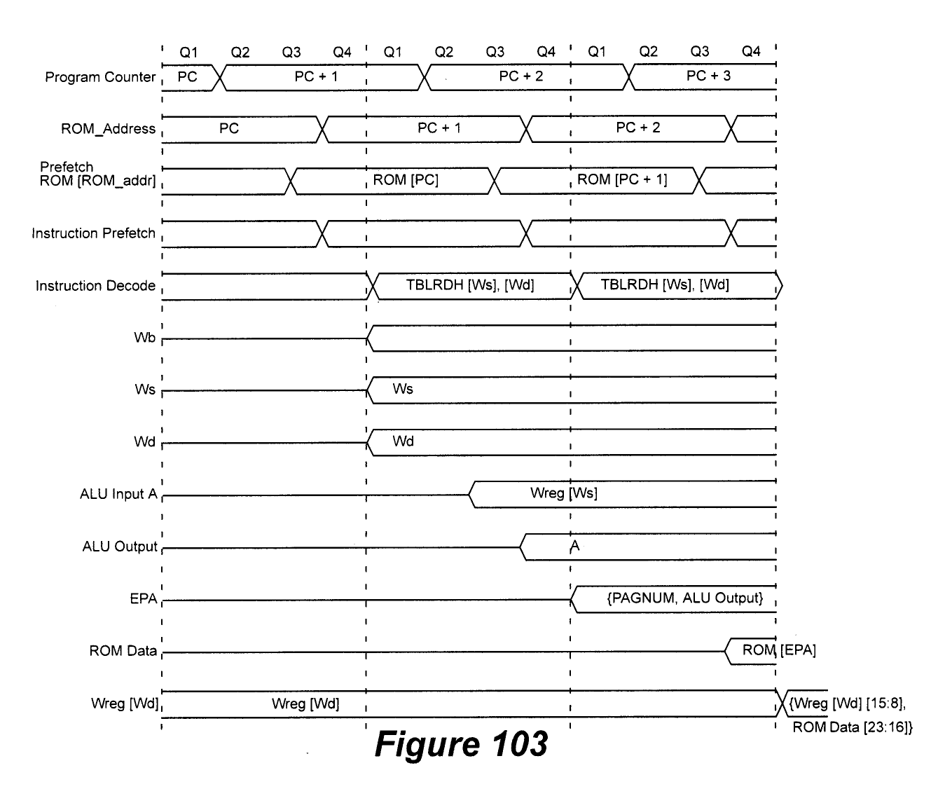

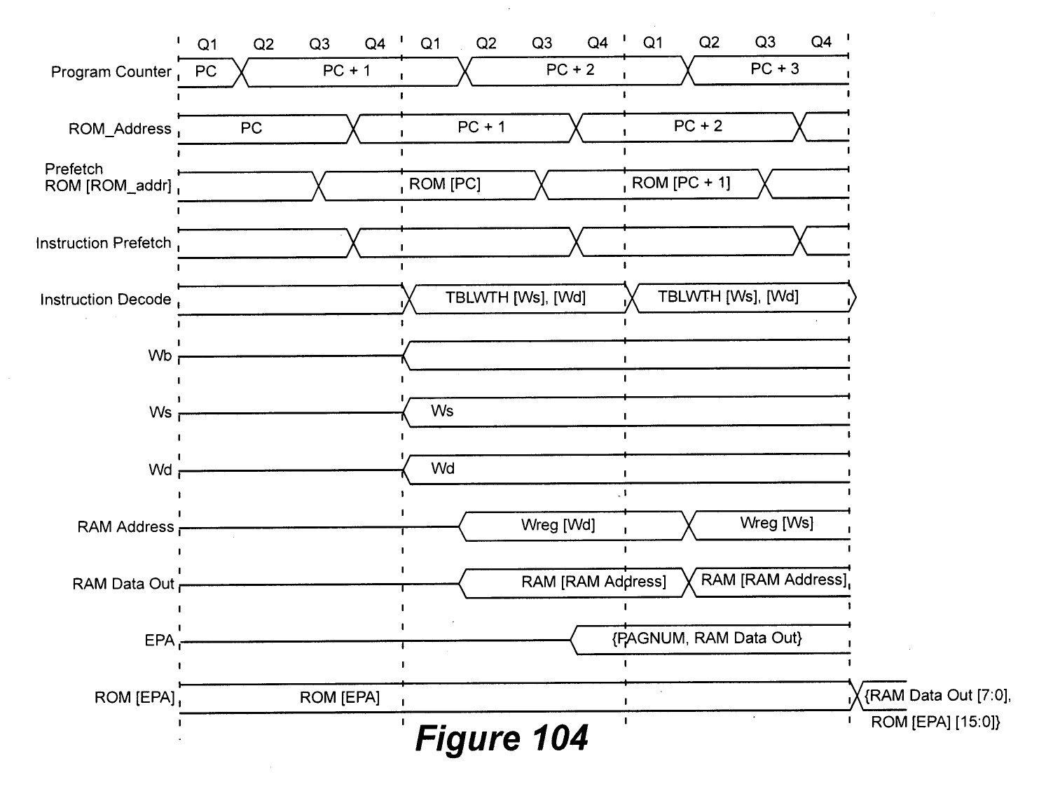

FIG. 100 shows a timing diagram illustrating a BCLRF, the BTSTSF, the BTSTF, the BTGF and BSETF operations. FIG. 101 shows a timing diagram illustrating a BSET, the BTG, the BTST, the BTSTS, and the BCLR operations. FIG. 102 shows a timing diagram illustrating a BTSS, the BTSC, the BTFSC and the BTFSS operations. FIG. 103 shows a timing diagram illustrating a TBLRDH and the TBLRDL operations. FIG. 104 shows a timing diagram illustrating a TBLWTH and the TBLWTL operations.

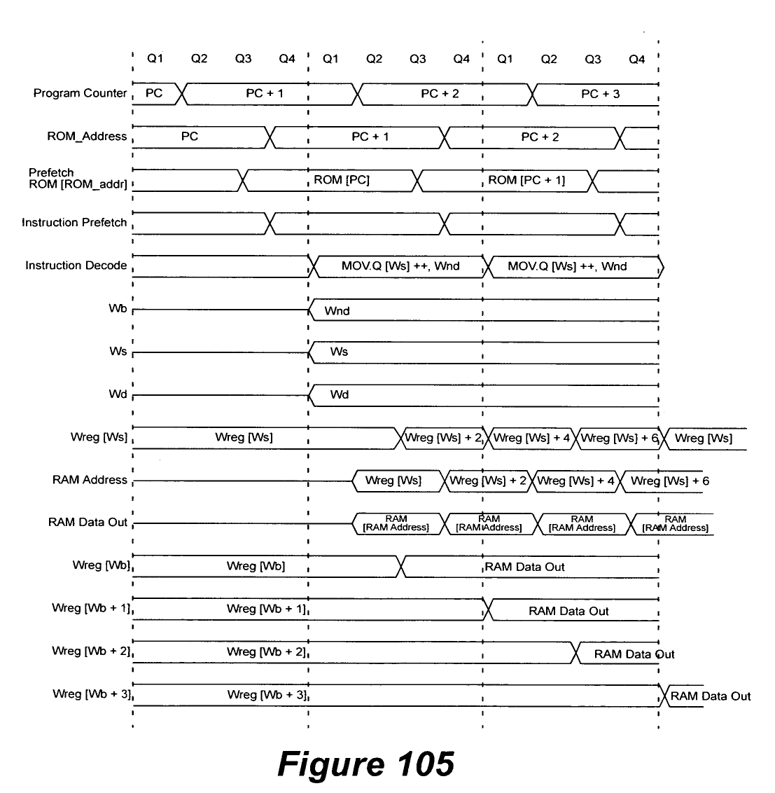

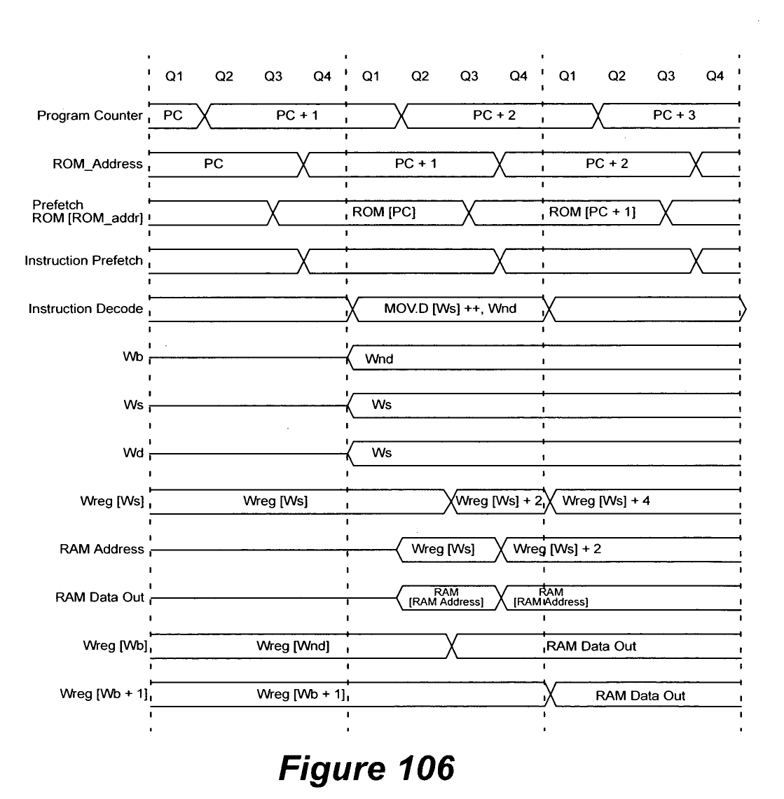

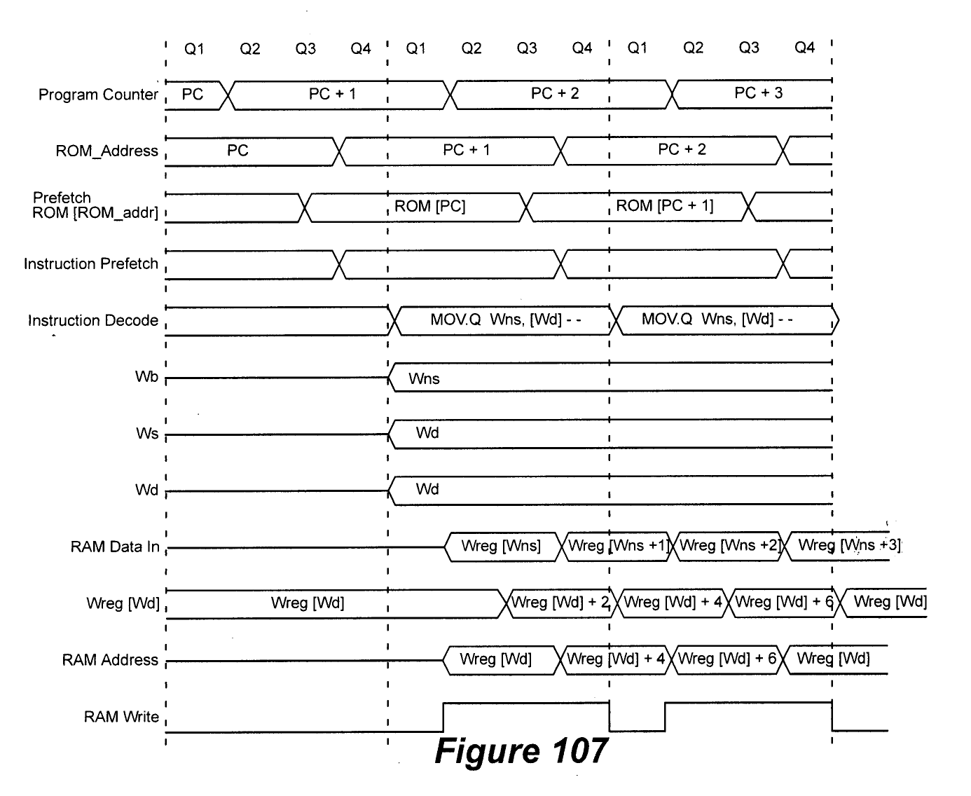

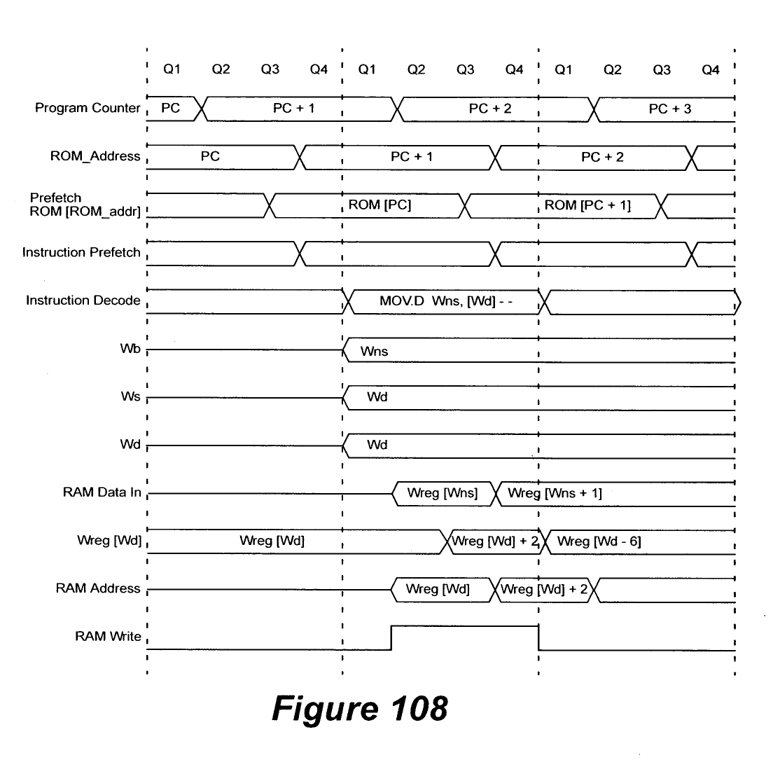

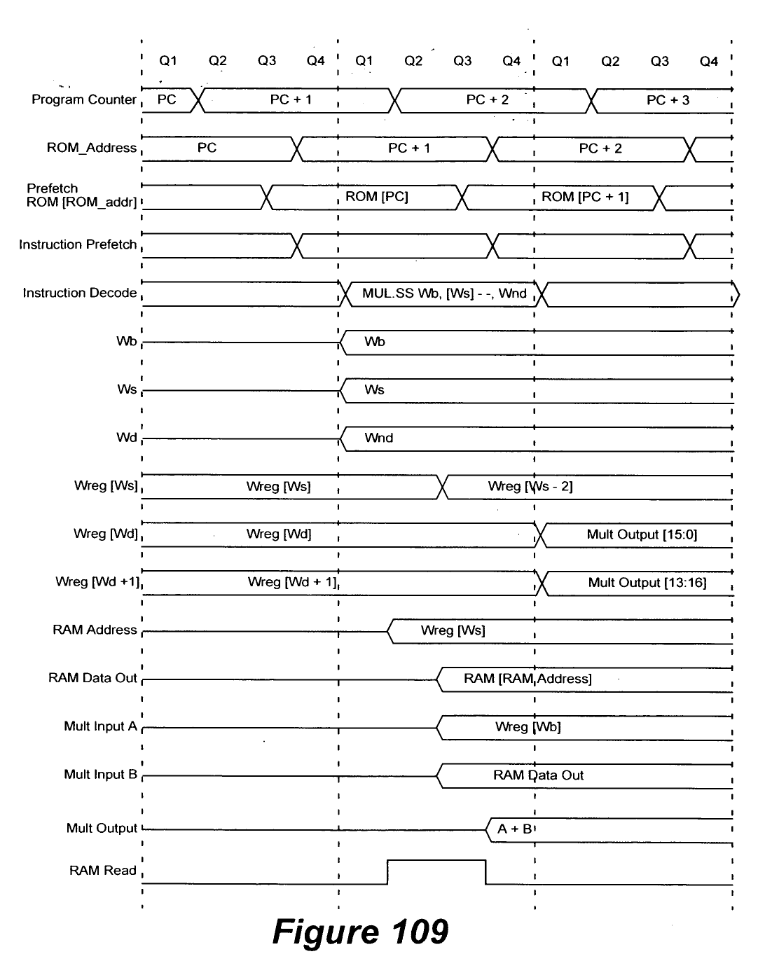

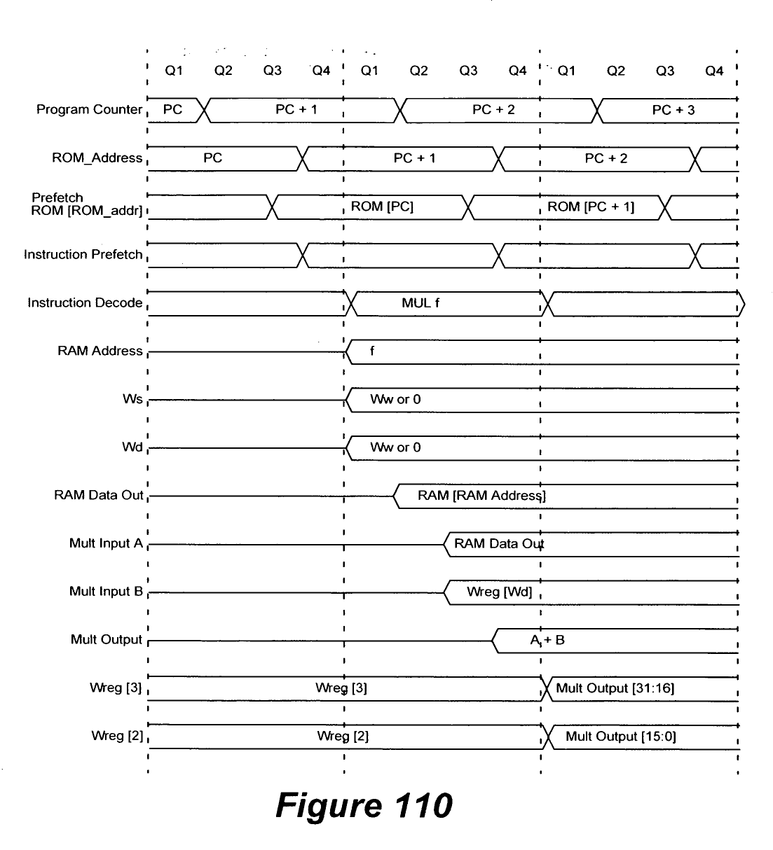

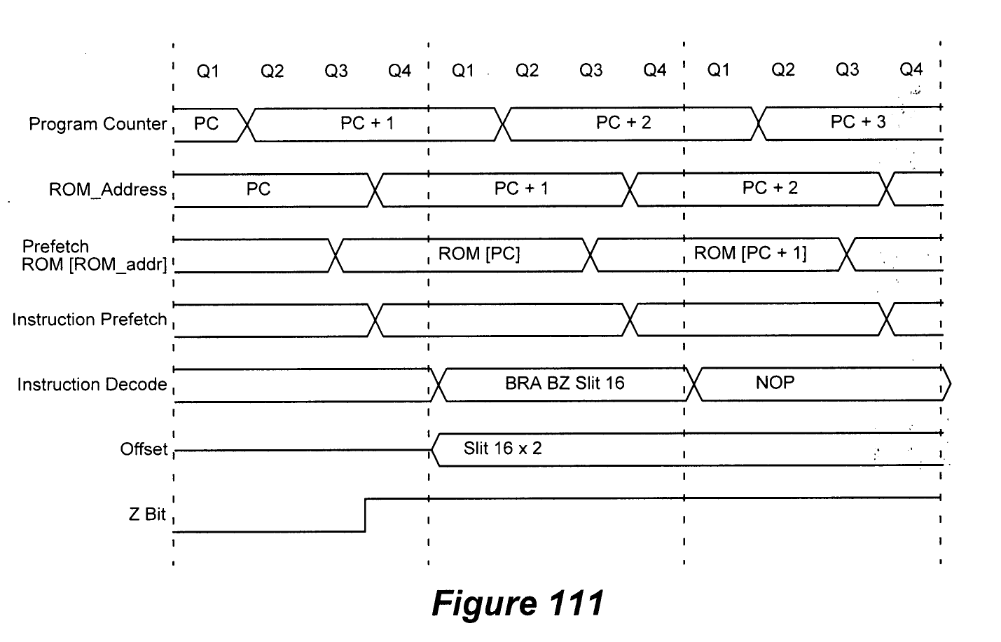

FIG. 105 shows a timing diagram illustrating a LDQW operation. FIG. 106 shows a timing diagram illustrating a LDDW operation. FIG. 107 shows a timing diagram illustrating a STQW operation. FIG. 108 shows a timing diagram illustrating a STDW operation. FIG. 109 shows a timing diagram illustrating a MULS, the MULSU, the MULSULS, the MULU, the MULULS and the MULUS operations. FIG. 110 shows a timing diagram illustrating a MULWF operation. FIG. 111 shows a timing diagram illustrating an ALL BRANCHES operation.

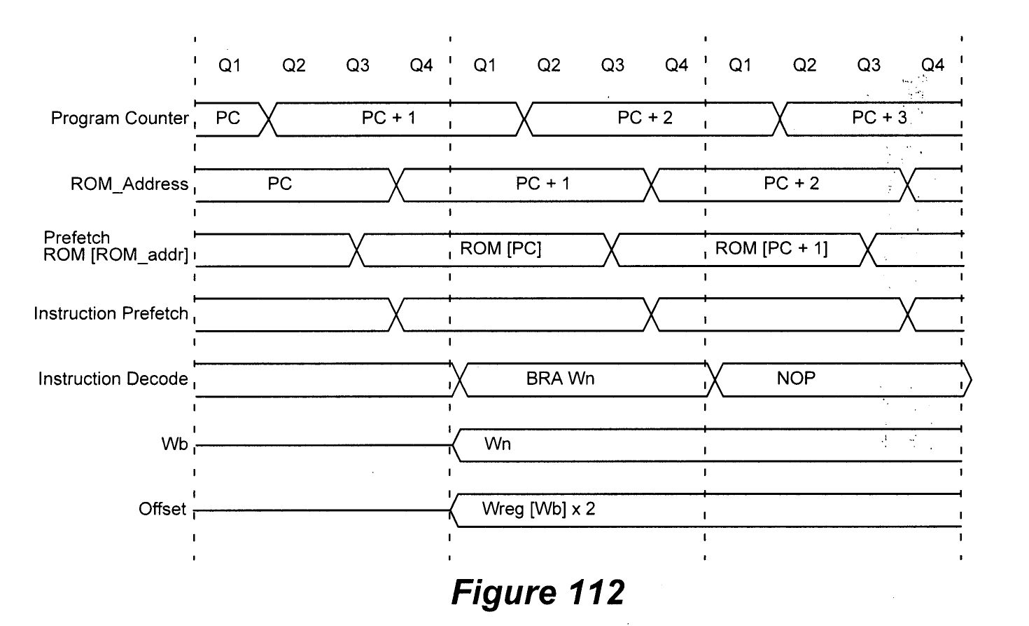

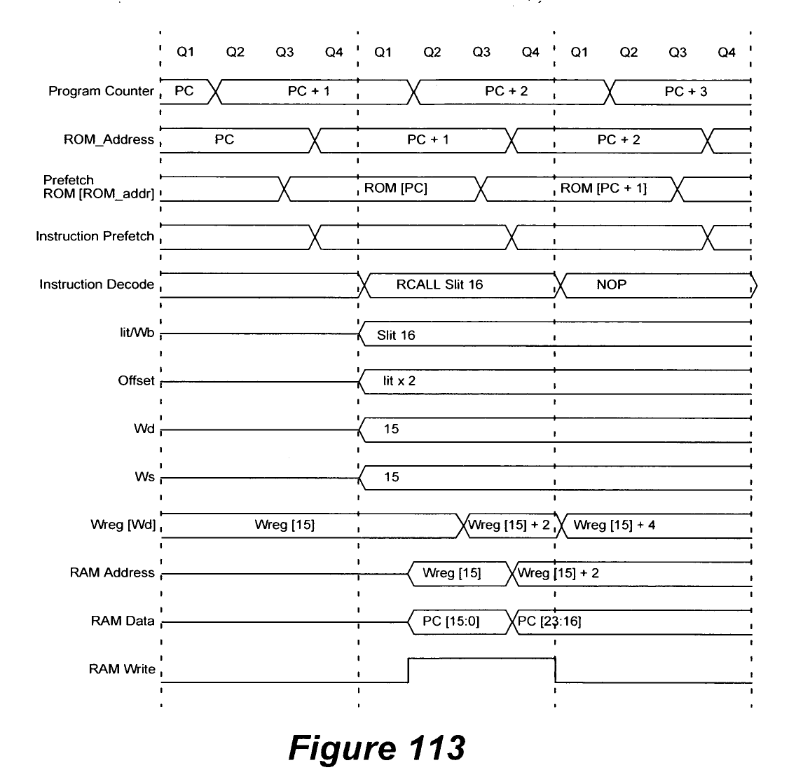

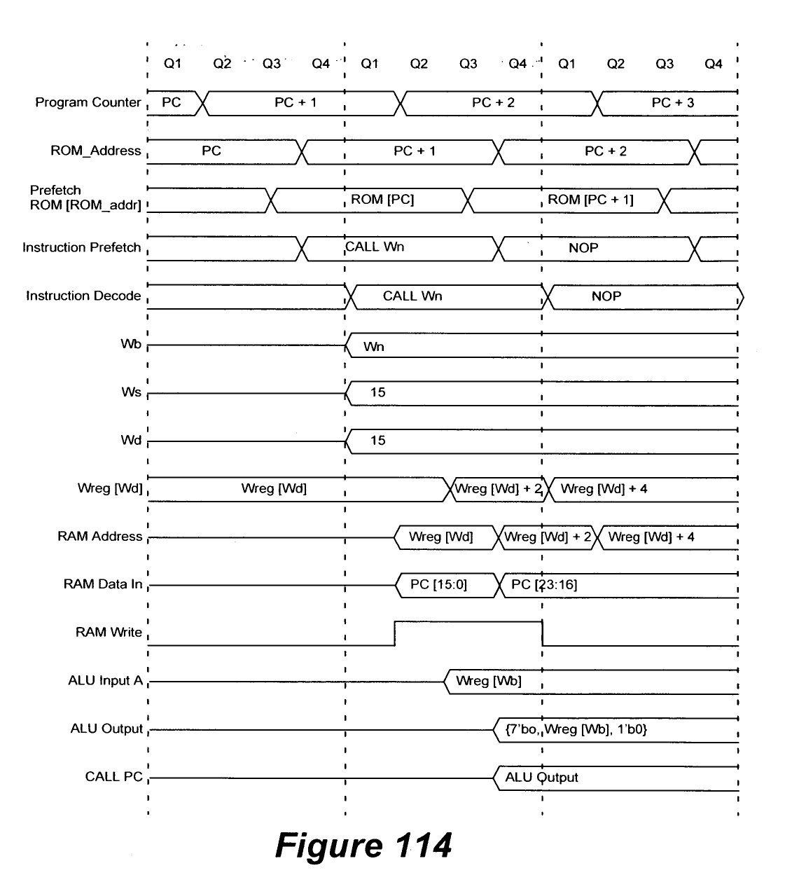

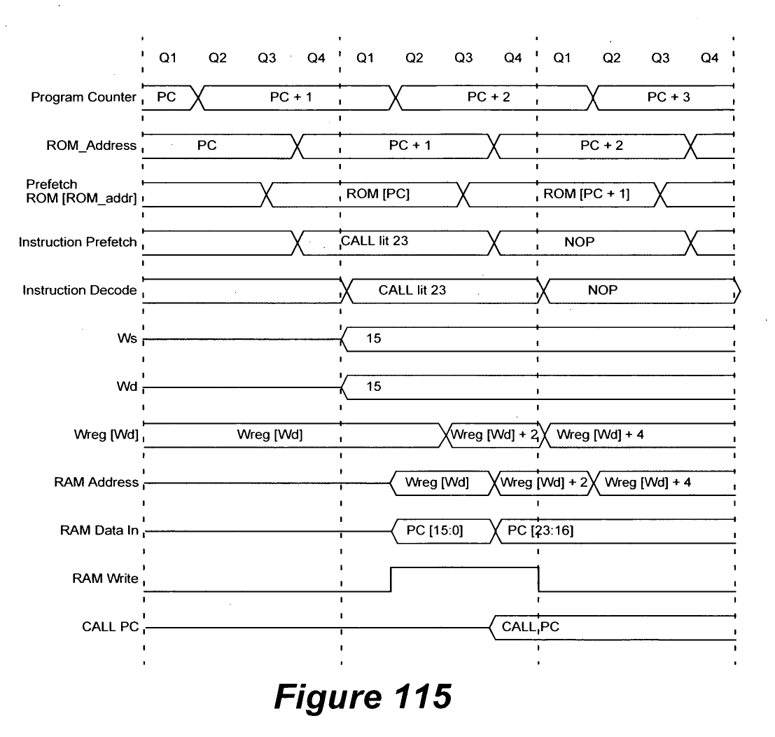

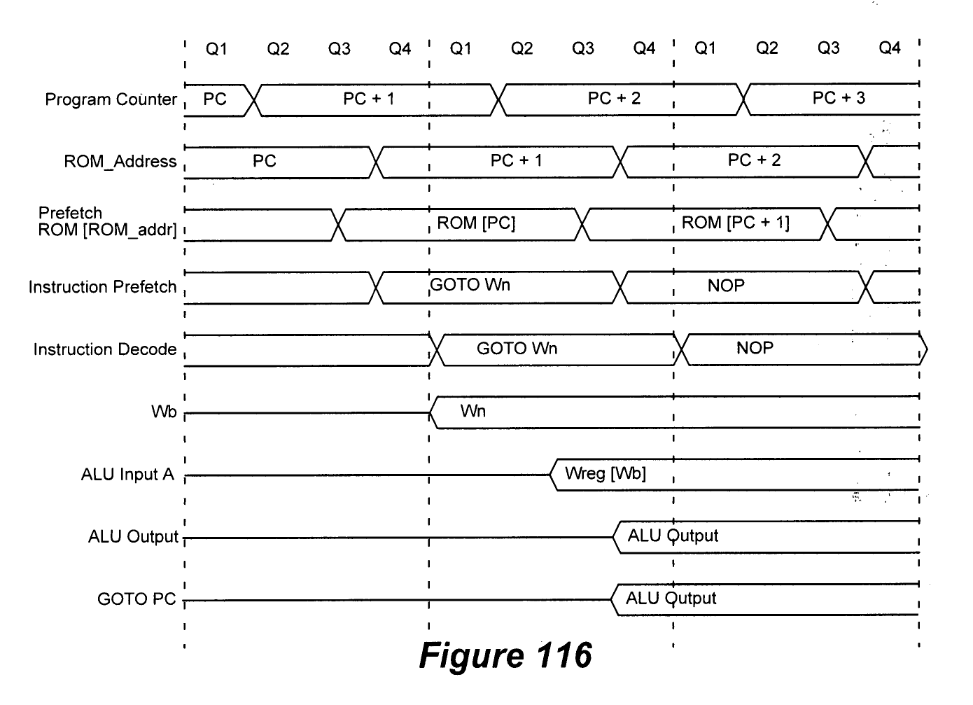

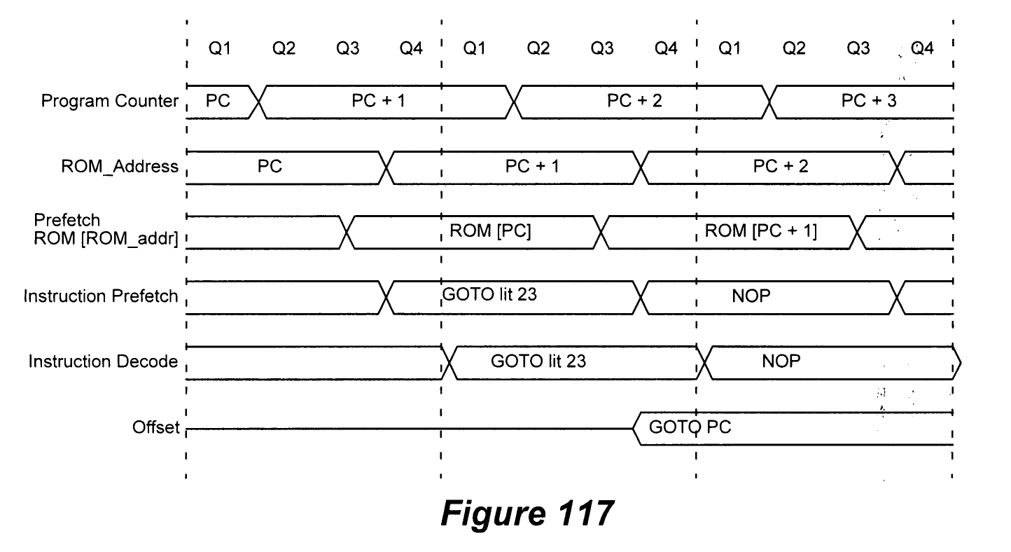

FIG. 112 shows a timing diagram illustrating a BRAW operation. FIG. 113 shows a timing diagram illustrating a RCALL, and the RCALLW operations. FIG. 114 shows a timing diagram illustrating a CALLW operation. FIG. 115 shows a timing diagram illustrating a CALL operation. FIG. 116 shows a timing diagram illustrating a GOTOW operation. FIG. 117 shows a timing diagram illustrating a GOTO operation.

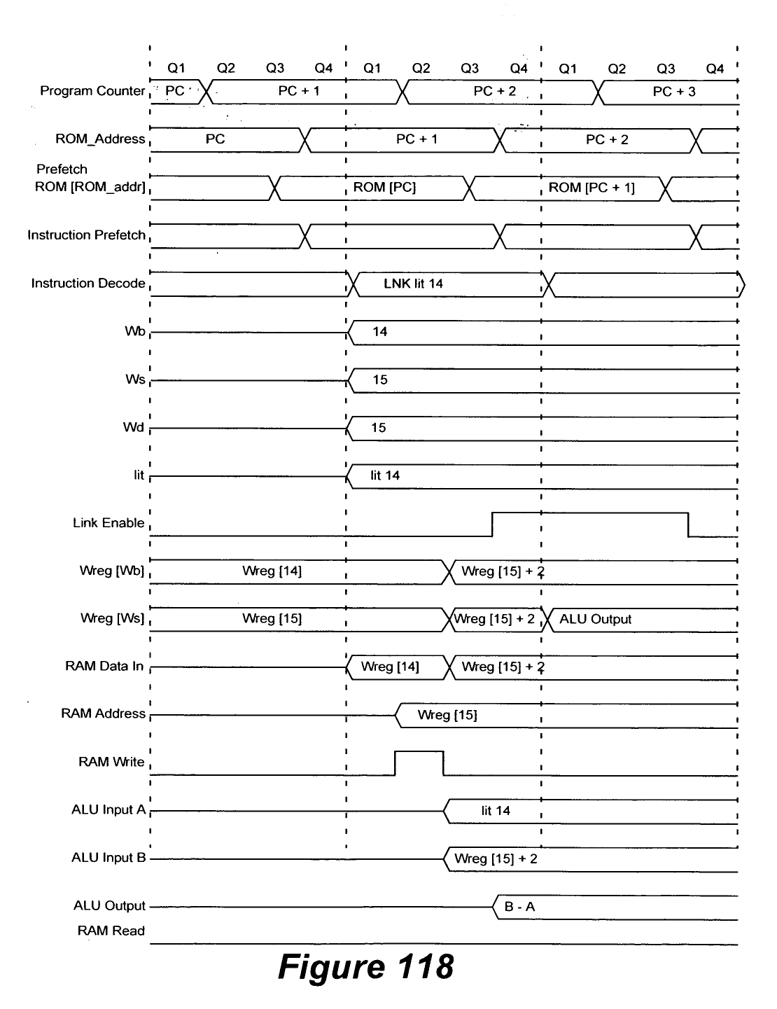

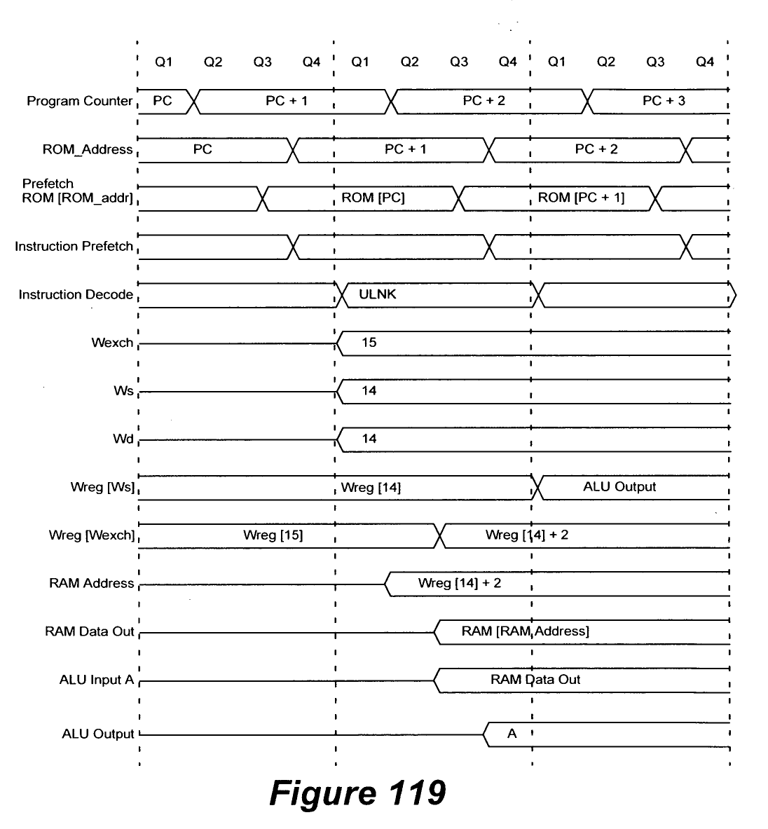

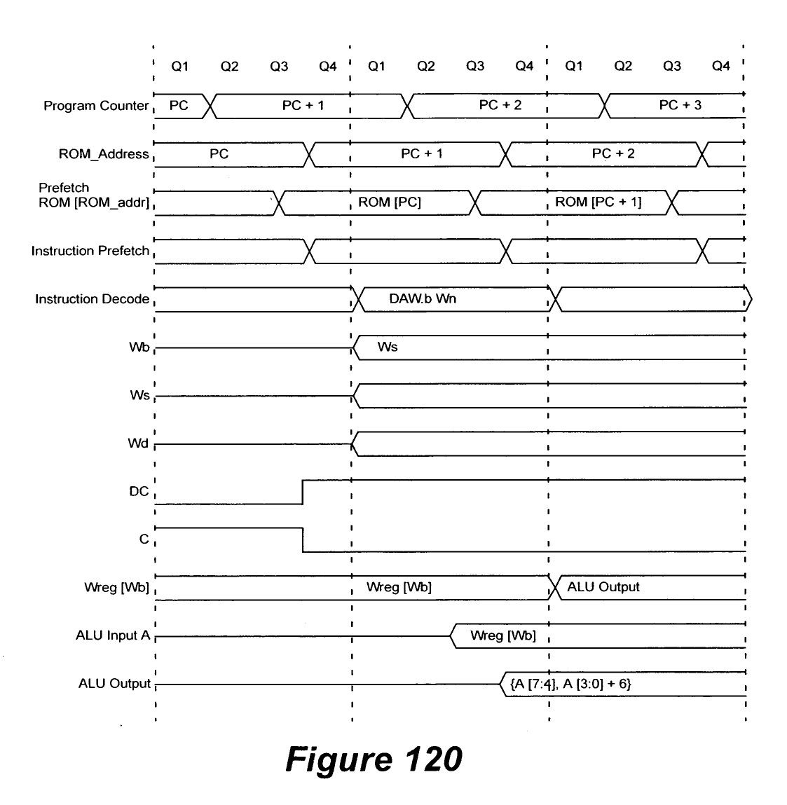

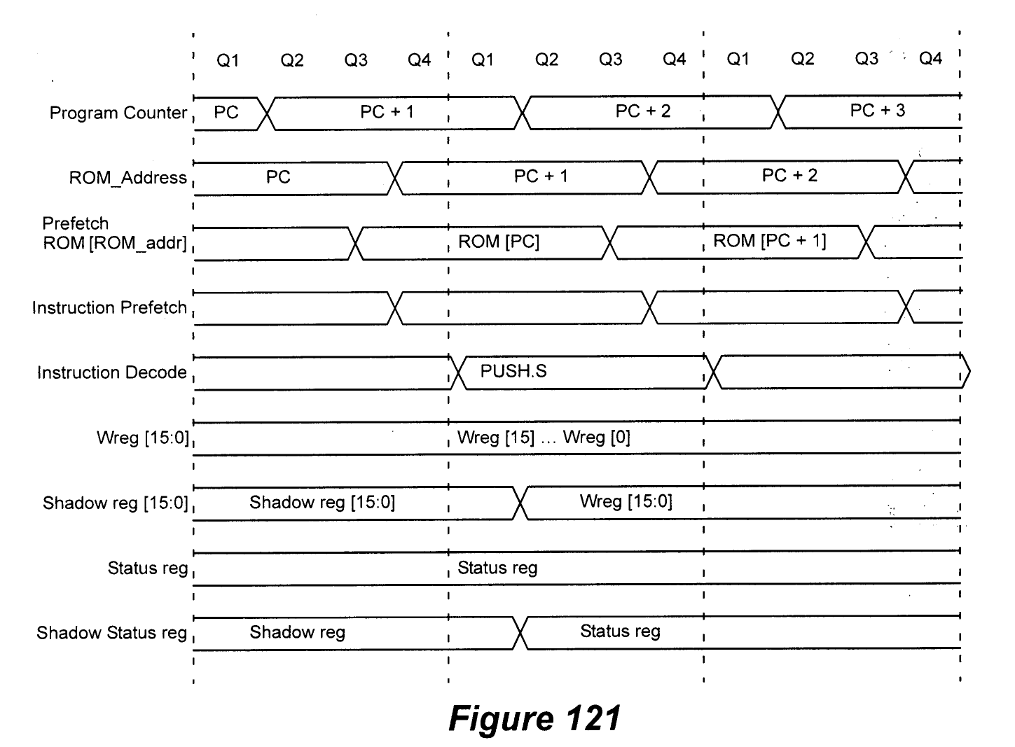

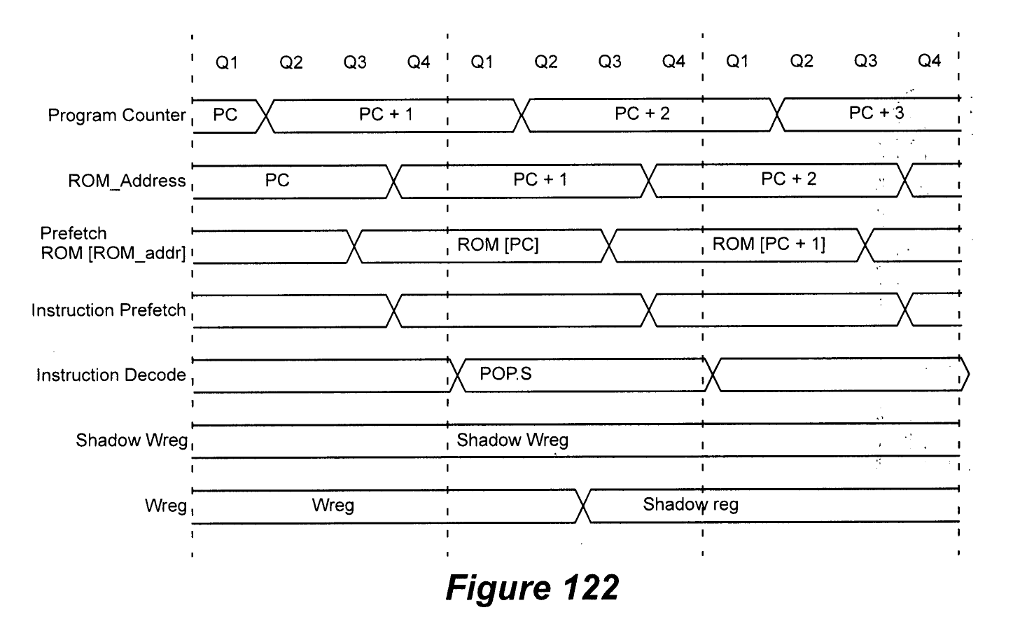

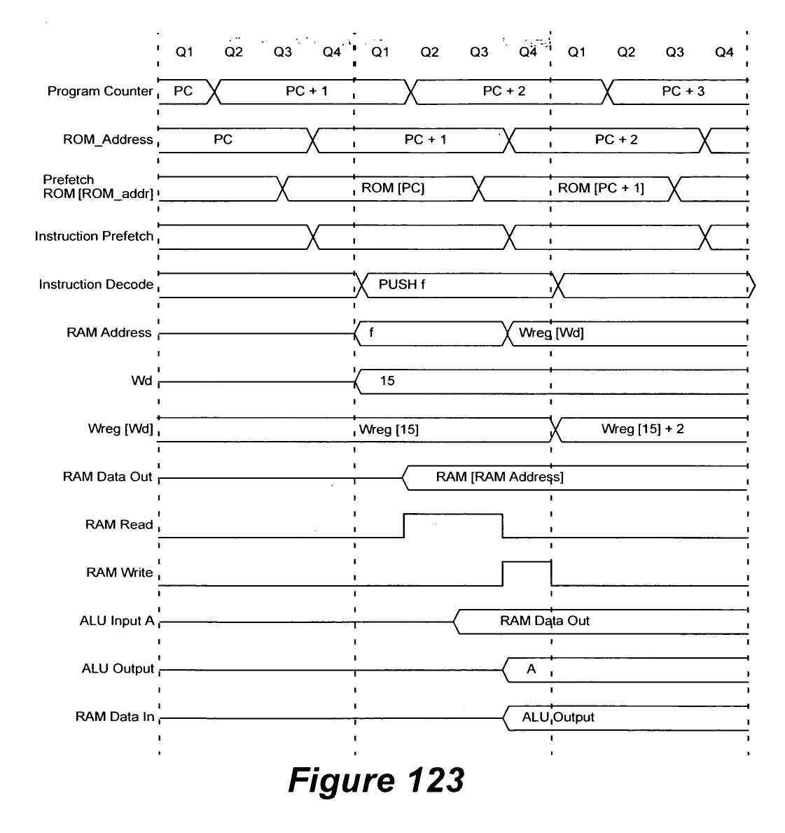

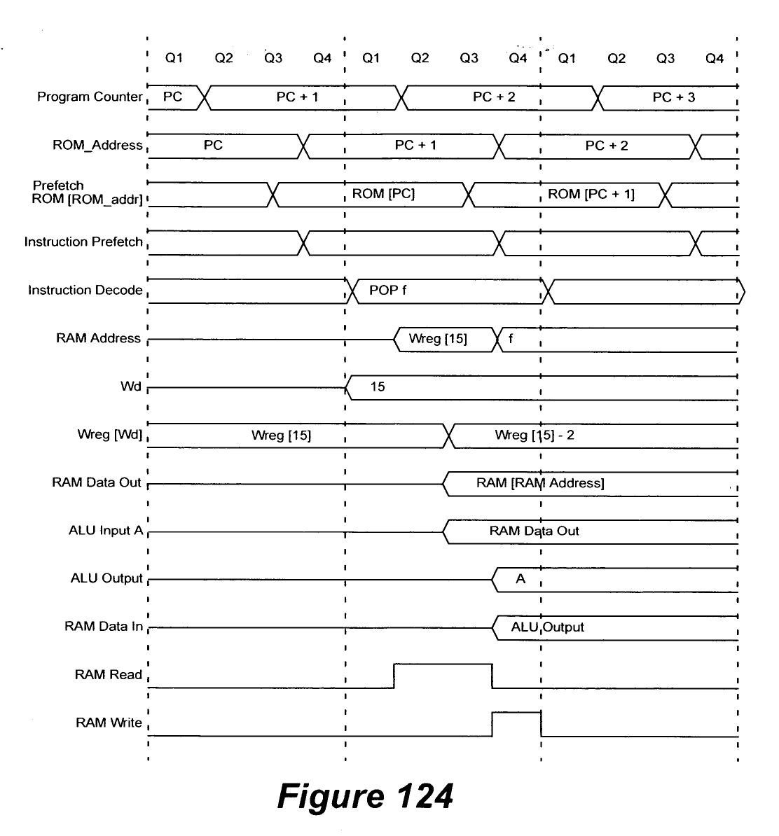

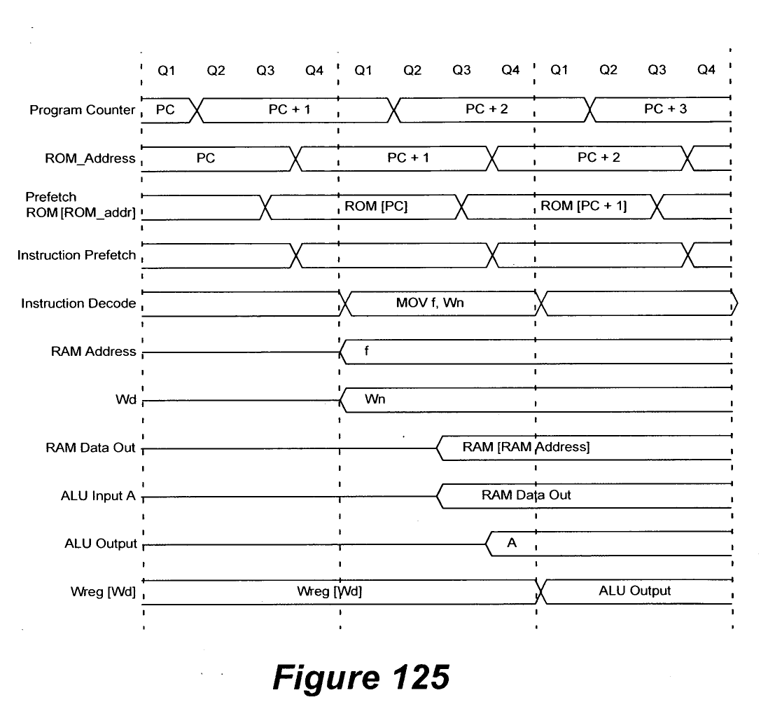

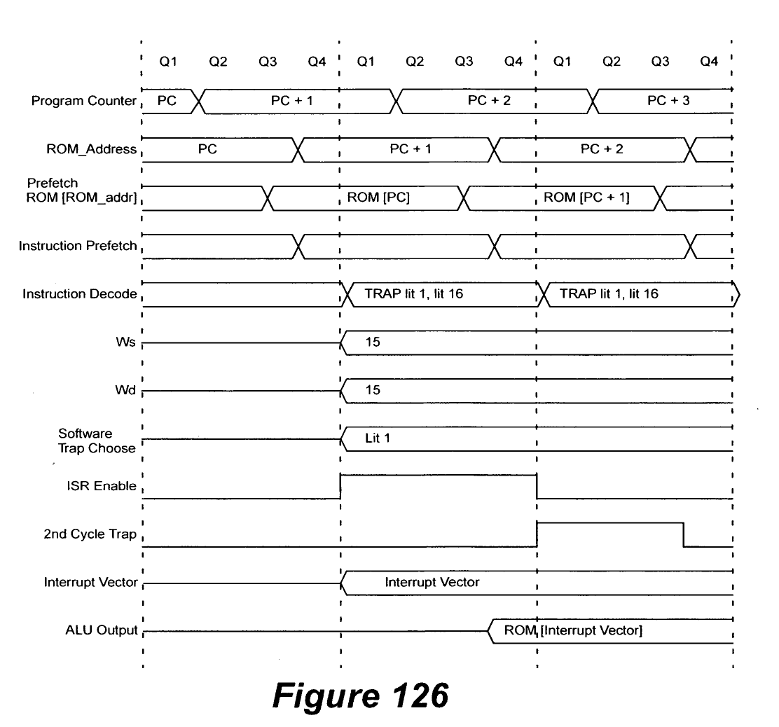

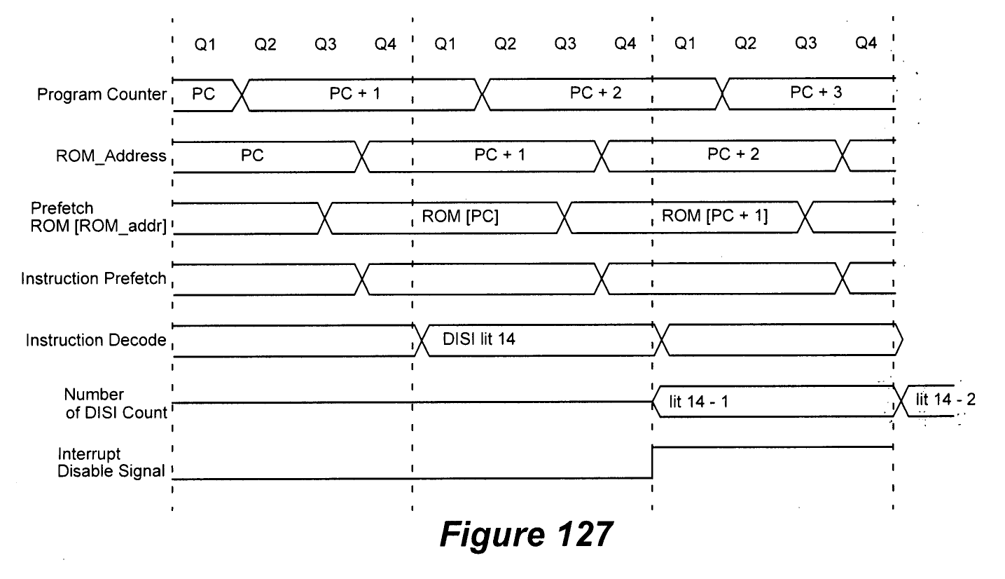

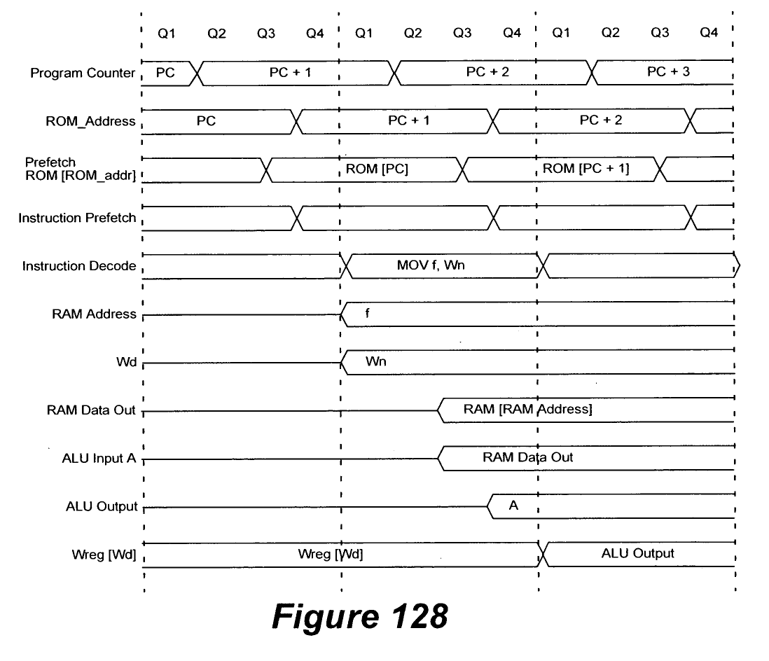

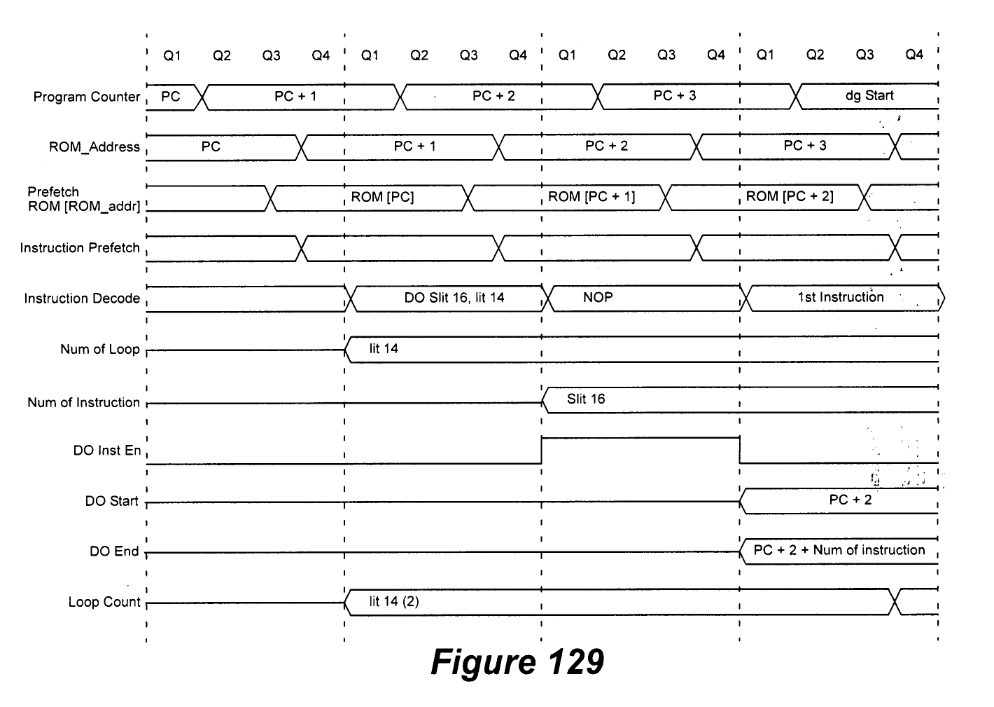

FIG. 118 shows a timing diagram illustrating a LNK operation. FIG. 119 shows a timing diagram illustrating a ULNK operation. FIG. 120 shows a timing diagram illustrating a DAW operation. FIG. 121 shows a timing diagram illustrating a SCRATCH operation. FIG. 122 shows a timing diagram illustrating a ITCH operation. FIG. 123 shows a timing diagram illustrating a PUSH operation. FIG. 124 shows a timing diagram illustrating a POP operation. FIG. 125 shows a timing diagram illustrating a LDW operation. FIG. 126 shows a timing diagram illustrating a TRAP operation. FIG. 127 shows a timing diagram illustrating a DISI operation. FIG. 128 shows a timing diagram illustrating a LDW operation. FIG. 129 shows a timing diagram illustrating a DO and the DOW operations.

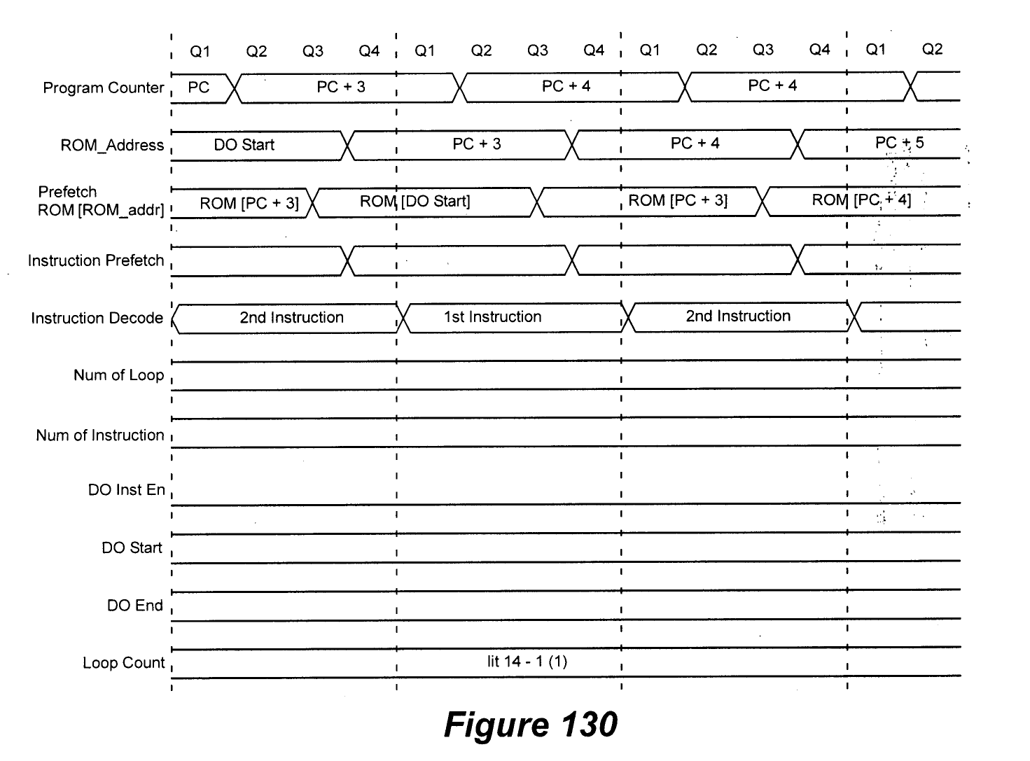

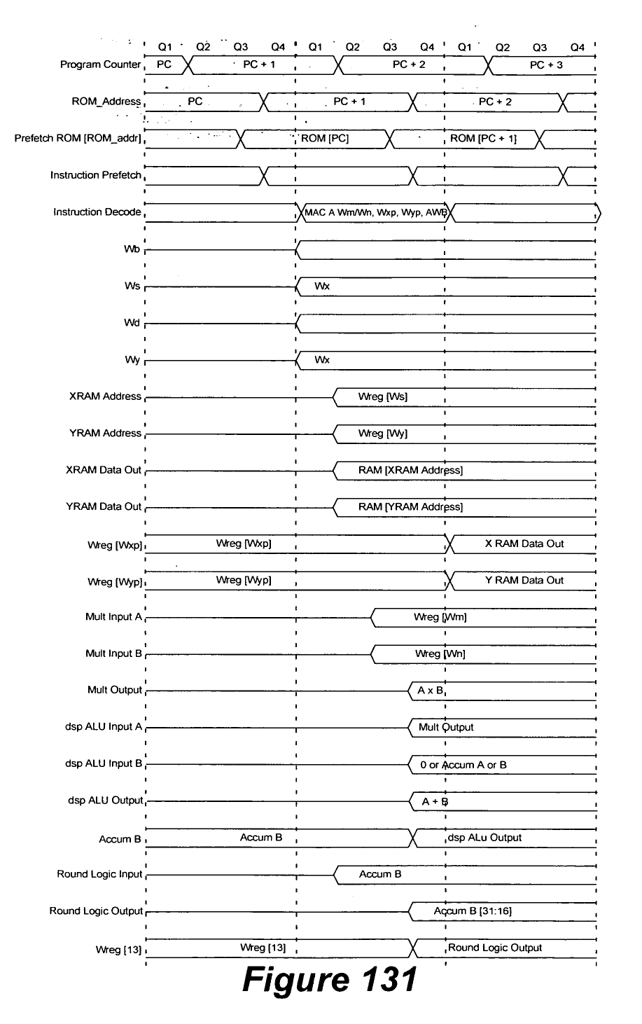

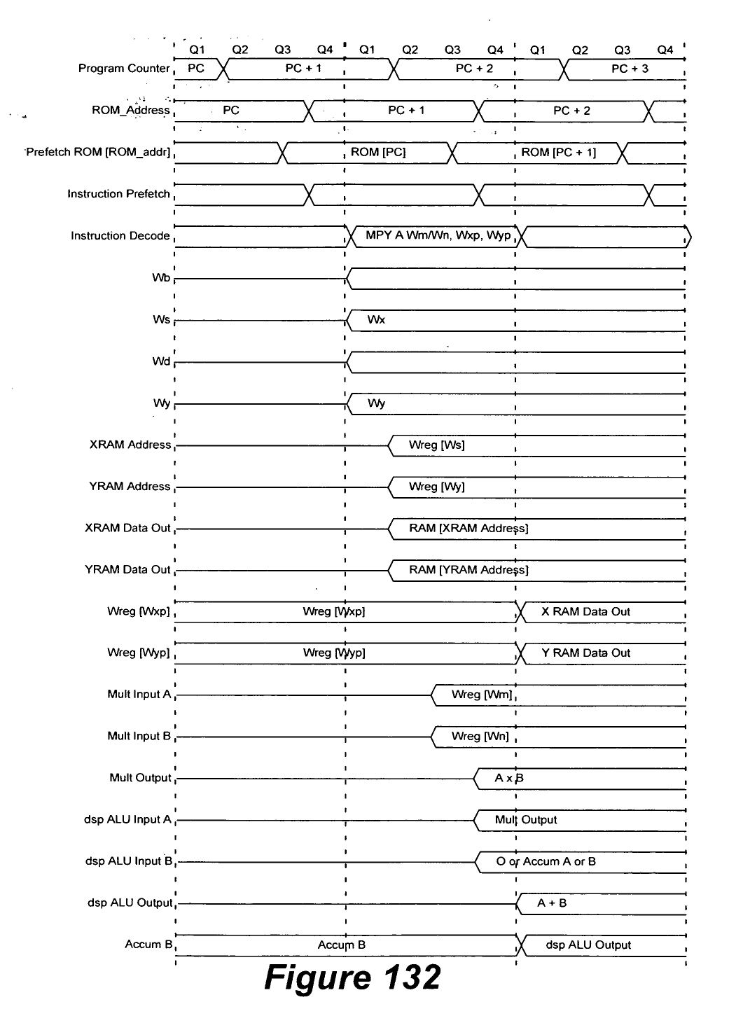

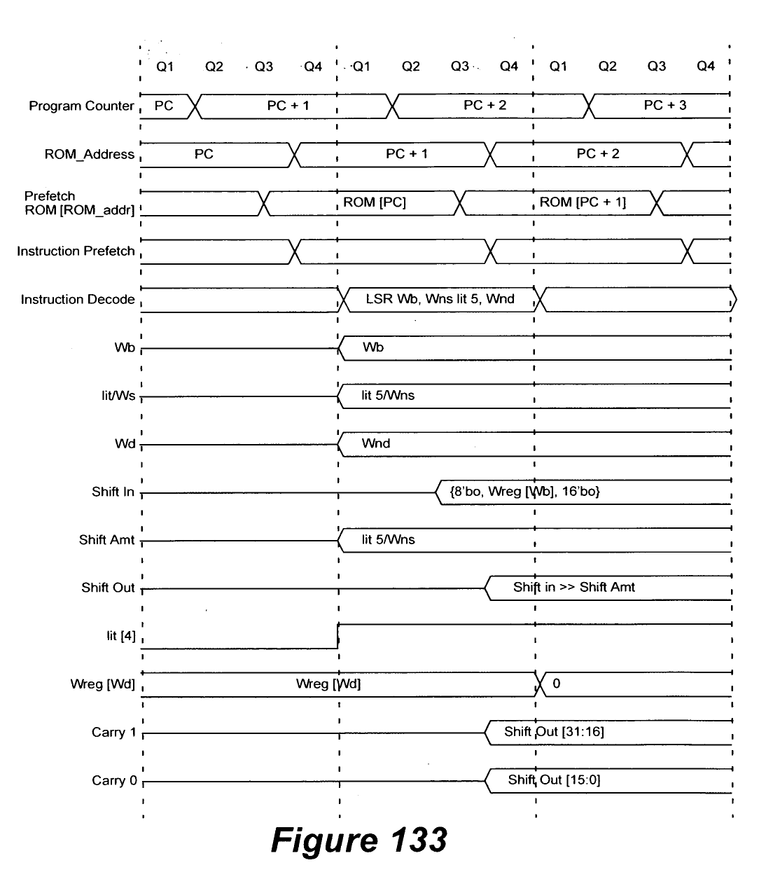

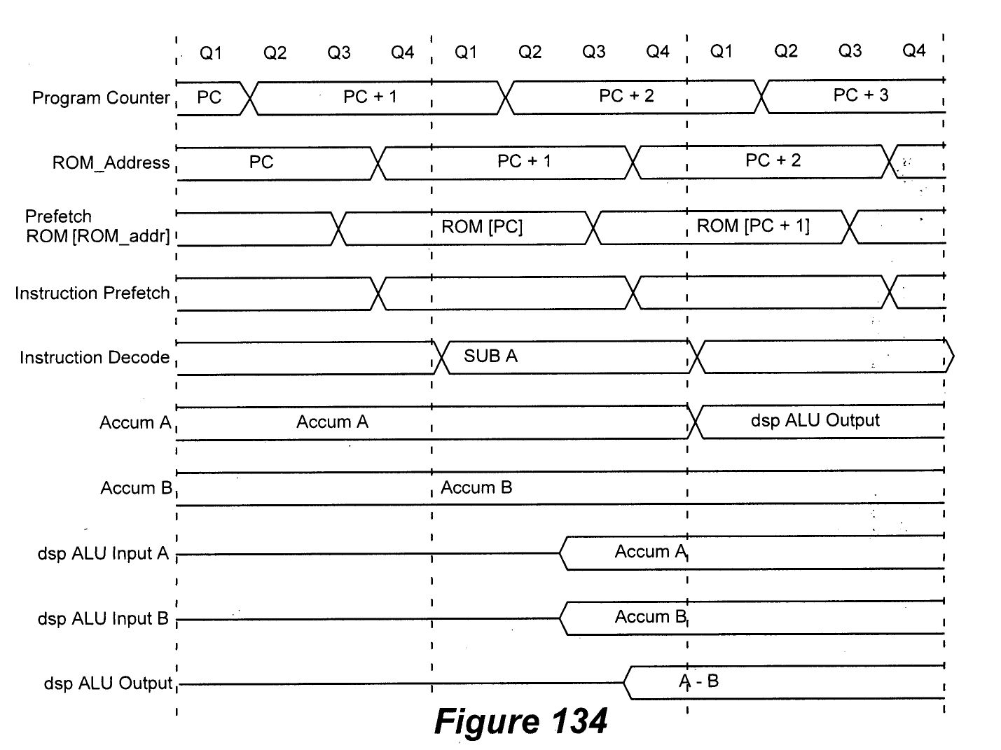

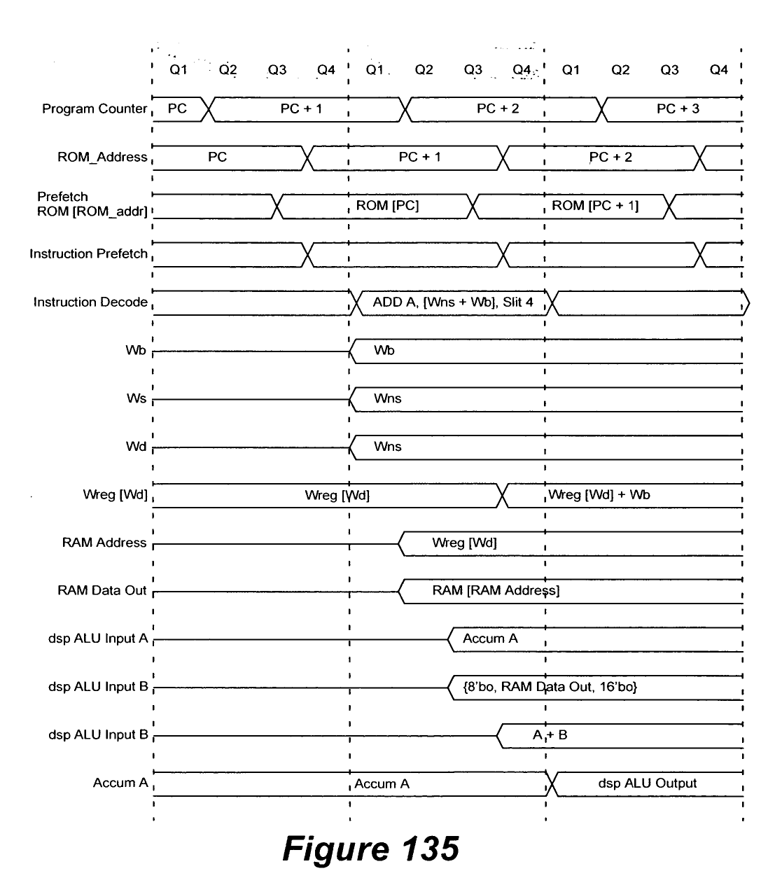

FIG. 130 shows a timing diagram illustrating a DO and the DOW operations continued. FIG. 131 shows a timing diagram illustrating a MAC, the CLRAC, the EDAC, the SQRAC and the MOVSAC operations. FIG. 132 shows a timing diagram illustrating a SQR, the ED, the MPY, the MPYN and the MSC operations. FIG. 133 shows a timing diagram illustrating a LSRW, the LSRK, the ASRK, the ASRW, the SLW and the SLK operations. FIG. 134 shows a timing diagram illustrating a ADDAB, the NEGAB and the SUBAB operations. FIG. 135 shows a timing diagram illustrating an ADDAC operation.

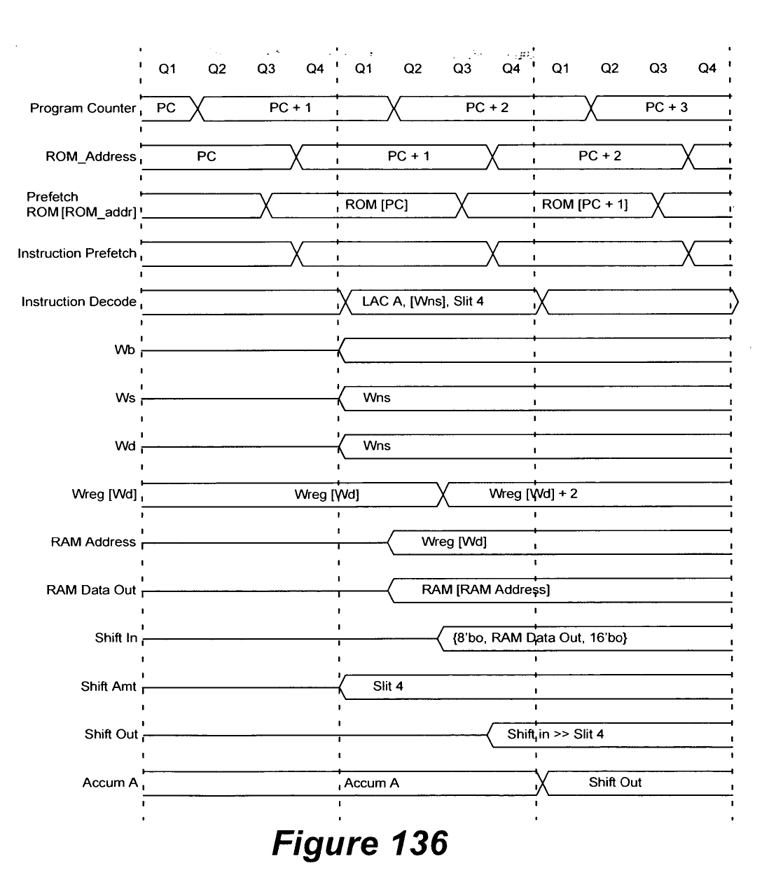

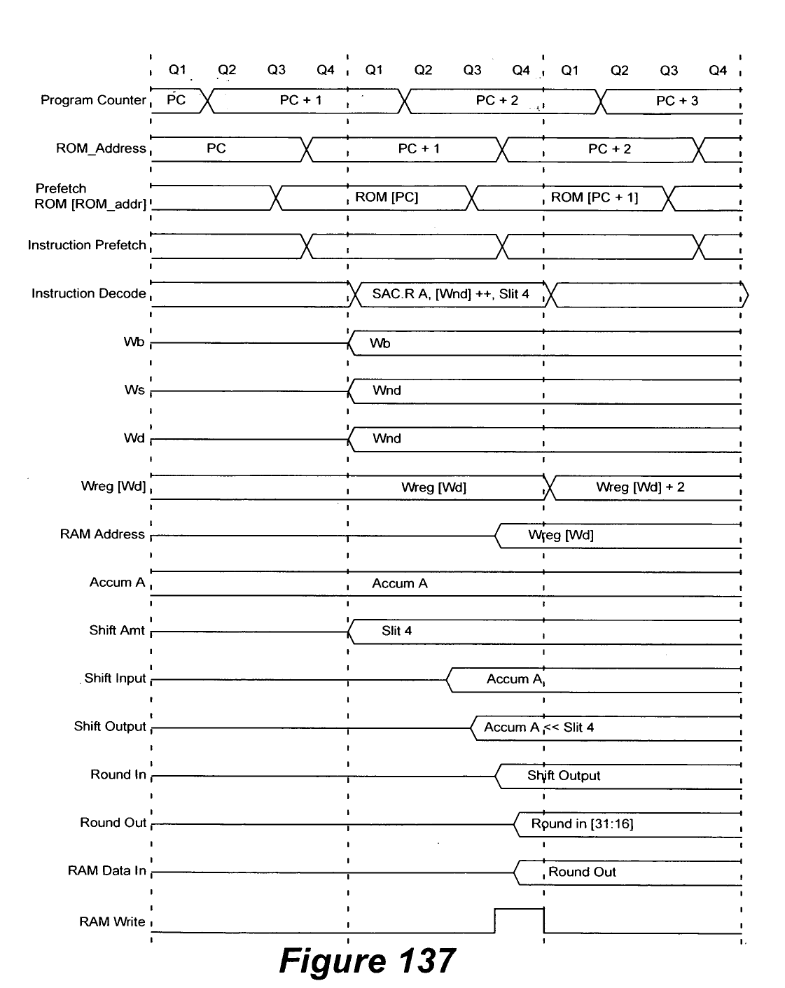

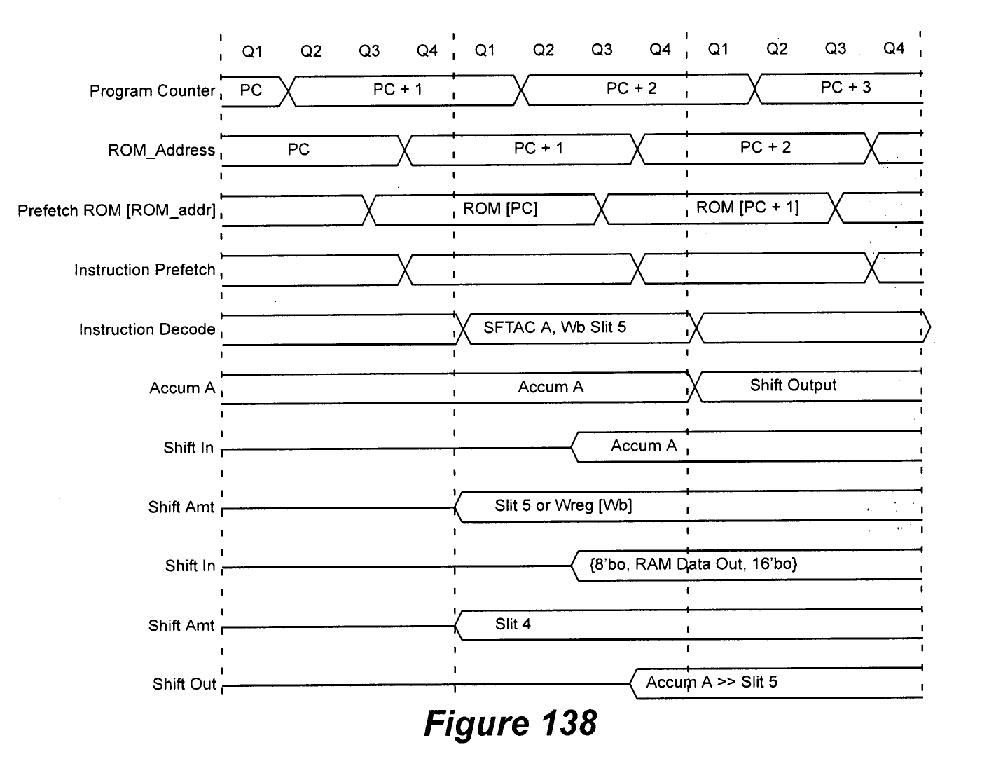

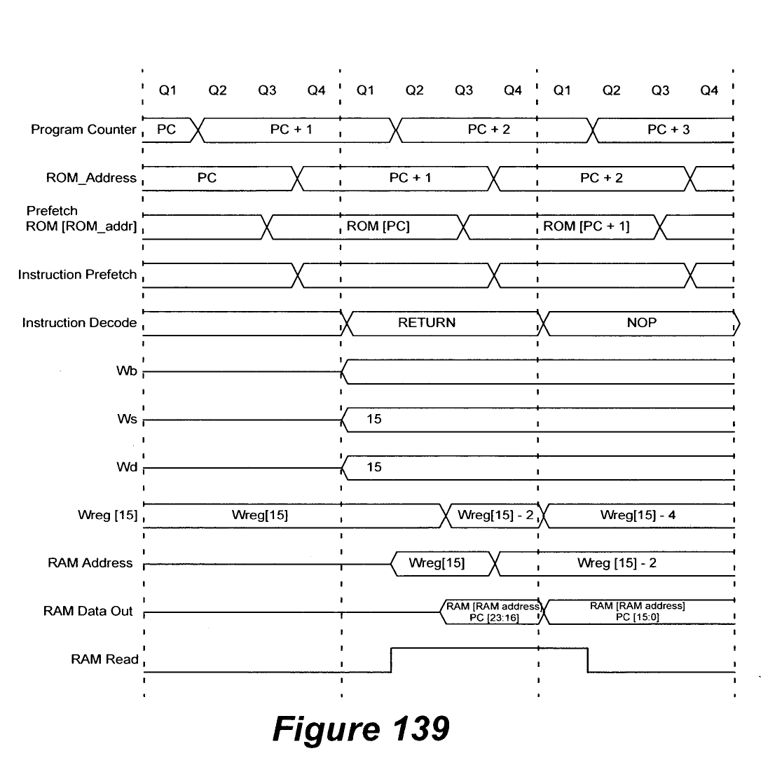

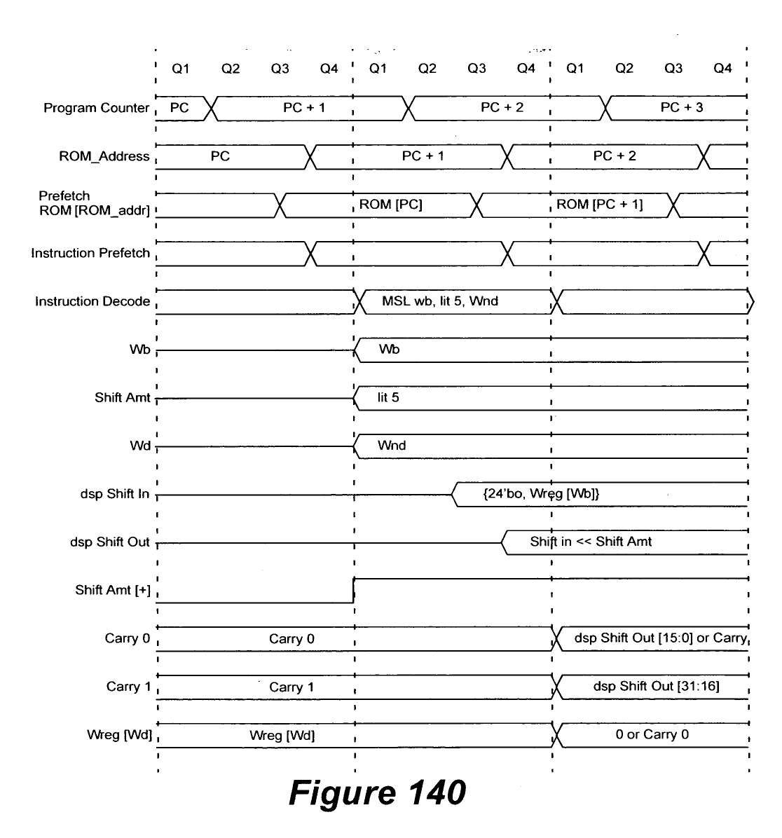

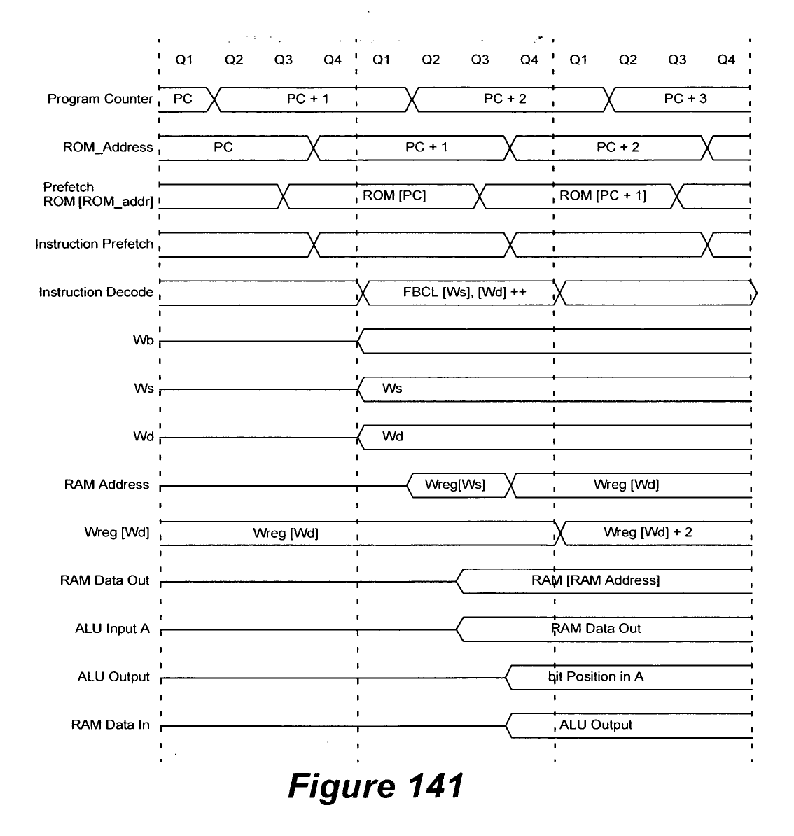

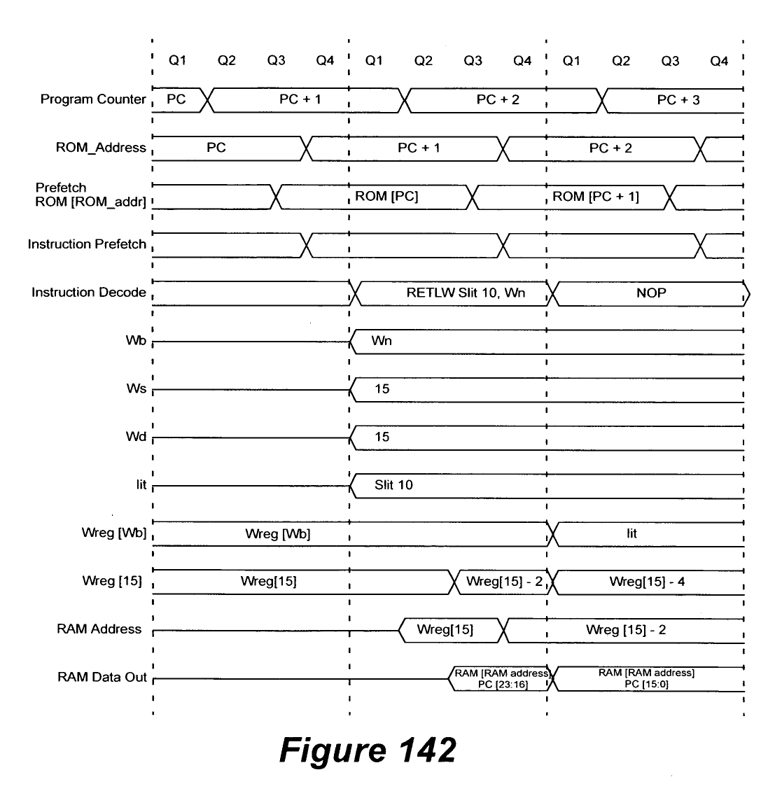

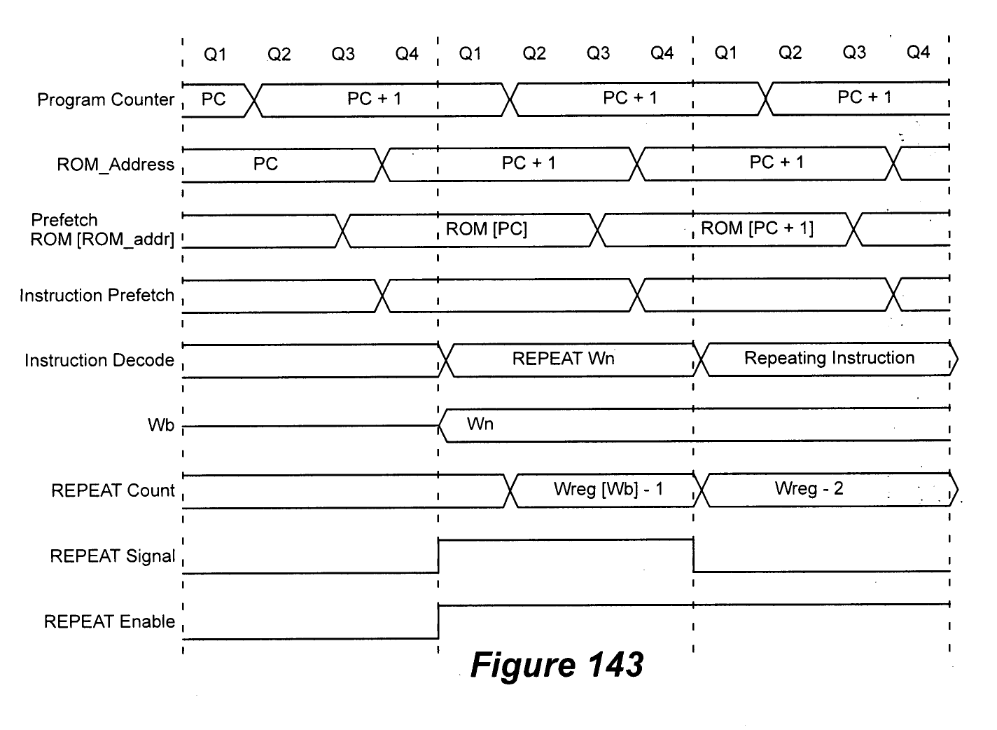

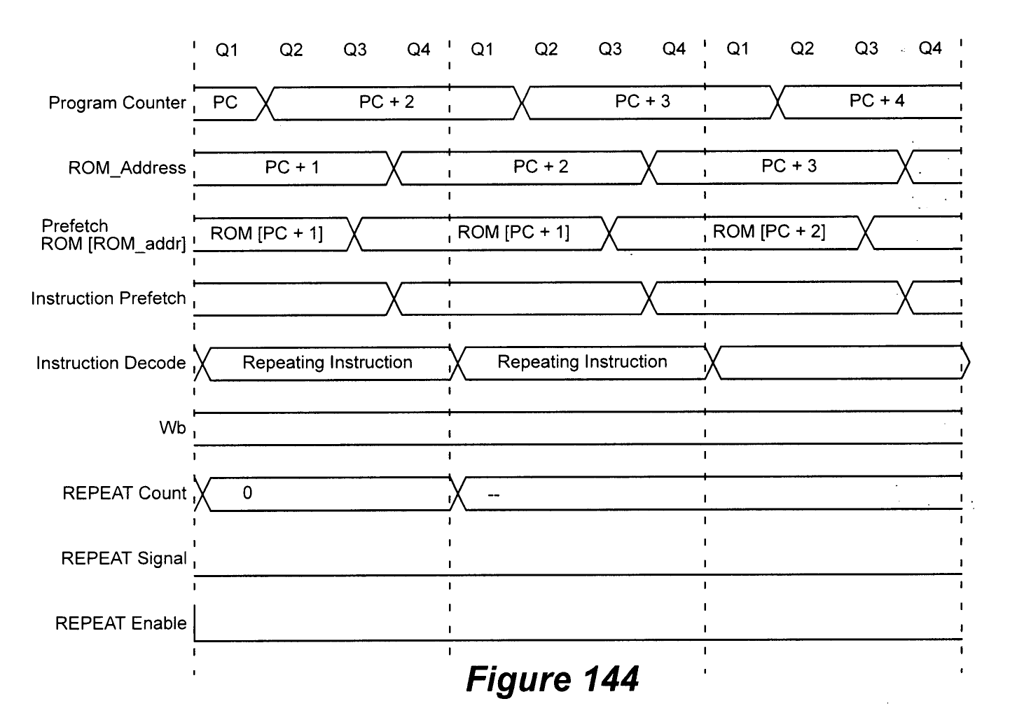

FIG. 136 shows a timing diagram illustrating a LAC operation. FIG. 137 shows a timing diagram illustrating a SAC and the SAC.R operations. FIG. 138 shows a timing diagram illustrating a SFTACK and the SFTAC operations. FIG. 139 shows a timing diagram illustrating a RETURN, the RE and the TFIE operations. FIG. 140 shows a timing diagram illustrating a MSLK, the MSRK, the MSLW and the MSRW operations. FIG. 141 shows a timing diagram illustrating a FBCL, the FBCR, the FFOL, the FFOR, the FFIL and the FFIR operations. FIG. 142 shows a timing diagram illustrating a RETLW operation. FIG. 143 shows a timing diagram illustrating a REPEAT and the REPEAT W operations. FIG. 144 shows a timing diagram illustrating a REPEAT and the REPEAT W operations continued.

Architectural Description

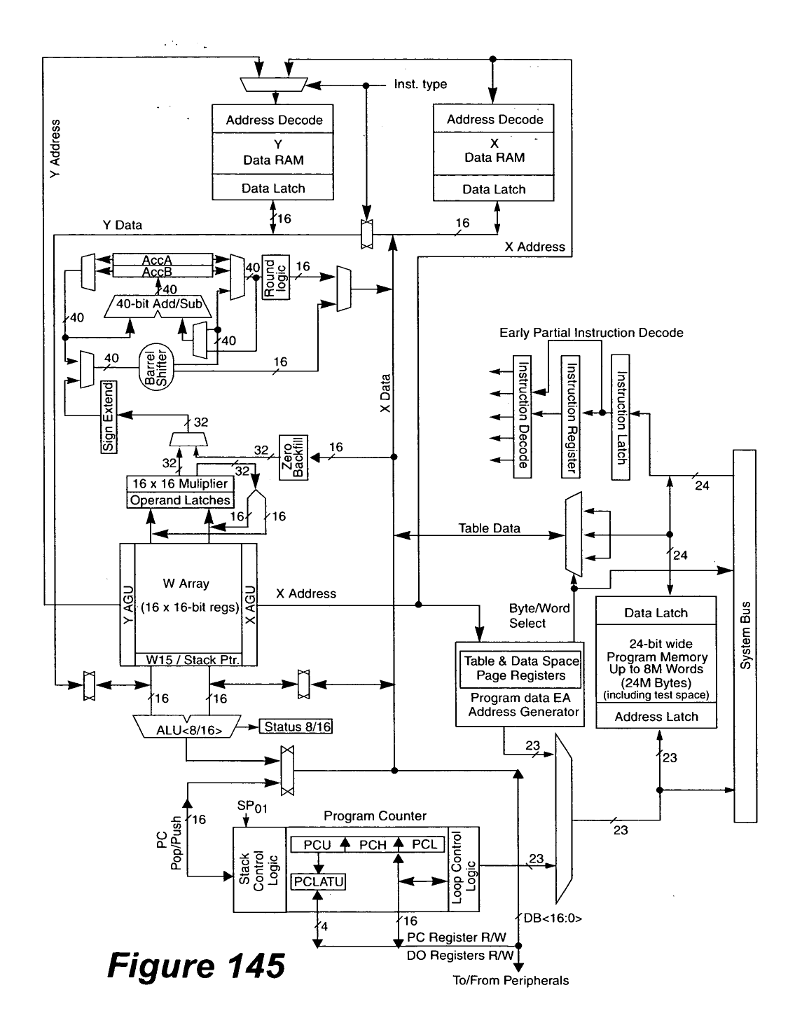

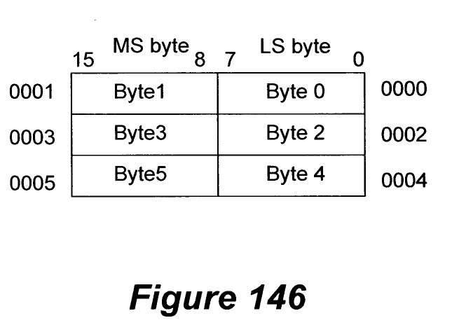

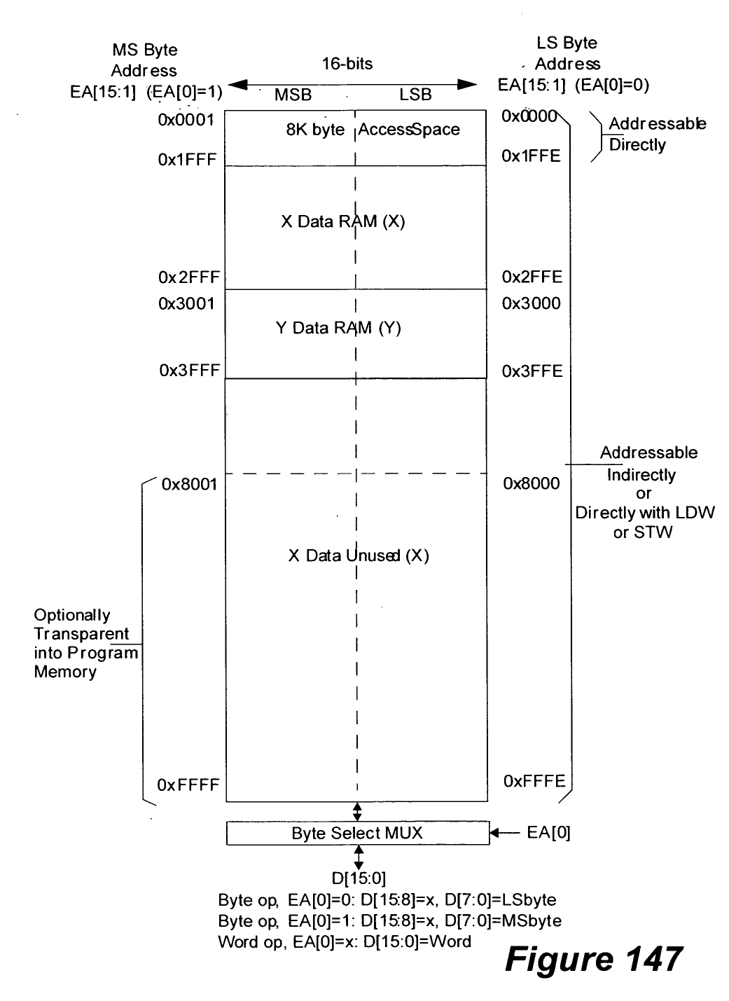

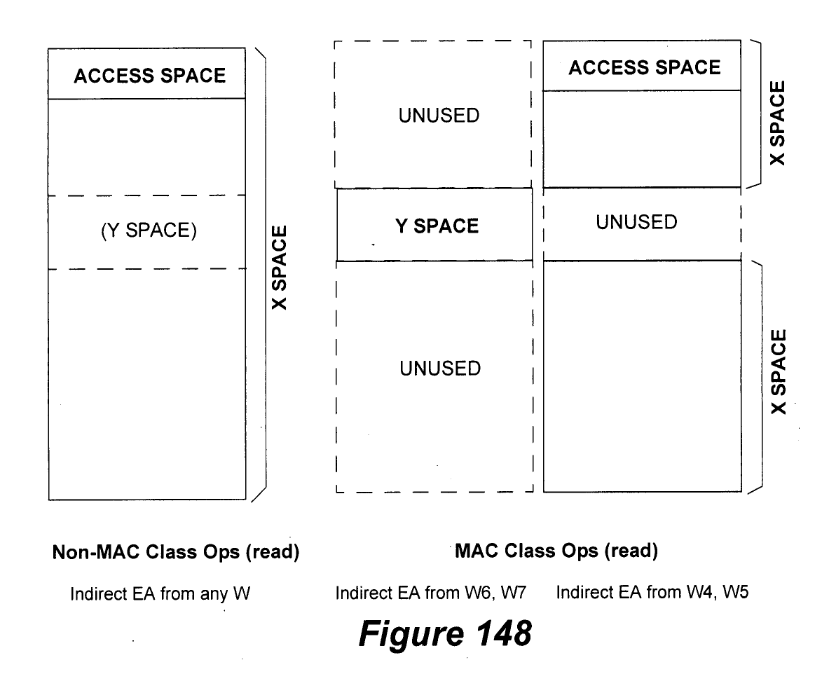

The foregoing illustrative example utilizes the disclosure provided above for various descriptions. The illustrative example of the central processing unit disclosed herein is a 16-bit (data) modified Harvard architecture with a greatly enhanced instruction set including significant support for digital signal processing (DSP). The forgoing description is better understood with reference to FIGS. 145-172. Specifically, FIG. 145 shows a block diagram illustrating a CPU Core. FIG. 146 shows a block diagram illustrating data alignment. FIG. 147 shows a block diagram illustrating a Data Space Memory Map Example. FIG. 148 shows a block diagram illustrating a data space for a microcontroller and digital signal processor instructions.

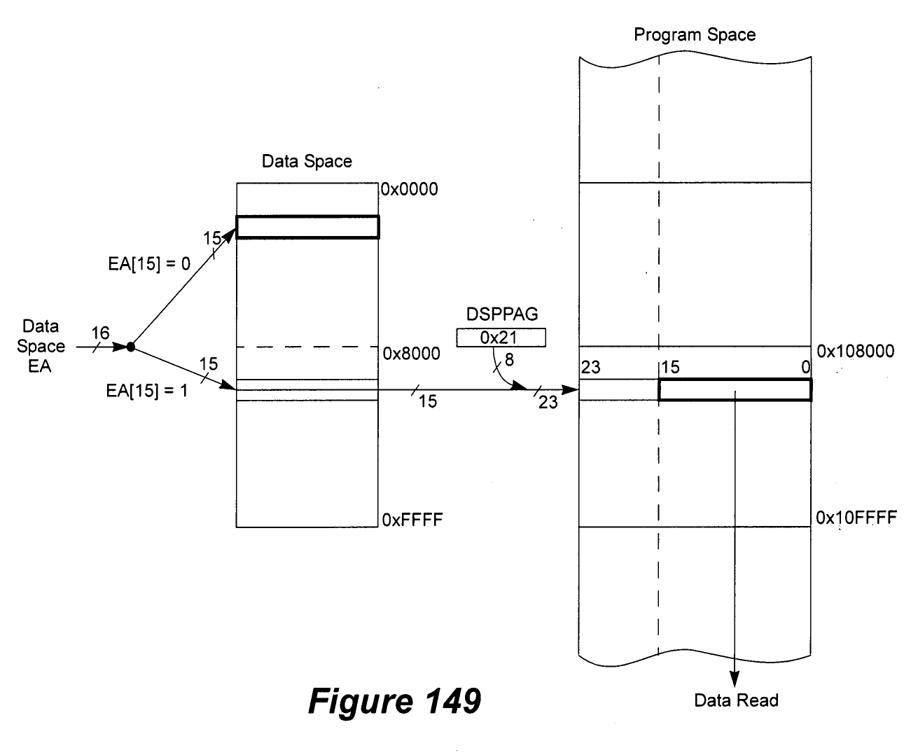

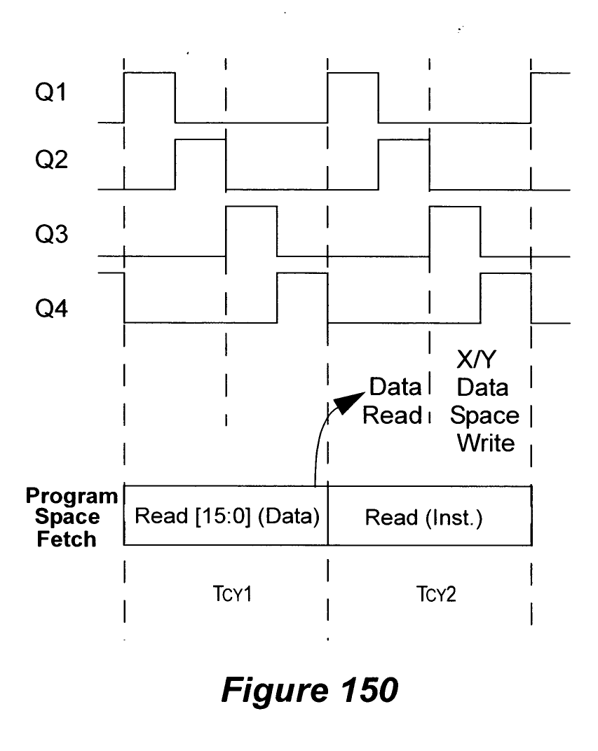

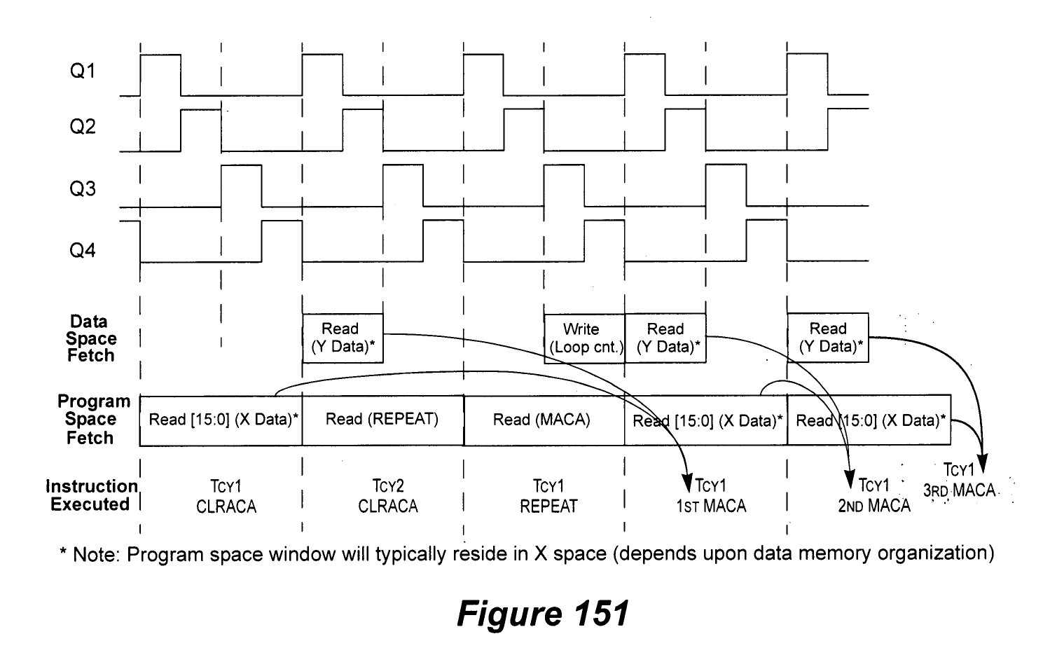

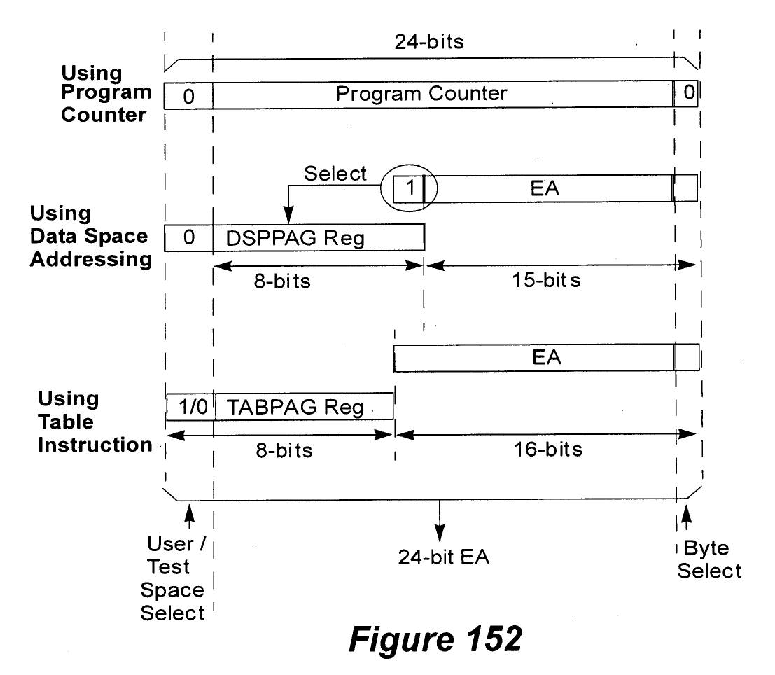

FIG. 149 shows a block diagram illustrating a data space window into the program space operation. FIG. 150 shows a block diagram illustrating a PS Data Read-Through DS operation. FIG. 151 shows a block diagram illustrating a PS Data Read-Through DS within a REPEAT loop operation. FIG. 152 shows a block diagram illustrating a data access operation from program space address generation.

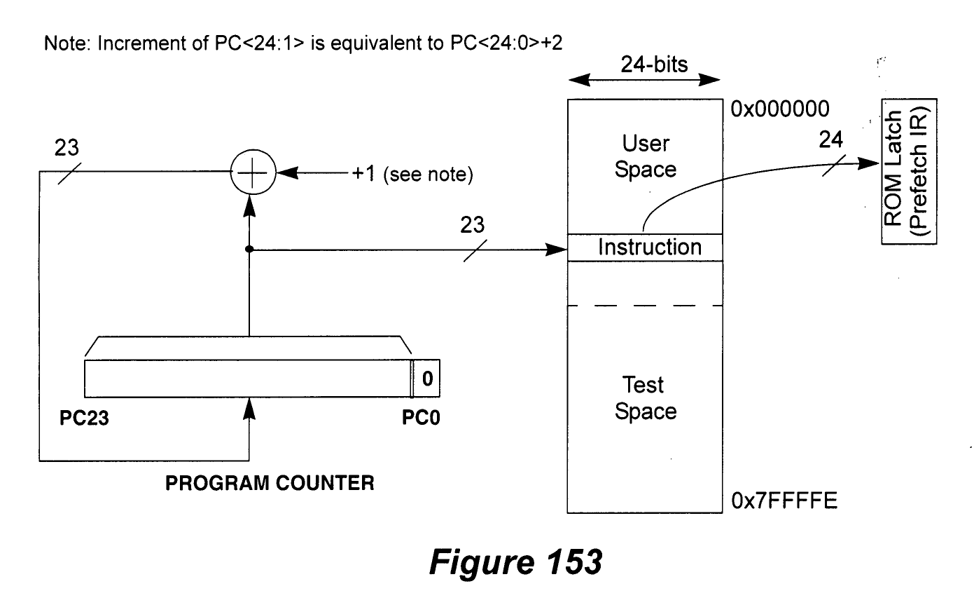

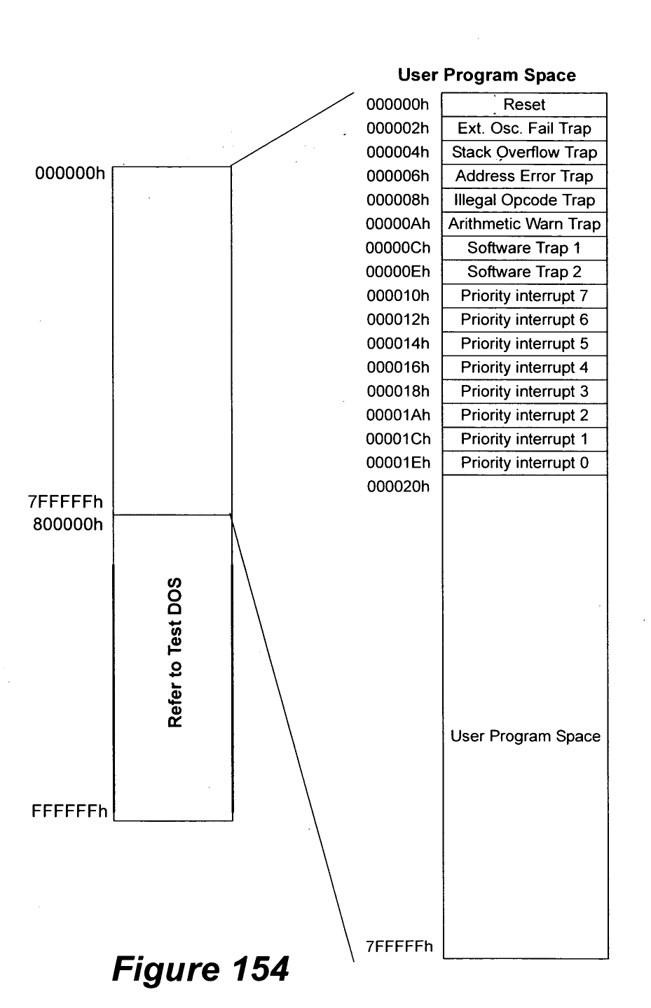

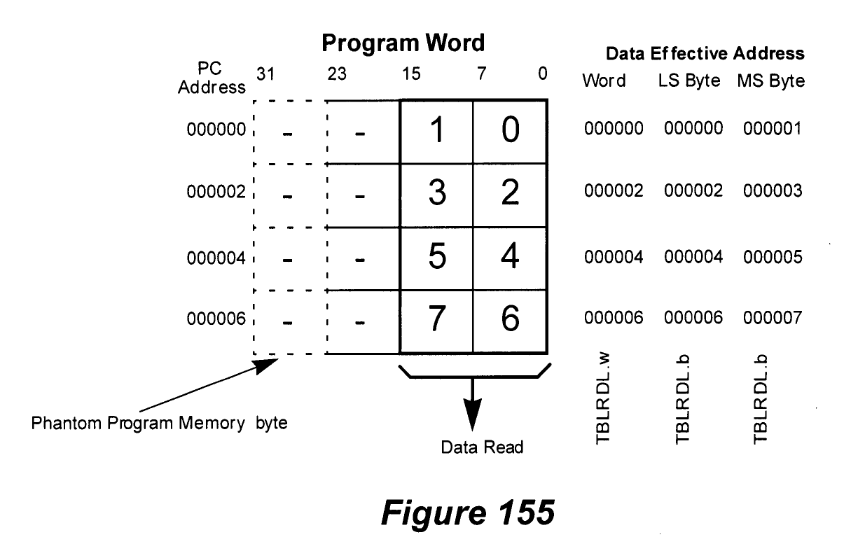

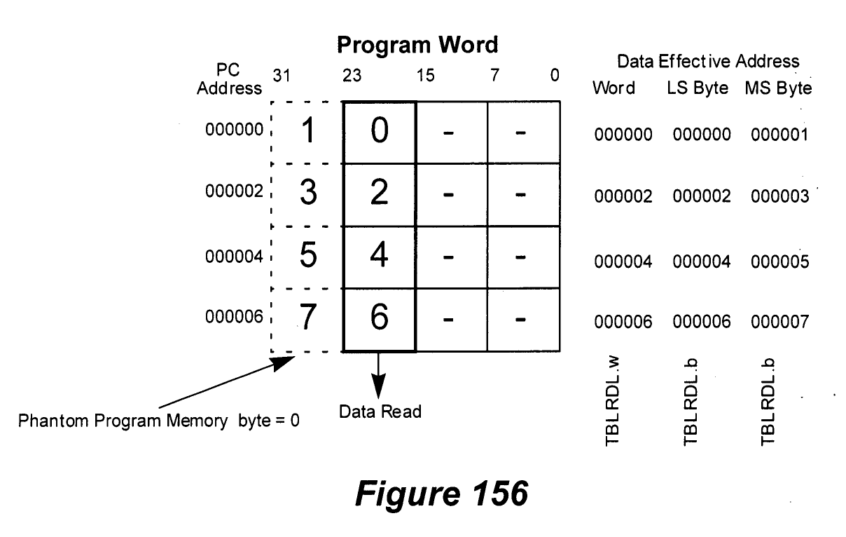

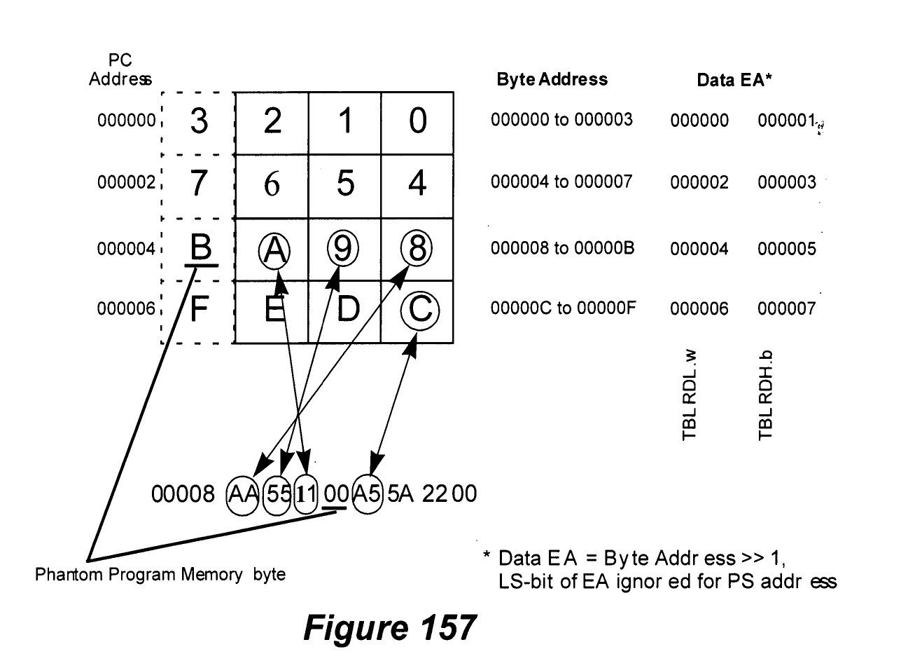

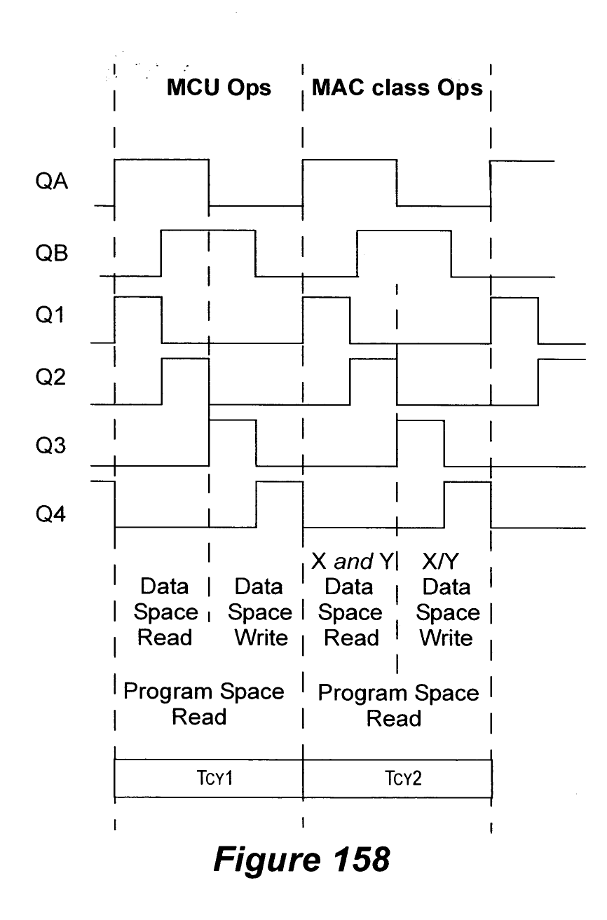

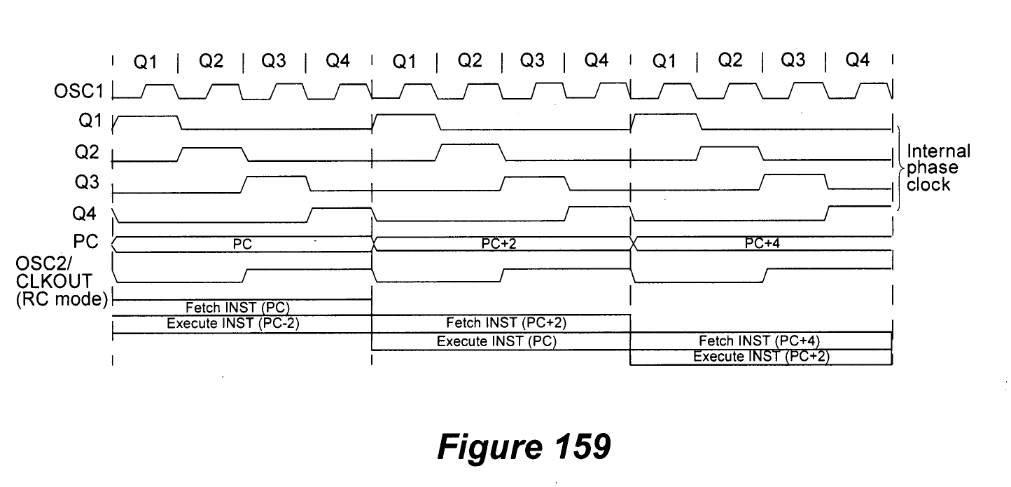

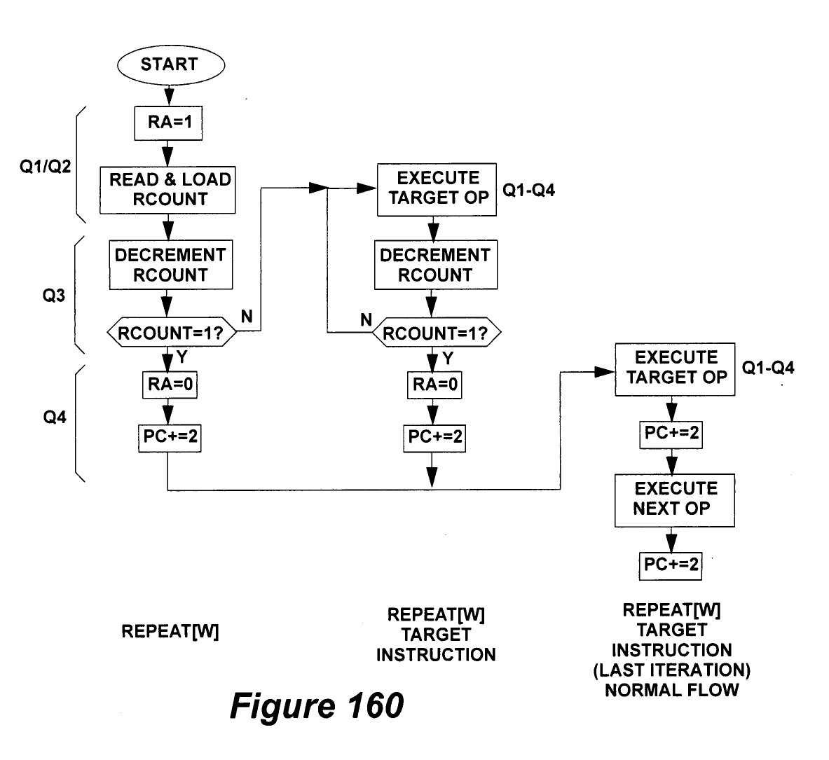

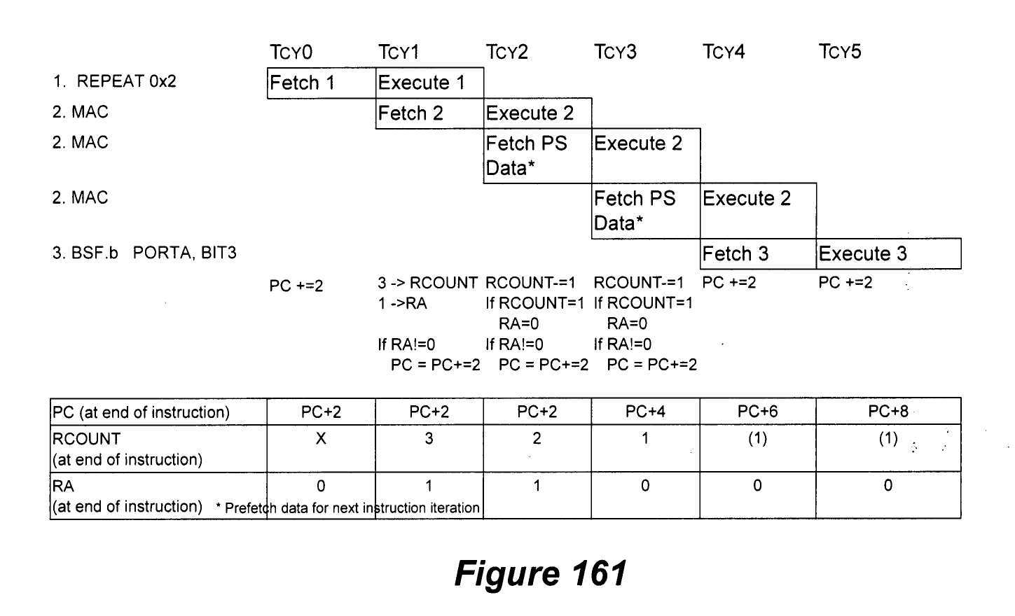

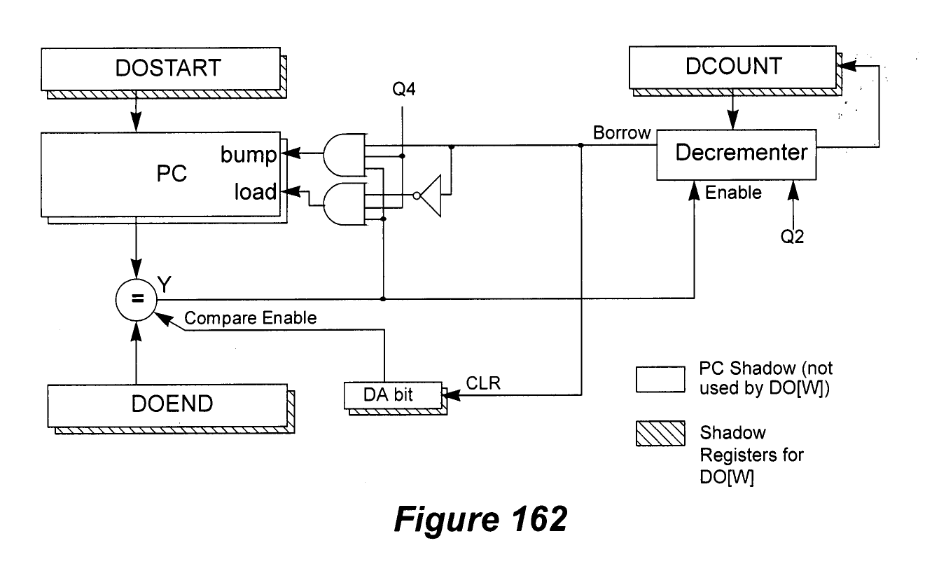

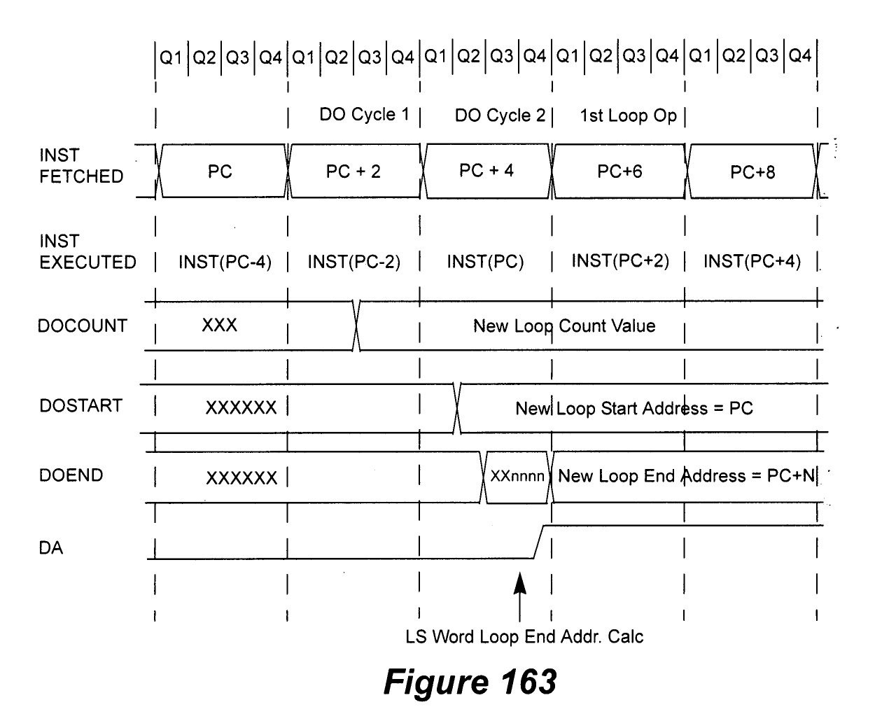

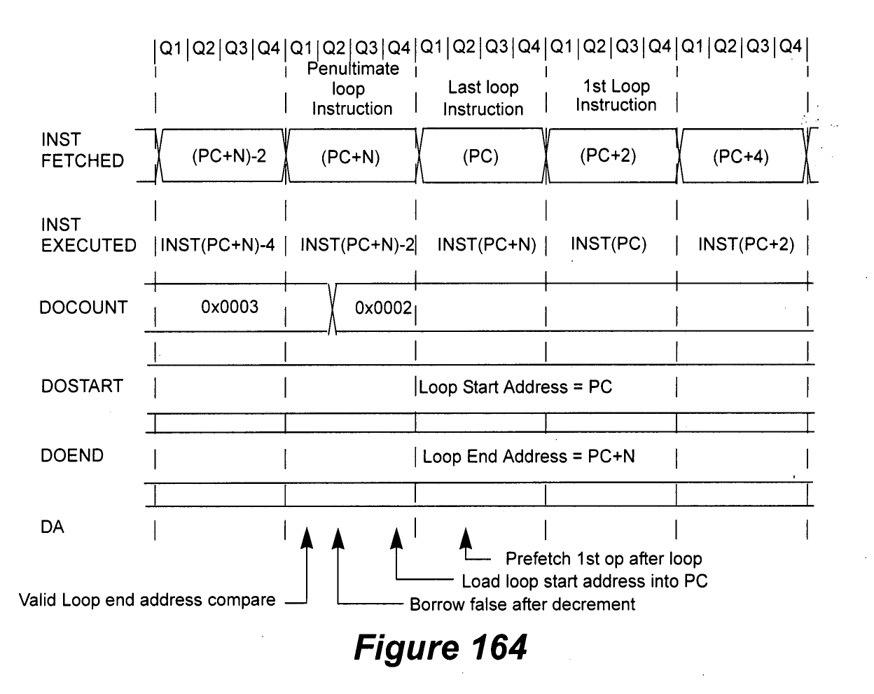

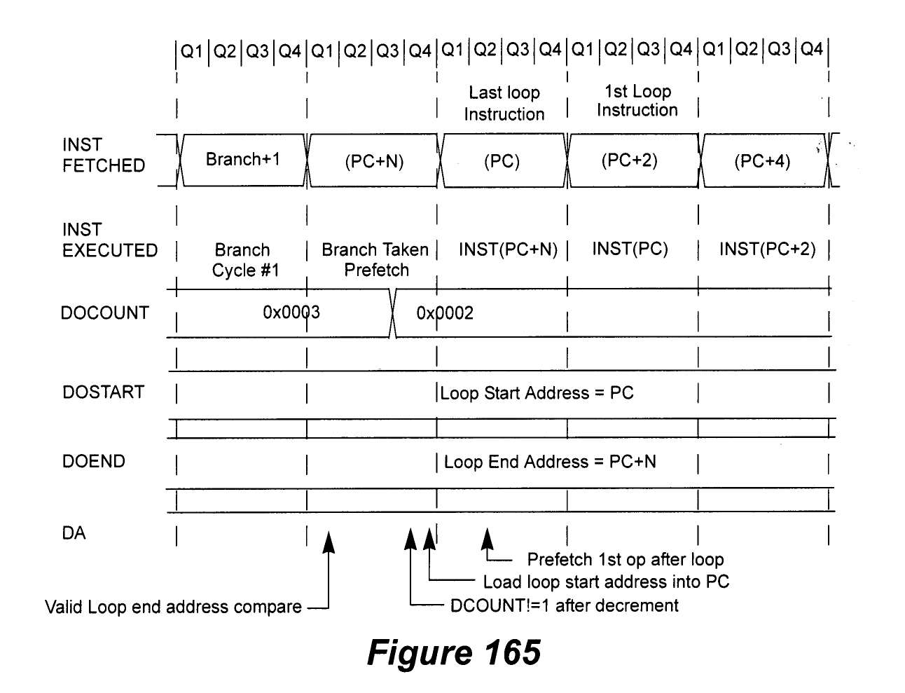

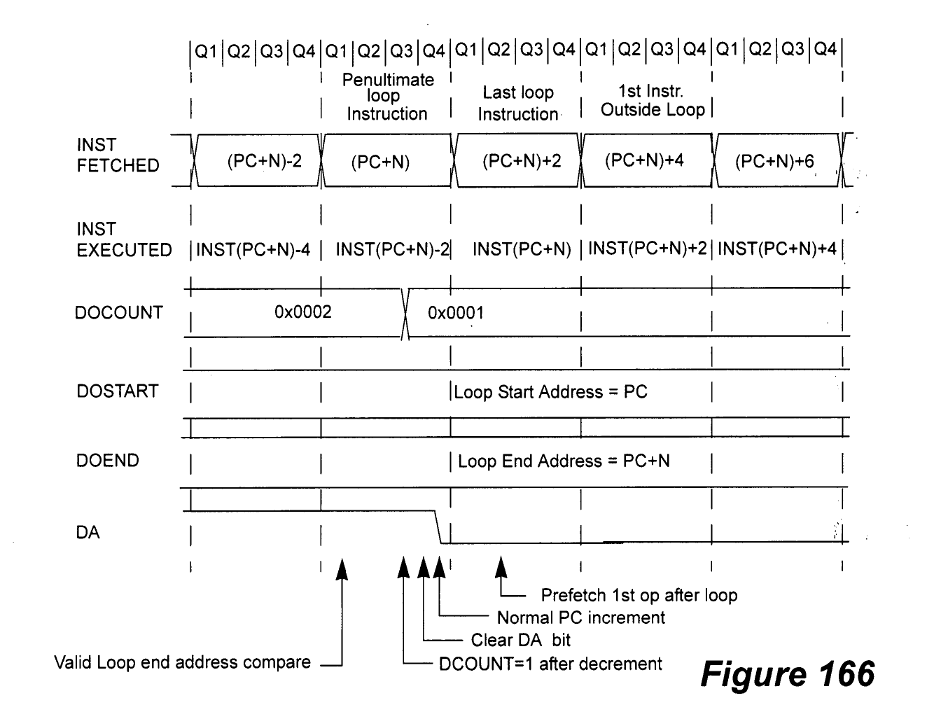

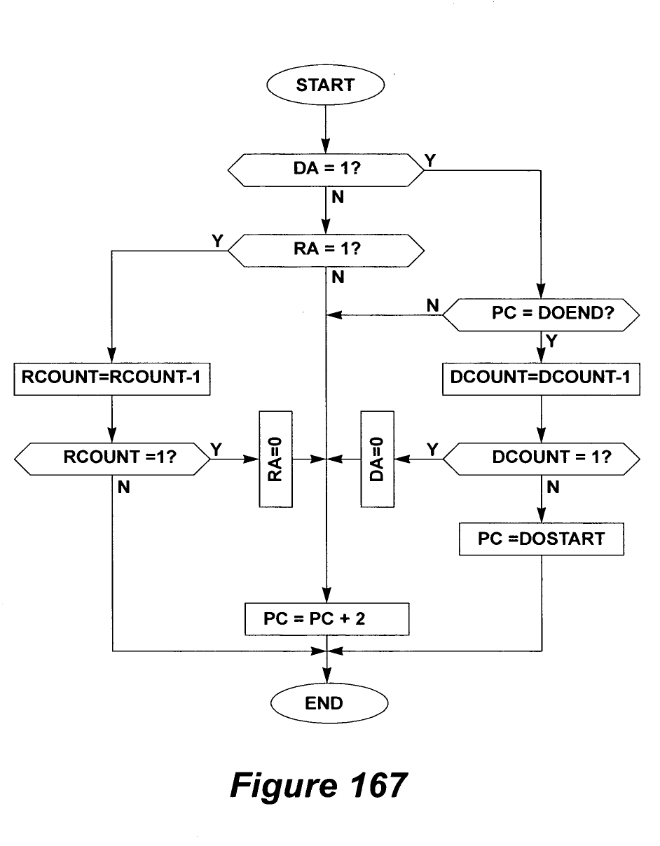

FIG. 153 shows a block diagram illustrating an instruction fetch. FIG. 154 shows a block diagram illustrating a program space memory map. FIG. 155 shows a block diagram illustrating a program data table access. FIG. 156 shows a block diagram illustrating program data table access. FIG. 157 shows a block diagram illustrating HEX file compatibility. FIG. 158 is a basic core timing diagram. FIG. 159 shows a timing diagram illustrating a clock/instruction cycle. FIG. 160 is a flow chart illustrating a REPEAT[W] loop functional flow. FIG. 161 shows a block diagram illustrating a REPEAT[W] instruction pipeline Flow. FIG. 162 shows a block diagram of a Do Loop hardware operation. FIG. 163 is timing diagram of a DO loop entry operation. FIG. 164 shows a timing diagram illustrating a DO loop continuation operation. FIG. 165 shows a timing diagram illustrating a DO Continue with Branch to Last Instruction operation. FIG. 166 shows a timing diagram illustrating a DO loop EXIT operation. FIG. 167 is a flow chart illustrating a DO and REPEAT operation.

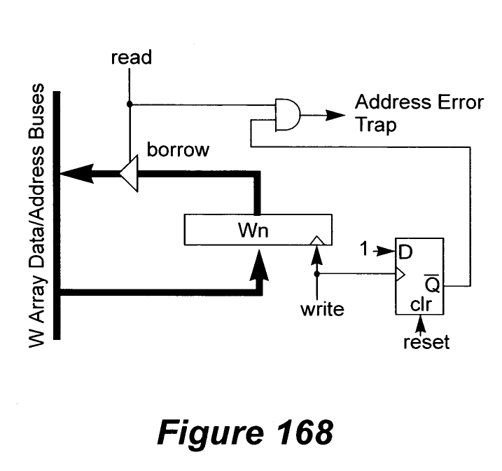

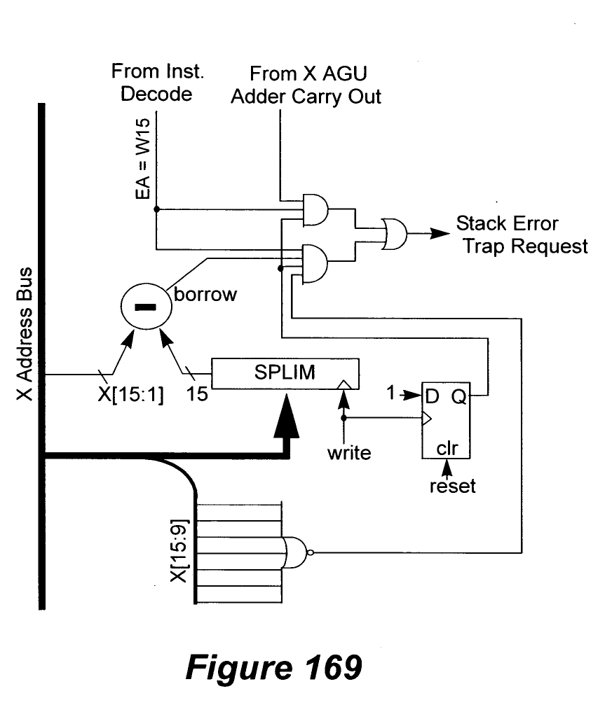

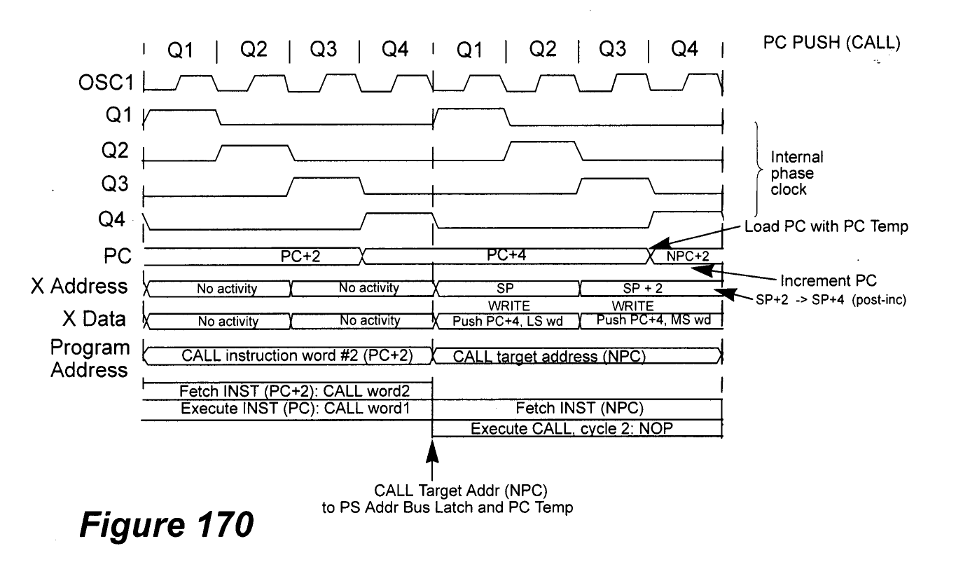

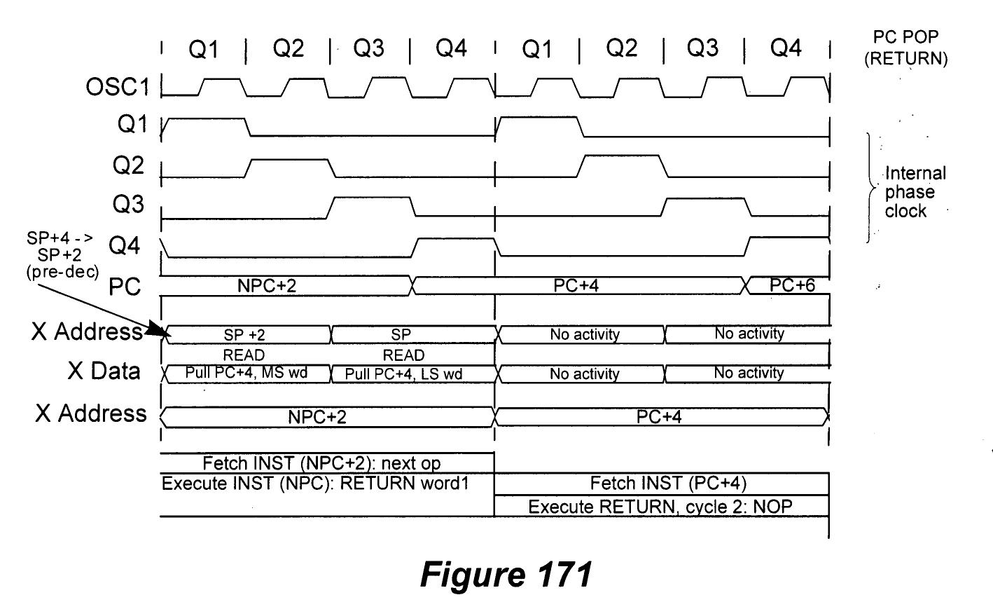

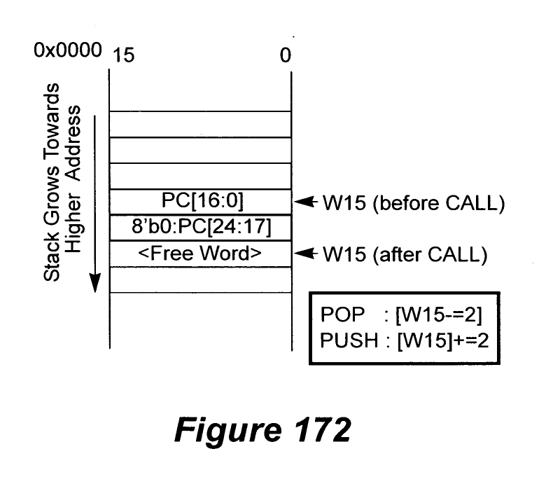

FIG. 168 shows a block diagram illustrating an Uninitialized W Register Trap operation. FIG. 169 shows a block diagram illustrating a Stack Pointer Overflow & Underflow Trap operation. FIG. 170 shows a timing diagram illustrating a Stack Timing of a PC PUSH CALL operation. FIG. 171 shows a timing diagram illustrating a Stack Timing of a PC POP RETURN operation. FIG. 172 shows a block diagram illustrating a CALL stack frame.

Core Overview

The core has a 24-bit instruction word, with a variable length opcode field. The PC is 24-bits wide (with the LS-bit always clear) addressing up to 8M long words (23-bits). An ‘C18-like’ instruction prefetch mechanism is used to help maintain throughput. Deeper levels of pipelining have been intentionally avoided to maintain good real-time performance. Unconditional overhead free program loop constructs are supported using the DO and REPEAT instructions, both of which are interruptable at any point.

The working register array has been extended to 16×16-bit registers, each of which can act as data, address or offset registers. One working register (W15) operates as a software stack for interrupts and calls.

The data space is 32K words of word or byte addressable space which is split into two blocks referred to as X and Y data memory. Each block has its own independent Address Generation Unit (AGU). Most instructions operate solely through the X memory AGU which will make it appear as one linear space encompassing all data space. The MAC class of DSP instructions will operate through both the X and Y AGUs, splitting the data address space into two parts. The X and Y data space boundary is arbitrary and defined through the address decode of each memory array. See FIG. 63, FIG. 64 and accompanying description.

The upper 32K bytes of data space memory can optionally be mapped into the lower half (user space) of program space at any 16K program word boundary defined by the 8-bit Data Space Program PAGe (DSPPAG) register. This lets any instruction to access program space as if it were data space (other than the additional access cycle it consumes) plus allows external RAM hooked onto the external program space to be mapped into data space, effectively providing an external data space bus.

Overhead free circular buffers (modulo addressing) are supported in both X and Y address spaces. They are intended to remove the loop overhead for DSP algorithms but X modulo addressing can be universally applied using any instructions.

The X AGU also supports bit reverse addressing to greatly simplify input or output data reordering for radix-2 FFT algorithms.

The core supports inherent (no operand), relative, literal, memory direct and four groups of addressing modes (MODE 1, MODE 2, MODE 3 and MODE 4) for register direct and register indirect modes. Each group offers up to six addressing modes. Instructions are associated with predefined addressing modes depending upon their functional requirements.

For most instructions, the core is capable of executing a data (or program data) memory read, a working register (data) read, a data memory write and a program (instruction) memory read per instruction cycle. As a result, three operand instructions can be supported, allowing A+B=C operations to be executed in a single cycle.

A DSP engine has been included to significantly enhance the core arithmetic capability and throughput. It features a high speed 16-bit by 16-bit multiplier, a 40-bit ALU, two 40-bit saturating accumulators and a 40-bit bidirectional barrel shifter. The barrel shifter is capable of shifting a 40-bit value up to 15 bits right or up to 16-bits left in a single cycle. The DSP instructions operate seamlessly with all other instructions and have been designed for optimal real-time performance. The MAC class of instructions can concurrently fetch two data operands from memory while multiplying two W registers. This requires that the data space be split for these instructions and linear for all others. This is achieved in a transparent and flexible manner through dedicating certain working registers to each address space for the MAC class of instructions.

The core features a vectored exception scheme with 15 individually prioritized vectors. The exceptions consist of reset, seven traps and eight interrupts. One interrupt level may be selected (typically the highest one) to execute as a fast (1 cycle entry, 1 cycle exit) interrupt. This function is actually an extension of the logic required to allow a REPEAT instruction loop to be interrupted which can significantly reduce latency in some application. A block diagram of the core is shown in FIG. 145.

Compiler Driven Enhancements

In addition to DSP performance requirements, the core architecture was strongly influenced by recommendations which would lead to a more efficient (code size and speed) C compiler.

For most instructions, the core is capable of executing a data (or program data) memory read, a working register (data) read, a data memory write and a program (instruction) memory read per instruction cycle. As a result, three operand instructions can be supported, allowing A+B=C operations to be executed in a single cycle. Instruction addressing modes are significantly more flexible than those of other processors, and are matched closely to compiler needs. The working register array has been extended to 16×16-bit registers, each of which can act as data, address or offset registers. One working register (W15) operates as a software stack for interrupts and calls.

Linear indirect access of all data space is possible, plus the memory direct address range has been extended to 8Kbytes (256bytes in C18). This together with the addition of 16-bit direct address LOAD and STORE instructions has allowed the C1 8 data space memory banking scheme to be eliminated. Linear indirect access of 32K word (64K byte) pages within program space (user and test space) is possible using any working register via new table read and write instructions. Part of data space can be mapped into program space, allowing constant data to be accessed as if it were in data space.

Instruction Fetch Mechanism

The core does not support an instruction pipeline. A pre-fetching mechanism accesses instruction a cycle ahead to maximize available execution time. Most instructions execute in a single cycle. Exceptions are:
1. Flow control instructions and interrupts where the ISR (instruction register) and pre-fetch buffer must be flushed and refilled.
2. Instructions where one operand is to be fetched from program space (using any method). These operations consume 2 cycles (with the notable exception of the MAC class of DSP instructions executed within a REPEAT loop which executes in 1 cycle).

Most instructions access data as required during instruction execution. Instructions which utilize the multiplier array must have data available at the beginning of the instruction cycle. Consequently, this data must be prefetched, usually by the preceding instruction, resulting in a simple out of order data processing model.

Data Address Space

The core features one program space and two data spaces. The data spaces can be considered either separately (for some DSP instructions) or together as one linear address range (for MCU instructions). The data spaces are accessed using two Address Generation Units (AGUs) and separate data paths.

Data Spaces

The X AGU is used by all instructions and supports all addressing modes. It also supports modulo and bit reversed addressing for any instructions subject to addressing mode restrictions (see [See Modulo and Bit Reversed Addressing Controller]). The X data path is the return data path for all single data space access instructions.

The Y AGU and data path are used in concert with the X AGU by the MAC class of instructions to provide two concurrent data read paths. No writes occur across the Y-bus. This class of instructions dedicate two W register pointers, W6 and W7, to always operate through the Y AGU and address Y data space independently from X data space. Note that during accumulator write-back, the data address space is considered combined X and Y, so the write will occur across the X-bus. Consequently, it can be to any address irrespective of where the EA is directed.

The Y AGU only supports MODE 4 post modification addressing modes associated with the MAC class of instructions. It also supports modulo addressing for automated circular buffers. Of course, all other instructions can access the Y data address space through the X AGU when it is regarded as part of the composite linear space.

The boundary between the X and Y data spaces is arbitrary and is defined by the memory address decode only (the CPU has no knowledge of the physical location of X or Y memory). The boundary is not user programmable but may change from variant to variant. Obviously, to present a linear data space to the MCU instructions, the address spaces of X and Y data spaces must be contiguous but this is not an architectural necessity. Note that any memory located between 0x8000 and 0xFFFF will not be accessible when program space visibility is enabled for this address space. It should be noted that as address space 0x8000 to 0xFFFF can map to a single memory in program space, it may need to be assigned to either X or Y space (but not both since concurrent accesses from the same space are not possible).

All (effective addresses) are 16-bits wide and point to bytes within the data space to facilitate backward compatibility with previous processors. Consequently, the data space address range is 64K bytes or 32K words.

Data Space Width

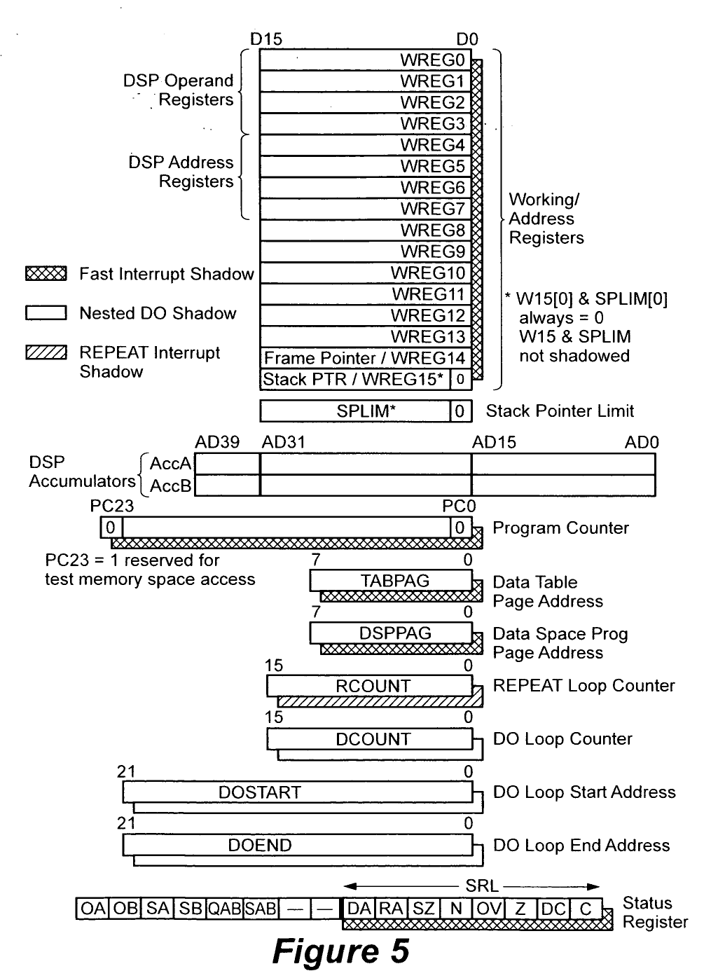

The core data width is 16-bits. All internal registers and data space memory are organized as 16-bits wide (some CPU registers are not 16-bits wide, see FIG. 5). Data space memory is organized in byte addressable, 16-bit wide blocks. Byte addressability requires independent byte write signals for upper and lower bytes.

Data Alignment

To help maintain backward compatibility and improve data space memory usage efficiency, the ISA supports both word and byte operations. Referring to FIG. 146, data is aligned in data memory and registers as words, but all data space EAs resolve to bytes. Data byte reads will read the complete word which contains the byte, using the LS-bit of any EA to determine which byte to select. The selected byte is place onto the LS-byte of the X data path (no byte accesses are possible from the Y data path as the MAC class of instruction can only fetch words). That is, data memory and registers are organized as two parallel byte wide entities with shared (word) address decode but separate write lines. Data byte writes will only write to the corresponding side of the array or register which matches the byte address. For word accesses, the LS-bit of the EA is ignored.

Byte reads will always read the entire word, so mechanisms to clear or set peripheral status bits when read (e.g. quick flag clearing mechanisms) are not allowed. As a consequence of this byte accessibility, all effective address calculations (including those generated by the DSP operations which are restricted to word size) must be scaled to step through word aligned memory. For example, the core must recognize that post modified register indirect addressing mode, [Ws]+=1, will result in a value of Ws+1 for byte operations and Ws+2 for word operations.

All word accesses must be aligned (to an even address). Mis-aligned word data fetches are not supported so care must therefore be taken when mixing byte and word operations or translating from C18 code. Should a mis-aligned read or write be attempted, an address fault trap will forced. Depending upon where the fault occurred in the instruction cycle, the Q1/Q2 access (typically a read) and/or the Q3/Q4 access (typically a write) for the instruction underway will be inhibited, and the PC will not be incremented. The trap will then be taken, allowing the system and/or user to examine the machine state prior to execution of the address fault.

All byte loads into any W register are loaded into the LS-byte. The MS-byte is not modified. It should be noted that byte operations use the 16-bit ALU and can produce results in excess of 8-bits. However, to maintain C18 backwards compatibility, the ALU result from all byte operations is written back as a byte (i.e. MS byte not modified), and the status register is updated based only upon the state of the LS-byte of the result.

A sign extend (SE) instruction is provided to allow users to translate 8-bit signed data to 16-bit signed values. Alternatively, for 16-bit unsigned data, users can clear the MS-byte of any W register though executing a CLR.b instruction on the appropriate address.

Although most instructions are capable of operating on word or byte data sizes, it should be noted that the DSP and some other new instructions operate on words only.

Data Space Memory Map

The data space memory is split into two blocks, X and Y data space. A key element of this architecture is that Y space is a subset of X space, and is fully contained within X space. In order to provide an apparent linear addressing space, X and Y space would typically have contiguous addresses (though this is not an architectural necessity).

When executing any instruction other than a MAC class one, the X block consists of the entire 64Kbyte data address space (including all Y addresses). When executing a MAC class of instruction, the X block consists of the entire 64Kbyte data address space less the Y address block for data reads (only). In other words, the full address space is available to all instructions other than the MAC class. During Q1/Q2 data reads, the MAC class of instructions extracts the Y address space from data space and addresses it using EA's sourced from W6 and W7. The remaining data space is referred to as X space but could more accurately be described as “X-Y” space, and is concurrently addressed using W4 and W5 during the same Q1/Q2 data read portion of the cycle. Both “X-Y” and Y address spaces are concurrently accessed only by the MAC class of instruction.

Note that it is the register number (and instruction class) that determine which address space is accessed for data reads and not the EA. Consequently, the data space partitioning of Y address space is arbitrary. In all cases, should an EA point to unoccupied space, all zeros will be returned. For example, although Y address space is visible by all non-MAC class instructions using any addressing mode, an attempt by a MAC instruction to fetch data from that space using W4 or W5 (X space pointers) will return 0x0000.

An example data space memory map is shown in FIG. 147. Note again that the partition between each address space is arbitrary and determined by the memory decode. Both X and Y address generation units (AGUs) can generate any effective address (EA) within a 64Kbyte range, however, EAs outside the physical memory provided will return all zeros.

An 8Kbyte access space is reserved in X address memory space between 0x0000 and 0x1FFF which is directly addressable via a 13-bit absolute address field within all memory direct instructions. The remaining X address space and all of the Y address space is addressable indirectly. The whole of X data space is additionally addressable using LDW and STW instructions which support memory direct addressing with a 16-bit address field.

Program Space Visibility from Data Space

The upper 32Kbytes of data space may optionally be mapped into any 16Kword program space page. This provides transparent access of stored constant data from X data space without the need to use special instructions (i.e. TBLRD, TBLWT instructions). Granularity of program space window may change, subject to conclusions of code security analysis.

This feature also allows the user to map the upper half of data space into an unused area of program memory and thus to the external bus (all unused internal addresses will be mapped externally). Through the placement of an external RAM at this address, external data space support is also provided. Data read and writes must therefore be supported to this address space. Note that the external address map is now essentially no longer strictly Harvard as program and data memory are combined.

Program space access through the data space occurs if the MS-bit of the data space EA is set and program space visibility is enabled by setting the PSV bit in the Core Control register (“CORCON”). Most of the CORCON function relate to DSP operation. Depending upon FLASH setup and access time, the instruction may need to be at least partially pre-decoded during Q4 of the prior instruction. Even so, this will remain a critical path, as the source EA cannot be evaluated until the data write completes in the prior instruction.

Data accesses to this area will add an addition cycle to the instruction being executed since two program memory fetches will be required. The data is fetched in the first cycle, which, other than for some instruction decode, is essentially a NOP. The next instruction is prefetched in the second cycle while the current instruction completes execution (i.e. normal operation) as shown in FIG. 150.

Furthermore, instructions executing from internal program memory but accessing external data memory RAM will sustain additional delay due to wait state insertion. Read-modify-write operations will sustain twice the delay. The External Bus Interface (EBI) definition is not complete at this time, however, it is expected that the device will be required to insert an even number of Q clocks into the instruction cycle between Q2 and Q3, and between Q4 and Q1 (of the next cycle) for external data space accesses.

Although not an architectural necessity, a typical data space configuration would define Y data space to be outside this re-mappable area, making the visible program space map to X data space. Y data space will typically contain state (variable) data for DSP operations, and must therefore be RAM. X data space will typically contain coefficient (constant) data which could be NVM or initialized RAM.

Although each transparent data space address will map directly into a program address (see FIG. 152), only the lower 16-bits of the 24-bit program word are used to contain the data. The upper 8-bits should be programmed to force an illegal instruction or software trap to maintain machine robustness.

For external accesses, data space would only require a 16-bit data path, with the trap instruction being automatically concatenated onto any 16-bit data reads.

The data space address is mapped into program memory as shown in FIG. 152. Note that, by incrementing the PC by 2 for each program memory word, the LS 14 bits (15 bits for the TBLRD, TBLWT instructions) of data and program space addresses directly translate. The remaining bits are provided by the Data Space Program PAGe register, DSPPAG<7:0> as shown in FIG. 152.

Data Pre-Fetch from Program Space within a REPEAT Loop

When prefetching data resident in program space via the data space window from within a REPEAT loop, all iterations of the repeated instruction will reload the instruction from the Instruction Latch without re-fetching it, thereby releasing the program bus for a data prefetch as shown in FIG. 151. In this example, the initial 2 data words for the first iteration of the instruction to be repeated (MACA) are fetched by a CLRACA instruction. As one of the words resides in program space, an additional cycle is required. The initial fetch of the MACA instruction is performed by the REPEAT instruction.

It is important to note that only the MAC class of instructions, which operate with prefetched data, will operate in this manner. All other instructions (e.g. MOV) which require data to be read by the end of Q2 will require the additional cycle in order to complete the data read prior to execution of the instruction during the second cycle.

Program Address Space

The program address space is 8M long words. It is addressable by a 24-bit value from either the PC, table instruction EA or data space EA when program space is mapped into data space as defined by Table 186. Note that the program space address is incremented by two between successive program words in order to provide compatibility with data space addressing. Consequently, the LS-bit of the program space address is always 0, resulting in 23-bits (8M) of address. Program space data accesses use the LS-bit of the program space address as a byte select (same as data space). Memory mapped or stacked PC may need to include the zero LS-bit.

The address space is split into two 4M long word spaces, one for user space the other for test and vector memory space as shown in FIG. 154. When in user mode, program space access is restricted to the lower 4M long word space, 0x000000 to 0x7FFFFE for all accesses other than TBLRD/TBLWT which use TABPAG[7] to determine user or test space access. Exception vectors also reside in test space. While in user mode, the PC is inhibited from ‘rolling over’ into test space (i.e. PC[23] is always clear).

TABLE 186
Program Space Address Construction

| | Access | Program Space Address | | | | |
|---|---|---|---|---|---|---|
| Access Type | Space | [23] | [22:16] | [15] | [14:1] | [0] |

| | | | | |
|---|---|---|---|---|
| Instruction Access | User | 0 | PC[23:1] | 0 |
| Instruction Access | Test | 1 | PC[23:1] | 0 |

| | | | |
|---|---|---|---|
| TBLRD/TBLWT | User/Test | TABPAG[7:0] | Data EA [15:0] |

| | | | | |
|---|---|---|---|---|
| DS Window into PS | User | 0 | DSPPAG[7:0] | Data EA [14:0] |

| | | |
|---|---|---|
| DS Window into PS | Test | Not allowed |

The program memory width is 24-bits (long word). To support data storage and FLASH programming, the array must support both word wide access from bits 0-15 and byte wide access from bits 16-23. An instruction fetch example is shown in FIG. 153. Note that incrementing PC[23:1] by one is equivalent to adding 2 to PC[23:0]. This architecture (internally) fetches 24-bit wide program memory. Consequently, instructions are always aligned. However, as the architecture is modified Harvard, data can also be present in program space.

There are two methods by which program space can be accessed—via special TABLE instructions or through the remapping of a 16Kword program space page into the upper half of data space (see FIG. 154). The TBLRDL and TBLWTL instructions offers a direct method of reading or writing the LS word of any address within program space without going through data space which is preferable for some applications. The TBLRDH and TBLWTH instructions are the only method whereby the upper 8-bits of a program word can be accessed as data. FIG. 152 shows how the EA is created for table operations.

Table Instructions

A set of TABLE instructions are provided to move byte or word sized data to and from program space. The instructions are orthogonal even though the MS byte will always read zeros. See dsPIC Instruction Set DOS for more details.
1. TBLRDL: Table read low
   Word: Read the LS word of the program address
   P[15:0] maps to D[15:0]
   Byte: Read one of the LS bytes of the program address
   P[7:0] maps to D[7:0] when byte select=0;
P[15:8] maps to D[7:0] when byte select=1
2. TBLWRL: Table write low
   See Program Memory DOS-00204
3. TBLRDH: Table read high
   Word: Read the MS word of the program address
   P[23:16] maps to D[7:0]; D[15:8] always=0
   Byte: Read one of the MS bytes of the program address
   P[23:16] maps to D[7:0] when byte select=0;
   D[7:0] will always=0 when byte select=1
4. TBLWRH: Table write high
   See Program Memory DOS-00204
      Where:
P=program space long word; and
D=data space word.

The PC is incremented by two for each successive 24-bit program word. This allows program memory addresses to directly map to data space addresses as shown in FIG. 155. Program memory can thus be regarded as two 16-bit word wide address spaces residing side by side, each with the same address range. TBLRDL and TBLWTL access the space which generates the LS data word, and TBLRDH and TBLWTH access the space which generates the MS data byte. As program memory is only 24-bits wide, the upper byte from this latter space does not exist, though it is addressable. It is therefore termed the ‘phantom’ byte.

For all the table instructions, the calculated EA (using MODE 2 addressing modes) is concatenated with the 8-bit data table page register, TABPAG<7:0>, to form a 23-bit effective programs space address plus a byte select for program memory as shown in FIG. 152. As there are 15-bits of program space address from the calculated EA, the data table page size in program memory is therefore 32K words.

The LS-bit of the calculated EA becomes the byte select and is used by TBLRDL and TBLWRL (see Program Memory DOS-00204) to select which byte is accessed. The TBLRDL and TBLWRL instructions therefore view program space as byte or aligned word addressable, 16-bit wide, 64K byte pages (i.e. same as data space). EA[0] is ignored for word wide accesses.

The TBLRDH and TBLWRH instructions are used to access the high order byte of the program address. These instructions also support word or byte access for orthogonality but the high order byte of the program address can only be read from the LS byte as shown in FIG. 156. The MS-byte of a TBLRDH word read will always be clear. These instructions therefore also view program space as byte or aligned word addressable, 16-bit wide, 64K byte pages (i.e. same as data space) as shown in FIG. 156.

It is assumed that for most applications that the high byte (P[23:16]) will not be used for data, making the program memory appear 16-bits wide for data storage. It is intended that the high byte contain a illegal opcode trap to protect the device from accidental execution of stored data. The TBLRDH and TBLWRH instructions are primarily provided for array program/verification purposes and for those applications who wish to compress data storage.

HEX Data File Compatibility

The program space data access described above can be made compatible with HEX format data files by regarding the program memory as 32-bits wide. Inserting the ‘phantom’ byte as shown in FIG. 157 allows the HEX format byte address to be directly used as the TBLWTL.w and TBLWTH(.b) EA after a single bit right shift.

HEX File Compatibility

External Bus Support

As discussed herein, program space is 24-bits wide which will require either a mix of external FLASH devices to provide all 24-bits in one bus cycle, or several cycles to fetch the 24-bit word in either 8-bit or 16-bit sections. The External Bus Interface (EBI) module will attempt to provide the user maximum flexibility in this area.

Data access is potentially somewhat simpler as the fundamental data size is 16-bits. To permit single (bus) cycle, 16-bit wide external memory access, the EBI may optionally be configured to read from a 16-bit external bus and then automatically concatenate an 8-bit trap field prior to passing the 24-bit pword to the CPU. A 16-bit external data bus can therefore be provided for data storage without compromising device robustness. The unused portion of the external bus data path can also revert back to I/O.

Clocking Scheme

Each instruction cycle (Tcy) is comprised of four Q cycles (Q1-Q4). These Q clock are derived using simple logic (i.e. there is no requirement to make them non-overlapping) within the core (and each peripheral module) from global QA and QB quadrature clocks. The quadrature clocks are generated by the PLL module. Maintaining minimal skew between QA and QB across the device will be a critical factor in attaining the target performance. The four phase Q cycles provide the timing/designation for the Decode, Read, Process Data, Write etc., of each instruction cycle. FIG. 158 shows the relationship of the Q cycles to the instruction cycle for both MCU and DSP instructions. The four Q cycles that make up an execution instruction cycle (Tcy) can be generalized as:
Q1: Instruction Decode Cycle or forced NOP and source EA calculation
Q2: Source Data Read Cycle or NOP
Q3: Process the Data and destination EA calculation
Q4: Destination Data Write Cycle or NOP

Each instruction will show the detailed Q cycle operation for the instruction. Although most instructions follow the scheme above, some issue two reads, others two writes per cycle. From a Q cycle perspective, the DSP instructions differ from in MCU instruction in so much as the DSP instruction can perform two simultaneous source data reads during the Q1/Q2 access from X and Y data space.

Instruction Cycle Timing

Internally, the program address latch is updated at the start of every Q1, and the instruction is fetched from the program memory and latched into the ROMLATCH using Q4. The PC is actually adjusted (incremented or loaded) during Q4 of the previous cycle but not transferred into the program address latch until the next instruction has started.

The instruction is decoded and executed during the following Q1 through Q4. The Instruction is decoded during Q1, though some pre-decode of register and addressing mode bit fields during the prior Q4 may be necessary to speed up execution. Care should be taken with any pre-decoding of the instruction to avoid issues (e.g., having to add extra cycles) during interrupt or call returns.

There are two, independent data space accesses to (possibly) two different addresses during each instruction cycle. During Q1 the (remainder) of the instruction decode is performed and the source operand EA is calculated. During Q2, the source operand data is fetched from memory or peripherals. The ALU performs the computation during Q3 at the same time as the destination EA is also calculated in one of the AGUs. During Q4 the results are written to the destination location.

The clocks and instruction execution flow are shown in FIG. 159. The data space buses are addressed twice during each cycle with a read (two reads for the DSP instructions) followed by a write. The program space bus is addressed once during each cycle. Note that, due to the longer FLASH access time (around 3 versus 1 Qclk for RAM/registers), program space data reads (table instructions etc.) will present data to the execution unit in Q4. Consequently, these instructions are all 2 cycle operations.

Instruction Flow/Pipelining

An “Instruction Cycle” consists of four Q cycles (Q1, Q2, Q3, and Q4). The instruction fetch and execute are pipelined such that fetch takes one instruction cycle while decode and execute takes another instruction cycle. However, due to this prefetch mechanism, each instruction effectively executes in one cycle.

Instruction Flow Types

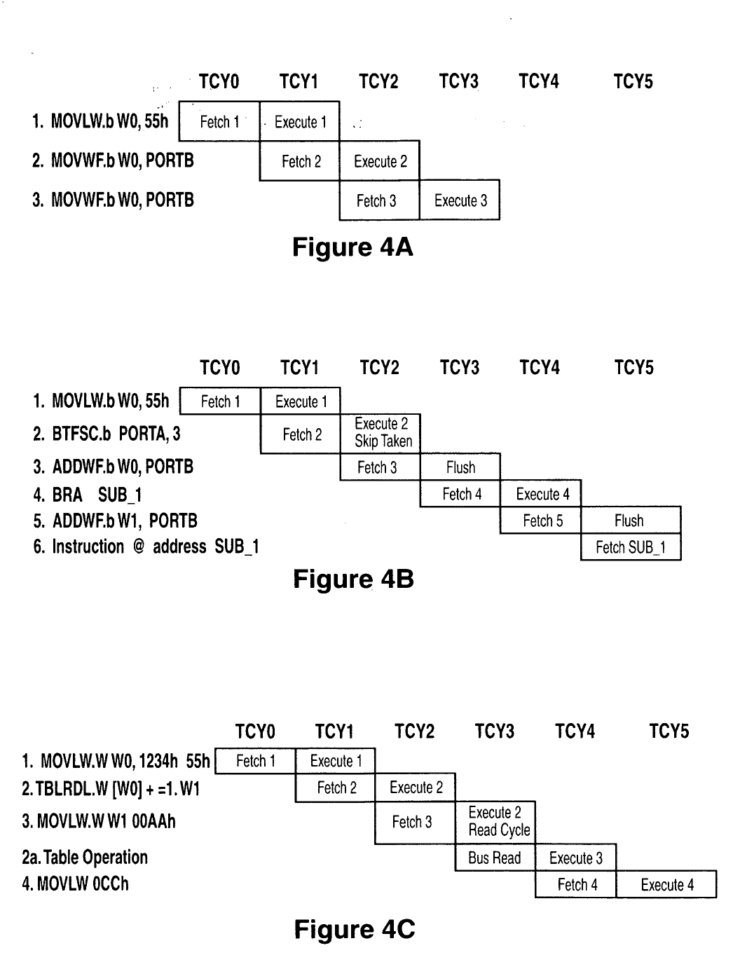

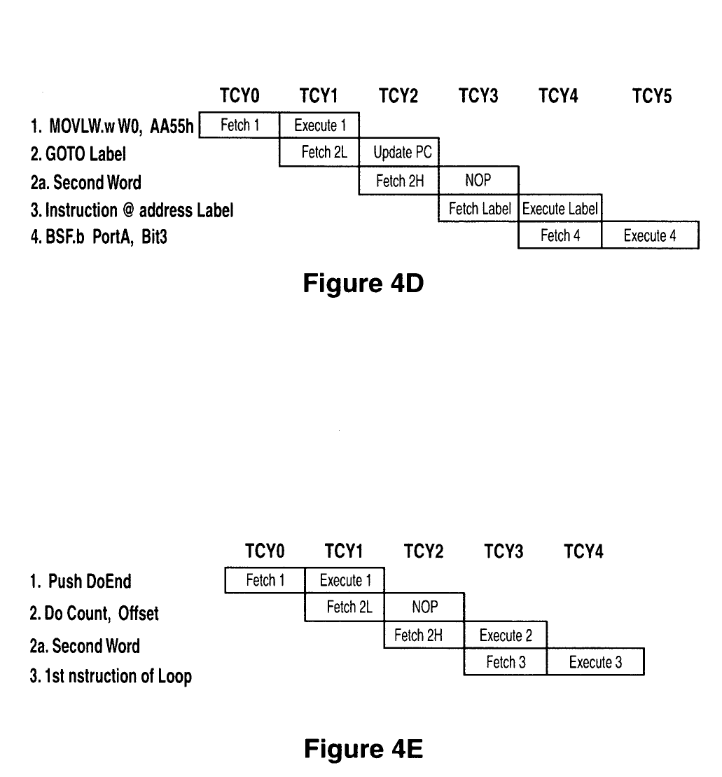

There are five types of instruction flows.
1. Normal 1 word 1 cycle pipelined instruction. These instructions will take one effective cycle to execute as shown in FIG. 4a.
2. One word 2 cycle pipeline flush instruction. These instructions include the relative branches, relative call, skips and returns. When an instruction changes the PC (other than to increment it), the pipelined fetch is discarded. This makes the instruction take two effective cycles to execute as shown in FIG. 4b.
3. Table operation instructions. These instructions will suspend the fetching to insert a read or write cycle to the program memory. The instruction fetched while executing the table operation is saved for 1 cycle and executed in the cycle immediately after the table operation as shown in FIG. 4c.
4. Two word instructions for CALL and GOTO. In these instructions, the fetch after the instruction contains the remainder of the jump or call destination addresses. Normally, these instructions would require 3 cycles to execute, 2 for fetching the 2 instruction words and 1 for the subsequent pipeline flush. However, by providing a high speed path on the second fetch, the PC can be updated with the complete value in the first cycle of instruction execution, resulting in a 2 cycle instruction as shown in FIG. 4d.
5. Two word instructions for DO and DOW. In these instructions, the fetch after the instruction contains an address offset. This address offset is added to the first instruction address to generate the last loop instruction address.
   Interrupt recognition execution. Instruction cycles during interrupts are shown in the interrupts section.
   Program Flow Loop Control

The dsPIC core supports both REPEAT and DO instruction constructs to provide unconditional automatic program loop control.

The REPEAT instruction will cause the instruction immediately following to be repeated a fixed number of times as defined by an 14-bit literal encoded in the instruction. The REPEATW instruction will cause the instruction immediately following it to be repeated a fixed number of times as defined by the contents of a W register declared within the instruction, enabling the loop count to be a variable. The loop count is held in the 16-bit RCOUNT register (which is memory mapped) and is thus user accessible. It is initialized by the REPEAT[W] instruction during Q2.

The instruction to be repeated is prefetched during the REPEAT[W] instruction and held in the ROMLATCH. It is not fetched again for all subsequent iterations, and the Instruction Register is loaded from the locked ROMLATCH.

For a loop count value equal 1, REPEAT[W] has the effect of a NOP (other than RCOUNT being loaded with 1). The RA (Repeat Active) status bit in the SR is not set during execution of REPEAT[W] and the PC is incremented as would normally be the case during Q4 of an instruction. The repeat loop is essentially disabled before it begins, allowing the next instruction to execute only once while pre-fetching the subsequent instruction (i.e. normal execution flow).

For loop count values greater than 1, the PC is not incremented as would normally be the case during Q4 of an instruction (and will therefore continue to point to the instruction to be repeated). Further PC increments are inhibited until the loop ends. The RA (Repeat Active) status bit in the SR is also set during execution of REPEAT[W]. See FIG. 160 for a functional flow diagram of the REPEAT[W] operation, and FIG. 161 for an instruction pipeline example of a REPEAT[W] loop. RA may be a read only bit within the SR and might not be modifyable through software.

The RCOUNT register is decremented then tested during each instruction iteration. It will equal two at the beginning of the penultimate instruction. The subsequent decrement will make RCOUNT=1, signifying the end of the repeat loop, which causes the RA bit in the SR to be cleared. In addition, the PC increment inhibit is released and the PC bumps in Q4 of this instruction to point to the instruction after the repeated instruction. The last instruction to be repeated is then executed as a normal instruction (i.e. includes an instruction prefetch & PC bump). Testing for the end of loop during the penultimate instruction is required to allow a normal instruction prefetch to occur during the last iteration (i.e. no delays due to ‘end of loop’ tests).

A consequence of executing the last instruction outside the repeat loop is that the loop will effectively iterate [loop count+1] times (i.e. a loop count of 0 is not possible). Choosing the loop termination count value to equal one enables the loop count and number of iteration to match for all but RCOUNT equal to zero. For a loop count value of 0, REPEAT will iterate the next instruction 16384 times and REPEATW will iterate the next instruction 65536 times

The combined instruction flow diagram for REPEAT[W] and DO[W] is shown in FIG. 167.

A REPEAT instruction loop may be interrupted at any time. As is the case for all instructions, the PC update is arranged such that it will not be incremented during the instruction when an exception is acknowledged. For a repeated instruction, the PC update is already inhibited (by the RA bit) which ensures that, upon return, the RETFIE instruction will correctly prefetch said instruction (i.e. the stacked PC will point to the instruction to be repeated).

Exception processing proceeds as normal, except for a fast interrupt acknowledgment where the contents of the Instruction Latch are transferred into a temp register (IR Temp). This occurs irrespective of the state of the RA bit and is not related to the REPEAT operation. Standard exception processing completes and the ISR is executed as normal in either case.

Note that, in order to interrupt a REPEAT in progress, the LS-byte of the SR (SRL, which includes the RA bit) is stacked during exception processing. This preserves the state of the RA bit prior to interruption. The RA bit in the SR is then cleared, also during exception processing. In addition, the RCOUNT register has a shadow register associated with it which is loaded during exception processing (any exception, not just for a fast interrupt). This, in conjunction with the preservation of the RA bit (SRL stacked), permits another REPEAT instruction to be executed within the initial interrupt service routine (i.e. any ISR provided interrupt nesting is not enabled).

Should interrupt nesting be enabled, subsequent interrupts must stack the RCOUNT register before another REPEAT loop may be executed from within the ISR. If RCOUNT is stacked, the RA preservation feature will also operate for all subsequent nested interrupts. Note that RCOUNT must be restored prior to returning from the ISR. The RA bit is restored automatically during interrupt return processing. Also note that for nested interrupts, the most efficient method to handling REPEAT instructions within ISRs will be to always stack RCOUNT.

Interrupt return operates as normal and requires no special handling for returning into a REPEAT[W] loop. Normal interrupts will prefetch the repeated instruction during the second cycle of the RETFIE. Return from a fast interrupt will reload the Instruction Latch from the IR Temp register and execute the next repeat iteration during the second cycle. The stacked RA bit will be restored when the SRL register is pooped and, if set, the interrupted REPEAT loop will be resumed. Clearing the RA bit in the stacked SR from within an ISR is a method to force an interrupted loop to terminate (subject to one more iteration) after the interrupt returns. RA is not software modifiable within the SR.

The DO & DOW instructions will execute instructions following the DO[W] until an end address is reached at which time instruction execution will start again at the instruction immediately following the DO[W]. This will be repeated a finite number of times as defined by either an 14-bit literal encoded in the 1st word of the instruction (for DO) or by the contents of a W register declared within the instruction (for DOW), enabling the loop count to be a variable. The instruction execution order need not be sequential, nor does the loop end address have to be greater than the start address.

Referring to FIG. 166, the DO[W] instruction loads the loop count value into the loop count register (DCOUNT) during Q2. Note that, as it is required that a REPEAT[W] instruction be executable from within a DO loop, the DCOUNT and RCOUNT registers must be independent. The associated decrementer can be shared however, the last instruction of a DO[W] loop cannot be:
1. a REPEAT[W] instruction or
2. the instruction within a repeat loop.
   Ideally, these circumstances should be detected & flagged by the assembler.

The loop start address (PC) is stored in the DOSTART register during Q2 of the second cycle. The two cycle DO[W] instruction then calculates the end address by executing a 23-bit signed addition of the current PC[23:1] (which points to the first loop instruction) and a signed 16-bit literal offset encoded within the 2nd word of the DO[W] instruction. This is executed using the MCU ALU during Q1 and Q3 of the 2nd cycle. The loop end address is stored in the DOEND register during Q4. The DOEND and DOSTART registers are closely coupled with the PC as shown in FIG. 162. The DA bit within the SR is also set during DO, forcing all subsequent instruction cycles to execute a PC address compare during Q1. This comparison must occur for every cycle (i.e. not just once for a 2 cycle instruction). DO is not required to execute from test memory space. The DOSTART, DOEND registers are therefore restricted to 22-bits each with an additional MS bit always=0.

The DO[W] literal address offset is such that the end address is calculated to be the last instruction within the loop. This will cause a valid PC address compare during the Q1 compare operation of the penultimate instruction (i.e. during the prefetch of the last instruction). This will then enable the loop counter to be decremented and tested, and the result combined with the address compare during Q3 of the same instruction.

If the loop counter after decrement does not equal 1 (as shown in FIG. 164), the PC is loaded with the loop start address during Q4 (such that the last instruction will prefetch the first loop instruction, initiating another loop pass). The loop penultimate instruction does not have to be the one immediately preceding the last loop instruction. It can be a branch or GOTO instruction which targets the last instruction as shown in FIG. 165 (for a branch).

If the loop counter after decrement equals 1 (as shown in FIG. 166), then the DA bit in the SR is cleared and the PC is incremented as normal during Q4 (such that the last instruction will prefetch the instruction following it and exit the loop).

The DO loop is equivalent to the ‘C’ construct DO-WHILE which implies that the loop will be executed at least once. Choosing the loop termination count value to equal one enables the loop count and number of iteration to match for all DCOUNT values except zero.

For a DCOUNT loop count value of 0, DO will iterate the loop 16384 times and REPEATW will iterate the loop 65536 times. The loop end comparison may be an equality test only. The loop end address must be pre-fetched in order for the end of loop condition to be recognized. That is, exiting the loop to a PC value greater than the end address (or less than the start address) will not cause the loop count to change.

The combined instruction flow diagram for REPEAT[W] and DO[W] is shown in FIG. 167.

The DOSTART, DOEND and DCOUNT loop registers have a shadow register associated with them which permit a single level of nesting. In addition, as the DOSTART, DOEND and DCOUNT registers are user accessible, they may be manually saved to permit additional nesting. However, it should be noted that the overhead associated with manually saving these registers outweighs the benefits of additional DO loop nesting with the possible exception of a DO loop within an interrupt.

When a DO is executed, the. DOSTART, DOEND and DCOUNT registers are transferred into the shadow registers prior to being updated with the new loop values. The DA bit is also shadowed prior to being set during DO execution. These operations occur for all DO instruction executions, whether nested or not. Similarly, during all loop exits, the shadow contents of the DOSTART, DOEND and DCOUNT registers and the DA bit are transferred back into their respective host registers.

DO Loops and Interrupts

A DO[W] loop may be interrupted at any time without penalty. Note that, in order to suspend an interrupted DO loop during execution of an ISR, the LS-byte of the SR (SRL, which includes the DA bit) is stacked then cleared (in the SR) during exception processing. Although this is not essential because the DO loop end address is unlikely to be encountered during the ISR, it is consistent with REPEAT operation. If a background DO loop was active (stacked DA bit set), the DOSTART, DOEND and DCOUNT registers must then be stacked before another DO loop may be executed from within the ISR. This applies to any interrupt class. These register must be restored prior to returning from the ISR. Prior to executing a DO within an interrupt requires stacking and restoring five words of data. This overhead may mean DO is not the most efficient means for loop control within an ISR.

Interrupt return operates as normal and requires no special handling for returning into a DO[W] loop. The stacked DA bit will be restored into the SRL register and, if set, the interrupted DO loop will resume. Clearing the DA bit in the stacked SR from within an ISR is a method to force an interrupted loop to terminate early after the interrupt returns. The loop will complete the iteration underway and then terminate. If the interrupt occurs during the penultimate or last instruction of the loop, one more iteration of the loop will occur. DA is not software modifiable within the SR.

DO and REPEAT Restrictions

Any instruction can follow a REPEAT except for:
1 Flow control (any branch, compare and skip, GOTO, CALL, CALLW, RCALL, RETURN or RETLW)
2. Another REPEAT or DO

As it is not especially useful to execute any of these instructions within a repeat loop, the restrictions on this instruction are minimal.

REPEAT is interruptible and can be then be nested from within an initial (first, unnested) ISR. If interrupt nesting is enabled, REPEAT can be nested from within any ISR but only after the user stacks the appropriate registers manually (all REPEAT control registers are user accessible).

All DO loops must contain at least 2 instructions because the loop termination tests are performed in the penultimate instruction. REPEAT should be used for single instruction loops. All other restrictions with regard to the DO loop revolve around the last instruction. With the notable exception of CALLW, the last instruction should not be:
1. Flow control (any branch, compare and skip, GOTO, RCALL)
2. Another REPEAT or DO
3. Instruction within a repeat loop
4. Any 2 word instruction

If at all possible, the assembler should be capable of flagging these instructions if placed at the end of a DO loop.

The (one word) CALLW will function correctly at the end of a DO loop because the stacked PC will address the start of loop instruction (to fetch upon return).

PC relative instructions (e.g. RCALL, branches) won't work correctly at the end of a loop because the PC calculation will be performed using the current PC value which will be the loop start address. That is, the assembler psuedo-PC and the real PC do not match at this point.

Should execution of a REPEAT[W] instruction as the last loop instruction be attempted, the DO[W] loop counter will take priority and the REPEAT target instruction will never be executed before the DO[W] loop jumps to the loop start. Should the last loop instruction be the instruction being repeated within a REPEAT loop, the DO[W] loop counter will also take priority and the REPEAT target instruction will only execute once with no change to RCOUNT before the DO[W] loop jumps to the loop start.

Two-word instructions will fail if placed at the end of a DO loop because the PC is adjusted in the penultimate instruction in order to accommodate the instruction prefetch (without a dead cycle). Consequently, the second word of a two-word instruction would therefore be incorrectly fetched from the loop start address.

RETURN and RETLW will work correctly when the last instruction of a DO loop but the user must be responsible for returning into the loop to complete it.

Programmer Model

The programmers model is shown in FIG. 5 and consists of 16×16-bit working registers, 2×40-bit accumulators, status register, data table page register, data space program page register, DO and REPEAT registers, and program counter. The working registers can act as data, address or offset registers. All registers are memory mapped.

Most of these registers have a shadow register associated with them as shown in FIG. 5. The shadow register is used as a temporary holding register and can transfer its contents to or from its host register upon some event occurring. None of the shadow registers are accessible directly. The following rules apply to register transfer into and out of shadows.
Fast Interrupts entry & exit
   W0 to W14 shadows transferred
   PC shadow transferred
   TABPAG & DSPPAG shadows
   transferred
   RCOUNT shadow transferred
   SR[6:0] shadow bits transferred
Normal Interrupt Entry
   RCOUNT shadow transferred
   SR[6] shadow bit transferred
Nested DO
   DOSTART, DOEND, DCOUNT shadows
   loaded

Byte instructions which target the working register array only effect the least significant byte of the target register. However, a consequence of memory mapped working registers is that both the least and most significant bytes can be manipulated through byte wide data memory space accesses.

Uninitialized W Register Trap

The W register array (except W15) is not effected by a reset and therefore must be considered uninitialized until a written to. An attempt to read an uninitialized register for an address access will generate an address error trap (fetch of an uninitialized address). In this situation, the user will most likely choose to reset the application, though recovery may be possible through an examination of the problematic instruction (via the stacked return address).

This function is achieved through the addition of a single latch to each W register (W0 through W14). The latch is cleared by reset and set by the first write to the associated register, as shown in [See Uninitialized W Register Trap]. When the latch is clear, a read of the corresponding register to either AGU will force an address error trap. W15 is initialized during reset (see [See Software Stack Pointer]) and consequently does not require this feature.

Default W Register Selection

The default W register for all file register instructions is defined by the WD[3:0] field in the CORCON (Core Control register). This field is reset to 0x0000, corresponding to register W0.

Software Stack Pointer

W15 has been dedicated as the software stack pointer, and will be automatically modified by exception processing and subroutine calls and returns. However, W15 can be referenced by any instruction in the same manner as all other W registers. This simplifies reading, writing and manipulating the stack pointer (e.g. creating stack frames). In order to protect against misaligned stack accesses, W15[0] is always clear.

W15 is initialized to 0x0200 during a reset. This will point to valid RAM in all derivatives and will guarantee stack availability for non-maskable trap exceptions or priority level 7 interrupts which may occur before the SP is set to where the user desires it. The user may reprogram the SP during initialization to any location within data space.

W14 has been dedicated as a stack frame pointer as defined by the LNK and ULNK instructions. However, W14 can be referenced by any instruction in the same manner as all other W registers.

The stack pointer always points to the first available free word and fills working from lower towards higher addresses. It pre-decrements for stack pops (reads) and post increments for stack pushs (writes) as shown in FIG. 172. Note that for a PC push during any CALL instruction, the MS-byte of the PC is zero extended before the push, ensuring that the MS-byte is always clear. The stack timing is shown in FIGS. 170 and 171. A PC push during exception processing will concatenate the SRL register to the MS-byte of the PC prior to the push.

There is a stack limit register (SPLIM) associated with the stack pointer that is uninitialized at reset. SPLIM[15:1] is a 15-bit register. As is the case for the stack pointer, SPLIM[0] is forced to 0 because all stack operations must be word aligned.

The stack overflow check will not be enabled until a word write to SPLIM occurs after which time it can only be disabled by a reset. All EA's generated using W15 as Wsrc or Wdst (but not Wb) are compared against the value in SPLIM. Should the EA be greater than the contents of SPLIM, then a stack error trap is generated. This comparison is a subtraction, so the trap will occur for any SP greater than SPLIM. In addition, should the SP EA calculation wrap over the end of data space (0xFFFF), AGU X will generate a carry signal which will also cause a stack error trap (if the SPLIM register has been initialized).

The stack is initialized to 0x0200 during reset. A simple stack underflow mechanism is provided which will initiate a stack error trap should the stack pointer address ever be less than 0x0200.

The dsPIC core has a 16-bit status register (SR), the LS-byte of which is referred to as the lower status register (SRL). A detailed description is shown in Table 187. SRL contains all the MCU ALU operation status flags (including the new ‘sticky Z’ (SZ) bit) plus the REPEAT and DO loop active status bits. During exception processing, SRL is concatenated with the MS-byte of the PC to form a complete word value which is then stacked. The upper byte of the SR contains the DSP Adder/Subtractor status bits.

All SR bits are read/write except for the DA and RA bits which are read only because accidentally setting them could cause erroneous operation (include inhibiting PC increments). When the memory mapped SR is the destination address for an operation which affects the any of the SR bits, data writes are disabled to all bits.

TABLE 187
SR, CPU Status Register (0xXXXX)
Upper Half:

| | | | | | | | |
|---|---|---|---|---|---|---|---|
| R/W-0 | R/W-0 | R/W-0 | R/W-0 | R/W-0 | R/W-0 | U | U |
| OA | OB | SA | SB | OAB | SAB | — | — |
| bit 15 | | | | | | | bit 8 |

Lower Half:

| | | | | | | | |
|---|---|---|---|---|---|---|---|
| R-0 | R-0 | R/W-0 | R/W-0 | R/W-0 | R/W-0 | R/W-0 | R/W- |
| | | | | | | | 0 |
| DA | RA | SZ | N | OV | Z | DC | C |
| bit 7 | | | | | | | bit 0 |

| | |
|---|---|
| 15 | OA: Accumulator A Overflow Status |
| | 1 = Accumulator A overflowed |
| | 0 = Accumulator A not overflowed |
| 14 | OB: Accumulator B Overflow Status |
| | 1 = Accumulator B overflowed |
| | 0 = Accumulator B not overflowed |
| 13 | SA: Accumulator A Saturation ‘Sticky’ Status |
| | 1 = Accumulator A is saturated or has been saturated at some time |
| | 0 = Accumulator A is not saturated |
| 12 | SB: Accumulator B Saturation ‘Sticky’ Status |
| | 1 = Accumulator B is saturated or has been saturated at some time |
| | 0 = Accumulator B is not saturated |
| 11 | OAB: OA \|\| OB Combined Accumulator Overflow Status |
| | 1 = Accumulators A or B have overflowed |
| | 0 = Neither Accumulators A or B have overflowed |
| 10 | SAB: SA \|\| SB Combined Accumulator ‘Sticky’ Status |
| | 1 = Accumulators A or B are saturated or have been saturated |
| | at some time in the past |
| | 0 = Neither Accumulator A or B are saturated |
| 9-8 | Unused |
| 7 | DA: DO Loop Active |
| | 1 = DO loop in progress |
| | 0 = DO loop not in progress |
| 6 | RA: REPEAT Loop Active |
| | 1 = REPEAT loop in progress |
| | 0 = REPEAT loop not in progress |
| 5 | SZ: MCU ALU ‘sticky’ Zero bit |
| | 1 = An operation which effects the Z bit has set it at some time |
| | in the past |
| | 0 = The most recent operation which effects the Z bit has cleared it |
| | (i.e. a non-zero result) |
| 4 | N: MCU ALU Negative bit |
| 3 | OV: MCU ALU Overflow bit |
| 2 | Z: MCU ALU Zero bit |
| 1 | DC: MCU ALU Half Carry/Borrow bit |
| 0 | C: MCU ALU Carry/Borrow bit |

Legend
R = Readable bit
W = Writable bit
U = Unimplemented bit, read as ‘0’
−n = Value at POR
1 = bit is set
0 = bit is cleared
x = bit is unknown

Exceptions and Stack

The core supports a prioritized interrupt and trap exception scheme. There are up to eight levels of interrupt priority, each of which has an interrupt vector associated with it. Each interrupt source is user programmable with regard to what priority (and therefore vector address) it uses. The highest priority interrupt is non-maskable. The are seven traps available to improve operational robustness, all of which are non-maskable. They adhere to a predefined priority scheme.

Stacking associated with exceptions and subroutine calls is executed on a software stack. Register W15 is dedicated as the stack pointer and has the LSB=0.

TABLE 188
Central Processing Unit Status Flag Operations

| | | | | | | | | | | | |
|---|---|---|---|---|---|---|---|---|---|---|---|
| PLA | | | | | | | | | | | |
| Mnemonic | Status Affected | C | DC | N | OV | SZ | Z | OA | OB | SA | SB |

Move Operations

| | | | | | | | | | | | |
|---|---|---|---|---|---|---|---|---|---|---|---|
| EXCH | None | — | — | — | — | — | — | — | — | — | — |
| LDDW | None | — | — | — | — | — | — | — | — | — | — |
| LDQW | None | — | — | — | — | — | — | — | — | — | — |
| LDW | None | — | — | — | — | — | — | — | — | — | — |
| MOV | None | — | — | — | — | — | — | — | — | — | — |
| MOVF | N, Z | — | — | [symbol] | — | — | [symbol] | — | — | — | — |
| MOVL | None | — | — | — | — | — | — | — | — | — | — |
| MOVLW | None | — | — | — | — | — | — | — | — | — | — |
| MOVWF | None | — | — | — | — | — | — | — | — | — | — |
| STDW | None | — | — | — | — | — | — | — | — | — | — |
| STQW | None | — | — | — | — | — | — | — | — | — | — |
| STW | None | — | — | — | — | — | — | — | — | — | — |

Table Operations

| | | | | | | | | | | | |
|---|---|---|---|---|---|---|---|---|---|---|---|
| TBLRDH | None | — | — | — | — | — | — | — | — | — | — |
| TBLRDL | None | — | — | — | — | — | — | — | — | — | — |
| TBLWTH | None | — | — | — | — | — | — | — | — | — | — |
| TBLWTL | None | — | — | — | — | — | — | — | — | — | — |

Math Operations - W Registers

| | | | | | | | | | | | |
|---|---|---|---|---|---|---|---|---|---|---|---|
| ADD | C, DC, N, OV, SZ, Z | [symbol] | [symbol] | [symbol] | [symbol] | [symbol] | [symbol] | — | — | [symbol] | [symbol] |
| ADDC | C, DC, N, OV, SZ, Z | [symbol] | [symbol] | [symbol] | [symbol] | [symbol] | [symbol] | — | — | — | — |
| AND | N, SZ, Z | — | — | [symbol] | — | [symbol] | [symbol] | — | — | — | — |
| IOR | N, SZ, Z | — | — | [symbol] | — | [symbol] | [symbol] | — | — | — | — |
| SUB | C, DC, N, OV, SZ, Z | [symbol] | [symbol] | [symbol] | [symbol] | [symbol] | [symbol] | — | — | — | — |
| SUBB | C, DC, N, OV, SZ, Z | [symbol] | [symbol] | [symbol] | [symbol] | [symbol] | [symbol] | — | — | — | — |
| SUBR | C, DC, N, OV, SZ, Z | [symbol] | [symbol] | [symbol] | [symbol] | [symbol] | [symbol] | — | — | — | — |
| SUBBR | C, DC, N, OV, SZ, Z | [symbol] | [symbol] | [symbol] | [symbol] | [symbol] | [symbol] | — | — | — | — |
| XOR | N, SZ, Z | — | — | [symbol] | — | [symbol] | [symbol] | — | — | — | — |

Math Operations - Short Literals (literal 0 . . . 31)

| | | | | | | | | | | | |
|---|---|---|---|---|---|---|---|---|---|---|---|
| ADDLS | C, DC, N, OV, SZ, Z | [symbol] | [symbol] | [symbol] | [symbol] | [symbol] | [symbol] | — | — | — | — |
| ADDCLS | C, DC, N, OV, SZ, Z | [symbol] | [symbol] | [symbol] | [symbol] | [symbol] | [symbol] | — | — | — | — |
| ANDLS | N, SZ, Z | — | — | [symbol] | — | [symbol] | [symbol] | — | — | — | — |
| IORLS | N, SZ, Z | — | — | [symbol] | — | [symbol] | [symbol] | — | — | — | — |
| SUBLS | C, DC, N, OV, SZ, Z | [symbol] | [symbol] | [symbol] | [symbol] | [symbol] | [symbol] | — | — | — | — |
| SUBBLS | C, DC, N, OV, SZ, Z | [symbol] | [symbol] | [symbol] | [symbol] | [symbol] | [symbol] | — | — | — | — |
| SUBRLS | C, DC, N, OV, SZ, Z | [symbol] | [symbol] | [symbol] | [symbol] | [symbol] | [symbol] | — | — | — | — |
| SUBBRLS | C, DC, N, OV, SZ, Z | [symbol] | [symbol] | [symbol] | [symbol] | [symbol] | [symbol] | — | — | — | — |
| XORLS | N, SZ, Z | — | — | [symbol] | — | [symbol] | [symbol] | — | — | — | — |

Math Operations - W Registers Single Operand

| | | | | | | | | | | | |
|---|---|---|---|---|---|---|---|---|---|---|---|
| CLR | Z | — | — | — | — | — | 1 | — | — | — | — |
| COM | N, SZ, Z | — | — | [symbol] | — | [symbol] | [symbol] | — | — | — | — |
| DEC | C, DC, N, OV, SZ, Z | [symbol] | [symbol] | [symbol] | [symbol] | [symbol] | [symbol] | — | — | — | — |
| DEC2 | C, DC, N, OV, SZ, Z | [symbol] | [symbol] | [symbol] | [symbol] | [symbol] | [symbol] | — | — | — | — |
| INC | C, DC, N, OV, SZ, Z | [symbol] | [symbol] | [symbol] | [symbol] | [symbol] | [symbol] | — | — | — | — |
| INC2 | C, DC, N, OV, SZ, Z | [symbol] | [symbol] | [symbol] | [symbol] | [symbol] | [symbol] | — | — | — | — |
| NEG | C, DC, N, OV, SZ, Z | [symbol] | [symbol] | [symbol] | [symbol] | [symbol] | [symbol] | — | — | — | — |
| SETM | None | — | — | — | — | — | — | — | — | — | — |

Math Operations - File Registers

| | | | | | | | | | | | |
|---|---|---|---|---|---|---|---|---|---|---|---|
| ADDWF | C, DC, N, OV, SZ, Z | [symbol] | [symbol] | [symbol] | [symbol] | [symbol] | [symbol] | — | — | — | — |
| ADDWFC | C, DC, N, OV, SZ, Z | [symbol] | [symbol] | [symbol] | [symbol] | [symbol] | [symbol] | — | — | — | — |
| ANDWF | N, SZ, Z | — | — | [symbol] | — | [symbol] | [symbol] | — | — | — | — |
| IORWF | N, SZ, Z | — | — | [symbol] | — | [symbol] | [symbol] | — | — | — | — |
| SUBFW | C, DC, N, OV, SZ, Z | [symbol] | [symbol] | [symbol] | [symbol] | [symbol] | [symbol] | — | — | — | — |
| SUBBFW | C, DC, N, OV, SZ, Z | [symbol] | [symbol] | [symbol] | [symbol] | [symbol] | [symbol] | — | — | — | — |
| SUBWF | C, DC, N, OV, SZ, Z | [symbol] | [symbol] | [symbol] | [symbol] | [symbol] | [symbol] | — | — | — | — |
| SUBBWF | C, DC, N, OV, SZ, Z | [symbol] | [symbol] | [symbol] | [symbol] | [symbol] | [symbol] | — | — | — | — |
| XORWF | N, SZ, Z | — | — | [symbol] | — | [symbol] | [symbol] | — | — | — | — |

Math Operations - File Registers Single Operand

| | | | | | | | | | | | |
|---|---|---|---|---|---|---|---|---|---|---|---|
| CLRF | Z | — | — | — | — | — | 1 | — | — | — | — |
| COMF | N, SZ, Z | — | — | [symbol] | — | [symbol] | [symbol] | — | — | — | — |
| DECF | C, DC, N, OV, SZ, Z | [symbol] | [symbol] | [symbol] | [symbol] | [symbol] | [symbol] | — | — | — | — |
| INCF | C, DC, N, OV, SZ, Z | [symbol] | [symbol] | [symbol] | [symbol] | [symbol] | [symbol] | — | — | — | — |
| NEGF | C, DC, N, OV, SZ, Z | [symbol] | [symbol] | [symbol] | [symbol] | [symbol] | [symbol] | — | — | — | — |
| SETF | None | — | — | — | — | — | — | — | — | — | — |

Math Operations - Literals (literal −512 . . . 511

| | | | | | | | | | | | |
|---|---|---|---|---|---|---|---|---|---|---|---|
| ADDLW | C, DC, N, OV, SZ, Z | [symbol] | [symbol] | [symbol] | [symbol] | [symbol] | [symbol] | — | — | — | — |
| ADDCLW | C, DC, N, OV, SZ, Z | [symbol] | [symbol] | [symbol] | [symbol] | [symbol] | [symbol] | — | — | — | — |
| ANDLW | N, SZ, Z | — | — | [symbol] | — | [symbol] | [symbol] | — | — | — | — |
| IORLW | N, SZ, Z | — | — | [symbol] | — | [symbol] | [symbol] | — | — | — | — |
| SUBLW | C, DC, N, OV, SZ, Z | [symbol] | [symbol] | [symbol] | [symbol] | [symbol] | [symbol] | — | — | — | — |
| SUBBLW | C, DC, N, OV, SZ, Z | [symbol] | [symbol] | [symbol] | [symbol] | [symbol] | [symbol] | — | — | — | — |
| XORLW | N, Z | — | — | [symbol] | — | [symbol] | [symbol] | — | — | — | — |

Math Operations - Multiply, Adjust

| | | | | | | | | | | | |
|---|---|---|---|---|---|---|---|---|---|---|---|
| DAW | C | [symbol] | — | — | — | — | — | — | — | — | — |
| DIV | None | — | — | — | — | — | — | — | — | — | — |
| MULS | None | — | — | — | — | — | — | — | — | — | — |
| MULSU | None | — | — | — | — | — | — | — | — | — | — |
| MULSULS | None | — | — | — | — | — | — | — | — | — | — |
| MULU | None | — | — | — | — | — | — | — | — | — | — |
| MULULS | None | — | — | — | — | — | — | — | — | — | — |
| MULUS | None | — | — | — | — | — | — | — | — | — | — |
| MULWF | None | — | — | — | — | — | — | — | — | — | — |
| SE | C, N, Z | [symbol] | — | [symbol] | — | [symbol] | — | — | — | — | — |
| ZE | None | — | — | — | — | — | — | — | — | — | — |
| SWAP | None | — | — | — | — | — | — | — | — | — | — |

Rotate/Shift Operations - W Registers

| | | | | | | | | | | | |
|---|---|---|---|---|---|---|---|---|---|---|---|
| ASR | C, N, OV, SZ, Z | [symbol] | — | [symbol] | [symbol] | [symbol] | [symbol] | — | — | — | — |
| LSR | C, N, OV, SZ, Z | [symbol] | — | [symbol] | [symbol] | [symbol] | [symbol] | — | — | — | — |
| RLC | C, N, SZ, Z | [symbol] | — | [symbol] | — | [symbol] | [symbol] | — | — | — | — |
| RLNC | N, SZ, Z | — | — | [symbol] | — | [symbol] | [symbol] | — | — | — | — |
| RRC | C, N, SZ, Z | [symbol] | — | [symbol] | — | [symbol] | [symbol] | — | — | — | — |
| RRNC | N, SZ, Z | — | — | [symbol] | — | [symbol] | [symbol] | — | — | — | — |
| SL | C, N, OV, SZ, Z | [symbol] | — | [symbol] | [symbol] | [symbol] | [symbol] | — | — | — | — |

Rotate/Shift Operations - File Registers

| | | | | | | | | | | | |
|---|---|---|---|---|---|---|---|---|---|---|---|
| ASRF | C, N, OV, SZ, Z | [symbol] | — | [symbol] | [symbol] | [symbol] | [symbol] | — | — | — | — |
| LSRF | C, N, OV, SZ, Z | [symbol] | — | [symbol] | [symbol] | [symbol] | [symbol] | — | — | — | — |
| RLCF | C, N, SZ, Z | [symbol] | — | [symbol] | — | [symbol] | [symbol] | — | — | — | — |
| RLNCF | N, SZ, Z | — | — | [symbol] | — | [symbol] | [symbol] | — | — | — | — |
| RRCF | C, N, SZ, Z | [symbol] | — | [symbol] | — | [symbol] | [symbol] | — | — | — | — |
| RRNCF | N, SZ, Z | — | — | [symbol] | — | [symbol] | [symbol] | — | — | — | — |
| SLF | C, N, OV, SZ, Z | [symbol] | — | [symbol] | [symbol] | [symbol] | [symbol] | — | — | — | — |

Barrel Shift Operations - W Registers (shift range −16 . . . 15)

| | | | | | | | | | | | |
|---|---|---|---|---|---|---|---|---|---|---|---|
| ASRW | C, SZ, Z | [symbol] | — | — | — | [symbol] | [symbol] | — | — | — | — |
| LSRW | C, SZ, Z | [symbol] | — | — | — | [symbol] | [symbol] | — | — | — | — |
| MSLW | C, SZ, Z | [symbol] | — | — | — | [symbol] | [symbol] | — | — | — | — |
| MSRW | C, SZ, Z | [symbol] | — | — | — | [symbol] | [symbol] | — | — | — | — |
| SLW | C, SZ, Z | [symbol] | — | — | — | [symbol] | [symbol] | — | — | — | — |

Barrel Shift Operations - Short Literals (shift range −16 . . . 15)

| | | | | | | | | | | | |
|---|---|---|---|---|---|---|---|---|---|---|---|
| ASRK | C, SZ, Z | [symbol] | — | — | — | [symbol] | [symbol] | — | — | — | — |
| LSRK | C, SZ, Z | [symbol] | — | — | — | [symbol] | [symbol] | — | — | — | — |
| MSLK | C, SZ, Z | [symbol] | — | — | — | [symbol] | [symbol] | — | — | — | — |
| MSRK | C, SZ, Z | [symbol] | — | — | — | [symbol] | [symbol] | — | — | — | — |
| SLK | C, SZ, Z | [symbol] | — | — | — | [symbol] | [symbol] | — | — | — | — |

DSP OPERATIONS - Accumulator Ops

| | | | | | | | | | | | |
|---|---|---|---|---|---|---|---|---|---|---|---|
| ADDAB | OA, OB, SA, SB | — | — | — | — | — | — | [symbol] | [symbol] | [symbol] | [symbol] |
| ADDAC | OA, OB, SA, SB | — | — | — | — | — | — | [symbol] | [symbol] | [symbol] | [symbol] |
| LAC | None | — | — | — | — | — | — | — | — | — | — |
| NEGAB | OA, OB, SA, SB | — | — | — | — | — | — | [symbol] | [symbol] | [symbol] | [symbol] |
| SAC | None | — | — | — | — | — | — | — | — | — | — |
| SFTAC | OA, OB, SA, SB | — | — | — | — | — | — | [symbol] | [symbol] | [symbol] | [symbol] |
| SFTACK | OA, OB, SA, SB | — | — | — | — | — | — | [symbol] | [symbol] | [symbol] | [symbol] |
| SRAC | None | — | — | — | — | — | — | — | — | — | — |
| SUBAB | OA, OB, SA, SB | — | — | — | — | — | — | [symbol] | [symbol] | [symbol] | [symbol] |

DSP OPERATIONS - MAC Ops

| | | | | | | | | | | | |
|---|---|---|---|---|---|---|---|---|---|---|---|
| CLRAC | OA, OB, SA, SB | — | — | — | — | — | — | [symbol] | [symbol] | [symbol] | [symbol] |
| ED | OA, OB, SA, SB | — | — | — | — | — | — | [symbol] | [symbol] | [symbol] | [symbol] |
| EDAC | OA, OB, SA, SB | — | — | — | — | — | — | [symbol] | [symbol] | [symbol] | [symbol] |
| MAC | OA, OB, SA, SB | — | — | — | — | — | — | [symbol] | [symbol] | [symbol] | [symbol] |
| MOVSAC | None | — | — | — | — | — | — | — | — | — | — |
| MPY | OA, OB, SA, SB | — | — | — | — | — | — | [symbol] | [symbol] | [symbol] | [symbol] |
| MPYN | OA, OB, SA, SB | — | — | — | — | — | — | [symbol] | [symbol] | [symbol] | [symbol] |
| MSC | OA, OB, SA, SB | — | — | — | — | — | — | [symbol] | [symbol] | [symbol] | [symbol] |
| SQR | OA, OB, SA, SB | — | — | — | — | — | — | [symbol] | [symbol] | [symbol] | [symbol] |
| SQRAC | OA, OB, SA, SB | — | — | — | — | — | — | [symbol] | [symbol] | [symbol] | [symbol] |

BIT OPERATIONS - W Registers

| | | | | | | | | | | | |
|---|---|---|---|---|---|---|---|---|---|---|---|
| BCLR | None | — | — | — | — | — | — | — | — | — | — |
| BSET | None | — | — | — | — | — | — | — | — | — | — |
| BSW | None | — | — | — | — | — | — | — | — | — | — |
| BTG | None | — | — | — | — | — | — | — | — | — | — |
| BTST | C or Z | [symbol] | — | — | — | — | [symbol] | — | — | — | — |
| BTSTS | C or Z | [symbol] | — | — | — | — | [symbol] | — | — | — | — |
| BTSTW | C or Z | [symbol] | — | — | — | — | [symbol] | — | — | — | — |

BIT OPERATIONS - File Registers

| | | | | | | | | | | | |
|---|---|---|---|---|---|---|---|---|---|---|---|
| BCLRF | None | — | — | — | — | — | — | — | — | — | — |
| BSETF | None | — | — | — | — | — | — | — | — | — | — |
| BTGF | None | — | — | — | — | — | — | — | — | — | — |
| BTSTF | Z | — | — | — | — | — | [symbol] | — | — | — | — |
| BTSTSF | Z | — | — | — | — | — | [symbol] | — | — | — | — |

BIT FIND OPERATIONS

| | | | | | | | | | | | |
|---|---|---|---|---|---|---|---|---|---|---|---|
| FBCL | SZ, Z | — | — | — | — | [symbol] | [symbol] | — | — | — | — |
| FBCR | SZ, Z | — | — | — | — | [symbol] | [symbol] | — | — | — | — |
| FF0L | SZ, Z | — | — | — | — | [symbol] | [symbol] | — | — | — | — |
| FF0R | SZ, Z | — | — | — | — | [symbol] | [symbol] | — | — | — | — |
| FF1L | SZ, Z | — | — | — | — | [symbol] | [symbol] | — | — | — | — |
| FF1R | SZ, Z | — | — | — | — | [symbol] | [symbol] | — | — | — | — |

Skip OPERATIONS - W Registers

| | | | | | | | | | | | |
|---|---|---|---|---|---|---|---|---|---|---|---|
| BTSC | None | — | — | — | — | — | — | — | — | — | — |
| BTSS | None | — | — | — | — | — | — | — | — | — | — |

Skip OPERATIONS - File Registers

| | | | | | | | | | | | |
|---|---|---|---|---|---|---|---|---|---|---|---|
| BTFSC | None | — | — | — | — | — | — | — | — | — | — |
| BTFSS | None | — | — | — | — | — | — | — | — | — | — |

Inc/Dec Skip OPERATIONS - File Registers

| | | | | | | | | | | | |
|---|---|---|---|---|---|---|---|---|---|---|---|
| DECFSNZ | None | — | — | — | — | — | — | — | — | — | — |
| DECFSZ | None | — | — | — | — | — | — | — | — | — | — |
| INCFSNZ | None | — | — | — | — | — | — | — | — | — | — |
| INCFSZ | None | — | — | — | — | — | — | — | — | — | — |

Compare OPERATIONS - W Registers

| | | | | | | | | | | | |
|---|---|---|---|---|---|---|---|---|---|---|---|
| CP0 | C, DC, N, OV, SZ, Z | [symbol] | [symbol] | [symbol] | [symbol] | [symbol] | [symbol] | — | — | — | — |
| CP1 | C, DC, N, OV, SZ, Z | [symbol] | [symbol] | [symbol] | [symbol] | [symbol] | [symbol] | — | — | — | — |
| CP | C, DC, N, OV, SZ, Z | [symbol] | [symbol] | [symbol] | [symbol] | [symbol] | [symbol] | — | — | — | — |
| CPB | C, DC, N, OV, SZ, Z | [symbol] | [symbol] | [symbol] | [symbol] | [symbol] | [symbol] | — | — | — | — |

Compare OPERATIONS - Short Literals (literal 0 . . . 31)

| | | | | | | | | | | | |
|---|---|---|---|---|---|---|---|---|---|---|---|
| CPLS | C, DC, N, OV, SZ, Z | [symbol] | [symbol] | [symbol] | [symbol] | [symbol] | [symbol] | — | — | — | — |
| CPBLS | C, DC, N, OV, SZ, Z | [symbol] | [symbol] | [symbol] | [symbol] | [symbol] | [symbol] | — | — | — | — |

Compare OPERATIONS - File Registers

| | | | | | | | | | | | |
|---|---|---|---|---|---|---|---|---|---|---|---|
| CPF0 | C, DC, N, OV, SZ, Z | [symbol] | [symbol] | [symbol] | [symbol] | [symbol] | [symbol] | — | — | — | — |
| CPF1 | C, DC, N, OV, SZ, Z | [symbol] | [symbol] | [symbol] | [symbol] | [symbol] | [symbol] | — | — | — | — |
| CPF | C, DC, N, OV, SZ, Z | [symbol] | [symbol] | [symbol] | [symbol] | [symbol] | [symbol] | — | — | — | — |
| CPFB | C, DC, N, OV, SZ, Z | [symbol] | [symbol] | [symbol] | [symbol] | [symbol] | [symbol] | — | — | — | — |

Compare Skip OPERATIONS - File Registers

| | | | | | | | | | | | |
|---|---|---|---|---|---|---|---|---|---|---|---|
| CPFSEQ | None | — | — | — | — | — | — | — | — | — | — |
| CPFSGT | None | — | — | — | — | — | — | — | — | — | — |
| CPFSLT | None | — | — | — | — | — | — | — | — | — | — |
| CPFSNE | None | — | — | — | — | — | — | — | — | — | — |

Branch Operations

| | | | | | | | | | | | |
|---|---|---|---|---|---|---|---|---|---|---|---|
| BC | None | — | — | — | — | — | — | — | — | — | — |
| BGE | None | — | — | — | — | — | — | — | — | — | — |
| BGT | None | — | — | — | — | — | — | — | — | — | — |
| BGTU | None | — | — | — | — | — | — | — | — | — | — |
| BLE | None | — | — | — | — | — | — | — | — | — | — |
| BLEU | None | — | — | — | — | — | — | — | — | — | — |
| BLT | None | — | — | — | — | — | — | — | — | — | — |
| BN | None | — | — | — | — | — | — | — | — | — | — |
| BNC | None | — | — | — | — | — | — | — | — | — | — |
| BNN | None | — | — | — | — | — | — | — | — | — | — |
| BNOV | None | — | — | — | — | — | — | — | — | — | — |
| BNZ | None | — | — | — | — | — | — | — | — | — | — |
| BOA | None | — | — | — | — | — | — | — | — | — | — |
| BOB | None | — | — | — | — | — | — | — | — | — | — |
| BOV | None | — | — | — | — | — | — | — | — | — | — |
| BRA | None | — | — | — | — | — | — | — | — | — | — |
| BSA | None | — | — | — | — | — | — | — | — | — | — |
| BSB | None | — | — | — | — | — | — | — | — | — | — |
| BZ | None | — | — | — | — | — | — | — | — | — | — |

Jump/Call/Return Operations

| | | | | | | | | | | | |
|---|---|---|---|---|---|---|---|---|---|---|---|
| BRAW | None | — | — | — | — | — | — | — | — | — | — |
| CALL | None | — | — | — | — | — | — | — | — | — | — |
| CALLW | None | — | — | — | — | — | — | — | — | — | — |
| GOTO | None | — | — | — | — | — | — | — | — | — | — |
| GOTOW | None | — | — | — | — | — | — | — | — | — | — |
| RCALL | None | — | — | — | — | — | — | — | — | — | — |
| RCALLW | None | — | — | — | — | — | — | — | — | — | — |
| RETFIE | INTLV | — | — | — | — | — | — | — | — | — | — |
| RETLW | None | — | — | — | — | — | — | — | — | — | — |
| RETURN | None | — | — | — | — | — | — | — | — | — | — |
| TRAP | None | — | — | — | — | — | — | — | — | — | — |

Looping Operations

| | | | | | | | | | | | |
|---|---|---|---|---|---|---|---|---|---|---|---|
| DO | None | — | — | — | — | — | — | — | — | — | — |
| DOW | None | — | — | — | — | — | — | — | — | — | — |
| REPEAT | None | — | — | — | — | — | — | — | — | — | — |
| REPEATW | None | — | — | — | — | — | — | — | — | — | — |

Stack Operations

| | | | | | | | | | | | |
|---|---|---|---|---|---|---|---|---|---|---|---|
| ITCH | All | [symbol] | [symbol] | [symbol] | [symbol] | [symbol] | [symbol] | [symbol] | [symbol] | [symbol] | [symbol] |
| LNK | None | — | — | — | — | — | — | — | — | — | — |
| POP | None | — | — | — | — | — | — | — | — | — | — |
| PUSH | None | — | — | — | — | — | — | — | — | — | — |
| SCRATCH | None | — | — | — | — | — | — | — | — | — | — |
| ULNK | None | — | — | — | — | — | — | — | — | — | — |

Control Operations

| | | | | | | | | | | | |
|---|---|---|---|---|---|---|---|---|---|---|---|
| CLRWDT | \overline{TO}, \overline{PD} | — | — | — | — | — | — | — | — | — | — |
| DISI | None | — | — | — | — | — | — | — | — | — | — |
| HALT | None | — | — | — | — | — | — | — | — | — | — |
| NOP | None | — | — | — | — | — | — | — | — | — | — |
| NOPR | None | — | — | — | — | — | — | — | — | — | — |
| RESET | None | — | — | — | — | — | — | — | — | — | — |
| SLEEP | \overline{TO}, \overline{PD} | — | — | — | — | — | — | — | — | — | — |

TABLE 189
Central Processing Unit Opcode Field Descriptions

| Field | Description |
|---|---|
| A | Accumulator selection bit: 0 = ACCA; 1 = ACCB |
| B | Byte mode selection bit: 0 = word operation; 1 = byte operation |
| D | Destination address bit: 0 = result stored in Wd; 1 = result stored in file register |
| S | Push or Pop shadows: 0 = no shadows; 1 = use shadows |
| z | Bit test destination: 0 = C flag bit; 1 = Z flag bit |
| dddd | Wd destination register select: 0000 = W0; 1111 = W15 |
| ssss | Ws source register select: 0000 = W0; 1111 = W15 |
| wwww | Wb base register select: 0000 = W0; 1111 = W15 |
| ppp | Addressing mode for Ws source register (See Table 190) |
| qqq | Addressing mode for Wd destination register (See Table 191) |
| ggg | Literal offset addressing mode for Ws source register (See Table 192) |
| hhh | Literal offset addressing mode for Wd destination register (See Table 193) |
| xx | Pre-fetch X Destination (See Table 195) |
| yy | Pre-fetch Y Destination (See Table 198) |
| iiii | Pre-fetch X Operation (SeeTable 194) |
| jjjj | Pre-fetch Y Operation (SeeTable 197) |
| mmm | Multiplier source select (SeeTable 196) |
| aa | Accumulator write back mode (See Table 199) |
| rrrr | Barrel shift count |
| bbb | 3-bit bit position select: 000 = LSB; 111 = Mr. Soliman Boustany |
| bbbb | 4-bit bit position select: 0000 = LSB; 1111 = Mr. Soliman Boustany |
| f ffff ffff ffff | 13-bit register file address (0x0000 to 0x1FFF) |
| ffff ffff ffff ffff | 16-bit register file address (0x0000 to 0xFFFF) |
| k kkkk | 5-bit literal field, constant data or label |
| kkkk kkkk | 8-bit literal field, constant data or label |
| kk kkkk kkkk | 10-bit literal field, constant data or label |
| kk kkkk kkkk kkkk | 14-bit literal field, constant data or label |
| kkkk kkkk kkkk kkkk | 16-bit literal field, constant data or label |
| n | 1-bit vector select for trap instructions |
| nnnn nnnn nnnn nnnn | 16-bit program offset field for relative branch/call instructions |
| nnnn nnnn nnnn nnn0 | 23-bit program address for goto/call instructions |
| nnn nnnn | |
| xxxx xxxx xxxx xxxx | 16-bit unused field (don't care) |

TABLE 190
Addressing Modes For Ws Source Register (Address Mode 1)

| | | Source | Instruction | |
|---|---|---|---|---|
| ppp | Addressing Mode | Operand | Operation (3) | Effective Address |
| 000 | Register Direct | Ws | Wd = Ws op Wb | EAs = W register number |
| 001 | Indirect | [Ws] | Wd = [Ws] op Wb | EAs = Ws |
| 010 | Indirect with post-decrement | [Ws]−− | Wd = [Ws]−− op Wb | EAs = Ws; |
| | | | | Ws <- (Ws − 1)⁽¹⁾ |
| | | | | - or - |
| | | | | Ws <- (Ws − 2)⁽²⁾ |
| 011 | Indirect with post-increment | [Ws]++ | Wd = [Ws]++ op Wb | EAs = Ws; |
| | | | | Ws <- (Ws + 1)⁽¹⁾ |
| | | | | - or - |
| | | | | Ws <- (Ws + 2)⁽²⁾ |
| 100 | Indirect with pre-decrement | [Ws−−] | Wd = [Ws−−] op Wb | Ws <- (Ws − 1)⁽¹⁾; |
| | | | | - or - |
| | | | | Ws <- (Ws − 2)⁽²⁾; |
| | | | | EAs = Ws |
| 101 | Indirect with pre-increment | [Ws++] | Wd = [Ws++] op Wb | Ws <- (Ws + 1)⁽¹⁾; |
| | | | | - or - |
| | | | | Ws <- (Ws + 2)⁽²⁾; |
| | | | | EAs = Ws |

| | |
|---|---|
| 11k | (Specifies Slit5 Source for Short Literal Instructions) |

Note:
¹For byte operations, add or subtract 1.
²For word operations, add or subtract 2.
3: Wd assumed to be in register direct mode (qqq = 000).

TABLE 191
Addressing Modes For Wd Destination Register (Address Mode 2)

| | | Destination | Instruction | |
|---|---|---|---|---|
| qqq | Addressing Mode | Operand | Operation (3) | Effective Address |
| 000 | Register Direct | Wd | Wd = Ws op Wb | EAd = W register number |
| 001 | Indirect | [Wd] | [Wd] = Ws op Wb | EAd = Wd |
| 010 | Indirect with post-decrement | [Wd]−− | [Wd]−− = Ws op Wb | EAd = Wd; |
| | | | | Ws <- (Wd − 1)⁽¹⁾ |
| | | | | - or - |
| | | | | Wd <- (Wd − 2)⁽²⁾ |
| 011 | Indirect with post-increment | [Wd]++ | [Wd]++ = Ws op Wb | EAd = Wd; |
| | | | | - or - |
| | | | | Wd <- (Wd + 1)⁽¹⁾ |
| | | | | - or - |
| | | | | Wd <- (Wd + 2)⁽²⁾ |
| 100 | Indirect with pre-decrement | [Wd−−] | [Wd−−] = Ws op Wb | Wd <- (Wd − 1)⁽¹⁾; |
| | | | | - or - |
| | | | | Wd <- (Wd − 2)⁽²⁾; |
| | | | | EAd = Wd |
| 101 | Indirect with pre-increment | [Wd++] | [Wd++] = Ws op Wb | Wd <- (Wd + 1)⁽¹⁾; |
| | | | | - or - |
| | | | | Wd <- (Wd + 2)⁽²⁾; |
| | | | | EAd = Wd |
| 11x | (Unused) | | | |

Note:
¹For byte operations, add or subtract 1.
²For word operations, add or subtract 2.
3. Ws assumed to be in register direct mode (ppp = 000).

TABLE 192
Offset Addressing Modes For Wso Source Register (Mode 3)

| ggg | Addressing Mode | Source Operand | Effective Address |
|---|---|---|---|
| 000 | Register Direct | Wns | EA = W register number |
| 001 | Indirect | [Wns] | EA = Wns |
| 010 | Indirect with post-decrement | [Wns]−− | EA = Wns; |
| | | | Wns <- (Wns − 1)⁽¹⁾ |
| | | | - or - |
| | | | Wns <- (Wns − 2)⁽²⁾ |
| 011 | Indirect with post-increment | [Wns]++ | EA = Wns; |
| | | | Wns <- (Wns + 1)⁽¹⁾ |
| | | | - or - |
| | | | Wns <- (Wns + 2)⁽²⁾ |
| 100 | Indirect with pre-decrement | [Wns−−] | Wns <- (Wns − 1)⁽¹⁾; |
| | | | - or - |
| | | | Wns <- (Wns − 2)⁽²⁾; |
| | | | EA = Wns |
| 101 | Indirect with register offset | [Wns + Wb] | EA = Wns + Wb⁽³⁾ |
| | Indirect with positve offset by short literal | [Wns + Slit5] | EA = Wns + gwwww)⁽⁴⁾ |
| | | | - or - |
| | | | EA = (Wns + 2 * gwwww)⁽⁵⁾ |
| 11g | Slit5 ∈ (−16 . . . 15) | | |

Note:
¹For byte operations, add or subtract 1.
²For word operations, add or subtract 2.
³For byte and word operations, add 2's compliment Wb.
⁴For byte operations, add or subtract gwwww.
⁵For word operations, add or subtract (2 * gwwww) or gwwww0.

TABLE 193
Offset Addressing Modes For Wdo Destination Register (Mode 3)

| hhh | Addressing Mode | Source Operand | Effective Address |
|---|---|---|---|
| 000 | Register Direct | Wnd | EA = W register number |
| 001 | Indirect | [Wnd] | EA = Wnd |
| 010 | Indirect with post-decrement | [Wnd]−− | EA = Wnd; |
| | | | Wnd <- (Wnd − 1)⁽¹⁾ |
| | | | - or - |
| | | | Wnd <- (Wnd −2)⁽²⁾ |
| 011 | Indirect with post-increment | [Wnd]++ | EA = Wnd; |
| | | | Wnd <- (Wnd + 1)⁽¹⁾ |
| | | | - or - |
| | | | Wnd <- (Wnd + 2)⁽²⁾ |
| 100 | Indirect with pre-decrement | [Wnd−−] | Wnd <- (Wnd − 1)⁽¹⁾; |
| | | | - or - |
| | | | Wnd <- (Wnd − 2)⁽²⁾; |
| | | | EA = Wnd |
| 101 | Indirect with register offset | [Wnd + Wb] | EA = Wnd + Wb⁽³⁾ |
| | Indirect with positve offset by short literal | [Wnd + Slit5] | EA = (Wnd + hwwww)⁽⁴⁾ |
| | | | - or - |
| | | | EA = (Wnd + 2 * hwwww)⁽⁵⁾ |
| 11h | Slit5 ∈ (−16 . . . 15) | | |

For byte operations, add or subtract 1.
For word operations, add or subtract 2.
For byte and word operations, add 2's compliment Wb.
For byte operations, add or subtract hwwww.
For word operations, add or subtract (2 * hwwww) or hwwww0.

TABLE 194
X DATA SPACE PREFETCH OPERATION

| iiii | Operation |
|---|---|
| 0000 | Wxp = [W4] |
| 0001 | Wxp = [W4], W4 = W4 + 2 |
| 0010 | Wxp = [W4], W4 = W4 + 4 |
| 0011 | Wxp = [W4], W4 = W4 + 6 |
| 0100 | No Prefetch for X Data Space |
| 0101 | Wxp = [W4], W4 = W4 − 6 |
| 0110 | Wxp = [W4], W4 = W4 − 4 |
| 0111 | Wxp = [W4], W4 = W4 − 2 |
| 1000 | Wxp = [W5] |
| 1001 | Wxp = [W5], W5 = W5 + 2 |
| 1010 | Wxp = [W5], W5 = W5 + 4 |
| 1011 | Wxp = [W5], W5 = W5 + 6 |
| 1100 | Wxp = [W5 + W8] |
| 1101 | Wxp = [W5], W5 = W5 − 6 |
| 1110 | Wxp = [W5], W5 = W5 − 4 |
| 1111 | Wxp = [W5], W5 = W5 − 2 |

TABLE 195
X Data Space Prefetch Destination

| xx | Wxp |
|---|---|
| 00 | W0 |
| 01 | W1 |
| 10 | W2 |
| 11 | W3 |

TABLE 196
MAC or MPY Source Operands

| mmm | Multiplicands |
|---|---|
| 000 | W0 * W1 |
| 001 | W0 * W2 |
| 010 | W0 * W3 |
| 011 | Invalid (CLRAC instruction) |
| 100 | W1 * W2 |
| 101 | W1 * W3 |
| 110 | W2 * W3 |
| 111 | Invalid (MOVS instruction) |

TABLE 197
Y Data Space Prefetch Operation

| jjjj | Operation |
|---|---|
| 0000 | Wyp = [W6] |
| 0001 | Wyp = [W6], W6 = W6 + 2 |
| 0010 | Wyp = [W6], W6 = W6 + 4 |
| 0011 | Wyp = [W6], W6 = W6 + 6 |
| 0100 | No Prefetch for Y Data Space |
| 0101 | Wyp = [W6], W6 = W6 − 6 |
| 0110 | Wyp = [W6], W6 = W6 − 4 |
| 0111 | Wyp = [W6], W6 = W6 − 2 |
| 1000 | Wyp = [W7] |
| 1001 | Wyp = [W7], W7 = W7 + 2 |
| 1010 | Wyp = [W7], W7 = W7 + 4 |
| 1011 | Wyp = [W7], W7 = W7 + 6 |
| 1100 | Wyp = [W7 + W8] |
| 1101 | Wyp = [W7], W7 = W7 − 6 |
| 1110 | Wyp = [W7], W7 = W7 − 4 |
| 1111 | Wyp = [W7], W7 = W7 − 2 |

TABLE 198
Y Data Space Prefetch Destination

| yy | Wyp |
|---|---|
| 00 | W0 |
| 01 | W1 |
| 10 | W2 |
| 11 | W3 |

TABLE 199
Mac Accumulator Write Back Selections

| aa | Multiplicands |
|---|---|
| 00 | W9 = Other Accumulator (direct) |
| 01 | [W9]++ = Other Accumulator |
| | (indirect, post-increment) |
| 10 | No write back |
| 11 | Invalid (MPYxxx instruction) |

The invention, therefore, is well adapted to carry out the objects and attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alternation, and equivalents in form and function, as well occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

1. An apparatus comprising:
a processor unit capable of executing one or more first instructions;
a digital signal processor operative with the central processing unit, the digital signal processor capable of executing one or more second instructions;
an instruction set having first instructions and second instructions; and
the central processing unit and the digital signal processor constructed and arranged to form a programmer model having the digital signal processor having two or more working registers, program memory storing one or more of the instructions in the instruction set, a program counter, and at least one execution unit capable of executing one or more of the instructions in the instruction set.

2. The apparatus of claim 1, wherein the instruction set includes one or more instructions selected from the group consisting of MAC, MSC, MP, MPYN and ED.

3. The apparatus of claim 1, wherein the instruction set includes one or more instructions selected from the group consisting of NOP, CALLW, RCALLW, GOTOW, BRAW, CALL, DO, DOW, REPEAT, REPEATW, BOA, BOB, BSA, and BSB.

4. The apparatus of claim 1, wherein the instruction set includes one or more instructions selected from the group consisting of SUBR, SUBRLS, MOVL, BOV, BC, BZ, BN, BLE, BLT, BLEU, BRA, BNOV, BNC, BNZ, BNN, BGT, BGE, and BGTU.

5. The apparatus of claim 1, wherein the instruction set includes one or more instructions selected from the group consisting of ADD, ADDLS, ADDC, ADDCLS, SUB, SUBLS, SUBB, SUBBLS, AND, ANDLS, XOR, XORLS, IOR, IORLS, and MOV.

6. The apparatus of claim 1, wherein the instruction set includes one or more instructions selected from the group consisting of BTST, BTSTS, BTSTW, BTSS, BTSC, BSETF, BCLRF, BTGF, BTSTF, BRSTSF, BSW, BTFSS and BTFSC.

7. The apparatus of claim 1, wherein the instruction set includes one or more instructions selected from the group consisting of ADDLW, ADDCLW, SUBLW, SUBBLW, ANDLW, XORLW, IORLW, ADDWF, ADDCWF, SUBWF, SUBBWF, ANDWF, XORWF, IORWF, MOVWF, MULU, MULUS, MULSU, MULS, TBLRDL, TBLRDH, TBLWTL, TBLWTH, MULWF, SUBFW, SUBBFW and MOVF.

8. The apparatus of claim 1, wherein the instruction set includes one or more instructions selected from the group consisting of MOVSAC, SFTAC, SFTACK, ADDAC, LAC, ADDAB, NEGAB, SUBAB, SAC and SRAC.

9. The apparatus of claim 1, wherein the instruction set includes one or more instructions selected from the group consisting of SL, LSR, ASR, RLNC, RLC, RRNC, RRC, SLF, LSRF, ASRF, RLNCF, RLCF, RRNCF, RRCF, SLW, and ASRW.

10. The apparatus of claim 1, wherein the instruction set includes one or more instructions selected from the group consisting of CP(LS), CPB(LS), CPF0, CPF, CPFB, INC, INC2, DEC, DEC2, NEG, COM, INCF, INCF2, DECF, DECF2, NEGF, COMF, CLRF and SETF.

11. The apparatus of claim 1, wherein the instruction set includes one or more instructions selected from the group consisting of PUSH, POP, LNK, ULNK, DISI, DAW, EXCH, SWAP, CLRWDT, RESET, ITCH, SCRATCH and NOPR.

12. The apparatus of claim 1, wherein the instruction set includes one or more instructions selected from the group consisting of ADD, ADDAB, ADDAC, ADDC, ADDCLS, ADDCLW, ADDCWF, ADDLS, ADDLW, ADDWF, AND, ANDLS, ANDLW, ANDWF, ASR, ASRF, ASRW, BC, BCLRF, BGE, BGT, BGTU, BLE, BLEU, BLT, BN, BNC, BNN, BNOV, BNZ, BOA, BOB, BOV, BRA, BRAW, BRSTSF, BSA, BSB, BSETF, BSW, BTFSC, BTFSS, BTGF, BTSC, BTSS, BTST, BTSTF, BTSTS, BTSTW, BZ, CALL, CALLW, CLRF, CLRWDT, COM, COMF, CP(LS), CPB(LS), CPF, CPF0, CPFB, DAW, DEC, DEC2, DECF, DECF2, DISI, DO, DOW, ED, EXCH, GOTOW, INC, INC2, INCF, INCF2, IOR, IORLS, IORLW, IORWF, ITCH, LAC, LNK, LSR, LSRF, MAC, MOV, MOVF, MOVL, MOVSAC, MOVWF, MP, MPYN, MSC, MULS, MULSU, MULU, MULUS, MULWF, NEG, NEGAB, NEGF, NOP, NOPR, POP, PUSH, RCALLW, REPEAT, REPEATW, RESET, RLC, RLCF, RLNC, RLNCF, RRC, RRCF, RRNC, RRNCF, SAC, SCRATCH, SETF, SFTAC, SFTACK, SL, SLF, SLW, SRAC, SUB, SUBAB, SUBB, SUBBFW, SUBBLS, SUBBLW, SUBBWF, SUBFW, SUBLS, SUBLW, SUBR, SUBRLS, SUBWF, SWAP, TBLRDH, TBLRDL, TBLWTH, TBLWTL, ULNK, XOR, XORLS, XORLW and XORWF.

13. The apparatus of claim 1, wherein the instruction set includes two or more instructions selected from the group consisting of ADD, ADDAB, ADDAC, ADDC, ADDCLS, ADDCLW, ADDCWF, ADDLS, ADDLW, ADDWF, AND, ANDLS, ANDLW, ANDWF, ASR, ASRF, ASRW, BC, BCLRF, BGE, BGT, BGTU, BLE, BLEU, BLT, BN, BNC, BNN, BNOV, BNZ, BOA, BOB, BOV, BRA, BRAW, BRSTSF, BSA, BSB, BSETF, BSW, BTFSC, BTFSS, BTGF, BTSC, BTSS, BTST, BTSTF, BTSTS, BTSTW, BZ, CALL, CALLW, CLRF, CLRWDT, COM, COMF, CP(LS), CPB(LS), CPF, CPF0, CPFB, DAW, DEC, DEC2, DECF, DECF2, DISI, DO, DOW, ED, EXCH, GOTOW, INC, INC2, INCF, INCF2, IOR, IORLS, IORLW, IORWF, ITCH, LAC, LNK, LSR, LSRF, MAC, MOV, MOVF, MOVL, MOVSAC, MOVWF, MP, MPYN, MSC, MULS, MULSU, MULU, MULUS, MULWF, NEG, NEGAB, NEGF, NOP, NOPR, POP, PUSH, RCALLW, REPEAT, REPEATW, RESET, RLC, RLCF, RLNC, RLNCF, RRC, RRCF, RRNC, RRNCF, SAC, SCRATCH, SETF, SFTAC, SFTACK, SL, SLF, SLW, SRAC, SUB, SUBAB, SUBB, SUBBFW, SUBBLS, SUBBLW, SUBBWF, SUBFW, SUBLS, SUBLW, SUBR, SUBRLS, SUBWF, SWAP, TBLRDH, TBLRDL, TBLWTH, TBLWTL, ULNK, XOR, XORLS, XORLW and XORWF.

14. The apparatus of claim 1, wherein the instruction set includes three or more instructions selected from the group consisting of ADD, ADDAB, ADDAC, ADDC, ADDCLS, ADDCLW, ADDCWF, ADDLS, ADDLW, ADDWF, AND, ANDLS, ANDLW, ANDWF, ASR, ASRF, ASRW, BC, BCLRF, BGE, BGT, BGTU, BLE, BLEU, BLT, BN, BNC, BNN, BNOV, BNZ, BOA, BOB, BOV, BRA, BRAW, BRSTSF, BSA, BSB, BSETF, BSW, BTFSC, BTFSS, BTGF, BTSC, BTSS, BTST, BTSTF, BTSTS, BTSTW, BZ, CALL, CALLW, CLRF, CLRWDT, COM, COMF, CP(LS), CPB(LS), CPF, CPF0, CPFB, DAW, DEC, DEC2, DECF, DECF2, DISI, DO, DOW, ED, EXCH, GOTOW, INC, INC2, INCF, INCF2, IOR, IORLS, IORLW, IORWF, ITCH, LAC, LNK, LSR, LSRF, MAC, MOV, MOVF, MOVL, MOVSAC, MOVWF, MP, MPYN, MSC, MULS, MULSU, MULU, MULUS, MULWF, NEG, NEGAB, NEGF, NOP, NOPR, POP, PUSH, RCALLW, REPEAT, REPEATW, RESET, RLC, RLCF, RLNC, RLNCF, RRC, RRCF, RRNC, RRNCF, SAC, SCRATCH, SETF, SFTAC, SFTACK, SL, SLF, SLW, SRAC, SUB, SUBAB, SUBB, SUBBFW, SUBBLS, SUBBLW, SUBBWF, SUBFW, SUBLS, SUBLW, SUBR, SUBRLS, SUBWF, SWAP, TBLRDH, TBLRDL, TBLWTH, TBLWTL, ULNK, XOR, XORLS, XORLW and XORWF.

15. The apparatus of claim 1, wherein the instruction set includes four or more instructions selected from the group consisting of ADD, ADDAB, ADDAC, ADDC, ADDCLS, ADDCLW, ADDCWF, ADDLS, ADDLW, ADDWF, AND, ANDLS, ANDLW, ANDWF, ASR, ASRF, ASRW, BC, BCLRF, BGE, BGT, BGTU, BLE, BLEU, BLT, BN, BNC, BNN, BNOV, BNZ, BOA, BOB, BOV, BRA, BRAW, BRSTSF, BSA, BSB, BSETF, BSW, BTFSC, BTFSS, BTGF, BTSC, BTSS, BTST, BTSTF, BTSTS, BTSTW, BZ, CALL, CALLW, CLRF, CLRWDT, COM, COMF, CP(LS), CPB(LS), CPF, CPF0, CPFB, DAW, DEC, DEC2, DECF, DECF2, DISI, DO, DOW, ED, EXCH, GOTOW, INC, INC2, INCF, INCF2, IOR, IORLS, IORLW, IORWF, ITCH, LAC, LNK, LSR, LSRF, MAC, MOV, MOVF, MOVL, MOVSAC, MOVWF, MP, MPYN, MSC, MULS, MULSU, MULU, MULUS, MULWF, NEG, NEGAB, NEGF, NOP, NOPR, POP, PUSH, RCALLW, REPEAT, REPEATW, RESET, RLC, RLCF, RLNC, RLNCF, RRC, RRCF, RRNC, RRNCF, SAC, SCRATCH, SETF, SFTAC, SFTACK, SL, SLF, SLW, SRAC, SUB, SUBAB, SUBB, SUBBFW, SUBBLS, SUBBLW, SUBBWF, SUBFW, SUBLS, SUBLW, SUBR, SUBRLS, SUBWF, SWAP, TBLRDH, TBLRDL, TBLWTH, TBLWTL, ULNK, XOR, XORLS, XORLW and XORWF.

16. The apparatus of claim 1, wherein the instruction set includes five or more instructions selected from the group consisting of ADD, ADDAB, ADDAC, ADDC, ADDCLS, ADDCLW, ADDCWF, ADDLS, ADDLW, ADDWF, AND, ANDLS, ANDLW, ANDWF, ASR, ASRF, ASRW, BC, BCLRF, BGE, BGT, BGTU, BLE, BLEU, BLT, BN, BNC, BNN, BNOV, BNZ, BOA, BOB, BOV, BRA, BRAW, BRSTSF, BSA, BSB, BSETF, BSW, BTFSC, BTFSS, BTGF, BTSC, BTSS, BTST, BTSTF, BTSTS, BTSTW, BZ, CALL, CALLW, CLRF, CLRWDT, COM, COMF, CP(LS), CPB(LS), CPF, CPF0, CPFB, DAW, DEC, DEC2, DECF, DECF2, DISI, DO, DOW, ED, EXCH, GOTOW, INC, INC2, INCF, INCF2, IOR, IORLS, IORLW, IORWF, ITCH, LAC, LNK, LSR, LSRF, MAC, MOV, MOVF, MOVL, MOVSAC, MOVWF, MP, MPYN, MSC, MULS, MULSU, MULU, MULUS, MULWF, NEG, NEGAB, NEGF, NOP, NOPR, POP, PUSH, RCALLW, REPEAT, REPEATW, RESET, RLC, RLCF, RLNC, RLNCF, RRC, RRCF, RRNC, RRNCF, SAC, SCRATCH, SETF, SFTAC, SFTACK, SL, SLF, SLW, SRAC, SUB, SUBAB, SUBB, SUBBFW, SUBBLS, SUBBLW, SUBBWF, SUBFW, SUBLS, SUBLW, SUBR, SUBRLS, SUBWF, SWAP, TBLRDH, TBLRDL, TBLWTH, TBLWTL, ULNK, XOR, XORLS, XORLW and XORWF.

17. The apparatus of claim 1, wherein the instruction set includes ten or more instructions selected from the group consisting of ADD, ADDAB, ADDAC, ADDC, ADDCLS, ADDCLW, ADDCWF, ADDLS, ADDLW, ADDWF, AND, ANDLS, ANDLW, ANDWF, ASR, ASRF, ASRW, BC, BCLRF, BGE, BGT, BGTU, BLE, BLEU, BLT, BN, BNC, BNN, BNOV, BNZ, BOA, BOB, BOV, BRA, BRAW, BRSTSF, BSA, BSB, BSETF, BSW, BTFSC, BTFSS, BTGF, BTSC, BTSS, BTST, BTSTF, BTSTS, BTSTW, BZ, CALL, CALLW, CLRF, CLRWDT, COM, COMF, CP(LS), CPB(LS), CPF, CPF0, CPFB, DAW, DEC, DEC2, DECF, DECF2, DISI, DO, DOW, ED, EXCH, GOTOW, INC, INC2, INCF, INCF2, IOR, IORLS, IORLW, IORWF, ITCH, LAC, LNK, LSR, LSRF, MAC, MOV, MOVF, MOVL, MOVSAC, MOVWF, MP, MPYN, MSC, MULS, MULSU, MULU, MULUS, MULWF, NEG, NEGAB, NEGF, NOP, NOPR, POP, PUSH, RCALLW, REPEAT, REPEATW, RESET, RLC, RLCF, RLNC, RLNCF, RRC, RRCF, RRNC, RRNCF, SAC, SCRATCH, SETF, SFTAC, SFTACK, SL, SLF, SLW, SRAC, SUB, SUBAB, SUBB, SUBBFW, SUBBLS, SUBBLW, SUBBWF, SUBFW, SUBLS, SUBLW, SUBR, SUBRLS, SUBWF, SWAP, TBLRDH, TBLRDL, TBLWTH, TBLWTL, ULNK, XOR, XORLS, XORLW and XORWF.

18. The apparatus of claim 1, wherein the instruction set includes fifteen or more instructions selected from the group consisting of ADD, ADDAB, ADDAC, ADDC, ADDCLS, ADDCLW, ADDCWF, ADDLS, ADDLW, ADDWF, AND, ANDLS, ANDLW, ANDWF, ASR, ASRF, ASRW, BC, BCLRF, BGE, BGT, BGTU, BLE, BLEU, BLT, BN, BNC, BNN, BNOV, BNZ, BOA, BOB, BOV, BRA, BRAW, BRSTSF, BSA, BSB, BSETF, BSW, BTFSC, BTFSS, BTGF, BTSC, BTSS, BTST, BTSTF, BTSTS, BTSTW, BZ, CALL, CALLW, CLRF, CLRWDT, COM, COMF, CP(LS), CPB(LS), CPF, CPF0, CPFB, DAW, DEC, DEC2, DECF, DECF2, DISI, DO, DOW, ED, EXCH, GOTOW, INC, INC2, INCF, INCF2, IOR, IORLS, IORLW, IORWF, ITCH, LAC, LNK, LSR, LSRF, MAC, MOV, MOVF, MOVL, MOVSAC, MOVWF, MP, MPYN, MSC, MULS, MULSU, MULU, MULUS, MULWF, NEG, NEGAB, NEGF, NOP, NOPR, POP, PUSH, RCALLW, REPEAT, REPEATW, RESET, RLC, RLCF, RLNC, RLNCF, RRC, RRCF, RRNC, RRNCF, SAC, SCRATCH, SETF, SFTAC, SFTACK, SL, SLF, SLW, SRAC, SUB, SUBAB, SUBB, SUBBFW, SUBBLS, SUBBLW, SUBBWF, SUBFW, SUBLS, SUBLW, SUBR, SUBRLS, SUBWF, SWAP, TBLRDH, TBLRDL, TBLWTH, TBLWTL, ULNK, XOR, XORLS, XORLW and XORWF.

19. The apparatus of claim 1, wherein the instruction set includes twenty or more instructions selected from the group consisting of ADD, ADDAB, ADDAC, ADDC, ADDCLS, ADDCLW, ADDCWF, ADDLS, ADDLW, ADDWF, AND, ANDLS, ANDLW, ANDWF, ASR, ASRF, ASRW, BC, BCLRF, BGE, BGT, BGTU, BLE, BLEU, BLT, BN, BNC, BNN, BNOV, BNZ, BOA, BOB, BOV, BRA, BRAW, BRSTSF, BSA, BSB, BSETF, BSW, BTFSC, BTFSS, BTGF, BTSC, BTSS, BTST, BTSTF, BTSTS, BTSTW, BZ, CALL, CALLW, CLRF, CLRWDT, COM, COMF, CP(LS), CPB(LS), CPF, CPF0, CPFB, DAW, DEC, DEC2, DECF, DECF2, DISI, DO, DOW, ED, EXCH, GOTOW, INC, INC2, INCF, INCF2, IOR, IORLS, IORLW, IORWF, ITCH, LAC, LNK, LSR, LSRF, MAC, MOV, MOVF, MOVL, MOVSAC, MOVWF, MP, MPYN, MSC, MULS, MULSU, MULU, MULUS, MULWF, NEG, NEGAB, NEGF, NOP, NOPR, POP, PUSH, RCALLW, REPEAT, REPEATW, RESET, RLC, RLCF, RLNC, RLNCF, RRC, RRCF, RRNC, RRNCF, SAC, SCRATCH, SETF, SFTAC, SFTACK, SL, SLF, SLW, SRAC, SUB, SUBAB, SUBB, SUBBFW, SUBBLS, SUBBLW, SUBBWF, SUBFW, SUBLS, SUBLW, SUBR, SUBRLS, SUBWF, SWAP, TBLRDH, TBLRDL, TBLWTH, TBLWTL, ULNK, XOR, XORLS, XORLW and XORWF.

20. The apparatus of claim 1, wherein the instruction set includes twenty five or more instructions selected from the group consisting of ADD, ADDAB, ADDAC, ADDC, ADDCLS, ADDCLW, ADDCWF, ADDLS, ADDLW, ADDWF, AND, ANDLS, ANDLW, ANDWF, ASR, ASRF, ASRW, BC, BCLRF, BGE, BGT, BGTU, BLE, BLEU, BLT, BN, BNC, BNN, BNOV, BNZ, BOA, BOB, BOV, BRA, BRAW, BRSTSF, BSA, BSB, BSETF, BSW, BTFSC, BTFSS, BTGF, BTSC, BTSS, BTST, BTSTF, BTSTS, BTSTW, BZ, CALL, CALLW, CLRF, CLRWDT, COM, COMF, CP(LS), CPB(LS), CPF, CPF0, CPFB, DAW, DEC, DEC2, DECF, DECF2, DISI, DO, DOW, ED, EXCH, GOTOW, INC, INC2, INCF, INCF2, IOR, IORLS, IORLW, IORWF, ITCH, LAC, LNK, LSR, LSRF, MAC, MOV, MOVF, MOVL, MOVSAC, MOVWF, MP, MPYN, MSC, MULS, MULSU, MULU, MULUS, MULWF, NEG, NEGAB, NEGF, NOP, NOPR, POP, PUSH, RCALLW, REPEAT, REPEATW, RESET, RLC, RLCF, RLNC, RLNCF, RRC, RRCF, RRNC, RRNCF, SAC, SCRATCH, SETF, SFTAC, SFTACK, SL, SLF, SLW, SRAC, SUB, SUBAB, SUBB, SUBBFW, SUBBLS, SUBBLW, SUBBWF, SUBFW, SUBLS, SUBLW, SUBR, SUBRLS, SUBWF, SWAP, TBLRDH, TBLRDL, TBLWTH, TBLWTL, ULNK, XOR, XORLS, XORLW and XORWF.
